(19) United States
(12) Patent Application Publication
(10) Pub. No.: US 2022/0338497 A1
(43) Pub. Date: Oct. 27, 2022

(54) CULTURED CHEESE MADE FROM PLANTS

(71) Applicant: Cross Cultured Foods PBC, Oakland, CA (US)

(72) Inventor: Nathaniel CHU, Berkeley, CA (US)

(21) Appl. No.: 17/726,446

(22) Filed: Apr. 21, 2022

Related U.S. Application Data
(60) Provisional application No. 63/179,134, filed on Apr. 23, 2021.

(51) Int. Cl. A23C 20/02; A23L 29/00; A23L 29/206

(52) U.S. Cl. CPC A23C 20/025; A23L 29/06; A23L 29/065; A23L 29/206; A23C 2220/20

(57) ABSTRACT

Cultured plant-based cheese compositions are formed from a plant-based emulsion made from legume material, seed material, or a combination thereof; coagulated into curds using a coagulating agent; and combined with one or more microbial cultures and proteolytic enzymes, which serve to develop flavor and texture during aging. Whey is then driven from the curds using a mechanical process to exert pressure on the curds. The cultured plant-based cheese composition may further include plant fats; sugars that serve to support the growth and fermentation of the microbial cultures; other ingredients that contribute to flavor development such as citrate or citric acid; or any combination thereof. Further flavor development occurs during aging, where the curds are maintained at temperatures of 0-16° C. for up to two years or more. In preferred variations, the cultured plant-based cheese composition does not comprise nuts.

### CROSS-REFERENCE TO RELATED APPLICATIONS

This application claims priority to U.S. Provisional Application No. 63/179,134, filed on Apr. 23, 2021, which is hereby incorporated by reference herein in its entirety.

### STATEMENT REGARDING FEDERALLY-SPONSORED RESEARCH

This invention was made with government support under Small Business Innovation Research (SBIR) Phase I Grant Number 2112405 awarded by the National Science Foundation. The government has certain rights in the invention.

### FIELD

The present disclosure relates generally to plant-based food compositions, and more specifically to hard, aged cultured plant-based cheese compositions and methods of making thereof.

### BACKGROUND

Since its origins about 8,000 years ago, cheese has been primarily a dairy product. Methods to produce cheese from the milk of cows, sheep, goats, and other mammals were developed and refined over millennia, serving both to preserve a quickly spoiled resource and to create new foods that were themselves delicious and valuable. Variations in these methods—including processing steps, kind of milk and ingredients, and location and time of production—led to the well-known diversity of cheeses enjoyed today.

Despite this diversity, dairy cheeses often share many of the same procedures and steps. First, milk is cultured with microbes, which acidify it. The milk is then solidified using a coagulant, usually containing a proteolytic enzyme from animal, plant, or microbial sources. Such enzymes coagulate milk proteins biochemically, which separates curds (solids) from whey (liquids). Different types of cheese curds are then cooked, stirred, washed, stacked, stretched or otherwise manipulated to facilitate the release of whey and alter the curds' physicochemical behavior. Most cheeses are then salted and shaped into forms; the most flavorful cheeses are then aged, a slow process during which enzymes and microbes break down the milk proteins and fats into flavor compounds we associate with different cheese varieties.

Nowadays, many people choose to avoid dairy products. Some do so for health reasons, including: allergies, as 2-3% of children in developed countries are allergic to milk proteins (Host, A. Frequency of cow's milk allergy in childhood. Ann. Allergy. Asthma. Immunol. 89, 33-37, 2002); lactose intolerance, as over 30% of people in the United States and over 60% of people globally are lactose intolerant (Storhaug, C. L. et al. Country, regional, and global estimates for lactose malabsorption in adults: a systematic review and meta-analysis. Lancet Gastroenterol. Hepatol. 2, 738-746, 2017); and cardiovascular health, as milk is high in fat and cholesterol. Other people have chosen to eliminate milk from their diets for ethical or religious reasons. Moreover, as global concern over climate change and environmental sustainability rise, many are choosing to consume fewer animal products because of their environmental footprint (Poore, J. & Nemecek, T. Reducing food's environmental impacts through producers and consumers. Science 360, 987-992, 2018).

To cater to such customers, many groups have made cheese imitations from nondairy ingredients. Early versions of these imitations were available starting in the 1980s, often created by replacing the ingredients of dairy cheese with food additives, colorings, flavors, and gums. So-called soy cheeses—named because they often used soy protein to replace some or all of the milk protein—provided an alternative for people with lactose intolerance but were limited in their applications because they still contained casein, a milk protein (“The Evolution of Vegan Cheese.” Fresh n′ Lean, 2018, https://www.freshnlean.com/vegan-cheese-evolution/). They were also generally deemed unpalatable, certainly less palatable than traditional dairy cheeses.

Within the last two decades, two new types of nondairy, “plant-based” cheeses have become widely available. The more common type combines a vegetable oil (e.g., coconut oil); starch (e.g., potato, tapioca, or cornstarch); and additives (flavors, colors, preservatives). These formulations represent a significant step forward from earlier cheese imitations: they are more palatable, convincing in texture, and entirely dairy free. Unfortunately, these cheeses also lack the compelling flavors of dairy cheese, and without dairy cheese's protein and calcium, they hold little nutritional value. The other type of plant-based cheese uses nuts, predominantly cashews and almonds, mixed with other flavorings (e.g., yeast and yeast extracts, miso, lactic acid) and sometimes microbial cultures, to create soft cheeses. Nut cheeses represent an advance, since they sometimes incorporate microbial culturing to develop tangy flavors from lactic acid. But they still suffer from limitations in texture and taste, they are expensive, and they still rely on additives to create flavor. Because both of these cheese groups use chemical or other additives to mimic cheese flavors, they generally don't taste nearly as complex or as intense as dairy cheeses. The lack of complexity, or depth, stems from the difficulty and expense of mimicking a suite of hundreds of flavor compounds (McSweeney P L H, Sousa M J. Biochemical pathways for the production of flavor compounds in cheeses during ripening: A review. Le Lait. 2000 May 1; 80(3):293-324). The lack of intensity happens because it is expensive to use chemical flavors in high concentrations and such concentrations can result in the perception of off-flavors.

One reason that the most advanced plant-based cheeses rely on additives for flavor is that many traditional cheese-making methods do not work with plant-derived substrates. For example, rennet, one of the critical enzyme mixtures that curdle milk, was evolutionarily shaped to curdle dairy milk in the stomachs of young mammals and therefore does not coagulate plant-based milks or proteins (Mantafounis, D. & Pitts, J. Protein engineering of chymosin: modification of the optimum pH of enzyme catalysis. Protein Eng. Des. Sel. 3, 605-609, 1990). Alternative proteolytic enzymes from plants or microbes are often similarly ineffective or, at best, create extremely weak curds that are difficult to manipulate. Most makers of plant-based cheeses have therefore pursued other means of coagulation, including adding cross-linking enzymes (US 2015/0305361 A1), applying heat, or adding acid, with varying degrees of success.

But what previous attempts have not considered is that every step in traditional cheesemaking (milk and its nutrient content, acidification, coagulation and separation of curds and whey, salting, shaping, and aging) serves a deeper purpose: to provide the appropriate conditions for microbes and their enzymes to create the flavors that consumers love. All cheese-making steps tune the proteins, carbohydrates, fats, moisture content, water activity, salt concentration, gases, acidity, and temperatures experienced by the microbial communities within the cheese, thereby supporting desired microbial and biochemical activity to create compelling flavors and dissuading unwanted microbial and biochemical activity from triggering spoilage.

Thus, a compelling, aged, plant-based cheese is not available on the market because the means of providing these microbiological conditions using plant-based ingredients have not yet been identified. For example, insufficient sugar in a plant-based milk can stifle microbial growth, whereas too much can provoke overactivity and sour or bitter flavors. Further, plant-based cheeses that exclude rennet because it does not coagulate plant-based milks also exclude the enzyme's other function, which is to break down larger proteins into shorter peptides that the microbial cultures convert into flavor compounds. Alternative methods for protein coagulation in plant-based cheeses often do not drive off sufficient moisture, producing soft cheeses that must be eaten fresh (e.g., ricotta, chevre) because they become rancid or rotten if aged. On the other hand, harder plant-based cheeses are generally made using methods of shaping, salting, and aging that result in too much or too little microbial activity for the desired flavor development. For these and other reasons, existing plant-based cheeses generally feature too few nutrients, too much moisture, too little salt, inappropriate cultures, or excessive evaporation to age for any significant period of time.

As a result of the many factors that need to be controlled to promote the right microbial activity, the market has yet to see a cost-effective, hard-texture, and full-flavor plant-based cheese that achieves a complexity and intensity of flavor similar to those of dairy cheeses.

It is therefore an object of the present invention to provide methods and materials to produce a hard-texture, flavorful, plant-based cheese using an aging process.

### BRIEF SUMMARY

The present disclosure provides novel plant-based cheeses that are cost-effective, hard-texture, and aged for 60 days or longer. The inventor has developed methods of producing such cheeses by identifying the biochemical parameters that provide the ideal microbiological conditions for the development of flavor during plant-based cheesemaking and aging. These methods include producing a plant-based milk that provides the right nutrient balance to support the metabolism of microbial cultures to create flavors, without stifling microbial growth or leading to excess microbial growth and sour or bitter flavors. Acidification of the plant-based milk through microbial metabolism may be controlled to achieve a pH low enough to discourage unwanted microbial growth but not so low as to hinder continued microbial activity. Preferably, these methods include the use of rennet or other enzymes to break down plant-based proteins and enhance flavor development. Effective coagulation of curds, in combination with a mechanical process to drive whey from the curds, can result in the ideal moisture content of the curds prior to aging. Salt content is preferably linked with moisture content to limit, yet not inhibit, microbial activity. The cheese may be shaped to control the rate of moisture loss. All of these parameters then come together during aging, when low temperatures and proper humidity foster the slow, controlled microbial processes that convert proteins and fats into the many flavors of the cheese. Preferably, the aging environment and formation of a cheese rind are controlled to ensure that the microbes have a suitable environment for the desired aging period. The result of these methods is a, hard, aged, plant-based cheese that achieves a complexity and an intensity of flavor similar to those of dairy cheeses. This cheese can then provide the base for a variety of cheeses that use different microbial cultures and slightly different processing parameters to create distinct flavor and texture profiles.

In one aspect, provided herein is a cultured plant-based cheese composition comprising: (a) legume material, seed material, or a combination thereof in an amount of at least 40% by dry weight of the cultured plant-based cheese composition; (b) one or more microbial cultures comprising one or more microbes; (c) one or more coagulating agents; (d) one or more proteolytic enzymes; and (e) less than 1% nuts by dry weight of the cultured plant-based cheese composition, wherein the cultured plant-based cheese composition has a moisture content of no greater than 60%; and wherein the cultured plant-based cheese composition has been aged for a period of about 60 days or longer. In some embodiments, the cultured plant-based cheese composition has a moisture content of no greater than 50%, no greater than 40%, or no greater than 30%. In further embodiments, the cultured plant-based cheese composition has been aged for a period of about 90 days or longer or of about 6 months or longer.

In some embodiments, the cultured plant-based cheese composition comprises legume material, seed material, or a combination thereof in an amount of at least 50% or at least 60% by dry weight of the cultured plant-based cheese composition. In some variations, the legume material is selected from the group consisting of soybean material, pea material, fava bean material, lentil material, chickpea material, peanut material, cannellini bean material, navy bean material, pinto bean material, and sweet lupine material. In one variation, the legume material is soybean material. In additional variations, the seed material is selected from the group consisting of sunflower seed material, pumpkin seed material, squash seed material, chia seed material, flax seed material, and hemp seed material. The cultured plant-based cheese composition may comprise any legume material or seed material known in the art or described herein, or any combination thereof.

In some embodiments, the cultured plant-based cheese composition comprises one or more microbes selected from the group consisting of Lactococcus sp., Lactobacillus sp., Streptococcus sp., Propionibacterium sp., Brevibacter sp., Leuconostoc sp., Corynebacterium sp., Pediococcus sp., Enterococcus sp., Bifidobacterium sp., Weissella sp., Penicillium sp., Aspergillus sp., Saccharomyces sp., Candida sp., and Geotrichum sp. In additional embodiments, the cultured plant-based cheese composition comprises one or more proteolytic enzymes selected from the group consisting of animal rennet, pepsin, chymosin, vegetable rennet, microbial rennet, papain, bromelain, serrapeptase, protease, pancreatin, and trypsin. In further embodiments, the cultured plant-based cheese composition comprises one or more coagulating agents comprising a mineral cation, an acid, a coagulating enzyme or any combination thereof. In some variations, the one or more coagulating agents comprise calcium, magnesium, or a combination thereof. In one variation, the one or more coagulating agents do not comprise a crosslinking enzyme. In another variation, the one or more coagulating agents do not comprise a transglutaminase.

In certain embodiments, the cultured plant-based cheese composition comprises less than 0.5% or less than 0.1% nuts by dry weight of the cultured plant-based cheese composition. In one embodiment, the cultured plant-based cheese composition does not comprise nuts. In another embodiment, the cultured plant-based cheese composition does not comprise almonds. In yet another embodiment, the cultured plant-based cheese composition does not comprise cashews.

In some embodiments, the cultured plant-based cheese composition comprises free amino acids in an amount of at least 30 mg, at least 50 mg, or at least 75 mg per 100 g of the cultured plant-based cheese composition. In some variations, at least 60% by weight of the free amino acids present in the plant-based cheese composition are derived from the legume material, seed material, or combination thereof of the plant-based cheese composition. In further variations, the free amino acids comprise free amino acid additives, free amino acids derived from additives, or a combination thereof in an amount of no more than 40% by weight. In additional embodiments, the cultured plant-based cheese composition comprises free glutamate in an amount of at least 30 mg, at least 50 mg, or at least 75 mg per 100 g of the cultured plant-based cheese composition. In some variations, at least 60% by weight of the free glutamate present in the plant-based cheese composition are derived from the legume material, seed material, or combination thereof of the plant-based cheese composition. In further variations, the free glutamate comprises free glutamate additives, free glutamate derived from additives, or a combination thereof in an amount of no more than 40% by weight. In still further variations, the plant-based cheese composition does not comprise nutritional yeast, does not comprise inactivated yeast, does not comprise yeast extract, does not comprise miso, does not comprise mushroom extract, does not comprise onion powder, does not comprise garlic powder, does not comprise exogenous free amino acids, does not comprise exogenous monosodium glutamate, does not comprise exogenous inosine-5′-monophosphate, does not comprise exogenous guanosine-5′-monophosphate, does not comprise exogenous succinic acid, does not comprise exogenous propionic acid, does not comprise exogenous lactic acid, does not comprise exogenous diacetyl, does not comprise exogenous acetic acid, does not comprise exogenous keto acids, does not comprise exogenous alpha-keto acids, does not comprise exogenous alpha-ketoglutarate, does not comprise exogenous methyl ketones, does not comprise exogenous lactones, does not comprise exogenous homofuraneol, does not comprise exogenous butyric acid, does not comprise exogenous furaneol, does not comprise exogenous 3-(methylthio) propanal, does not comprise exogenous 2,3-butanedione, does not comprise exogenous (e)-2-nonenal, and/or does not comprise exogenous (Z)-2-nonenal.

In some embodiments, the cultured plant-based cheese composition further comprises one or more plant fats selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil. In further embodiments, the cultured plant-based cheese composition further comprises one or more sugars selected from the group consisting of lactose, sucrose, dextrose, galactose, fructose, maltose, and glucose. In additional embodiments, the cultured plant-based cheese composition further comprises one or more syrups selected from the group consisting of honey, corn syrup, rice syrup, and high-fructose corn syrup. In yet additional embodiments, the cultured plant-based cheese composition further comprises one or more of salt, flavoring agents, texturizing agents, and citrate. In still further embodiments, the cultured plant-based cheese composition may further comprise coloring agents, preservatives, or a combination thereof. The cultured plant-based cheese composition may comprise any combination of the legume materials, seed materials, microbes, enzymes, coagulating agents, amino acids, plant fats, sugars, syrups, salts, flavoring agents, texturizing agents, and additives described herein. In some embodiments, the cultured plant-based cheese composition has a pH of between 4.0 and 6.5, between 4.4 and 5.5, between 4.5 and 5.8, or between 5.5 and 7.2.

In another aspect, provided herein is a meltable plant-based cheese composition, comprising: (i) the cultured plant-based cheese composition of the present invention in an amount of between about 5% and about 50% by weight of the meltable plant-based cheese composition; (ii) one or more gelling agents in an amount of between about 5% and about 60% by weight of the meltable plant-based cheese composition; (iii) one or more plant fats in an amount of between 0% and about 30% by weight of the meltable plant-based cheese composition; (vi) salt in an amount of between about 0.5% and about 3% by weight of the meltable plant-based cheese composition; and (v) water in an amount of between about 20% and about 70% by weight of the meltable plant-based cheese composition; wherein the meltable plant-based cheese composition melts at a temperature of between about of between about 50° C. and about 90° C. In some embodiments, the one or more gelling agents comprise native tapioca starch, modified tapioca starch, native potato starch, modified potato starch, native corn starch, modified corn starch, carrageenan, agar agar, konjac flour, konjac gum, locust bean gum, xanthan gum, or a combination thereof. In further embodiments, the one or more plant fats are selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil. In still further embodiments, the meltable plant-based cheese composition may further comprise coloring agents, preservatives, or a combination thereof. The meltable plant-based cheese composition may comprise any combination of the gelling agents, plant fats, salts, microbes, enzymes, coagulating agents, amino acids, sugars, syrups, flavoring agents, texturizing agents, and additives described herein.

In another aspect, provided herein is a method of producing a cultured plant-based cheese composition, the method comprising: (a) providing a plant-based emulsion comprising legume material, seed material, or a combination thereof; (b) adding one or more starter cultures comprising one or more microbes; (c) culturing the one or more microbial cultures in the plant-based emulsion; (d) coagulating the proteins in the plant-based emulsion to form curds and whey; (e) separating the curds from the whey; (r) salting the curds; (g) shaping the curds; and (h) aging the curds for a period of about 60 days or longer to produce the cultured plant-based cheese composition, wherein the cultured plant-based cheese composition has a moisture content of no greater than 60% and comprises less than 1% nuts by dry weight of the cultured plant-based cheese composition. In some embodiments, the aging of step (h) occurs over a period of about 90 days or longer or of about 6 months or longer. In certain embodiments, the method further comprises adding coloring agents, preservatives, or a combination thereof to the plant-based emulsion or to the curds. In some embodiments, the cultured plant-based cheese composition has a pH of between 4.0 and 6.5, between 4.4 and 5.5, between 4.5 and 5.8, or between 5.5 and 7.2.

In some embodiments, the plant-based emulsion of step (a) is a plant-based milk comprising legume material, seed material, or a combination thereof. In certain embodiments, the plant-based emulsion comprises legume material, seed material, or a combination thereof in an amount of at least about 40%, at least 50%, or at least 60% by dry weight of the plant-based emulsion. In some embodiments, the plant-based emulsion of step (a) has a Brix value of about 5° Bx or higher or of about 9° Bx or higher. In some embodiments, the plant-based emulsion comprises one or more plant fats selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil. In further embodiments, the plant-based emulsion comprises one or more sugars selected form the group consisting of lactose, sucrose, dextrose, galactose, fructose, maltose, and glucose. In yet further embodiments, the plant-based emulsion comprises one or more syrups selected from the group consisting of honey, corn syrup, rice syrup, and high-fructose corn syrup. The plant-based emulsion can comprise any combination of the legume materials, seed materials, plant fats, sugars, and syrups described herein.

In some embodiments, step (a) comprises substeps: (a1) providing a base composition comprising legume material, seed material, or a combination thereof; (a2) mixing the base composition with water; and (a3) comminuting the base composition and water to produce the plant-based emulsion. In certain embodiments, step (a) further comprises substep (a4) separating and discarding the insoluble solids from the plant-based emulsion. In some variations, the base composition comprises legume material, seed material, or a combination thereof in an amount of at least 90%, at least 95%, or at least 99% by dry weight of the base composition. In additional variations, the base composition comprises legume material selected from the group consisting of soybean material, pea material, fava bean material, lentil material, chickpea material, peanut material, cannellini bean material, navy bean material, pinto bean material, and sweet lupine material. In one variation, the legume material is soybean material. In further variations, the base composition comprises seed material selected from the group consisting of sunflower seed material, pumpkin seed material, squash seed material, chia seed material, flax seed material, and hemp seed material.

In some embodiments, the one or more microbes of step (b) are selected from the group consisting of Lactococcus sp., Lactobacillus sp., Streptococcus sp., Propionibacterium sp., Brevibacter sp., Leuconostoc sp., Corynebacterium sp., Pediococcus sp., Enterococcus sp., Bifidobacterium sp., Weissella sp., Penicillium sp., Aspergillus sp., Saccharomyces sp., Candida sp., and Geotrichum sp. In further embodiments, the method further comprises adding one or more proteolytic enzymes prior to step (d). In some variations, the one or more proteolytic enzymes are selected from the group consisting of animal rennet, pepsin, chymosin, vegetable rennet, microbial rennet, papain, bromelain, serrapeptase, protease, pancreatin, and trypsin.

In some embodiments, the culturing of step (c) results in acidification of the plant-based emulsion sufficient to cause the coagulation of step (d). In other embodiments, coagulating of step (d) comprises adding one or more coagulating agents selected from the group consisting of mineral cations, acids, or coagulating enzymes. In some variations, the one or more coagulating agents comprise calcium, magnesium, or a combination thereof. In one variation, the one or more coagulating agents do not comprise a crosslinking enzyme. In another variation, the one or more coagulating agents do not comprise a transglutaminase. In some embodiments, the separating of step (e) occurs over a period of no more than three hours. In additional embodiments, the separating of step (e) comprises a mechanical process to drive the whey from the curds. In one variation, the mechanical process is pressing. In another aspect, the present invention provides the curds produced according to the steps of the method described herein.

In some embodiments, the method further comprises: (i) mixing the cultured plant-based cheese composition with one or more gelling agents, one or more plant fats, and salt to create a mixture; (j) blending the mixture; (k) heating the mixture to between 50 and 90° C. for between 0 and 20 minutes to produce a cooked mixture; (l) dispensing the cooked mixture into a form; and (m) setting the cooked mixture in the form at between 1 and 8° C. for at least one day (e.g., between 1 and 14 days) to produce a meltable plant-based cheese composition. In certain embodiments, the one or more gelling agents comprise native tapioca starch, modified tapioca starch, native potato starch, modified potato starch, native corn starch, modified corn starch, carrageenan, agar agar, konjac flour, konjac gum, locust bean gum, xanthan gum, or a combination thereof. In further embodiments, the one or more plant fats are selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil. The mixture of step (i) may comprise any combination of the gelling agents, plant fats, salts, microbes, enzymes, coagulating agents, amino acids, sugars, syrups, flavoring agents, texturizing agents, and additives described herein. In one variation, the mixture of step (i) comprises: (i) cultured plant-based cheese composition in an amount of between about 5% and about 50% by weight; (ii) one or more gelling agents in an amount of between about 5% and about 60% by weight; (iii) one or more plant fats in an amount of between 0% and about 30% by weight; (vi) salt in an amount of between about 0.5% and about 3% by weight; and (v) water in an amount of between about 20% and about 70% by weight. In certain embodiments, the method further comprises adding coloring agents, preservatives, or a combination thereof to the mixture of step (i).

In yet another aspect, provided herein is a method of producing a cultured plant-based cheese composition, the method comprising: (a) hydrating powdered legume material, powdered seed material, or a combination thereof to a moisture content of no greater than 60%; (b) mixing the hydrated powdered legume material, powdered seed material, or combination thereof with one or more plant fats, salt, and acid to create a protein substrate; (c) adding one or more microbial cultures comprising one or more microbes to the protein substrate; (d) shaping the protein substrate; and (e) aging the protein substrate for a period of about 60 days or longer to produce the cultured plant-based cheese composition, wherein the cultured plant-based cheese composition comprises less than 1% nuts by dry weight of the cultured plant-based cheese composition. In some embodiments, the aging of step (e) occurs over a period of about 90 days or longer or of 6 months or longer. In certain embodiments, the method further comprises adding coloring agents, preservatives, or a combination thereof to the protein substrate. In a further aspect, provided herein is the cultured plant-based cheese composition produced according to the methods described herein. In some embodiments, the cultured plant-based cheese composition has a pH of between 4.0 and 6.5, between 4.4 and 5.5, between 4.5 and 5.8, or between 5.5 and 7.2.

In some embodiments, the cultured plant-based cheese composition comprises powdered legume material, powdered seed material, or a combination thereof in an amount of at least about 40%, at least about 50%, or at least about 60% by dry weight of the plant-based emulsion. In further embodiments, the powdered legume material, powdered seed material, or combination thereof is selected from the group consisting of isolated protein, legume flour, and seed flour. In additional embodiments, the powdered legume material is selected from the group consisting of soybean material, pea material, fava bean material, lentil material, chickpea material, peanut material, cannellini bean material, navy bean material, pinto bean material, and sweet lupine material. In one variation, the powdered legume material is soybean material. In yet additional embodiments, the powdered seed material is selected from the group consisting of sunflower seed material, pumpkin seed material, squash seed material, chia seed material, flax seed material, and hemp seed material.

In some embodiments, the acid of step (b) is lactic acid. In further embodiments, the one or more plant fats of step (b) are selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil. In additional embodiments, the protein substrate further comprises one or more sugars selected form the group consisting of lactose, sucrose, dextrose, galactose, fructose, maltose, and glucose. In yet additional embodiments, the protein substrate further comprises one or more syrups selected from the group consisting of honey, corn syrup, rice syrup, and high-fructose corn syrup. The protein substrate may comprise any combination of the powdered legume materials, powdered seed materials, microbes, enzymes, coagulating agents, amino acids, plant fats, sugars, syrups, salts, flavoring agents, texturizing agents, and additives described herein.

In some embodiments, the one or more microbes of step (c) are selected from the group consisting of Lactococcus sp., Lactobacillus sp., Streptococcus sp., Propionibacterium sp., Brevibacter sp., Leuconostoc sp., Corynebacterium sp., Pediococcus sp., Enterococcus sp., Bifidobacterium sp., Weissella sp., Penicillium sp., Aspergillus sp., Saccharomyces sp., Candida sp., and Geotrichum sp. In further embodiments, step (c) further comprises adding one or more proteolytic enzymes to the protein substrate. In some variations, the one or more proteolytic enzymes are selected from the group consisting of animal rennet, pepsin, chymosin, vegetable rennet, microbial rennet, papain, bromelain, serrapeptase, protease, pancreatin, and trypsin.

### DESCRIPTION OF THE FIGURES

The patent or application file contains at least one drawing executed in color. Copies of this patent or patent application publication with color drawing(s) will be provided by the Office upon request and payment of the necessary fee.

The present application can be understood by reference to the following description taken in conjunction with the accompanying figures.

FIG. 1 depicts acidification of plant-based milk in a paddle mixer. Cultures were added to milk made from soybeans and containing additional sucrose and coconut oil, and the mixture was agitated a stable temperature to acidify the milk.

FIG. 2 depicts the coagulation of plant-based milk and curd formation in a paddle mixer. A cation coagulant was added to the plant-based milk to induce coagulation of the proteins therein. Solidification of the curds is demonstrated by a spoon breaking the solid surface of the curds.

FIG. 3 depicts curds at the salting stage of cheesemaking, after coagulation of plant-based milk and separation of whey from the curds by pressing to a moisture content of below 60%.

FIG. 4 depicts plant-based curds that have been shaped into a wheel.

FIG. 5A depicts a firm, cultured plant-based cheese that has been aged for about four months using the natural rind method. The dryness of the rind and the formation of patches of dark grey and green molds thereon are shown.

FIG. 5B depicts finished aged, cultured plant-based cheeses and sample dishes.

FIG. 6A depicts another firm, cultured plant-based cheese that has been aged for five months using the natural rind method. The formation of a coating of light grey and green molds thereon is shown.

FIG. 6B depicts the same firm, cultured plant-based cheese as FIG. 6A that has been rubbed with olive oil, creating a dark green rind.

FIG. 6C depicts another firm, cultured plant-based cheese that has been aged for nine months using the natural rind method. The dryness of the rind is shown.

FIG. 6D depicts another firm, cultured plant-based cheese that has been aged for eleven months using the natural rind method. The dryness of the rind and the formation of a thick coating of white and light gray molds is shown.

FIG. 7 depicts a firm, cultured plant-based cheese that has been aged for seven months using the bandaged rind method. The formation of a variety of green, light grey, and white molds on the rind is shown.

FIG. 8A depicts a cheese that has been aged with a polymer coating and a foil wrap.

FIG. 8B depicts a cheese that has been aged with only a polymer coating.

FIG. 9 depicts a plot of weight lost by cultured plant-based cheeses during aging. Each point represents an individual batch of cheese. The x axis plots each cheese's age in days at the time of weighing.

FIGS. 10A-10B depict the glutamate content of plant-based cheeses produced from soybeans, with or without using starter cultures and a proteolytic enzyme (chymosin), as compared to a dairy cheddar cheese. Bars represent the average of three technical replicate samples taken from the cheese. FIG. 10A depicts plant-based cheeses that were aged for 3 months. FIG. 10B depicts plant-based cheeses that were aged for 7 months.

FIGS. 11A-11C depict cheese parameter space as defined by glutamate (in milligrams of glutamate per 100 grams of cheese), lactic acid (expressed as pH as a proxy), and moisture content (in percent moisture). FIG. 11A depicts this parameter space in three dimensions. FIG. 11B depicts the acceptable area within the parameter space as a rectangular prism. FIG. 11C depicts the preferred area as a rectangular prism within the parameter space.

FIGS. 12A-12C depict exemplary aged dairy cheeses plotted within the parameter space defined in FIGS. 11A-11C. FIG. 12A depicts exemplary aged dairy cheeses within the parameter space defined in FIG. 11A. FIG. 12B depicts exemplary aged dairy cheeses within the rectangular prism representing the acceptable area of the parameter space as defined in FIG. 11B. FIG. 12C depicts exemplary aged dairy cheeses within and outside of the rectangular prism representing the preferred area within the parameter space as defined in FIG. 11C.

FIGS. 13A-13D depict exemplary unaged dairy cheeses plotted within the parameter space defined in FIGS. 11A-11C. FIG. 13A depicts exemplary unaged dairy cheeses within the parameter space defined in FIG. 11A. FIG. 13B depicts exemplary unaged dairy cheeses falling outside the rectangular prism representing the acceptable area of the parameter space as defined in FIG. 11B. FIG. 13C depicts a rotated view of FIG. 13B to better illustrate the glutamate axis, showing that unaged dairy cheeses do not fall within the acceptable area due to low glutamate and high moisture. FIG. 13D depicts exemplary unaged dairy cheeses falling outside the rectangular prism representing the preferred area within the parameter space as defined in FIG. 11C.

FIGS. 14A-14E depict exemplary plant-based cheeses containing no additives or exogenous sources of flavors, representative of those that existed prior to the present invention, plotted within the parameter space defined in FIGS. 11A-11C. FIG. 14A depicts exemplary previously-existing plant-based cheeses within the parameter space defined in FIG. 11A. FIG. 14B depicts exemplary previously-existing plant-based cheeses without flavoring additives falling outside the rectangular prism representing the acceptable area of the parameter space as defined in FIG. 11B. FIG. 14C depicts a rotated view of FIG. 14B to better illustrate the glutamate axis, showing that none of the previously-existing plant-based cheeses without flavoring additives fall within the acceptable area. FIG. 14D depicts exemplary previously-existing plant-based cheeses falling outside the rectangular prism representing the preferred area within the parameter space as defined in FIG. 11C. FIG. 14E depicts a rotated view of FIG. 14D to better illustrate the glutamate axis, showing that none of the previously-existing plant-based cheeses without flavor additives fall within the preferred area.

FIGS. 15A-15F depict exemplary plant-based cheeses produced as described herein, plotted within the parameter space defined in FIGS. 11A-11C. FIG. 15A depicts plant-based cheeses produced as described herein within the parameter space defined in FIG. 11A. FIG. 15B depicts a rotated view of FIG. 15A to better illustrate the glutamate axis. FIG. 15C depicts plant-based cheeses produced as described herein, plotted within the rectangular prism representing the acceptable area of the parameter space as defined in FIG. 11B. FIG. 15D depicts a rotated view of FIG. 15C to better illustrate the glutamate axis, showing that all four of the exemplary plant-based cheeses produced as described herein fall within the acceptable area.

FIG. 15E depicts plant-based cheeses produced as described herein, plotted within and outside the rectangular prism representing the preferred area within the parameter space as defined in FIG. 11C. FIG. 15F depicts a rotated view of FIG. 15E to better illustrate the glutamate axis, showing that two of the four exemplary plant-based cheeses produced as described herein fall within the preferred area.

FIG. 16 depicts a bar chart showing the glutamate concentration of exemplary dairy cheeses, previously-existing plant-based cheeses, and plant-based cheeses produced herein, as characterized in Example 13 and Table 15.

FIGS. 17A-17B depict plant-based grana cheese Batch 33, produced from native soybeans according to the methods described in Example 3C and Table 4A. FIG. 17A depicts both a full wheel of the plant-based grana cheese with rind, upon which a coating of light grey, green, and white molds thereon is shown, and a wheel that has been halved to show the interior of the cheese, which is a golden yellow with crumbly appearance. FIG. 17B depicts a close-up view of a piece of the plant-based grana cheese, showing its interior texture.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

### Overview

Currently, many people choose to avoid dairy products for health, ethical, or religious reasons. Therefore, there is a need for plant-based cheese compositions. However, many dairy cheesemaking processes—such as coagulating dairy milk with proteolytic enzymes to form curds, separation of curds and whey, the use of microbial cultures to develop flavor, and aging—have not been successfully applied in the production of plant-based cheeses due to the biochemical and biophysical differences between dairy milks and plant-based milks. Most plant-based cheeses on the market are primarily made up of fats and gelling agents and rely on additives to impart flavor, resulting in flavor profiles that are less desirable and more mild than those of dairy cheeses. Other plant-based cheeses are derived from nuts and may be cultured; however, these cheeses are expensive due to the use of nuts as a main ingredient and their textures are often soft. As a result, there is a need for a cost-effective, hard-texture, low-moisture, and full-flavored cultured plant-based cheese.

In one aspect, described herein in is a cultured plant-based cheese composition that has been aged for a period of about 60 days or longer comprising legume material, seed material, or a combination thereof and one or more microbial cultures, having a moisture content of no greater than 60%. In some embodiments, the cultured plant-based cheese composition comprises less than 1% nuts by dry weight. The cultured plant-based cheese composition has an improved flavor profile compared to plant-based cheeses on the market, and may have a flavor profile similar to that of a dairy cheese. In another aspect, described herein is a meltable plant-based cheese composition comprising the cultured plant-based cheese composition and the flavor profile thereof. In other aspects, described herein are methods of producing the cultured plant-based cheese composition from legume material, seed material, or a combination thereof. In one aspect, described herein is a method of producing the cultured plant-based cheese composition by providing a plant-based emulsion and subsequently culturing the plant-based emulsion, coagulating the plant-based emulsion to form curds, separating the curds and whey, and aging the curds for a period of about 60 days or longer. In one embodiment of this aspect, separating of the curds and whey comprises a mechanical process to drive the whey from the curds, such as pressing. In another aspect, described herein is a method of producing the cultured plant-based cheese composition by hydrating powdered legume material, powdered seed material, or a combination thereof to produce a protein substrate and aging the protein substrate for a period of about 60 days or longer. In some embodiments of these aspects, the method further comprises mixing the cultured plant-based cheese composition with plant fats, a gelling agent, salt, and water to produce a meltable plant-based cheese composition.

### Definitions

As used herein, “additive” refers to any minor ingredient added at any point during the cheesemaking process to produce the desired flavor, texture profile, and overall sensory experience associated with the cultured plant-based cheese composition, but is not required to produce the cultured plant-based cheese composition of the present disclosure. As used herein, the term “additive” excludes the ingredients required to produce the cultured plant-based cheese composition of the cultured plant-based cheese composition including, but not limited to, legume material, seed material, or a combination thereof; microbial cultures comprising microbes; coagulating agents; and proteolytic enzymes. Likewise, as used herein, “additive” excludes bulk nutritional ingredients added in the cheesemaking process, such as fats, sugars, and salt.

As used herein, “aging” refers to the process of holding curds at a controlled temperature and humidity (or otherwise controlling moisture loss), allowing living microbial cultures, added proteolytic or lipolytic enzymes, and/or the enzymes of lysed (killed) microbial cells to metabolize the compounds in the curds over time. Aging is also known in the art as affinage, ripening, or maturing.

As used herein, “Brix value” refers to a measurement of dissolved solids in a solution as determined by measuring the specific gravity or refractive index of the solution. The Brix value of a solution is expressed in degrees Brix (° Bx). The Brix value includes dissolved sugars, proteins, and other materials dissolved in the solution.

As used herein, “cheese” refers to a composition formed from an aggregate of proteins and fats, either animal- or plant-based. The aggregate of proteins and fats may be curds formed by coagulation of either animal- or plant-based proteins in a solution, or may be a mechanically-created protein substrate. Traditionally, “cheese” refers to a dairy-product made from the coagulated proteins and fats of mammalian milk. As used herein, “cheese” is more broadly used to describe soft to hard food products that are similar in texture or taste to dairy cheeses. “Cheese” may refer to a dairy cheese, a non-dairy cheese, a plant-based cheese, a vegan cheese, a cheese replica, a cheese substitute, processed cheese products, analog cheese, or anything considered by those of ordinary skill in the art to be cheese or a culinary replacement for cheese. An “aged” cheese is one that has been allowed to develop new flavors and textures for a given period by holding curds at a controlled temperature and humidity, which often allows for biochemical processes to break down macromolecules (large molecules such as proteins and fats) into flavor compounds. This aging process results in a complex and desirable flavor profile in the cheese.

As used herein, “coagulating agent” refers to an ingredient that triggers the coagulation of proteins (e.g., milk proteins) suspended in a solution. Examples include mineral cations (calcium chloride, calcium sulfate, magnesium chloride, or similar), food-safe acids, proteolytic enzymes, and cross-linking enzymes.

As used herein, “cultured” refers to a composition of matter which has at any point comprised a living microbial culture.

As used herein, “curds” refers to a solidified mass comprising coagulated proteins, fats, and other materials formed by coagulation of a dairy milk, a non-dairy milk, or a plant-based emulsion.

As used herein, “emulsion” refers to a mix of an aqueous solution and a fat.

As used herein, “flavor compound” refers to any small molecule that imparts an aroma or flavor note.

As used herein, “flavor profile” refers to the identity and strength of flavor notes that give each cheese its unique flavor. “Flavor profile” may refer to the flavor profile of a single plant-based cheese composition or to that a class of dairy or non-dairy cheeses. Each flavor note may be associated with a specific flavor compound or set of flavor compounds.

As used herein, “free amino acid” refers to an amino acid molecule which is not covalently linked to another compound such as a protein, a peptide, or any other molecule. Free amino acids may include any of the twenty canonical amino acids or any other amino acid known in the art.

As used herein, “free glutamate” refers to a glutamate molecule which is not covalently linked to another compound such as a protein, a peptide, or any other molecule.

As used herein, “insoluble solids” refers to any insoluble plant material and may include, but is not limited to, fibrous material such as high molecular weight insoluble fibers and okara.

As used herein, “legume” refers to a plant species belonging to the pea family (Fabiaceae), including but not limited to those grown as crops.

As used herein, to “melt” means to undergo a phase shift wherein a solid becomes a liquid through the addition of heat. As used herein, “meltable” refers to a composition that melts at temperatures typically maintained in culinary or cooking processes.

As used herein, “microbial culture” refers to a population of microbial cells comprising one or more microbial species, and may refer to a starter culture prior to its use in the cheesemaking process or a living, viable, or non-viable population of microbial cells present within the plant-based emulsion, curds, or cultured plant-based cheese composition of the present disclosure. Microbial cultures may include bacteria, yeast, filamentous fungi (molds), or any combination thereof. As used herein, “microbes” may refer to living, viable, or non-viable individual microbial cells or to species or genera of the bacteria, yeast, or filamentous fungi. “Living” refers to microbial cultures or microbes that are physiologically active and may be metabolizing the matter of their environment, undergoing cell replication (growth), or a combination thereof. “Viable” refers to microbial cultures or microbes which are not physiologically active but may become physiologically active given adequate environmental conditions, resulting in living cultures or microbes. “Non-viable” (dead) refers to microbial cultures or microbes which are not physiologically active and are incapable of becoming physiologically active under typical environmental conditions. Nevertheless, under certain conditions the enzymes and other cellular processes formerly contained within the living organism may continue after the cellular host is dead. For example, non-viable cells may release enzymes into their environment which retain their enzymatic activity after the death of the microbial cells in which they were once contained.

As used herein, “milk” may refer to any dairy, non-dairy, or plant-based milk or a plant-based emulsion comprising plant proteins and fats.

As used herein, “nonstarter cultures” refers to microbes or microbial cultures which are not added by the cheesemaker but are either native to the milk or introduced from the environment and may refer to nonstarter lactic acid bacteria. In some cheeses, these cultures may contribute little to acidification of dairy and non-dairy milks and instead grow during aging as the starter cultures die off. Without wishing to be bound by theory, many nonstarter cultures can have a significant effect on flavor development, while other nonstarter cultures play a role in the ecological succession of a cheese. For example, many yeasts from the environment may play a role in preparing the cheese surface for colonization with white molds (e.g., Penicillium candidum) by moderating the acidity of the cheese surface.

As used herein, “nuts” is used in the culinary sense to refer to seeds which are surrounded by a hard tough shell, are neither legumes nor grains, and are considered nuts by one of ordinary skill in the culinary arts. In the culinary parlance, and as used herein, “nuts” may refer to tree nuts including, but not limited to, cashews, almonds, walnuts, macadamia nuts, Brazil nuts, chestnuts, hazelnuts, pecans, pistachios, shea nuts, pine nuts, kola nuts, and the like.

As used herein, “percent weight per volume (% w/v)” refers to the grams of solute in 100 milliliters of a solution (e.g., 1% weight per volume is 1 gram of solute in 100 milliliters of solution).

As used herein, “plant-based” refers to compositions which consist primarily of non-animal material. Non-animal material may include plant material, material obtained from plants, microbial material, or a combination thereof. In some embodiments, plant-based compositions may be entirely free of animal-derived materials, these compositions being commonly referred to as vegan in the art. In other embodiments, plant-based compositions may include trace amounts of products derived from animals.

As used herein, “plant-based milk” refers to a plant-based emulsion comprising plant proteins and plant fats produced by comminuting and processing a base composition with water.

As used herein, “plant-based emulsion” refers to a liquid solution comprising plant-based proteins and fats and encompasses a variety of forms of plant-based emulsions, including plant-based milks.

As used herein, “seed” refers to any seed used in culinary applications which one of ordinary skill in the culinary arts would not consider a legume, a nut, or a grain. In culinary parlance, and as used herein, the term most often refers to edible seeds that are not considered nuts, such as sunflower seeds, pumpkin seeds, hemps seeds, etc. Seeds may include vegetable seeds, fruit seeds, or a combination thereof. As used herein, “seed material” refers to any material derived from a seed that comprises protein. As used herein, “whole seed material” refers to unprocessed fresh or dried seeds.

As used herein, “starter culture” refers to the added microbial cultures (bacteria or fungi) used to acidify (a.k.a., ripen or culture) dairy milk, non-dairy milk, or a plant-based emulsion. Some starter cultures, such as certain molds and bacteria, may not acidify the dairy milk, non-dairy milk, or a plant-based emulsion but instead play other roles in flavor development during aging.

As used herein, “whey” refers to the liquid portion of the dairy milk, a non-dairy milk, or a plant-based emulsion that is not incorporated into the curds as a part of coagulation and, therefore, can be easily separated from the curds.

### Cultured Plant-Based Cheese Compositions

In one aspect, the present disclosure describes a cultured plant-based cheese composition comprising legume material, seed material, or a combination thereof. In one embodiment, the cultured plant-based cheese composition further comprises microbial starter cultures comprising one or more microbes, one or more coagulating agents, one or more proteolytic enzymes, additional sugars, additional vegetable fats, salt, or any combination thereof. In one embodiment, the cultured-plant-based cheese does not comprise nuts. In some embodiments, the cultured plant-based cheese composition has been aged for a period of about 60 days or longer.

As used herein, “cultured” refers to a composition of matter which has at any point comprised a living microbial culture.

As used herein, “plant-based” refers to compositions which consist primarily of non-animal material. Non-animal material may include plant material, material obtained from plants, microbial material, or a combination thereof. Plant material may include fruits, roots, shoots, or any part of a plant. Material obtained from plants may include plant extracts, plant fats, plant oils, plant enzymes, plant carbohydrates, plant sugars, plant syrups, or any material obtained, extracted, or separated from plant tissue. Plant enzymes may include, for example, vegetable rennet. Microbial material may include microbes, live or dead cultures, live or dead bacteria, live or dead fungi, microbial enzymes, ingredients derived from microbes, or any material obtained, extracted, or separated from bacterial or fungal cells. In some embodiments, plant-based compositions may be entirely free of animal-derived materials, these compositions being commonly referred to as vegan in the art. In other embodiments, plant-based compositions may include trace amounts of products derived from animals. In some embodiments, the cultured plant-based cheese composition is vegan. In other embodiments, the cultured plant-based cheese composition is dairy-free, also referred to as non-dairy.

As used herein, “cheese” refers to a composition formed from an aggregate of proteins and fats, either dairy- or plant-based. The aggregate of proteins and fats may be curds formed by coagulation of either dairy- or plant-based proteins in a solution, or may be a mechanically-created protein substrate. The cheese may be a dairy cheese, a non-dairy cheese, a plant-based cheese, a vegan cheese, a cheese replica, a cheese substitute, processed cheese products, or anything considered by those of ordinary skill in the art to be cheese or a culinary replacement for cheese. An aged cheese is one that has been allowed to develop new flavors and textures for a given period, often by allowing biochemical processes to break down macromolecules (large molecules such as proteins and fats) into flavor compounds. This aging process results in a complex and desirable flavor profile in the cheese. A processed cheese is a food produced by pasteurizing, emulsifying, and blending natural cheese into new forms. Examples of processed cheese include Kraft Singles®, so called “American” cheese, and Velveeta®.

In some embodiments, the cultured plant-based cheese composition has an improved flavor profile compared to other plant-based cheeses available on the market. In preferred embodiments, the cultured plant-based cheese composition has the same desirability to consumers as a dairy cheese. In one variation, the desirable flavor of the cultured plant-based cheese composition is characterized by the presence and quantity of free amino acids, including glutamate. In another variation, the desirable flavor of the cultured plant-based cheese composition is characterized by the presence of other flavor compounds. In some embodiments, the cultured plant-based cheese composition comprises a desirable cheesy or cheese-like flavor profile that is unique in comparison to flavor profiles of known dairy or plant-based cheeses. In other embodiments, the cultured plant-based cheese composition has essentially the same flavor profile of a traditional dairy-based cheese, such as Cheddar, Roquefort, Brie, Gruyere, Feta, Mozzarella, Manchego, Gorgonzola, Epoisses, Swiss Cheese, Gouda Cheese, Monterey Jack, Muenster Cheese, Provolone, Blue Cheese, Camembert, Irish Cheddar, Havarti, Buffalo Mozzarella, Colby-Jack, Edam, Ricotta, Pepper Jack Cheese, Goat Cheese, Colby Cheese, Stilton Cheese, Emmentaler, Cream Cheese, Comte Cheese, American Farmhouse Cheddar, Cottage Cheese, Grana Padano, Halloumi, Rembrandt Gouda, Sharp Provolone, Provola, Danish Blue, Saint Albray, Appenzeller Cheese, Mascarpone, Tomme De Savoie, String Cheese, Saint-Marcellin, American Cheese, Pont-L'Evêque Cheese, Mahon Cheese, Cantal Cheese, Emmental Français, Selles-Sur-Cher Cheese, Neufchatel Cheese, Morbier Cheese, Fourme De Montbrison, Cheese Curdcaprice Des Dieux, Reblochon, Coulommiers Cheese, Taleggio Cheese, Vacherin, Beaufort Cheese, Beaufort Alpage, Abondance Cheese, Saint-Paulin Cheese, Chaource Cheese, Livarot Cheese, Rocamadour Cheese, Cambozola, Oregon Blue Vein, Leonora Goat Cheese, Pimento Cheese, Banon Cheese, Cabrales Cheese, Tete De Moine, Boerenkaas, Emmental De Savoie, Brocciu, Laguiole Cheese, Limburger Cheese, Queso De Bola, Maroilles Cheese, Stichelton, Ossau-Lraty Cheese, Saint-Nectaire, Pont L'Evêque, Crottin De Chavignol, Mimolette, Pélardon, Fourme D'Ambert, Fromage Frais, Bleu Du Vercors-Sassenage, Cabecou, Saint-Félicien Cheese, Bleu D'Auvergne, Bleu De Bresse, Farmer Cheese, Hooligan, Bleu Des Causses, Cheddar, Parmesan, Colby, Roquefort, Camembert, Chevre, Cotija, Emmental, Feta, Gouda, Taleggio, Parmigiano-Reggiano, Manchego, Monterey Jack, Jack, Appenzeller, Asiago, Caciocavallo, Caciotta, Fiore Sardo, Fontina, Gruyere, Havarti, Kashkaval, Marble Cheese, Montasio, Pecorino, Reggianito, Romano, Stravecchio, Tilsit, and the like.

### Legume and Seed Materials

In some embodiments of the invention, the cultured plant-based cheese composition comprises legume material, seed material, or a combination thereof in an amount of at least 40% by dry weight of the cultured plant-based food composition.

As used herein, “legume” refers to plants of the Fabiaceae family. Legumes include, but are not limited to, soybeans, fava beans, cannellini beans, navy beans, pinto beans, lima beans, kidney beans, mung beans, sweet lupine, lentils, peas, chickpeas, cowpeas, English peas, yellow peas, green peas, peanuts, alfalfa, clover, mesquite, carob, Stylosanthes, Sesbania, Vetch (Vicia), Arachis, Indigofera, and Leucaena. Legumes can include any bean, pea, lentil, or lupin. “Legume” may refer to the legume plant or to the fruits, seeds, or pods of the legume plant. As used herein, “legume material” refers to any material derived from a legume that comprises protein. For example, legume material may include, but is not limited to, fruits, seeds, or pods of legumes; pulses; powders or flours produced from the fruits, seeds, or pods of legumes; isolated legume protein; legume pastes or purees; legume butters including, but not limited to, peanut butter and soy butter; tofu; legume food products; or any combination thereof. As used herein, “whole legume material” refers to unprocessed fruits, seeds, or pods of legumes, such as beans, peas, bean pods, chickpeas, lentils, and the like.

As used herein, “seed” refers to any seed used in culinary applications which one of ordinary skill in the culinary arts would not consider a legume, a nut, or a grain. For example, seed can include sunflower seed, pumpkin seed, squash seed, chia seed, flax seed, hemp seed, safflower seed, cotton seed, rape seed, sesame seed, mustard seed, camelina seed, and poppy seed. Squash seed may include seeds from any plant in the Cucurbita family, for example, pumpkin seed, watermelon seed, winter squash seed, summer squash seed, or cucumber seed. Seeds may include vegetable seeds, fruit seeds, or a combination thereof. As used herein, “seed material” refers to any material derived from a seed that comprises protein. For example, seed material may include, but is not limited to, fresh or dried seeds; powders or flours produced from seeds; isolated seed protein; seed pastes or purees; seed butters including, but not limited to, sunflower seed butter, sesame seed butter, squash seed butter, poppy seed butter, hemp seed butter, and tahini; seed food products; or any combination thereof. As used herein, “whole seed material” refers to unprocessed fresh or dried seeds.

In some embodiments, the cultured plant-based cheese composition comprises legume material, seed material, or a combination thereof in an amount of at least 30% by dry weight of the cultured plant-based food composition. In some variations, the cultured plant-based cheese composition comprises legume material, seed material, or a combination thereof in an amount of at least 30%, at least 35%, at least 40%, at least 45%, at least 50%, at least 55%, at least 60%, at least 65%, at least 70%, at least 75%, at least 80%, at least 85%, at least 90%, or at least 95% by dry weight of the cultured plant-based food composition. In other variations, the cultured plant-based cheese composition comprises legume material, seed material, or a combination thereof in an amount of between 40% and 50%, between 50% and 60%, between 60% and 70%, between 70% and 80%, between 80% and 90%, or between 90% and 100% by dry weight of the cultured plant-based food composition.

### Microbial Cultures

In some embodiments, the cultured plant-based cheese composition comprises one or more microbial cultures comprising one or more microbes. As used herein, “microbial culture” refers to a population of microbial cells comprising one or more microbial species, and may refer to a viable microbial inoculum prior to its use in the cheesemaking process or a living, viable, or non-viable population of microbial cells present within the plant-based emulsion, curds, or cultured plant-based cheese composition of the present disclosure. Microbial cultures may include bacteria, yeast, filamentous fungi (molds), or any combination thereof. As used herein, “microbes” may refer to living, viable, or non-viable individual microbial cells or to species or genera of the bacteria, yeast, or filamentous fungi. “Living” refers to microbial cultures or microbes that are physiologically active and may be metabolizing the matter of their environment, undergoing cell replication (growth), or a combination thereof. “Viable” refers to microbial cultures or microbes which are not physiologically active but may become physiologically active given adequate environmental conditions, resulting in living cultures or microbes. “Non-viable” (dead) refers to microbial cultures or microbes which are not physiologically active and are incapable of becoming physiologically active under typical environmental conditions. Nevertheless, under certain conditions the enzymes and other cellular processes formerly contained within the living organism may continue after the cellular host is dead. For example, non-viable cells may release enzymes into their environment which retain their enzymatic activity after the death of the microbial cells in which they were once contained. The cultured plant-based cheese composition of the present disclosure may comprise microbes in any of living, viable, or non-viable states, or any combination thereof.

The cultured plant-based cheese composition may comprise microbial cultures including starter cultures, nonstarter cultures, or a combination thereof. As used herein, “starter culture” refers to the added microbes (bacteria or fungi) used to acidify (a.k.a., ripen or culture) dairy milk, non-dairy milk, or a plant-based emulsion. Some starter cultures, such as certain molds, may not acidify the dairy milk, non-dairy milk, or a plant-based emulsion but instead play other roles in flavor development during aging. As used herein, “nonstarter cultures” refers to microbes or microbial cultures which are not added by the cheesemaker but are either native to the milk or introduced from the environment, and may refer to nonstarter lactic acid bacteria. In some cheeses, these cultures may contribute little to acidification of dairy and non-dairy milks and instead grow during aging as the starter cultures die off. Without wishing to be bound by theory, many nonstarter cultures can have a significant effect on flavor development, while other nonstarter cultures play a role in the ecological succession of a cheese. For example, many yeasts from the environment may play a role in preparing the cheese surface for colonization with white molds (e.g., Penicillium candidum) by moderating the acidity of the cheese surface.

In a preferred embodiment, the cultured plant-based cheese composition comprises one or more microbes which may include, but are not limited to, Lactococcus sp., Lactobacillus sp., Streptococcus sp., Propionibacterium sp., Brevibacter sp., Leuconostoc sp., Corynebacterium sp., Pediococcus sp., Enterococcus sp., Bifidobacterium sp., Weissella sp., Penicillium sp., Aspergillus sp., Saccharomyces sp., Candida sp., and Geotrichum sp. In another embodiment, the cultured plant-based cheese composition may comprise any microbe known to be used in the production of fermented dairy or non-dairy food products. In some variations, the cultured plant-based cheese composition may comprise one or more bacteria including, but not limited to, Bacillus sp., Acetobacter sp., Aerococcus sp., Bifidobacterium sp., Brevibacter sp., Carnobacterium sp., Corynebacterium sp., Enterococcus sp., Lactococcus sp., Lactobacillus sp., Leuconostoc sp., Oenococcus sp., Pediococcus sp., Propionibacterium sp., Staphylococcus sp., Streptococcus sp., Tetragenococcus sp., Vagococcus sp., or Weissella sp. In additional variations, the cultured plant-based cheese composition may comprise one or more fungi including, but not limited to, Aspergillus sp., Candida sp., Debaryomyces sp., Geotrichum sp., Kluyveromyces sp., Penicillium sp., Pichia sp., Rhizopus sp., Rhodotorula sp, Saccharomyces sp., Trichosporon sp., Yarrowia sp., or Zygosaccharomyces sp. Additional examples of microbes which may be used in the production of fermented dairy or non-dairy food products are provided in US 2015/0305361 A1 and WO 2019/209939 A2, which are herein incorporated by reference in their entirety.

Microbes may be detected in the cultured plant-based cheese composition by any means known in the art, including methods used for the detection of microbes in dairy cheese. For example, the microbial cultures and specific microbes present in the cultured plant-based cheese composition may be detected and identified by using a sample of the cultured plant-based cheese composition to inoculate liquid growth culture media, solid growth culture media or a combination thereof; allowing the microbes in the sample to grow in the growth culture media; and isolating and identifying the microbial cultures and/or microbes. In another example, the nucleic acids of the microbes may be detected in a sample of the cultured plant-based cheese composition through a variety of well-known nucleic acid detection, genomic, and transcriptomic methods including, but not limited to, PCR, quantitative PCR, hybridization with one or more microbe-specific probes (e.g. micro-arrays, gene arrays, in-situ or in vitro hybridization with fluorescently labeled probes, etc.) Sanger DNA sequencing, next-generation DNA and RNA sequencing (e.g. Illumina, PacBio, or other high-throughput sequencing platforms), 16S sequencing, metagenomic sequencing, and the like. In a further example, the proteins of the microbes may be detected in a sample of the cultured plant-based cheese composition through a variety of well-known protein detection and proteomics methods including 1D or 2D SDS-PAGE, Western blotting, liquid chromatography coupled with mass spectrometry (MS) or tandem MS (LC-MS and LC-MS/MS), MALDI-TOF MS, and the like. Methods that may be used for the detection of microbes in cheese are described in numerous publications including, by way of example, US 2015/0305361 A1; Bhagya et al, 2018, Sequencing of the cheese microbiome and its relevance to industry. Frontiers in Microbiology 9:1020; De Filippis et al., 2016, Metatranscriptomics reveals temperature-driven functional changes in microbiome impacting cheese maturation rate. Sci Rep 6, 21871; De Filippis et al., 2014, A Selected Core Microbiome Drives the Early Stages of Three Popular Italian Cheese Manufactures. PLoS ONE 9(2); Tilocca et al., 2020, Milk microbiota: Characterization methods and role in cheese production, Journal of Proteomics, Volume 210, 103534; Schneider and Riedel, 2009, Environmental proteomics: Analysis of structure and function of microbial communities, Proteomics, 10, 785-798; and Jang and Kim, 2018, Rapid and robust MALDI-TOF MS techniques for microbial identification: a brief overview of their diverse applications. J Microbiol. 56, 209-216. These methods may be used to detect microbes in any of living, viable, or non-viable states, or any combination thereof.

### Coagulating Agents

In some embodiments, the cultured plant-based cheese composition comprises one or more coagulating agents. In some variations, the cultured plant-based cheese composition comprises one or more coagulating agents in an amount of at least about 0.0001%, at least about 0.001%, at least about 0.01%, at least about 0.1%, at least about 0.5%, at least about 1%, at least about 1.5%, at least about 2%, at least about 3%, at least about 4%, at least about 5%, at least about 6%, at least about 7%, at least about 8%, at least about 9%, or at least about 10% by dry weight of the cultured plant-based cheese composition. In a preferred embodiment, the one or more coagulation agents comprises one or more mineral cation coagulating agents. In some embodiments, the one or more mineral cation coagulating agents may include, but are not limited to, calcium, magnesium, and the like. In some variations, these mineral cations may be present as mineral cation salts, including, but not limited to, calcium chloride, calcium sulfate, magnesium chloride, and the like. In some embodiments, the coagulating agent comprises an acid. The acid can either be produced by starter cultures or added in the form of an edible acid. In some variations, the acid may include, but are not limited to, glucono delta-lactone, citric acid, acetic acid, lactic acid, tartaric acid, malic acid, fumaric acid, phosphoric acid, vinegar (e.g. white vinegar, apple cider vinegar, rice wine vinegar, sherry vinegar, balsamic vinegar, red wine vinegar, and/or white wine vinegar), fruit juice (e.g. lemon juice, lime juice, grapefruit juice, and/or apple juice), or any combination thereof. In some embodiments, the one or more coagulating agents may comprise an acid, a coagulating enzyme, a proteolytic enzyme, a cross-linking enzyme, a microbe, or any combination thereof. In other embodiments, the cultured plant-based cheese composition does not include a cross-linking enzyme. In one variation, the cultured plant-based cheese composition does not include transglutaminase.

### Enzymes

In some embodiments, the cultured plant-based cheese composition comprises one or more enzymes. The cultured plant-based cheese may comprise, for example, proteolytic enzymes, lipases, or a combination thereof.

In a subset of embodiments, the cultured plant-based cheese composition comprises one or more proteolytic enzymes. In one embodiment, the one or more proteolytic enzymes may include, but are not limited to, animal rennet, pepsin, chymosin, vegetable rennet, microbial rennet, papain, bromelain, serrapeptase, protease, pancreatin, and trypsin. Animal rennet refers to a suite of enzymes extracted from the stomach of a young mammal (e.g., calf) and used to coagulate milk. Animal rennet may be derived from mammals including, but not limited to, cows, goats, sheep, and pigs. Rennets may also include vegetable rennets derived from plants and microbial rennets derived from wild type or genetically modified microbes. Any rennet known to one of ordinary skill in the art of cheesemaking may be used. Examples of commercially available rennets that may be used include, but are not limited to: Mucor rennet, a native fungal rennet from Mucor miehei (Organic Liquid Vegetable Rennet, New England Cheesemaking Supply Co.); Star rennet, a chymosin enzyme produced in a genetically engineered fungal host (Chy-Max® Extra, Dairy Connection Inc.); Supreme rennet, a heat-labile protease from the fungus Rhizomucor miehei (Marzyme, Dairy Connection Inc.); and mucorpepsin rennet derived from thistle (Liquid Vegetable Rennet, New England Cheesemaking Supply Co.). In one variation, the proteolytic enzyme is chymosin derived from rennet. Chymosin is the primary proteolytic enzyme responsible for the coagulating action of rennet when used in dairy cheesemaking. Chymosin analogs can also be derived from microbial fermentation. Any food-safe proteolytic enzyme or protease known in the art to break down proteins to form peptides, free amino acids, other flavor molecules, or a combination thereof may be added to the plant-based emulsion or curds for the development of the flavor profile of the cultured plant-based cheese. The enzymes may be of microbial, plant, or animal origin and may or may not be of commercial origin. Additional examples of enzymes, including proteases and lipases, which may be added to non-dairy and plant-based cheeses are provided in US 2015/0305361 A1, which is herein incorporated by reference in its entirety.

In some embodiments, the one or more proteolytic enzymes comprise a protease or peptidase. In general, a protease or peptidase is an enzyme that conducts proteolysis, that is, catalyzes the hydrolysis of peptide bonds that link amino acids together into peptide chains. The protease can be a serine protease, a threonine protease, an asparagine protease, a mixed protease, a cysteine protease, an aspartate protease, or a metalloprotease. The protease can be an exopeptidase, e.g., an aminopeptidease or carboxypeptidase, or the protease can be an endopeptidase, e g., a trypsin, a chymotrypsin, pepsin, papain, cathepsin G, or elastase. The protease can be any protease selected from the group consisting of pepsin A. nepenthesin, walleye dermal sarcoma virus retropepsin, Ty3 transposon peptidase, Gypsy transposon peptidase, Osvaldo retrotransposon peptidase, retrotransposon peptidase, cauliflower mosaic virus-type peptidase, bacilliform virus peptidase, thermopsin, signal peptidase 11, spumapepsin, Copia transposon peptidase, Ty1 transposon peptidase, presenilin 1, impas 1 peptidase, type 4 prepilin peptidase 1, preflagellin peptidase, gpr peptidase, omptin, DNA-damage inducible protein 1, HybD peptidase, PerP peptidase, skin SASPase, sporulation factor SpoIIGA, papain, bleomycin hydrolase, calpain-2, poliovirus-type picornain 3C, enterovirus picornain 2A, foot-and-mouth disease virus picornain 3C, cowpea mosaic comovirus-type picornain 3C, hepatitis A virus-type picornain 3C, parechovirus picomain 3C, rice tungro spherical virus-type peptidase, nuclear-inclusion-a peptidase, adenain, potato virus Y-type helper component peptidase, chestnut blight fungus virus p29 peptidase, chestnut blight fungus virus p48 peptidase, sindbis virus-type nsP2 peptidase, streptopain, clostripain, ubiquitinyl hydrolase-LI, legumain, caspase-1, metacaspase Yca1, pyroglutamyl-peptidase I, murine hepatitis coronavirus papain-like peptidase 1, murine hepatitis coronavirus papain-like peptidase 2, hepatitis C virus peptidase 2, ubiquitin-specitic peptidase 14, tymovirus peptidase, carlavirus peptidase, rabbit hemorrhagic disease virus 3C-like peptidase, gingipain R, gamma-glutamyl hydrolase, rubella virus peptidase, foot-and-mouth disease virus L-peptidase, porcine transmissible gastroenteritis virus-type main peptidase, porcine reproductive and respiratory syndrome arterivirus-type cysteine peptidase alpha, equine arteritis virus-type cysteine peptidase, equine arteritis virus Nsp2-type cysteine peptidase, beet necrotic yellow vein furovirus-type papain-like peptidase, calicivirin, bacteriocin-processing peptidase, dipeptidyl-peptidase VI, beet yellows virus-type papain-like peptidase, amidophosphoribosyltransferase precursor, acyl-coenzyme A:6-aminopenicillanic acid acyl-transferase precursor, hedgehog protein, staphopain A, Ulp1 peptidase, separase, D-alanyl-glycyl peptidase, pestivirus Npro peptidase, autophagin-1, YopJ protein, PfpI peptidase, vaccinia virus I7L processing peptidase, YopT peptidase, HopN1 peptidase, penicillin V acylase precursor, sortase A, sortase B, gill-associated virus 3C-like peptidase, African swine fever virus processing peptidase, Cezanne deubiquitinylating peptidase, otubain-1, IdeS peptidase, Cyl) peptidase, dipeptidase A, AvrRpt2 peptidase, pseudomurein endoisopeptidase Pei, pestivirus NS2 peptidase, AgrB peptidase, viral tegument protein deubiquitinylating peptidase, UfSP1 peptidase, ElaD peptidase, RTX self-cleaving toxin, L,D-transpeptidase, gamma-glutamylcysteine dipeptidyltranspeptidase, prtH peptidase, OTLD1 deubiquitinylating enzyme, OTU1 peptidase, ataxin-3, nairovirus deubiquitinylating peptidase, acid ceramidase precursor, LapG peptidase, lysosomal 66.3 kDa protein, McjB peptidase, DeSI-1 peptidase, USPL1 peptidase, scytalidoglutamic peptidase, pre-neck appendage protein, aminopeptidase N, angiotensin-converting enzyme peptidase unit 1, thimet oligopeptidase, oligopeptidase F, thermolysin, mycolysin, immune inhibitor A peptidase, snapalysin, leishmanolysin, bacterial collagenase V, bacterial collagenase H, matrix metallopeptidase-1, serralysin, fragilysin, gametolysin, astacin, adamalysin, neprilysin, carboxypeptidase A1, carboxypeptidase E, gamma-D-glutamyl-meso-diaminopimelate peptidase 1, cytosolic carboxypeptidase 6, zinc D-Ala-D-Ala carboxypeptidase, van Y D-Ala-D-Ala carboxypeptidase, Ply118 L-Ala-D-Glu peptidase, vanX D-Ala-D-Ala dipeptidase, pitrilysin, mitochondrial processing peptidase beta-subunit, eupitrilysin, leucyl aminopeptidase, aminopeptidase I, membrane dipeptidase, glutamate carboxypeptidase, peptidase T. Xaa-His dipeptidase, carboxypeptidase Ssl, carnosine dipeptidase II, O-sialoglycoprotein peptidase, beta-lytic metallopeptidase, lysostaphin, methionyl aminopeptidase 1, aminopeptidase P. IgA1-specific metallopeptidase, tentoxilysin, aminopeptidase S, glutamate carboxypeptidase II, IAP aminopeptidase, aminopeptidase Ap1, aminopeptidase T, hyicolysin, carboxypeptidase Taq, anthrax lethal factor, deuterolysin, fungalysin, isoaspartyl dipeptidase, FtsH peptidase, glutamyl aminopeptidase, cytophagalysin, pappalysin-1, pox virus metallopeptidase, Ste24 peptidase, HItpX peptidase, Omal peptidase, dipeptidyl-peptidase III, S2P peptidase, sporulation factor SpoIVFB, archaelysin, D-aminopeptidase DppA, BlaRI peptidase, prtB g p., enhancin, glycyl aminopeptidase, IgA peptidase, StcE peptidase, PSMD14 peptidase, JAMM-like protein, AMSH deubiquitinating peptidase, peptidyl-Asp metallopeptidase, camelysin, murein endopeptidase, imelysin, Atp23 peptidase, tryptophanyl aminopeptidase 7-DMATS-type peptidase, ImmA peptidase, prenyl peptidase 2. Wssl peptidase, microcystinase M1rC, PrsW peptidase, mpriBi peptidase, NIeC peptidase, PghP gamma-polyglutamate hydrolase, chloride channel accessory protein 3. IMPa peptidase, MtfA peptidase, NeD peptidase, TYPE ENZYME, nodavirus peptide lyase, tetravirus coat protein, Tsh-associated self-cleaving domain, picobirnavirus self-cleaving protein, YscU protein, reovirus type I coat protein, poliovirus capsid VPO-type self-cleaving protein, intein-containing V-type proton ATPase catalytic subunit A, intein-containing replicative DNA helicase precursor, intein-containing chloroplast ATP-dependent peptide lyase, DmpA aminopeptidase, chymotrypsin A, glutamyl peptidase I, DegP peptidase, lysyl peptidase, streptogrisin A, astrovirus serine peptidase, togavirin, IgA1-specific serine peptidase, flavivirin, subtilisin Carlsberg, kexin, prolyl oligopeptidase, dipeptidyl-peptidase IV, acylaminoacyl-peptidase, glutamyl endopeptidase C, carboxypeptidase Y, D-Ala-D-Ala carboxypeptidase A, D-Ala-D-Ala carboxypeptidase B, D-Ala-D-Ala peptidase C, peptidase Clp, Xaa-Pro dipeptidyl-peptidase, Lon-A peptidase, cytomegalovirus assemblin, repressor LexA, signal peptidase I, signalase 21 kDa component, TraF peptidase, lysosomal Pro-Xaa carboxypeptidase, hepacivirin, potyvirus P1 peptidase, pestivirus NS3 polyprotein peptidase, equine arteritis virus serine peptidase, prolyl aminopeptidase, PS-10 peptidase, sobemovirus peptidase, luteovirus peptidase, C-terminal processing peptidase-1, tricorn core peptidase, penicillin G acylase precursor, dipeptidyl-peptidase 7, HetR peptidase, signal peptide peptidase A, protein C, archaean signal peptide peptidase 1, infectious pancreatic necrosis birnavirus Vp4 peptidase, dipeptidase E, sedolisin, rhomboid-1, SpoIVB peptidase, nucleoporin 145, lactoferrin, influenza A PA peptidase, EGF-like module containing mucin-like hormone receptor-like 2, Ssy5 peptidase, picornain-like cysteine peptidase, murein tetrapeptidase LD-carboxypeptidase, PIDD auto-processing protein unit 1, Tellina virus 1 VP4 peptidase, MUC1 self-cleaving mucin, dystroglycan, gpO peptidase, {Escherichia coli} phage KIF endosialidase CIMCD self-cleaving protein, White bream virus serine peptidase, prohead peptidase gp21, prohead peptidase, CARDS self-cleaving protein, prohead peptidase gp175, destabilase, archaean proteasome, beta component, Hs1V component of HslUV peptidase, glycosylasparaginase precursor, gamma-glutamyltransferase 1, ornithine acetyltransferase precursor, polycystin-1, collagenase, protein P5 murein endopeptidase, Lit peptidase, homomultimeric peptidase, yabG protein, microcin-processing peptidase 1, AIDA-1 self-cleaving autotransporter protein, and Dop isopeptidase.

In some embodiments, the cultured plant-based cheese may comprise proteolytic enzymes, lipases, or a combination thereof in an amount of between about 0.01 IMCU and about 0.05 IMCU, between about 0.05 IMCU and about 0.1 IMCU, between about 0.1 IMCU and about 0.5 IMCU, between about 0.5 IMCU and about 1 IMCU, between about 1 IMCU and about 5 IMCU, between about 5 IMCU and about 10 IMCU, between about 10 IMCU and about 20 IMCU, between about 20 IMCU and about 30 IMCU, between about 30 IMCU and about 40 IMCU, between about 40 IMCU and about 50 IMCU, between about 50 IMCU and about 75 IMCU, between about 75 IMCU and about 100 IMCU, between about 100 IMCU and about 125 IMCU, between about 125 IMCU and about 150 IMCU, between about 150 IMCU and about 200 IMCU, between about 200 IMCU and about 300 IMCU, between about 300 IMCU and about 400 IMCU, between about 400 IMCU and about 500 IMCU, between about 500 IMCU and about 600 IMCU, between about 600 IMCU and about 700 IMCU, between about 700 IMCU and about 800 IMCU, between about 800 IMCU and about 900 IMCU, or between about 900 IMCU and about 1000 IMCU, between about 1000 IMCU and about 1500 IMCU, between about 1500 IMCU and about 2000 IMCU, between about 2000 IMCU and about 2500 IMCU, between about 2500 IMCU and about 3000 IMCU, between about 3000 IMCU and about 3500 IMCU, between about 3500 IMCU and about 4000 IMCU, between about 4000 IMCU and about 4500 IMCU, or between about 4500 IMCU and about 5000 IMCU.

### Nuts

In some embodiments, the cultured plant-based cheese composition does not comprise nuts. As used herein, “nuts” is used in the culinary sense to refer to seeds which are neither legumes nor grains and are considered nuts by one of ordinary skill in the culinary arts. “Nuts” may refer to tree nuts including, but not limited to, cashews, almonds, walnuts, macadamia nuts, Brazil nuts, chestnuts, hazelnuts, pecans, pistachios, shea nuts, pine nuts, kola nuts, and the like. Nut allergy is one of the most common food allergies, often causing severe and life-threatening allergic reactions. In some embodiments, the cultured-plant based cheese is free of nuts with the benefit that it can be consumed by those with nut allergies. In other embodiments, the cultured-plant based cheese is free of nuts with the benefit that it can be produced at a lower cost than nut-based cheeses. In some variations, the cultured plant-based cheese composition may comprise less than 10%, less than 5%, less than 1%, less than 0.5%, less than 0.1%, less than 0.05%, or less than 0.01% nuts by dry weight of the cultured plant-based cheese composition. In other variations, the cultured plant-based cheese composition does not comprise almonds, cashews, or macadamia nuts. In one variation, the cultured plant-based cheese composition does not comprise almonds. In one variation, the cultured plant-based cheese composition does not comprise cashews. In one variation, the cultured plant-based cheese composition does not comprise macadamia nuts.

### Moisture Content

In some embodiments, the cultured plant-based cheese composition has a moisture content of no greater than 60%. In some variations, the cultured plant-based cheese composition has a moisture content of about 60% or less, about 55% or less, about 50% or less, about 45% or less, about 40% or less, about 35% or less, about 30% or less, about 25% or less, about 20% or less, or about 15% or less. In some embodiments, the cultured plant-based cheese composition has a moisture content of between about 10% and about 15%, about 15% and about 20%, about 20% and about 25%, about 25% and about 30%, between about 30% and about 35%, between about 35% and about 40%, between about 40% and about 45%, between about 45% and about 50%, between about 50% and about 55%, between about 55% and about 60%, or between about 60% and about 65%.

In some embodiments, the cultured plant-based cheese composition has a moisture content of between about 25% and about 60%. In some variations, the cultured plant-based cheese composition has a moisture content of between about 25% and about 30%, between about 25% and about 35%, between about 25% and about 40%, between about 25% and about 45%, between about 25% and about 50%, between about 25% and about 55%, between about 25% and about 60%, between about 30% and about 35%, between about 30% and about 40%, between about 30% and about 45%, between about 30% and about 50%, between about 30% and about 55%, between about 30% and about 60%, between about 35% and about 40%, between about 35% and about 45%, between about 35% and about 50%, between about 35% and about 55%, between about 35% and about 60%, between about 40% and about 45%, between about 40% and about 50%, between about 40% and about 55%, between about 40% and about 60%, between about 45% and about 50%, between about 45% and about 55%, between about 45% and about 60%, between about 50% and about 55%, between about 50% and about 60%, or between about 55% and about 60%.

In other embodiments, the cultured plant-based cheese composition has a moisture content of between about 28% and about 47%. In some variations, the cultured plant-based cheese composition has a moisture content of between about 28% and about 30%, between about 28% and about 32%, between about 28% and about 34%, between about 28% and about 36%, between about 28% and about 38%, between about 28% and about 40%, between about 28% and about 42%, between about 28% and about 44%, between about 28% and about 47%, between about 30% and about 32%, between about 30% and about 34%, between about 30% and about 36%, between about 30% and about 38%, between about 30% and about 40%, between about 30% and about 42%, between about 30% and about 44%, between about 30% and about 47%, between about 32% and about 34%, between about 32% and about 36%, between about 32% and about 38%, between about 32% and about 40%, between about 32% and about 42%, between about 32% and about 44%, between about 32% and about 47%, between about 34% and about 36%, between about 34% and about 38%, between about 34% and about 40%, between about 34% and about 42%, between about 34% and about 44%, between about 34% and about 47%, between about 36% and about 38%, between about 36% and about 40%, between about 36% and about 42%, between about 36% and about 44%, between about 36% and about 47%, between about 38% and about 40%, between about 38% and about 42%, between about 38% and about 44%, between about 38% and about 47%, between about 40% and about 42%, between about 40% and about 44%, between about 40% and about 47%, between about 42% and about 44%, between about 42% and about 47%, or between about 44% and about 47%.

### Aging

In some embodiments, the cultured plant-based cheese composition has been aged for a period of about 60 days or longer. In some variations, the cultured plant-based cheese composition has been aged for a period of at least about 60 days, at least about 70 days, at least about 80 days, at least about 90 days, at least about 120 days, at least about 150 days, at least about 180 days, at least about 210 days, at least about 240 days, at least about 270 days, at least about 330 days, or at least about 360 days. In other variations, the cultured plant-based cheese composition has been aged for a period of about 60 and about 90 days, between about 90 and about 120 days, between about 120 and about 150 days, between about 150 and about 180 days, between about 180 and about 210 days, between about 210 and about 240 days, between about 240 and about 270 days, between about 270 and about 300 days, between about 300 and about 330 days, or between about 330 and about 360 days. In additional variations, the cultured plant-based cheese composition has been aged for a period of at least about 2 months, at least about 3 months, at least about 4 months, at least about 5 months, at least about 6 months, at least about 7 months, at least about 8 months, at least about 9 months, at least about 10 months, at least about 11 months, at least about 12 months, at least about 14 months, at least about 16 months, at least about 18 months, at least about 20 months, at least about 22 months, at least about 24 months, at least about 30 months, or at least about 36 months. In other variations, the cultured plant-based cheese composition has been aged for a period of between about 2 and about 3 months, between about 3 and about 4 months, between about 4 and about 5 months, between about 5 and about 6 months, between about 6 and about 7 months, between about 7 and about 8 months, between about 8 and about 9 months, between about 9 and about 10 months, between about 10 and about 11 months, between about 11 and about 12 months, between about 12 and about 14 months, between about 14 and about 16 months, between about 16 and about 18 months, between about 18 and about 20 months, between about 20 and about 22 months, between about 22 and about 24 months, between about 24 and about 30 months, or between about 30 and about 36 months.

### Flavor Profile

In some embodiments, the cultured plant-based cheese composition has a complex flavor profile similar to that of a dairy cheese. As used herein, “flavor profile” refers to the identity and strength of flavor notes that give each cheese its unique flavor. Flavor profile may refer to the flavor profile of a single plant-based cheese composition or to that a class of dairy or non-dairy cheeses. For example, the cheddar class of cheeses has a distinct flavor profile from the parmesan class of cheeses. Flavor notes that may contribute to a cheese's flavor profile include, but are not limited to, balsamic, bitter, buttery, caramellic, cheesy, chocolate, citrus, cocoa, coffee, dairy, dark fruit, earthy, fatty, floral, fruity, garlic, goaty, green, hawthorn, herbaceous, malty, melon, milky, mushroom, musty, nutty, oily, orange, peach, pear, pine, pineapple, pungent, rose, rue, sour, spicy, sweaty, sweet, tonka, umami, vanilla, waxy, woody, yogurt, yeasty, and the like. Each of these flavor notes may be associated with a specific flavor compound or set of flavor compounds. As used herein, “flavor compound” refers to any small molecule that imparts an aroma or flavor note. Classes of flavor compounds may include, but are not limited to, free amino acids, salts, organic acids, sugars, sugar alcohols, lactones, alcohols, proteins, peptides, fats, fatty acids, and any volatile compound which imparts a flavor or aroma note. Specific flavor compounds which are beneficial to the production of a dairy or non-dairy cheese with a desired flavor profile include, but are not limited to, glutamate (umami), aspartic acid (umami, tart), glycine (sweet), cysteine (rotten), alanine (sweet), threonine (sweet), proline (sharp, mineral, sweet, sour, salty), serine (sweet), lysine (sharp, bitter, salty), glutamine (umami, savory, sweet), phenylalanine (bitter, pungent), tyrosine (bland), arginine (sharp, bitter), leucine (bitter, bland), isoleucine (bitter, bland), valine (bitter, bland), methionine (bitter, metallic), histidine (salty, sour, bitter), aspartic acid (sour, sharp), histidine (sharp, bitter), threonine (sweet, fatty), tryptophan (sharp, bitter), diacetyl (buttery, creamy, milky), gamma-octolactone (sweet, coconut, waxy, creamy, tonka, dairy, fatty), delta-octolactone (sweet, fatty, coconut, tonka, tropical, dairy), 2-butanone (acetone-like, fruity, butterscotch), 2-ethyl-1-hexanol (sweet, fruity fatty), 2-heptanone (cheese, fruity, coconut), 2-methyl butanal (cocoa, coffee, nutty), 2-methyl butanoic acid (fruity, acidic, dairy, buttery, cheesy), 2-methyl propanoic acid (rancid, buttery), 2-nonanone (green, herbal, cheesy, fresh), 2-undecanone (waxy, fruity, cheesy), 2,3-hexanedione (creamy, butter, fruity, caramellic), 3-methyl butanal (chocolate, peachy, fatty), 3-methyl butanoic acid (cheesy, dairy, creamy, fermented, sweet, waxy), 5-hydroxy-4-octanone (buttery), acetic acid (sour), acetoin (sweet, buttery, creamy, dairy, milky, fatty), butyrolactone (milky, creamy, fruity, peachy), decanoic acid (rancid, sour, fatty, goaty), dimethyl trisulfide butanoic acid (sulfurous, savory, cheesy, dairy, creamy, sharp), ethyl butanoate (fruity, sweet), ethyl octanoate (sweet, waxy, fruity, pineapple, creamy, fatty), hexanoic acid (sour, fatty, sweaty, cheesy), hexanoic acid methyl ester (fruity, pineapple), methional (musty, tomato, potato, cheesy), methyl isobutyl ketone (herbal, fruity, dairy), octanoic acid (fatty, waxy, rancid, oily, vegetable, cheesy), propanoic acid (acidic and dairy-like), and the like. Additional examples of flavor notes and flavor compounds which contribute to the flavor profiles of dairy, non-dairy and plant-based cheeses are provided in US 2015/0305361 A1, which is herein incorporated by reference in its entirety.

In some embodiments, the cultured plant-based cheese composition comprises a desirable cheesy or cheese-like flavor profile that is unique in comparison to flavor profiles of known dairy or plant-based cheeses. In other embodiments, the cultured plant-based cheese composition comprises a flavor profile similar to that of a dairy cheese known in the art. For example, in one embodiment, the cultured plant-based cheese composition comprises a flavor profile similar to that of Cheddar, Roquefort, Brie, Gruyere, Feta, Mozzarella, Manchego, Gorgonzola, Epoisses, Swiss Cheese, Gouda Cheese, Monterey Jack, Muenster Cheese, Provolone, Blue Cheese, Camembert, Irish Cheddar, Havarti, Buffalo Mozzarella, Colby-Jack, Edam, Ricotta, Pepper Jack Cheese, Goat Cheese, Colby Cheese, Stilton Cheese, Emmentaler, Cream Cheese, Comte Cheese, American Farmhouse Cheddar, Cottage Cheese, Grana Padano, Halloumi, Rembrandt Gouda, Sharp Provolone, Provola, Danish Blue, Saint Albray, Appenzeller Cheese, Mascarpone, Tomme De Savoie, String Cheese, Saint-Marcellin, American Cheese, Pont-L'Evêque Cheese, Mahon Cheese, Cantal Cheese, Emmental Francais, Selles-Sur-Cher Cheese, Neufchatel Cheese, Morbier Cheese, Fourme De Montbrison, Cheese Curdcaprice Des Dieux, Reblochon, Coulommiers Cheese, Taleggio Cheese, Vacherin, Beaufort Cheese, Beaufort Alpage, Abondance Cheese, Saint-Paulin Cheese, Chaource Cheese, Livarot Cheese, Rocamadour Cheese, Cambozola, Oregon Blue Vein, Leonora Goat Cheese, Pimento Cheese, Banon Cheese, Cabrales Cheese, Tete De Moine, Boerenkaas, Emmental De Savoie, Brocciu, Laguiole Cheese, Limburger Cheese, Queso De Bola, Maroilles Cheese, Stichelton, Ossau-Lraty Cheese, Saint-Nectaire, Pont L'Eveque, Crottin De Chavignol, Mimolette, Pélardon, Fourme D'Ambert, Fromage Frais, Bleu Du Vercors-Sassenage, Cabecou, Saint-Félicien Cheese, Bleu D'Auvergne, Bleu De Bresse, Farmer Cheese, Hooligan, Bleu Des Causses, Cheddar, Parmesan, Colby, Roquefort, Camembert, Chevre, Cotija, Emmental, Feta, Gouda, Taleggio, Parmigiano-Reggiano, Manchego, Monterey Jack, Jack, Appenzeller, Asiago, Caciocavallo, Caciotta, Fiore Sardo, Fontina, Gruyere, Havarti, Kashkaval, Marble Cheese, Montasio, Pecorino, Reggianito, Romano, Stravecchio, Tilsit, and the like. In further embodiments, the cultured plant-based cheese composition has a flavor profile similar to that of any one of the dairy cheeses described herein.

In some embodiments, it is desirable to produce a plant-based cheese composition which comprises few or no additives and consists primarily of whole or natural materials. Therefore, in a preferred embodiment, the flavor compounds present in the plant-based cheese composition are principally or entirely derived from the non-additive materials of the plant-based cheese composition. Specifically, in the preferred embodiment, the flavor compounds present in the plant-based cheese composition are principally or entirely either present in the non-additive materials of the cultured plant-based cheese composition, or are produced by microbial cultures metabolizing the compounds in the non-additive materials during the cheesemaking process to produce the flavor compounds. In some embodiments, the flavor compounds of the present plant-based cheese composition comprise additives, molecules derived from additives, or a combination thereof in an amount of no more than 40% by weight. In some embodiments, the flavor compounds present in the plant-based cheese composition comprise additives, molecules derived from additives, or a combination thereof in an amount of less than about 40% by weight. In some variations, the flavor compounds present in the plant-based cheese composition comprise additives, molecules derived from additives, or a combination thereof in an amount of less than about 35%, less than about 30%, less than about 25%, less than about 20%, less than about 15%, less than about 10%, less than about 9%, less than about 8%, less than about 7%, less than about 6%, less than about 5%, less than about 4%, less than about 3%, less than about 2%, less than about 1%, less than about 0.5%, less than about 0.1%, less than about 0.05%, less than about 0.01%, less than about 0.005%, or less than about 0.001% by weight. In another embodiment, the flavor compounds present in the plant-based cheese composition do not comprise additives. In another embodiment, the flavor compounds present in the plant-based cheese composition do not comprise molecules derived from additives. In another embodiment, the flavor compounds present in the plant-based cheese composition comprise neither additives nor molecules derived from additives.

### Free Amino Acids

In some embodiments, the cultured plant-based cheese composition comprises free amino acids. As used herein, “free amino acid” refers to an amino acid molecule which is not covalently linked to another compound such as a protein, a peptide, or any other molecule. Free amino acids may include any of the twenty canonical amino acids or any other amino acid known in the art. For example, free amino acids may include, but are not limited to, alanine, beta-alanine, arginine, asparagine, aspartate, citrulline, cysteine (Cys), cystine (Cys-Cys), gamma-aminobutyric acid (GABA), glutamate, glutamine, glycine, histidine, hydroxyproline, isoleucine, leucine, lysine, methionine, ornithine, phenylalanine, proline, serine, threonine, tryptophan, tyrosine, valine, and the like. In some embodiments, the cultured plant-based cheese composition comprises free amino acids in an amount of at least 50 mg per 100 g of the cultured plant-based cheese composition. In some embodiments, the cultured plant-based cheese composition comprises free amino acids in an amount of at least 75 mg per 100 g of the cultured plant-based cheese composition. In some variations, the cultured plant-based cheese composition comprises free amino acids in an amount of at least 50 mg, at least 60 mg, at least 70 mg, at least 80 mg, at least 90 mg, at least 100 mg, at least 125 mg, at least 150 mg, at least 175 mg, at least 200 mg, at least 225 mg, at least 250 mg, at least 300 mg, at least 350 mg, at least 400 mg, at least 450 mg, at least 500 mg, at least 600 mg, at least 700 mg, at least 800 mg, at least 900 mg, at least 1000 mg, at least 1100 mg, at least 1200 mg, at least 1300 mg, at least 1400 mg, at least 1500 mg, at least 1600 mg, at least 1700 mg, at least 1800 mg, at least 1900 mg, at least 2 g per 100 g, at least 3 g per 100 g, at least 4 g per 100 g, at least 5 g per 100 g, at least 6 g per 100 g, at least 7 g per 100 g, at least 8 g per 100 g, at least 9 g per 100 g, at least 10 g per 100 g, at least 11 g per 100 g, at least 12 g per 100 g, at least 13 g per 100 g, at least 14 g per 100 g, at least 15 g per 100 g, at least 16 g per 100 g, at least 17 g per 100 g, at least 18 g per 100 g, at least 19 g per 100 g, or at least 20 g per 100 g of the cultured plant-based cheese composition.

In some embodiments, the free amino acids present in the plant-based cheese composition are principally or entirely derived from the legume material, seed material, or combination thereof of the plant-based cheese composition. In one embodiment, at least 60% by weight of the free amino acids present in the plant-based cheese composition are derived from the legume material, seed material, or combination thereof of the plant-based cheese composition. In some variations, at least about 60%, at least about 65%, at least about 70%, at least about 75%, at least about 80%, at least about 85%, at least about 90%, at least about 95%, at least about 96%, at least about 97%, at least about 98%, at least about 99%, at least about 99.9%, or at least 99.99% by weight of the free amino acids present in the plant-based cheese composition are derived from the legume material, seed material, or combination thereof of the plant-based cheese composition. In one variation, the entirety of the free amino acids present in the plant-based cheese composition are derived from the legume material, seed material, or combination thereof of the plant-based cheese composition. In some embodiments, the free amino acids present in the plant-based cheese composition are principally or entirely derived from the non-additive materials of the plant-based cheese composition. In some embodiments, the free amino acids present in the cultured plant-based cheese composition comprise free amino acid additives, free amino acids derived from additives, or a combination thereof in an amount of no more than 40% by weight. In some embodiments, the free amino acids present in the cultured plant-based cheese composition comprise free amino acid additives, free amino acids derived from additives, or a combination thereof in an amount of less than about 40% by weight. In some variations, the free amino acids present in the cultured plant-based cheese composition comprise free amino acid additives, free amino acids derived from additives, or a combination thereof in an amount of less than about 35%, less than about 30%, less than about 25%, less than about 20%, less than about 15%, less than about 10%, less than about 9%, less than about 8%, less than about 7%, less than about 6%, less than about 5%, less than about 4%, less than about 3%, less than about 2%, less than about 1%, less than about 0.5%, less than about 0.1%, less than about 0.05%, less than about 0.01%, less than about 0.005%, or less than about 0.001% by weight. In another embodiment, the free amino acids present in the cultured plant-based cheese composition do not comprise free amino acid additives. In another embodiment, the free amino acids present in the cultured plant-based cheese composition do not comprise free amino acids derived from additives. In another embodiment, the free amino acids present in the cultured plant-based cheese composition comprise neither free amino acid additives nor free amino acids derived from additives.

In some embodiments, the cultured plant-based cheese composition comprises free glutamate in an amount sufficient to impart an umami flavor. Umami refers to the basic taste in foods described as “savory” and corresponding to the presence of free glutamate, nucleotides, or a combination thereof. As used herein, “free glutamate” refers to a glutamate molecule which is not covalently linked to another compound such as a protein, a peptide, or any other molecule. In some embodiments, the cultured plant-based cheese composition comprises free glutamate in an amount of at least 5 mg per 100 g of the cultured plant-based cheese composition. In a preferred embodiment, the cultured plant-based cheese composition comprises free glutamate in an amount of at least 50 mg per 100 g of the cultured plant-based cheese composition. In a preferred embodiment, the cultured plant-based cheese composition comprises free glutamate in an amount of at least 75 mg per 100 g of the cultured plant-based cheese composition. In some variations, the cultured plant-based cheese composition comprises free glutamate in an amount of at least 5 mg, at least 10 mg, at least 15 mg, at least 20 mg, at least 25 mg, at least 30 mg, at least 35 mg, at least 40 mg, at least 45 mg, at least 50 mg, at least 60 mg, at least 70 mg, at least 80 mg, at least 90 mg, at least 100 mg, at least 125 mg, at least 150 mg, at least 175 mg, at least 200 mg, at least 225 mg, at least 250 mg, at least 300 mg, at least 350 mg, at least 400 mg, at least 450 mg, at least 500 mg, at least 600 mg, at least 700 mg, at least 800 mg, at least 900 mg, at least 1000 mg, at least 1100 mg, at least 1200 mg, at least 1300 mg, at least 1400 mg, at least 1500 mg, at least 1600 mg, at least 1700 mg, at least 1800 mg, at least 1900 mg, or at least 2000 mg per 100 g of the cultured plant-based cheese composition.

In some embodiments, the cultured plant-based cheese composition comprises free glutamate in an amount of between about 50 mg and about 2,000 mg per 100 g of the cultured plant-based cheese composition. In some embodiments, the cultured plant-based cheese composition comprises free glutamate in an amount of between about 75 mg and about 1,400 mg per 100 g of the cultured plant-based cheese composition. In some variations, the cultured plant-based cheese composition comprises free glutamate in an amount of between about 30 mg and about 40 mg, between about 30 mg and about 50 mg, between about 30 mg and about 60 mg, between about 30 mg and about 70 mg, between about 30 mg and about 80 mg, between about 30 mg and about 90 mg, between about 30 mg and about 100 mg, between about 40 mg and about 50 mg, between about 40 mg and about 60 mg, between about 40 mg and about 70 mg, between about 40 mg and about 80 mg, between about 40 mg and about 90 mg, between about 40 mg and about 100 mg, between about 50 mg and about 60 mg, between about 50 mg and about 70 mg, between about 50 mg and about 80 mg, between about 50 mg and about 90 mg, between about 50 mg and about 100 mg, between about 60 mg and about 70 mg, between about 60 mg and about 80 mg, between about 60 mg and about 90 mg, between about 60 mg and about 100 mg, between about 70 mg and about 80 mg, between about 70 mg and about 90 mg, between about 70 mg and about 100 mg, between about 80 mg and about 90 mg, between about 80 mg and about 100 mg, or between about 90 mg and about 100 mg per 100 g of the cultured plant-based cheese composition. In other variations, the cultured plant-based cheese composition comprises free glutamate in an amount of between about 50 g and about 100 mg, between about 50 mg and about 150 mg, between about 50 mg and about 200 mg, between about 50 mg and about 250 mg, between about 50 mg and about 300 mg, between about 50 mg and about 400 mg, between about 50 mg and about 500 mg, between about 50 mg and about 750 mg, between about 50 mg and about 1,000, between about 50 mg and about 1,500 mg, between about 50 mg and about 2,000 mg, between about 100 mg and about 150 mg, between about 100 mg and about 200 mg, between about 100 mg and about 250 mg, between about 100 mg and about 300 mg, between about 100 mg and about 400 mg, between about 100 mg and about 500 mg, between about 100 mg and about 750 mg, between about 100 mg and about 1,000, between about 100 mg and about 1,500 mg, between about 100 mg and about 2,000 mg, between about 150 mg and about 200 mg, between about 150 mg and about 250 mg, between about 150 mg and about 300 mg, between about 150 mg and about 400 mg, between about 150 mg and about 500 mg, between about 150 mg and about 750 mg, between about 150 mg and about 1,000, between about 150 mg and about 1,500 mg, between about 150 mg and about 2,000 mg, between about 200 mg and about 250 mg, between about 200 mg and about 300 mg, between about 200 mg and about 400 mg, between about 200 mg and about 500 mg, between about 200 mg and about 750 mg, between about 200 mg and about 1,000, between about 200 mg and about 1,500 mg, between about 200 mg and about 2,000 mg, between about 250 mg and about 300 mg, between about 250 mg and about 400 mg, between about 250 mg and about 500 mg, between about 250 mg and about 750 mg, between about 250 mg and about 1,000, between about 250 mg and about 1,500 mg, between about 250 mg and about 2,000 mg, between about 300 mg and about 400 mg, between about 300 mg and about 500 mg, between about 300 mg and about 750 mg, between about 300 mg and about 1,000, between about 300 mg and about 1,500 mg, between about 300 mg and about 2,000 mg, between about 400 mg and about 500 mg, between about 400 mg and about 750 mg, between about 400 mg and about 1,000, between about 400 mg and about 1,500 mg, between about 400 mg and about 2,000 mg, between about 500 mg and about 750 mg, between about 500 mg and about 1,000, between about 500 mg and about 1,500 mg, between about 500 mg and about 2,000 mg, between about 750 mg and about 1,000, between about 750 mg and about 1,500 mg, between about 750 mg and about 2,000 mg, between about 1,000 mg and about 1,500 mg, between about 1,000 mg and about 2,000 mg, or between about 1,500 mg and about 2,000 mg per 100 g of the cultured plant-based cheese composition.

In one variation, the free glutamate present in the plant-based cheese composition are principally or entirely derived from the legume material, seed material, or combination thereof of the plant-based cheese composition. In some embodiments, the free glutamate present in the plant-based cheese composition are principally or entirely derived from the non-additive materials of the plant-based cheese composition. In some embodiments, at least 60% by weight of the free glutamate present in the plant-based cheese composition are derived from the legume material, seed material, or combination thereof of the plant-based cheese composition. In some variations, at least about 60%, at least about 65%, at least about 70%, at least about 75%, at least about 80%, at least about 85%, at least about 90%, at least about 95%, at least about 96%, at least about 97%, at least about 98%, at least about 99%, at least about 99.9%, or at least 99.99% by weight of the free glutamate present in the plant-based cheese composition are derived from legume material, seed material, or combination thereof of the plant-based cheese composition. In one variation, the entirety of the free glutamate present in the plant-based cheese composition are derived from the legume material, seed material, or combination thereof of the plant-based cheese composition. In another variation, the cultured plant-based cheese composition does not comprise a free glutamate additive. In yet another variation, the cultured plant-based cheese does not comprise a monosodium glutamate additive. In some embodiments, the glutamate present in the cultured plant-based cheese composition comprises free glutamate additives, free glutamate derived from additives, or a combination thereof in an amount of no more than 40% by weight. In some embodiments, the free glutamate present in the cultured plant-based cheese composition comprises free glutamate additives, free glutamate derived from additives, or a combination thereof in an amount of less than about 40% by weight. In some variations, the free glutamate present in the cultured plant-based cheese composition comprises free amino acid additives, free glutamate derived from additives, or a combination thereof in an amount of less than about 35%, less than about 30%, less than about 25%, less than about 20%, less than about 15%, less than about 10%, less than about 9%, less than about 8%, less than about 7%, less than about 6%, less than about 5%, less than about 4%, less than about 3%, less than about 2%, less than about 1%, less than about 0.5%, less than about 0.1%, less than about 0.05%, less than about 0.01%, less than about 0.005%, or less than about 0.001% by weight. In another embodiment, the free glutamate present in the cultured plant-based cheese composition do not comprise free amino acid additives. In another embodiment, the free glutamate present in the plant-based cheese composition does not comprise free glutamate derived from additives. In another embodiment, the free glutamate present in the plant-based cheese composition comprises neither free glutamate additives nor free glutamate derived from additives.

### Fats

The cultured plant-based cheese composition may further include an additional plant fat—such as corn, soybean, sunflower, coconut, canola, palm, rice, safflower, peanut, olive, cottonseed—which adds to the taste, texture, and aroma of the resulting cheeses because of the fat's inherent characteristics and because of its breakdown products produced during aging and fermentation of the cultured plant-based cheese composition.

In some embodiments, the cultured plant-based cheese composition comprises one or more fats. These plant fats may be in addition to those fats naturally present in the legume material, seed material, or combination thereof. In one embodiment, the one or more added fats is from an animal source. In a preferred embodiment, the cultured plant-based cheese composition comprises one or more plant fats. In some variations, the one or more plant fats may include, but are not limited to, corn oil, soybean oil, sunflower oil, coconut oil, canola oil, palm oil, palm kernel oil, rice bran oil, safflower oil, peanut oil, olive oil, cocoa oil, cocoa butter, walnut oil, cottonseed oil, mango oil, flaxseed oil, what oil, barley oil, grain oil, legume oil, nut oil, fruit oil, squash seed oil, avocado oil, grape seed oil, sesame oil, argan oil, almond oil, babassu oil, microbial oil products, or any combination thereof. The one or more plant fats may be any plant-based source of fat known in the art, including any seed oil, legume oil, or nut oil.

### Sugars

The cultured plant-based cheese composition may further include one or more sugars such as sucrose, dextrose, fructose, glucose, or maltose in the form of beet sugars, cane sugars, corn syrup, rice syrup, or tapioca syrup. These sugars can be added to the plant-based emulsion in order to support the growth and acid production of microbial cultures. Sugars can be added to the final plant-based emulsion in concentrations of 1-5% weight per volume. Any sugars that are not fermented during acidification of the milk may be mostly removed with the whey during cheesemaking or fully fermented during aging. Thus, they are mostly absent from the final product.

In some embodiments, the cultured plant-based cheese composition comprises one or more sugars. The one or more sugars may be in addition to those sugars naturally present in the legume material, seed material, or combination thereof. In some variations, the one or more sugars are simple sugars (monosaccharides and disaccharides) which may include, but are not limited to, lactose, sucrose, dextrose (glucose), galactose, fructose, maltose, ribose, arabinose, xylose, melibiose, trehalose, and cellobiose. In some variations, the cultured plant-based cheese composition comprises one or more complex carbohydrates such as starch, pectin, glycogen, dextrans, amylose, amylopectin, maltodextrin, and the like. In other variations, the cultured plant-based cheese composition comprises one or more sugars in the form of one or more syrups including, but not limited to, honey, corn syrup, high fructose corn syrup, rice syrup, agave nectar, molasses, coconut nectar, maple syrup, tapioca syrup, and the like. In yet other variations, the cultured plant-based cheese composition may comprise other sources of sugar such as fruit and vegetable juices, fruit and vegetable juice concentrates, fruit and vegetable extracts, whole fruits and vegetables, cane sugar, beet sugar, coconut sugar, sugar alcohols, sugar derivatives, and the like. In some embodiments, the one or more sugars are added to the plant-based emulsion in an amount of between 0% and about 5% weight per volume (% w/v) of the plant-based emulsion.

### Salt

In some embodiments, the cultured plant-based cheese composition comprises salt. The cultured plant-based cheese composition may comprise any type of salt known in the art for use in food applications, including, but not limited to, table salt (sodium chloride), sea salt, kosher salt, fleur de sel, sel gris, pink salt, Himalayan black salt, smoked salt, flake salt, pickling salt, and the like. In a preferred embodiment, the cultured plant-based cheese composition comprises non-iodized salt.

### Additives

In additional embodiments, the cultured plant-based cheese composition may comprise additives used to produce a desired flavor, texture profile, and overall sensory experience associated with the cultured plant-based cheese composition. As used herein, “additive” refers to any minor ingredient added at any point during the cheesemaking process to produce the desired flavor, texture profile, and overall sensory experience associated with the cultured plant-based cheese composition, but is not required to produce the cultured plant-based cheese composition of the present disclosure. As used herein, the term “additive” excludes the ingredients required to produce the cultured plant-based cheese composition of the cultured plant-based cheese composition including the legume material, seed material, or combination thereof; microbial cultures comprising microbes; coagulating agents; and proteolytic enzymes. Likewise, as used herein, “additive” excludes bulk nutritional ingredients added in the cheesemaking process, specifically, added fats, sugars, and salt.

In some embodiments, the cultured plant-based cheese composition comprises one or more additives. In some embodiments, the cultured plant-based cheese composition comprises one or more of flavoring agents, texturizing agents, and citrate. In some additional embodiments, the cultured plant-based cheese composition may comprise coloring agents or preservatives. Flavoring agents may include, but are not limited to, flavor molecules or flavor molecule precursors, either isolated or partially isolated; plant, bacterial, or fungal extracts; herbs or spices; vinegars; amino acid additives; monosodium glutamate; or other artificial or natural sources of flavor compounds. In one embodiment, the cultured plant-based cheese composition may further comprise ingredients that contribute citrate or citric acid to the plant-based emulsion, including, but not limited to, sodium citrate, calcium citrate, or citrus fruits. Citrate occurs naturally in mammalian milk, and, without wishing to be bound by theory, its breakdown creates many important cheese flavors such as diacetyl, a key aromatic in butter. Additional examples of additives that may be used to manipulate the flavor of the cultured plant-based cheese composition are provided in US 2015/0305361 A1, which is herein incorporated by reference in its entirety.

In some embodiments, it is desirable to produce a plant-based cheese composition which comprises few or no additives and consists primarily of whole, natural, or minimally processed materials. Therefore, in a preferred embodiment, the cultured plant-based cheese composition comprises additives in an amount of less than about 20% by dry weight of the cultured plant-based cheese composition. In some variations, the cultured plant-based cheese composition comprises additives in an amount of less than about 15%, less than about 10%, less than about 9%, less than about 8%, less than about 7%, less than about 6%, less than about 5%, less than about 4%, less than about 3%, less than about 2%, less than about 1%, less than about 0.5%, less than about 0.1%, less than about 0.05%, less than about 0.01%, less than about 0.005%, less than about 0.001%, less than about 0.0005%, less than about 0.0001% by dry weight of the cultured plant-based cheese composition.

In some embodiments, the cultured plant-based cheese composition does not comprise additives. In some embodiments, the cultured plant-based cheese composition does not comprise flavoring agents. In some embodiments, the cultured plant-based cheese composition does not comprise texturizing agents. In some embodiments, the cultured plant-based cheese composition does not comprise coloring agents. In some embodiments, the cultured plant-based cheese composition does not comprise preservatives. In certain embodiments, the cultured plant-based cheese composition does not comprise miso. In certain embodiments, the cultured plant-based cheese composition does not comprise nutritional yeast (also known as inactivated yeast). In certain embodiments, the cultured plant-based cheese composition does not comprise yeast extract. In one embodiment, the cultured plant-based cheese composition does not comprise an amino acid additive. In some variations, the cultured plant-based cheese composition does not comprise one or more, or any, of fermented tofu, soy sauce, tamari, miso made from any fermented grain, legume, or seed, fermented soy beans, koji, koji fermented grains, legumes or seeds, autolyzed yeast, mushroom extract, onion powder, garlic powder, monosodium glutamate, guanosine-5′-monophosphate, succinic acid, propionic acid, alpha-keto acids, alpha-ketoglutarate, methyl ketones, lactones, 2,3-butanedione, (e)-2-nonenal, (Z)-2-nonenal, disodium inosinate, disodium guanylate, diacetyl, acetoin, acetylpropionyl, dimethyl sulfide, lemon juice, lactic acid, mustard, dijon mustard, homofuraneol, butyric acid, furaneol, delta-decalactone, skatole, 6-(Z)-dodecenyl-gamma-lactone, 3-(methylthio) propanal, (E)-beta-damascenone, 2, 3-butanedione, nonanal, trans-4,5-epozy-2-(E)-decenal, acetic acid, 1-octen-3-one, hexanoic acid, dimethyl trisulfide, (E)-2-nonenal, ethyl butanoate, ethyl-3-methyl butanoate, ethyl isobutanoate, 2,3-methyl-1-butanol, phenyl acetaldehyde, ethyl hexanoate, ethyl butanoate, nonanal, 1-octen-3-ol, delta decalactone, trans-4,5-epoxy-2-(e)-decenal, delta-dodecalactone, 2-acetylthiazoline, 2/3-methyl betanal, hexanal, octanal, 2-acetyl-2-thiazoline, beta-damascenone, 2-acteyl-1-pyrroline, (E,Z)-2,6-nonadienal, (E,E)-2,4-nonadienal, (Z)-4-Heptenal, (Z)-1,5-octadien-3-one, 2-isobutyl-3-methoxypyrazine, 2-nonanone, 2-isopropyl-3-methoxypyrazine, decanal, 2/3-methyl butanal, ethyl octanoate, 1-hexen-3-one, methyl propanal, 3-(metylthio) propanal, p-cresol, butanoic acid, isovaleric acid, 2-phenylethanol, octanoic acid, 4,5-dimethyl-3-hydroxy-2(5H)-furanone, phenyl acetic acid, pentanoic acid, guiacol, gamma-decalactone, 2-acetylpyrazine, linalool, and geosmin. In some embodiments, the cultured plant-based cheese composition does not comprise “natural flavors” and/or “artificial flavors”, which include, but are not limited to, fermented tofu, soy sauce, tamari, miso made from any fermented grain, legume, or seed, fermented soy beans, koji, koji fermented grains, legumes or seeds, autolyzed yeast, mushroom extract, onion powder, garlic powder, monosodium glutamate, inosine-5′-monophosphate, guanosine-5′-monophosphate, succinic acid, propionic acid, alpha-keto acids, alpha-ketoglutarate, methyl ketones, lactones, 2,3-butanedione, (e)-2-nonenal, (Z)-2-nonenal, disodium inosinate, disodium guanylate, diacetyl, acetoin, acetylpropionyl, dimethyl sulfide, lemon juice, lactic acid, mustard, dijon mustard, homofuraneol, butyric acid, furaneol, delta-decalactone, skatole, 6-(Z)-dodecenyl-gamma-lactone, 3-(methylthio) propanal, (E)-beta-damascenone, 2, 3-butanedione, nonanal, trans-4,5-epozy-2-(E)-decenal, acetic acid, 1-octen-3-one, hexanoic acid, dimethyl trisulfide, (E)-2-nonenal, ethyl butanoate, ethyl-3-methyl butanoate, ethyl isobutanoate, 2,3-methyl-1-butanol, phenyl acetaldehyde, ethyl hexanoate, ethyl butanoate, nonanal, 1-octen-3-ol, delta decalactone, trans-4,5-epoxy-2-(e)-decenal, delta-dodecalactone, 2-acetylthiazoline, 2/3-methyl betanal, hexanal, octanal, 2-acetyl-2-thiazoline, beta-damascenone, 2-acteyl-1-pyrroline, (E,Z)-2,6-nonadienal, (E,E)-2,4-nonadienal, (Z)-4-Heptenal, (Z)-1,5-octadien-3-one, 2-isobutyl-3-methoxypyrazine, 2-nonanone, 2-isopropyl-3-methoxypyrazine, decanal, 2/3-methyl butanal, ethyl octanoate, 1-hexen-3-one, methyl propanal, 3-(metylthio) propanal, p-cresol, butanoic acid, isovaleric acid, 2-phenylethanol, octanoic acid, 4,5-dimethyl-3-hydroxy-2(5H)-furanone, phenyl acetic acid, pentanoic acid, guiacol, gamma-decalactone, 2-acetylpyrazine, linalool, and geosmin.

In some embodiments, the cultured plant-based cheese composition does not comprise exogenous flavor additives and/or does not comprise exogenous flavor compounds. As defined herein, “exogenous” refers to additives, such as flavor additives, and flavor compounds that are not derived from the legume material, seed material, plant fats, and/or sugars that make up the bulk of the starting material (e.g., the plant-based emulsion) of the cultured plant-based cheese product. In some embodiments, the cultured plant-based cheese composition does not comprise one or more, or any, of exogenous free amino acids, exogenous keto acids, exogenous monosodium glutamate, exogenous inosine-5′-monophosphate, exogenous guanosine-5′-monophosphate, exogenous succinic acid, exogenous propionic acid, exogenous alpha-keto acids, exogenous alpha-ketoglutarate, exogenous methyl ketones, exogenous lactones, exogenous 2,3-butanedione, exogenous (e)-2-nonenal, (Z)-2-nonenal, exogenous disodium inosinate, exogenous disodium guanylate, exogenous diacetyl, exogenous acetoin, exogenous acetylpropionyl, exogenous dimethyl sulfide, exogenous lactic acid, exogenous homofuraneol, exogenous butyric acid, exogenous furaneol, exogenous delta-decalactone, exogenous skatole, exogenous 6-(Z)-dodecenyl-gamma-lactone, exogenous 3-(methylthio) propanal, exogenous (E)-beta-damascenone, exogenous 2, 3-butanedione, exogenous nonanal, exogenous trans-4,5-epozy-2-(E)-decenal, exogenous acetic acid, exogenous 1-octen-3-one, exogenous hexanoic acid, exogenous dimethyl trisulfide, exogenous (E)-2-nonenal, exogenous ethyl butanoate, exogenous ethyl-3-methyl butanoate, exogenous ethyl isobutanoate, exogenous 2,3-methyl-1-butanol, exogenous phenyl acetaldehyde, exogenous ethyl hexanoate, exogenous ethyl butanoate, exogenous nonanal, exogenous 1-octen-3-ol, exogenous delta decalactone, exogenous trans-4,5-epoxy-2-(e)-decenal, exogenous delta-dodecalactone, exogenous 2-acetylthiazoline, exogenous 2/3-methyl betanal, exogenous hexanal, exogenous octanal, exogenous 2-acetyl-2-thiazoline, exogenous beta-damascenone, exogenous 2-acteyl-1-pyrroline, exogenous (E,Z)-2,6-nonadienal, exogenous (E,E)-2,4-nonadienal, exogenous (Z)-4-Heptenal, exogenous (Z)-1,5-octadien-3-one, exogenous 2-isobutyl-3-methoxypyrazine, exogenous 2-nonanone, exogenous 2-isopropyl-3-methoxypyrazine, exogenous decanal, exogenous 2/3-methyl butanal, exogenous ethyl octanoate, exogenous 1-hexen-3-one, exogenous methyl propanal, exogenous 3-(metylthio) propanal, exogenous p-cresol, exogenous butanoic acid, exogenous isovaleric acid, exogenous 2-phenylethanol, exogenous octanoic acid, exogenous 4,5-dimethyl-3-hydroxy-2(5H)-furanone, exogenous phenyl acetic acid, exogenous pentanoic acid, exogenous guiacol, exogenous gamma-decalactone, exogenous 2-acetylpyrazine, exogenous linalool, and exogenous geosmin. In some embodiments, the cultured plant-based cheese composition does not comprise exogenous flavor additives comprising dairy cheese (e.g., Cheddar cheese) flavor compounds. Dairy cheese flavor compounds are known the in art and are described in, for example, Singh et al. 2003 (Singh, T. K., M. A. Drake, and K. R. Cadwallader. “Flavor of Cheddar cheese: A chemical and sensory perspective.” Comprehensive reviews in food science and food safety 2.4 (2003): 166-189) and Cadwallader and Singh 2009 (Cadwallader, Keith R., and T. K. Singh. “Flavours and off-flavours in milk and dairy products.” Advanced dairy chemistry. Springer, New York, N.Y., 2009. 631-690).

In some embodiments, the cultured plant-based cheese composition does not comprise a gelling agent. In some embodiments, the cultured plant-based cheese composition does not comprise starch. In some variations, the cultured plant-based cheese composition does not comprise one or more, or any, of potato starch, corn starch, rice starch, and tapioca starch. In some embodiments, the cultured plant-based cheese composition does not comprise native starch. In some variations, the cultured plant-based cheese composition does not comprise one or more, or any, of native potato starch, native corn starch, native rice starch, and native tapioca starch. In some embodiments, the cultured plant-based cheese composition does not comprise modified food starch. In some variations, the cultured plant-based cheese composition does not comprise one or more, or any, of modified potato starch, modified corn starch, modified rice starch, and modified tapioca starch. In some embodiments, the cultured plant-based cheese composition does not comprise one or more, or any, of carrageenan, agar agar, konjac flour, konjac gum, locust bean gum, xanthan gum, and any other gelling agent described herein.

### pH of the Cultured Plant-Based Cheese Composition

In some embodiments, the cultured plant-based cheese composition has been cultured or aged to reach a desired pH. In some embodiments, the cultured plant-based cheese composition has a pH of between about 4.5 and about 7.5. In one preferred variation, the cultured plant-based cheese composition has a pH of between 4.5 and 5.8. In another preferred variation, the cultured plant-based cheese composition has a pH of between 5.5 and 7.2. In yet another preferred variation, the cultured plant-based cheese composition has a pH of between 4.0 and 6.5. In still another preferred variation, the cultured-plant-based cheese composition has a pH of between 4.4 and 5.5. In some additional variations, the cultured plant-based cheese composition has a pH of between about 4.5 and about 5.0, between about 4.5 and about 5.5, between about 4.5 and about 6.0, between about 5.0 and about 5.5, between about 5.0 and about 6.0, or between about 5.5 and about 6.0, between about 6.0 and about 6.5, or between about 6.5 and about 7.0, or between about 7.0 and about 7.5. In additional variations, the cultured plant-based cheese composition has a pH of between about 4.5 and about 4.8, between about 4.8 and about 5.0, between about 5.0 and about 5.2, between about 5.2 and about 5.4, between about 5.4 and about 5.6, between about 5.6 and about 5.8, between about 5.8 and about 6.0, between about 6.0 and about 6.2, between about 6.2 and about 6.4, between about 6.4 and about 6.6, between about 6.6 and about 6.8, between about 6.8 and about 7.0, between about 7.0 and about 7.2, or between about 7.2 and about 7.5. In one variation, the cultured plant-based cheese composition has a pH of about 4.5 or higher.

### Meltable Plant-Based Cheese Compositions

In another aspect, provided herein is a meltable plant-based cheese composition. As used herein, “meltable” refers to a composition that melts at temperatures typically maintained in culinary or cooking processes. As used herein, to “melt” means to undergo a phase shift wherein a solid becomes a liquid through the addition of heat. The cultured plant-based cheese compositions described herein can be used as a base to provide flavor to a meltable plant-based cheese which approximates the flavor profile of a dairy cheese more closely than the meltable plant-based cheeses currently commercially available. In some embodiments, the meltable plant-based cheese composition comprises the cultured plant-based cheese composition in an amount of between about 5% and about 75% by weight of the meltable plant-based cheese composition. In some variations, the meltable plant-based cheese composition comprises the cultured plant-based cheese composition in an amount of between about 5% and about 10%, between about 10% and about 15%, between about 10% and about 20%, between about 15% and about 20%, between about 15% and about 25%, between about 20% and about 25%, between about 20% and about 30%, between about 25% and about 30%, between about 25% and about 35%, between about 30% and about 35%, between about 30% and about 40%, between about 35% and about 40%, between about 35% and about 45%, between about 40% and about 45%, between about 40% and about 50%, between about 45% and about 50%, between about 50% and about 55%, between about 50% and about 60%, between about 55% and about 60%, between about 55% and about 65%, between about 60% and about 65%, between about 60% and about 70%, between about 65% and about 70%, between about 65% and about 75%, or between about 70% and about 75% by weight of the meltable plant-based cheese composition. In some variations, the meltable plant-based cheese composition comprises the cultured plant-based cheese composition in an amount of between about 20% and about 30%, between about 20% and about 40%, between about 20% and about 50%, between about 20% and about 60%, between about 20% and about 70%, between about 20% and about 75%, between about 30% and about 40%, between about 30% and about 50%, between about 30% and about 60%, between about 30% and about 70%, between about 30% and about 75%, between about 40% and about 50%, between about 40% and about 60%, between about 40% and about 70%, between about 40% and about 75%, between about 50% and about 60%, between about 50% and about 70%, between about 50% and about 75%, between about 60% and about 70%, or between about 60% and about 75% by weight of the meltable plant-based cheese composition.

In some embodiments, the meltable plant-based cheese composition comprises one or more gelling agents. The one or more gelling agents may be any gelling agent known in the art for use as a thickener in food products. The one or more gelling agents may include, but are not limited to gels (e.g., agar agar, carrageenan, gelatin, pectin, alginate, gellan), gums (e.g., xanthan gum, guar gum, locust bean gum, gellan gum, acacia gum, gum arabic, carob bean gum, gum tragacanth, cassia gum, konjac flour, and konjac gum), native starches (e.g., corn, tapioca, cassava, potato, wheat, rice, arrowroot, oat, sweet potato, sago, mung bean), modified starches (native starches that are physically, chemically, and/or enzymatically modified, including those from corn, tapioca, cassava, potato, wheat, rice, arrowroot, oat, sweet potato, sago, mung bean), cellulose derivatives (e.g., carboxymethyl cellulose, methyl cellulose, hydroxypropyl methylcellulose), and the like. In some embodiments, the meltable plant-based cheese composition comprises one or more gelling agents in an amount of between about 0.5% and about 60% by weight of the meltable plant-based cheese composition. In some variations, the meltable plant-based cheese composition comprises one or more gelling agents in an amount of between about 0.5% and about 1%, between about 1% and about 5%, between about 1% and about 10%, between about 5% and about 10%, between about 5% and about 15%, between about 10% and about 15%, between about 10% and about 20%, between about 15% and about 20%, between about 15% and about 25%, between about 20% and about 25%, between about 20% and about 30%, between about 25% and about 30%, between about 25% and about 35%, between about 30% and about 35%, between about 30% and about 40%, between about 35% and about 40%, between about 35% and about 45%, between about 40% and about 45%, between about 40% and about 50%, between about 45% and about 50%, between about 50% and about 55%, or between about 55% and about 60% by weight of the meltable plant-based cheese composition.

In some embodiments, the meltable plant-based cheese composition comprises one or more fats in an amount of between 0% and 30% by weight of the meltable plant-based cheese composition. The meltable plant-based cheese composition may comprise any added animal- or plant-based fat described herein or known in the art. In some embodiments, the meltable plant-based cheese composition comprises one or more plant fats in an amount of between about 0% and about 30% by weight of the meltable plant-based cheese composition. In some variations, the meltable plant-based cheese composition comprises one or more plant fats in an amount of between about 0% and about 5%, 5% and about 10%, between about 10% and about 15%, between about 10% and about 20%, between about 15% and about 20%, between about 15% and about 25%, between about 20% and about 25%, between about 20% and about 30%, or between about 25% and about 30% by weight of the meltable plant-based cheese composition.

In some embodiments, the meltable plant-based cheese composition comprises salt in an amount of between 0% and 5% by weight of the meltable plant-based cheese composition. The meltable plant-based cheese composition may comprise any salt described herein or known in the art to be used in food applications. In a preferred embodiment, the meltable plant-based cheese composition comprises salt in an amount of between 1% and 3% by weight of the meltable plant-based cheese composition. In some variations, the meltable plant-based cheese composition may comprise between about 0.01% and about 0.05%, about 0.05% and about 0.1%, about 0.1% and about 0.5%, between about 0.5% and about 1.0%, between about 1.0% and about 1.5%, between about 1.5% and about 2.0%, between about 2.0% and about 2.5%, between about 2.5% and about 3.0%, between about 3.0% and about 3.5%, between about 3.5% and about 4.0%, between about 4.0% and about 4.5%, or between about 4.5% and about 5.0% by weight of the meltable plant-based cheese composition.

In some embodiments, the meltable plant-based cheese composition comprises water in an amount of between 10% and 80% by weight of the meltable plant-based cheese composition. In some variations, the meltable plant-based cheese composition comprises water in an amount of between about 10% and about 20%, between about 10% and about 30%, between about 20% and about 30%, between about 20% and about 40%, between about 20% and about 70%, between about 30% and about 40%, between about 30% and about 50%, between about 30% and about 70%, between about 40% and about 50%, between about 40% and about 60%, between about 50% and about 80%, between about 50% and about 60%, between about 50% and about 70%, between about 60% and about 70%, between about 60% and about 80%, or between about 70% and about 80% by weight of the meltable plant-based cheese composition. In some embodiments, the meltable plant-based cheese composition melts at a temperature of between about 50° C. and about 90° C. In some variations, the meltable plant-based cheese composition melts at a temperature above 50° C., above 55° C., above 60° C., above 65° C., above 70° C., above 75° C., above 80° C., above 85° C., or above 90° C. In certain embodiments, the meltable plant-based cheese composition further comprises coloring agents, preservatives, or a combination thereof.

### Methods of Producing Cultured Plant-Based Cheese Compositions

In another aspect, the present disclosure provides a method of producing a cultured plant-based cheese composition. The method parallels traditional cheesemaking of natural cheeses. Natural cheeses are a category of cheeses that generally serve as a contrast to processed cheeses. Natural cheese is considered “true cheese”—coagulated milk proteins and fats that are separated from the whey. Depending on the variety, natural cheese may be cultured, pressed, aged, heated, kneaded, or otherwise manipulated to obtain a final product. Examples of dairy natural cheeses include cheddar, parmesan, mozzarella, cottage cheese, cream cheese, colby, and paneer. In one embodiment, the cultured plant-based cheese is produced by providing a plant-based emulsion or plant-based milk, culturing the plant-based emulsion or plant-based milk, coagulating the proteins in the plant-based emulsion or plant-based milk to form solidified curds and liquid whey, separating the curds and whey, and then salting, shaping, and aging the curds. As used herein, “milk” may refer to any dairy, non-dairy, or plant-based milk or a plant-based emulsion comprising plant proteins.

In one embodiment of this aspect, the disclosed method of producing a cultured plant-based cheese composition has a lower cost compared to methods of producing other plant-based cheeses available on the market. In one variation of this embodiment, the lower cost is a result of utilizing low-cost legumes, seeds, or combinations thereof to produce the plant-based emulsion or plant-based milk. In another variation, the lower cost is a result of using materials other than tree nuts, such as cashews and almonds. In another variation, the lower cost is a result of shorter timeframes associated with the coagulation and separation steps of the process.

In another embodiment, the disclosed method of producing a cultured plant-based cheese composition results in a cultured plant-based cheese composition with an improved flavor profile compared to other plant-based cheeses available on the market. In one embodiment of this aspect, the desirable flavor profile is achieved through aging the curds in the presence of microbes, proteolytic enzymes, or a combination thereof. In variations of this embodiment, the improved flavor profile of the cultured plant-based cheese may be achieved via metabolism of the proteins, carbohydrates and fats of the cheese by bacteria, yeast, filamentous fungi, or any combination thereof during the aging step of the process. In other variations of this embodiment, the disclosed process of producing the cultured plant-based cheese results in a cultured plant-based cheese composition with a moisture content no greater than 60%, no greater than 50%, or no greater than 40%.

In yet another embodiment, the disclosed method of producing cultured plant-based cheese composition results in a cultured plant-based cheese composition with few to no additives. In variations of this embodiment, the method does not comprise adding additives (e.g., flavoring agents, texturizing agents, coloring agents, preservatives, nutritional yeast, yeast extract, amino acid additives, pre-fermented additives such as miso, etc.) to the plant-based food composition or a precursor thereof such as the plant based milk or the curds. In variations of this embodiments, the plant-based cheese composition does not comprise starch (e.g., native starch such as tapioca starch and/or modified food starch).

### Plant-Based Emulsions and Plant-Based Milks

In one embodiment, the method of producing the cultured plant-based cheese composition comprises providing a plant-based emulsion comprising legume material, seed material, or a combination thereof. As used herein, “plant-based emulsion” refers to a liquid solution comprising plant-based proteins and encompasses a variety of forms of plant-based emulsions, including plant-based milks. The plant-based emulsion comprises plant-based proteins derived from legume material, seed material, or a combination thereof. The plant-based emulsion may be tailored to provide a suitable environment for microbial culturing of the solution and an optimal substrate for coagulation of the proteins to form solid curds, separation of the curds from the remaining liquid (whey), shaping the curds, and developing the desired flavor and texture characteristics of the cultured plant-based cheese composition during aging of the curds. In some variations, the plant-based emulsion may also comprise plant fats, sugars, or a combination thereof in addition to those fats and sugars naturally present in the legume or seed material. In other variations, the plant-based emulsion may comprise additives to tailor the plant-based emulsion to produce the desired flavor and texture profile of the cultured plant-based cheese composition by the process described herein.

In some embodiments, the plant-based emulsion is a plant-based milk. Non-dairy, nut-free plant-based cheeses may be formed from a non-dairy plant-based milk made from legumes or seeds. Such a milk—a solution of suspended proteins and fats—is typically made by grinding (comminuting) legumes or seeds with water to create a raw slurry. Grinding may be accomplished with milling, blending, or grinding machines. The slurry may or may not be cooked or otherwise processed at this stage, for example by boiling the slurry for up to 30 minutes or longer. The slurry may then be filtered to separate the fibrous solids from the plant-based milk, although in some cases these solids may be retained. The milk may then also be cooked or processed as before to generate the final milk. The percentage of dissolved solids in such milks can vary (0.1-20%), but higher solid contents (above 8%) are more advantageous for cheesemaking.

As used herein, “milk” may refer to a dairy-based or a plant-based milk. As used herein, “plant-based milk” refers to a plant-based emulsion comprising plant proteins and plant fats produced by comminuting and processing a base composition with water. In some embodiments, the base composition comprises legume material, seed material, or a combination thereof. In some embodiments, the base composition comprises legume material, seed material, or a combination thereof in an amount of at least 40% by dry weight of the base composition. In variations of this embodiment, the base composition comprises legume material, seed material, or a combination thereof in an amount of at least 50%, at least 60%, at least 70%, at least 80%, at least 90%, at least 95%, at least 96%, at least 97%, at least 98%, or at least 99% by dry weight of the base composition. In a preferred embodiment, the base composition comprises primarily whole legume material or whole seed material, such as unprocessed legume fruits, seeds, or pods; whole fresh or dried seeds; or a combination thereof. Thus, in the preferred embodiment, the plant-based milk comprises proteins, carbohydrates and fats derived from the whole legume or whole seed material of the base composition. In some variations of this embodiment, the plant-based milk is produced by comminuting and processing whole beans, whole peas, whole lentils, or whole seeds to produce the plant-based milk. In another variation, the plant-based milk is soy milk produced by comminuting and processing whole soybeans as described herein. In another embodiment, the plant-based milk may be obtained from a commercial source.

Comminution of the legume material, seed material, or combination thereof can be accomplished by any means known in the art. Methods of comminution are well-known and include, but are not limited to, blending, grinding, milling, mashing, homogenization, passing through a screen or sieve, micronization, or pulverization. Comminution can be accomplished using any suitable equipment available in the art, such as blenders, grinders, juicers, mills, or homogenizers. In one embodiment, comminution is accomplished using any commercially-available soybean grinder, sometimes known as a soy milk maker. Soy milk makers include, for example, the TGM-200 continuous soybean grinder with okara separator. In another embodiment, comminution is accomplished using any commercially-available blender. In some embodiments, the legume material, seed material, or combination thereof is soaked in a liquid prior to comminution. In one embodiment, the legume material, seed material, or combination thereof is soaked in boiling water. In another embodiment, the legume material, seed material, or combination thereof is soaked in cool water. In some variations, the boiling water or cold water has an alkaline pH of at least 7 or of between 7 and 12. In some variations, the boiling water or cold water has an alkaline pH of between 7 and 8, between 7 and 9, between 7 and 10, between 7 and 11, between 7 and 12, between 8 and 9, between 8 and 10, between 8 and 11, between 8 and 12, between 9 and 10, between 9 and 11, between 9 and 12, between 10 and 11, between 10 and 12, or between 11 and 12. In some variations, the pH of the boiling water or cold water is adjust to a pH of between 7 and 12 by adding an alkylating agent (e.g., baking soda, sodium hydroxide, or other bases) prior to soaking the legume material, seed material, or combination thereof in the boiling water or cold water.

In some embodiments, the plant-based emulsion comprises legume material, seed material, or a combination thereof in an amount of at least 40% by dry weight of the plant-based emulsion. In some variations, the plant-based emulsion comprises legume material, seed material, or a combination thereof in an amount of at least 45%, at least 50%, at least 55%, at least 60%, at least 65%, at least 70%, at least 75%, at least 80%, at least 85%, at least 90%, or at least 95% by dry weight of the plant-based emulsion. In other variations, the plant-based emulsion comprises legume material, seed material, or a combination thereof in an amount of between 40% and 50%, between 50% and 60%, between 60% and 70%, between 70% and 80%, between 80% and 90%, or between 90% and 100% by dry weight of the plant-based emulsion.

In some embodiments, insoluble solids are removed from the plant-based milk by means of filtration. As used herein, “insoluble solids” refers to any insoluble plant material and may include, but is not limited to, fibrous material such as high molecular weight insoluble fibers and okara. Okara is the fibrous material resulting from the comminution of soybeans which may or may not be removed during the preparation of soy milk. Insoluble solids may be removed from the plant-based milk by any means available in the art, including, but not limited to, filtration, centrifugation, phase separation, skimming, decanting, and the like. In one embodiment, separation of insoluble solids is accomplished using any commercially-available soybean grinder with a separator, sometimes known as a soy milk maker. Soy milk makers include, for example, the TGM-200 continuous soybean grinder with okara separator. In some variations, after removals of insoluble solids, the plant-based milk may have less than 1%, less than 5%, less than 10%, less than 20%, less than 30%, less than 40%, or less than 50% of the insoluble solids present in the plant-based milk prior to the removal of insoluble solids. In other variations, the plant-based milk can have at least 50%, at least 60%, at least 70%, at least 80%, at least 90%, at least 95%, or at least 99% of the insoluble solids removed.

In some embodiments, the plant-based emulsion has an amount of dissolved solids which is optimal for producing the cultured plant-based cheese composition. The amount of dissolved solids can be expressed as a Brix value. As used herein, “Brix value” refers to a measurement of dissolved solids in a solution as determined by measuring the specific gravity or refractive index of the solution. The Brix value of a solution is expressed in degrees Brix (° Bx). The Brix value includes dissolved sugars, proteins, and other materials dissolved in the solution. In some embodiments, the plant-based emulsion has a Brix value of between 1° Bx and 20° Bx. In particularly preferred embodiments, the plant-based emulsion has a value of between 5° Bx and 20° Bx. In some variations, the plant-based emulsion has a Brix value of at least 1° Bx, at least 2° Bx, at least 3° Bx, at least 4° Bx, at least 5° Bx, at least 6° Bx, at least 7° Bx, at least 8° Bx, at least 9° Bx, at least 10° Bx, at least 11° Bx, at least 12° Bx, at least 13° Bx, at least 14° Bx, at least 15° Bx, at least 16° Bx, at least 17° Bx, at least 18° Bx, or at least 19° Bx. In further variations, the plant-based emulsion has a Brix value of between 1° Bx and 20° Bx, between 5° Bx and 20° Bx, between 6° Bx and 20° Bx, between 7° Bx and 20° Bx, between 8° Bx and 20° Bx, between 9° Bx and 20° Bx, between 10° Bx and 20° Bx, between 11° Bx and 20° Bx, between 12° Bx and 20° Bx, between 13° Bx and 20° Bx, between 14° Bx and 20° Bx, or between 15° Bx and 20° Bx. The Brix value may be measured before or after addition of fats, sugars and additives to the plant-based emulsion. Further, the Brix value may be measured before or after cooking the plant-based emulsion.

In some embodiments, the Brix value of the plant-based milk is measured prior to the addition of plant fats, sugars, or additives to the plant-based milk. In some variations, the plant-based milk has a Brix value of at least 1° Bx, at least 2° Bx, at least 3° Bx, at least 4° Bx, at least 5° Bx, at least 6° Bx, at least 7° Bx, at least 8° Bx, at least 9° Bx, at least 10° Bx, at least 11° Bx, at least 12° Bx, at least 13° Bx, at least 14° Bx, at least 15° Bx, at least 16° Bx, at least 17° Bx, at least 18° Bx, or at least 19° Bx prior to the addition of plant fats, sugars, or additives to the plant-based milk. In further variations, the plant-based emulsion has a Brix value of between 1° Bx and 20° Bx, between 5° Bx and 20° Bx, between 6° Bx and 20° Bx, between 7° Bx and 20° Bx, between 8° Bx and 20° Bx, between 9° Bx and 20° Bx, between 10° Bx and 20° Bx, between 11° Bx and 20° Bx, between 12° Bx and 20° Bx, between 13° Bx and 20° Bx, between 14° Bx and 20° Bx, or between 15° Bx and 20° Bx prior to the addition of plant fats, sugars, or additives to the plant-based milk. The Brix value may be measured before or after cooking the plant-based emulsion.

In some embodiments, the plant-based emulsion is cooked in order to kill any undesirable microbes and to denature the proteins in the solution. In some variations of this embodiment, the cooking achieves pasteurization or sterilization of the plant-based emulsion. In some variations of this embodiment where the plant-based emulsion comprises legume material, cooking of the plant based solution can decrease the “beany” taste of the plant-based emulsion and render the proteins therein more digestible. In some variations, cooking at higher temperatures leads to increased cohesiveness of the curds formed during coagulation, resulting in greater ease of coagulation of the curds and separation of the curds from the whey. In some embodiments, the plant-based emulsion is cooked to a temperature above 95° C. and simmered or boiled for 10-30 minutes. In some variations, the plant-based emulsion may be cooked to a temperature above 40° C., above 50° C., above 60° C., above 70° C., above 80° C., above 90° C., above 100° C., above 110° C., or above 120° C. In further variations, the plant-based emulsion may be cooked, simmered or boiled for at least 1 minute, at least 2 minutes, at least 3 minutes, at least 4 minutes, at least 5 minutes, at least 10 minutes, at least 15 minutes, at least 20 minutes, at least 30 minutes, at least 45 minutes, or at least 60 minutes. In other variations, the plant-based emulsion may be cooked, simmered or boiled for between 1 and 5 minutes, between 5 and 10 minutes, between 10 and 15 minutes, between 15 and 20 minutes, between 20 and 30 minutes, and between 30 and 60 minutes. In yet additional variations, the plant-based emulsion may be cooked either before or after the removal of insoluble solids.

Cultured plant-based cheeses may further include a plant-based sugar such as sucrose, dextrose, fructose, glucose, or maltose in the form of beet sugars, cane sugars, corn syrup, rice syrup, or tapioca syrup. These sugars can be added to the plant-based emulsion in order to support the growth and acid production of microbial cultures. Sugars can be added to the final plant-based emulsion in concentrations of 1-5% weight per volume. Without wishing to be bound by theory, any sugars that are not fermented during acidification of the milk are mostly removed with the whey during cheesemaking or fully fermented during aging. Thus, they are mostly absent from the final product. In some cases, without added sugars, starter cultures may instead digest proteins and peptides in the plant-based milk, which can lead to bitter flavors.

In some embodiments, the plant-based emulsion comprises one or more added sugars in addition to those sugars naturally present in the legume or seed material. In some variations, the one or more added sugars are simple sugars (monosaccharides and disaccharides) which may include, but are not limited to, lactose, sucrose, dextrose (glucose), galactose, fructose, maltose, ribose, arabinose, xylose, melibiose, trehalose, and cellobiose. In some variations, the plant-based emulsion comprises one or more complex carbohydrates such as starch, pectin, glycogen, dextrans, amylose, amylopectin, maltodextrin, and the like. In other variations, the plant-based emulsion comprises one or more added sugars in the form of one or more syrups including, but not limited to, honey, corn syrup, high fructose corn syrup, rice syrup, agave nectar, molasses, coconut nectar, maple syrup, tapioca syrup, and the like. In yet other variations, the plant-based emulsion may comprise other sources of added sugar such as fruit and vegetable juices, fruit and vegetable juice concentrates, fruit and vegetable extracts, whole fruits and vegetables, cane sugar, beet sugar, coconut sugar, sugar alcohols, sugar derivatives, and the like. In some embodiments, the one or more sugars are added to the plant-based emulsion in an amount of between 0% and about 5% weight per volume (% w/v) of the plant-based emulsion. In some variations, sugars are added to the plant-based emulsion in an amount of between 0.01% w/v and 5% w/v, between 0.1% w/v and 5% w/v, between 0.5% w/v and 5% w/v, between 1% w/v and 5% w/v, between 2% w/v and 5% w/v, between 3% w/v and 5% w/v, or between 4% w/v and 5% w/v. In other variations, sugars are added to the plant-based emulsion in an amount of between 0.01% w/v and 4% w/v, between 0.01% w/v and 3% w/v, between 0.01% w/v and 2% w/v, between 0.01% w/v and 1% w/v, between 0.01% w/v and 0.5% w/v, or between 0.01% w/v and 0.1% w/v. In some variations, sugars are added to the plant-based emulsion in an amount of greater than 5% w/v.

The plant-based emulsion may further include an additional vegetable oil—such as corn, soybean, sunflower, coconut, canola, palm, rice, safflower, peanut, olive, cottonseed which adds to the taste, texture, and aroma of the resulting cheeses because of the oil's inherent characteristics and because of its breakdown products during aging and fermentation. Fats can be added at multiple points during cheesemaking, but they are most effectively added to the milk in concentrations of 1-10% weight per volume.

In some embodiments, the plant-based emulsion comprises one or more fats. In some variations, the plant-based emulsion comprises one or more added fats in addition to those naturally present in the legume material, seed material, or combination thereof. In one embodiment, the one or more added fats is from an animal source. In a preferred embodiment, the one or more added fats is from a non-animal source. In some variations, the one or more added fats is a plant fat which may include, but is not limited to, corn oil, soybean oil, sunflower oil, coconut oil, canola oil, palm oil, palm kernel oil, rice bran oil, safflower oil, peanut oil, olive oil, cocoa oil, cocoa butter, walnut oil, cottonseed oil, mango oil, flaxseed oil, what oil, barley oil, grain oil, legume oil, nut oil, fruit oil, squash seed oil, avocado oil, grape seed oil, sesame oil, argan oil, almond oil, babassu oil, microbial oil products, or any combination thereof. The one or more plant fats may be any plant-based source of fat known in the art, including any seed oil, legume oil, or nut oil. In some embodiments, one or more fats is added to the plant-based emulsion prior to coagulation, either before or after culturing. In variations of this embodiment, one or more fats are added to the plant-based emulsion in an amount of between 0% w/v and about 10% w/v of the plant-based emulsion. In some variations, one or more fats are added to the plant-based emulsion in an amount of between 0.5% w/v and 10% w/v, between 1% w/v and 10% w/v, between 2% w/v and 10% w/v, between 3% w/v and 10% w/v, between 4% w/v and 10% w/v, between 5% w/v and 10% w/v, between 6% w/v and 10% w/v, between 7% w/v and 10% w/v, between 8% w/v and 10% w/v, or between 9% w/v and 10% w/v. In other variations of this embodiment, one or more fats are added to the plant-based emulsion in an amount of between 0.5% w/v and 9% w/v, between 0.5% w/v and 8% w/v, between 0.5% w/v and 7% w/v, between 0.5% w/v and 6% w/v, between 0.5% w/v and 5% w/v, between 0.5% w/v and 4% w/v, between 0.5% w/v and 3% w/v, between 0.5% w/v and 2% w/v, or between 0.5% w/v and 1% w/v. In some variations, one or more fats are added to the plant-based emulsion in an amount of greater than 10% w/v. In other embodiments, one or more fats is added the plant-based emulsion after formation of the curds, either before or after separation of the curds and whey.

In additional embodiments, the plant-based emulsion may comprise additives in order to produce the desired flavor, texture profile, and overall sensory experience associated with the cultured plant-based cheese compositions produced by the processes described herein. For example, in some embodiments, the plant-based emulsion comprises one or more additives in the form of added flavoring agents, texturizing agents, coloring agents, or preservatives. Flavoring agents may include, but are not limited to, flavor molecules or flavor molecule precursors, either isolated or partially isolated; plant, bacterial, or fungal extracts; herbs or spices; vinegars; amino acid additives; monosodium glutamate; or other artificial or natural sources of flavor compounds. Additional examples of additives used to manipulate the flavor of plant-based cheeses are provided in US 2015/0305361 A1, which is herein incorporated by reference in its entirety.

In some embodiments, it is desirable to produce a plant-based cheese composition which comprises few or no additives and consists primarily of whole or natural materials. Therefore, in a preferred embodiment, the cultured plant-based cheese composition comprises additives in an amount of less than about 20% by dry weight of the cultured plant-based cheese composition. In some variations, the cultured plant-based cheese composition comprises additives in an amount of less than about 15%, less than about 10%, less than about 9%, less than about 8%, less than about 7%, less than about 6%, less than about 5%, less than about 4%, less than about 3%, less than about 2%, less than about 1%, less than about 0.5%, less than about 0.1%, less than about 0.05%, less than about 0.01%, less than about 0.005%, less than about 0.001%, less than about 0.0005%, less than about 0.0001% by dry weight of the cultured plant-based cheese composition. In one embodiment, the cultured plant-based cheese composition does not comprise additives.

In one embodiment, the plant-based emulsion may further include other ingredients that contribute citrate or citric acid to the plant-based emulsion, including, but not limited to, sodium citrate, calcium citrate, or citrus fruits. Citrate occurs naturally in mammalian milk, and, without wishing to be bound by theory, its breakdown creates many important cheese flavors such as diacetyl, a key aromatic in butter. In the case of sodium citrate, it can be added to the final milk in concentrations of between about 0.01 and about 1% weight per volume. In some variations, sodium citrate is added to the plant-based emulsion in an amount of between 0.01% w/v and 1% w/v, between 0.05% w/v and 1% w/v, between 0.1% w/v and 1% w/v, between 0.2% w/v and 1% w/v, between 0.3% w/v and 1% w/v, between 0.4% w/v and 1% w/v, between 0.5% w/v and 1% w/v, between 0.6% w/v and 1% w/v, between 0.7% w/v and 1% w/v, between 0.8% w/v and 1% w/v, or between 0.9% w/v and 1% w/v. In other variations, sodium citrate is added to the plant-based emulsion in an amount of between 0.01% w/v and 0.9% w/v, between 0.01% w/v and 0.8% w/v, between 0.01% w/v and 0.7% w/v, between 0.01% w/v and 0.6% w/v, between 0.01% w/v and 0.5% w/v, between 0.01% w/v and 0.4% w/v, between 0.01% w/v and 0.3% w/v, between 0.01% w/v and 0.2% w/v, between 0.01% w/v and 0.1% w/v, or between 0.01% w/v and 0.05% w/v. In some variations, sodium citrate is added to the plant-based emulsion in an amount of greater than 1% w/v.

The added sugars, fats, and additives are added to the plant-based emulsion at any time during the cheesemaking process. In one embodiment, the added sugars, fats, and additives are added to the plant-based emulsion just after cooking the plant-based emulsion before the plant-based emulsion cools down from the cooking temperature.

### Culturing Plant-Based Emulsions

One or more bacterial or fungal cultures (Lactococcus sp., Lactobacillus sp., Streptococcus sp., Propionibacterium sp., Penicillium sp., Brevibacter sp., Leuconostoc sp., Corynebacteria sp., Bifidobacterium sp.) may be added to the milk acidify it and contribute to the cheese's eventual flavor and texture. Depending on the microbes and the milk substrate, the amount of culture used can range from 0.01 to 10 direct culture units (DCU) per liter.

In some embodiments, the method of producing the cultured plant-based cheese composition comprises adding one or more starter cultures comprising one or more microbes and culturing the one or more microbial cultures in the plant-based emulsion. In some variations, certain microbial cultures, known as starter cultures, are added to any variation of the plant-based emulsion described herein and allowed to grow in the plant-based emulsion. In variations of this embodiment, the growth of microbial cultures in the plant-based emulsion results in the acidification of the plant-based emulsion and the production of flavor compounds from microbial metabolism of the proteins, sugars, fats, and other materials therein. The culturing of the plant-based emulsion may be optimized to reach a target pH and to produce a desired profile of flavor compounds. In some variations, all or a portion of the microbes of the microbial cultures remain viable throughout the coagulation, separation, and aging steps of the cheesemaking process, allowing for the development of complex flavor profiles over time. In another embodiment, microbial cultures or starter cultures are added to the curds after the coagulation, separation, or shaping steps of the cheesemaking process and allowed to grow and produce flavor compounds by metabolizing the proteins, sugars, fats, and other materials therein.

The starter cultures added to the plant-based emulsion or curds of the present disclosure may include any starter culture or inoculum known to be used in the production of fermented dairy or non-dairy food products. In some embodiments, the starter cultures added to the plant-based emulsion or curds comprise mesophilic microbes, thermophilic microbes, or a combination thereof. Mesophilic cultures are microbial cultures used in cheesemaking that are generally most active around 32° C. and can be killed by temperatures above 43° C. Thermophilic cultures are microbial cultures used in cheesemaking that are most active around 40° C. The temperature at which these cultures are no longer viable varies widely, but it is generally no higher than 60° C. In some variations, the starter cultures added to the plant-based emulsion or curds may include, but are not limited to, one or more of MA series cultures (MA 11, MA 14, MA 16, and MA19; Danisco) comprising mesophilic bacteria Lactococcus lactis subsp. lactis and Lactococcus lactis subsp. cremoris; TA 60 series cultures (TA 61 and TA 62; Danisco) comprising thermophilic bacterium Streptococcus thermophilus; Thermophilic C201 cultures (TC201; New England Cheesemaking Supply Company) comprising thermophilic bacteria Streptococcus thermophilus, Lactobacillus helveticus, and Lactobacillus delbrueckii subsp. lactis; MA 4000 series cultures (MA 4001 and MA 4002; Danisco) comprising mesophilic bacteria Lactococcus lactis subsp. lactis, Lactococcus lactis subsp. cremoris, Lactococcus lactis subsp. lactis biovar. diacetylactis and thermophilic bacterium Streptococcus thermophilus; Su Casu cultures (Danisco) comprising thermophilic bacteria Streptococcus thermophilus, Lactobacillus delbrueckii subsp. lactis, and Lactobacillus helveticus; or Kazu cultures (Danisco) comprising mesophilic bacteria Lactococcus lactis subsp. lactis, Lactococcus lactis subsp. cremoris, Lactococcus lactis subsp. lactis biovar. diacetylactis, and thermophilic bacterium Lactobacillus helveticus. Additional examples of start cultures which may be used in the production of fermented dairy or non-dairy food products are provided in US 2015/0305361 A1 which is herein incorporated by reference in its entirety.

In certain embodiments, one or more starter cultures are added to the plant-based emulsion and allowed to grow in the plant-based emulsion prior to coagulation. The growth of starter cultures in the plant-based emulsion, also referred to as the culturing of the plant-based emulsion, may be accomplished by any means known in the art for culturing dairy or non-dairy milk. In some embodiments, the amount of starter culture added to the plant-based emulsion and the temperature and timing of the culturing are optimized to acidify the plant-based emulsion to reach a target pH at the end of culturing; to reach a target pH at the beginning of aging; to produce a desired profile of flavor compounds; to result in the presence of living or viable cultures in the plant-based emulsion, curds, or cultured plant-based cheese of the present disclosure; or any combination thereof.

The plant-based emulsion may be cultured at any temperature known in the art to be appropriate for the microbial cultures being used. For example, the plant-based emulsion may be cultured at a temperature of 26-33° C. for optimal growth of mesophilic cultures or at 35-41° C. for optimal growth of thermophilic cultures. The plant-based emulsion may be cultured at any temperature between about 4° C. and about 50° C. depending upon the optimal growth temperature for the microbial cultures used. In some embodiments, the culturing may take place entirely at one temperature, for example, if only mesophilic or only thermophilic cultures are used in the culturing. In alternative embodiments, the culturing may take place at multiple temperatures if, for example, a mix of thermophilic and mesophilic cultures is used in the culturing. For example, the culturing may take place at 26-33° C. for a period of time to allow optimal growth of mesophilic cultures, after which the temperature is increased to 35-41° C. for a second period of time to allow optimal growth of thermophilic cultures; or vice versa. In some variations, the temperature of the plant-based emulsion may be altered one, two, three, or more times during culturing to optimize the growth of the microbial cultures used. In certain embodiments, the plant-based emulsion may be aerated during culturing. Aeration of the plant-based emulsion during culturing can be achieved by any means known in the art, including stirring, agitation, shaking, or the like.

The plant-based emulsion may be cultured for any amount of time required to reach the desired target pH at the end of culturing and, subsequently, at the beginning of aging. Without wishing to be bound by theory, the microbial cultures may continue to grow and acidify their environment after the completion of culturing the plant-based emulsion, for example, during coagulation and separation; therefore, in some embodiments, the timing of culturing and target pH at the end of culturing may be co-optimized with the timing of coagulation and separation of curds and whey to reach an optimal target pH at the beginning of aging. For example, if significant acidification is expected after culturing due to a longer time period of coagulation, separation, and shaping of the curds, the target pH at the end of culturing will be higher and the culture time will be lower than if little to no acidification were expected after culturing due to a shorter time period of during coagulation, separation, and shaping of the curds. The plant-based emulsion may be cultured any amount of time from about 40 minutes to about 24 hours or until the desired target pH is reached. Depending upon the desired flavor profile and style of the cultured plant-based cheese, the target pH of the plant-based emulsion after culturing may be between about 5.0 and about 7.0. For example, in some variations, the target pH of the plant-based emulsion after culturing is between about 5.0 and about 5.5, between about 5.5 and about 6.0, between about 6.0 and about 6.5, or between about 6.5 and about 7.0. In some embodiments, the target pH of the plant-based emulsion after culturing is between about 5.9 and about 6.6. In some variations, the target pH is between about 5.9 and about 6.0, between about 6.0 and about 6.1, between about 6.1 and about 6.2, between about 6.2 and about 6.3, between about 6.3 and about 6.4, between about 6.4 and about 6.5, or between about 6.5 and about 6.6. In some preferred embodiments, the target pH of the plant-based emulsion after culturing is between about 6.0 and about 6.3.

The microbial cultures may be added in any amount sufficient to acidify the plant-based emulsion to the desired pH within the desired timeframe. The amount of starter culture added may be expressed in terms of direct culture units (DCU; also known as Danisco culture units). DCU refers to a measurement of the bacterial activity of a freeze-dried culture. Created by the company Danisco, this metric is the company's benchmark for the amount of culture needed to inoculate ten liters of milk. In one embodiment, starter culture may be added to the plant-based emulsion in an amount of about 0.25 DCU per liter of the plant-based emulsion (DCU/L). In other embodiments, starter culture may be added to the plant-based emulsion in an amount of between about 0.01 to about 10 DCU/L. In some variations, starter culture may be added to the plant-based emulsion in an amount of between about 0.01 and about 0.05 DCU/L, between about 0.05 and about 0.1 DCU/L, between about 0.1 and about 0.2 DCU/L, between about 0.2 and about 0.3 DCU/L, between about 0.3 and about 0.4 DCU/L, between about 0.5 and about 0.5 DCU/L, between about 0.5 and about 1 DCU/L, between about 1 and about 2 DCU/L, between about 2 and about 3 DCU/L, between about 2 and about 3 DCU/L, between about 3 and about 4 DCU/L, between about 5 and about 5 DCU/L, or between about 5 and about 10 DCU/L. In further variations, starter culture may be added to the plant-based emulsion in an amount of at least about 0.01 DCU/L, at least about 0.05 DCU/L, at least about 0.1 DCU/L, at least about 0.2 DCU/L, at least about 0.3 DCU/L, at least about 0.4 DCU/L, at least about 0.5 DCU/L, at least about 1 DCU/L, at least about 2 DCU/L, at least about 3 DCU/L, at least about 4 DCU/L, at least about 5 DCU/L, or at least about 10 DCU/L.

### Adding Enzymes to the Plant-Based Emulsion

In some embodiments, the flavor profile of the cultured plant-based cheese composition is developed in part by the addition of proteolytic enzymes, lipases, or a combination thereof to the plant-based emulsion or curds during the cheesemaking process. Enzymes (e.g. rennet, chymosin, vegetable rennet, microbial rennet, lipase) from microbes or plants may be added to the cultured plant-based emulsion to aid in protein and fat breakdown during aging. Enzymes may be added at concentrations of 50-200 IMCU (international milk clotting units) per liter of plant-based emulsion at any point before coagulation. Different enzymes produce different flavor and texture profiles in the resulting cheeses. In dairy cheesemaking, these enzymes trigger the coagulation of proteins, but in plant-based milks they do not have this effect.

In some embodiments, proteolytic enzymes may be added to the plant-based emulsion before or after culturing but prior to coagulation. In other embodiments, proteolytic enzymes may be added to the plant-based emulsion after coagulation. In a preferred embodiment, the proteolytic enzymes remain active and continue breaking down the proteins of the curds during aging of the curds to produce the flavor profile of the cultured plant-based food composition. As a result, in some embodiments, the cultured plant-based cheese composition of the present disclosure comprises one or more proteolytic enzymes.

In some embodiments, the one or more proteolytic enzymes may include, but are not limited to, animal rennet, pepsin, chymosin, vegetable rennet, microbial rennet, papain, bromelain, serrapeptase, protease, pancreatin, and trypsin. However, any food-safe proteolytic enzyme or protease known in the art to break down proteins to form peptides, free amino acids, other flavor molecules, or a combination thereof may be added to the plant-based emulsion or curds for the development of the flavor profile of the cultured plant-based cheese. The proteolytic enzymes may be of microbial, plant, or animal origin and may or may not be of commercial origin. Additional examples of enzymes, including proteases and lipases, which may be added to non-dairy and plant-based cheeses are provided in US 2015/0305361 A1, which is herein incorporated by reference in its entirety.

The enzymes described herein may be added to the plant-based emulsion or curds in any combination and in any amount required to produce the desired flavor profile of the cultured plant-based cheese. In some embodiments, the enzymes may be added to the plant-based emulsion in an amount of between 0.00001% w/v and 5% w/v of the plant-based emulsion. In some variations, proteolytic enzymes may be added to the plant-based emulsion in an amount of between about 0.00001% w/v and about 0.0001% w/v, between about 0.0001% w/v and about 0.001% w/v, between about 0.001% w/v and about 0.01% w/v, between about 0.01% w/v and about 0.1% w/v, between about 0.1% w/v and about 0.5% w/v, between about 0.5% w/v and about 1.0% w/v, between about 1.0% w/v and about 1.5% w/v, between about 1.5% w/v and about 2.0% w/v, between about 2.0% w/v and about 2.5% w/v, between about 2.5% w/v and about 3.0% w/v, between about 3.0% w/v and about 3.5% w/v, between about 3.5% w/v and about 4.0% w/v, between about 4.0% w/v and about 4.5% w/v, between about 4.5% w/v and about 5.0% w/v, or greater than about 5.0% w/v. In one embodiment, rennet is added to the plant-based emulsion. Any rennet described herein or known to one of ordinary skill in the art of cheesemaking may be used. The amount of rennet may be expressed in international milk clotting units (IMCU), wherein one IMCU corresponds to the amount of rennet required to coagulate 10 mL of reconstituted skim milk powder within 100 seconds at 30° C. In some embodiments, rennet is added to the plant-based emulsion in an amount of between about 10 IMCU and about 200 IMCU per liter of plant-based emulsion. In some variations, rennet is added to the plant-based emulsion in an amount of between about 10 IMCU and about 20 IMCU, between about 20 IMCU and about 30 IMCU, between about 30 IMCU and about 40 IMCU, between about 40 IMCU and about 50 IMCU, between about 50 IMCU and about 75 IMCU, between about 75 IMCU and about 100 IMCU, between about 100 IMCU and about 125 IMCU, between about 125 IMCU and about 150 IMCU, between about 150 IMCU and about 200 IMCU, between about 200 IMCU and about 300 IMCU, between about 300 IMCU and about 400 IMCU, between about 400 IMCU and about 500 IMCU, between about 500 IMCU and about 600 IMCU, between about 600 IMCU and about 700 IMCU, between about 700 IMCU and about 800 IMCU, between about 800 IMCU and about 900 IMCU, or between about 900 IMCU and about 1000 IMCU per liter of plant-based emulsion.

### Coagulating the Proteins in Plant-Based Emulsions

In some embodiments, the method of producing the cultured plant-based cheese composition comprises coagulating the proteins in the plant-based emulsion to form curds and whey plant-based emulsion. As used herein, “curds” refers to a solidified mass comprising proteins, fats, and other materials formed by coagulation of a dairy milk, a non-dairy milk, or a plant-based emulsion. As used herein, “whey” refers to the liquid portion of the dairy milk, a non-dairy milk, or a plant-based emulsion that is not incorporated into the curds as a part of coagulation and, therefore, can be easily separated from the curds. In some embodiments, the process of coagulation of the plant-based emulsion to form the curds and separation of the curds from the whey is optimized to achieve the desired pH and moisture content of the curds prior to aging to produce the cultured plant-based cheese composition of the present disclosure. In alternative embodiments, the process may be optimized to achieve the desired pH and moisture content of the curds for direct consumption rather than aging. In some embodiments, the curds are salted prior to aging to achieve the optimal salt concentration for the desired flavor profile of the plant-based cheese composition after aging.

Coagulation of the proteins in the plant-based emulsion may be achieved by any means known in the art. For example, in one embodiment, a coagulating agent (e.g., mineral cation) is added to induce protein coagulation, resulting in the separation of curds from whey. Mineral cations may be added at concentrations of 0.1-10% weight per volume. In a preferred embodiment, a mineral cation is added to the plant-based emulsion in an amount of between about 0.1% w/v and about 10% w/v of the plant-based emulsion to induce the formation of curds. Mineral cations that can be used to induce formation of curds in the plant-based emulsion may include, but are not limited to, calcium, magnesium, and the like. In some variations, a mineral cation may be added in the form of a mineral cation salt, for example, calcium chloride, calcium sulfate, magnesium chloride, or the like. In further variations, the mineral cation or mineral cation salt is added in an amount of between about 0.1% w/v and about 0.5% w/v, between about 0.5% w/v and about 1% w/v, between about 1% w/v and about 2% w/v, between about 2% w/v and about 3% w/v, between about 3% w/v and about 4% w/v, between about 4% w/v and about 5% w/v, between about 5% w/v and about 6% w/v, between about 6% w/v and about 7% w/v, between about 7% w/v and about 8% w/v, between about 8% w/v and about 9% w/v, or between about 9% w/v and about 10% w/v of the plant-based emulsion.

In another embodiment, one or more acids is added to the plant-based emulsion to induce formation of the curds. In some variations, the one or more acids may include, glucono delta-lactone, citric acid, acetic acid, lactic acid, tartaric acid, malic acid, fumaric acid, phosphoric acid, vinegar (e.g. white vinegar, apple cider vinegar, rice wine vinegar, sherry vinegar, balsamic vinegar, red wine vinegar, and/or white wine vinegar), fruit juice (e.g. lemon juice, lime juice, grapefruit juice, and/or apple juice), or any combination thereof. Acid may be added in any amount sufficient to induce the formation of curds, for example, but not limited to, an amount sufficient to reduce the pH of the plant-based emulsion to less than 6. In one embodiment, the acid produced by microbial cultures during the culturing of the plant-based emulsion contributes to the formation of curds. In another embodiment, the acid produced by microbial cultures during the culturing of the plant-based emulsion is sufficient to induce the formation of curds. In some embodiments, formation of curds is enhanced by heating the plant-based emulsion. In other embodiments, formation of curds may be induced by adding any coagulating enzyme known in the art to coagulate dairy or non-dairy milks, including, but not limited to, rennet (animal, vegetable, or microbial), chymosin, papain, bromelain, thermolysin, aspartic protease, and the like. Coagulation may be achieved with or without the use of a crosslinking enzymes, including, but not limited to, transglutaminase. Additional examples of coagulating agents which may be used in the coagulation of plant-based milks are provided in WO 2019/209939 A2, which is herein incorporated by reference in its entirety.

Coagulation may occur over any period of time and at any temperature required for curd formation sufficient to allow separation of the curds and whey. In some embodiments, it is preferred to limit the time period and temperature of coagulation for one or more reasons, including minimizing the amount of time required for the cheesemaking process as a whole and achieving the desired pH of the curds at the start of aging. Without wishing to be bound by theory, as described herein, growth of microbial cultures and, thus, acidification may continue after the completion of culturing the plant-based emulsion, including during coagulation. Therefore, in some embodiments, the timing and temperature of coagulation is co-optimized with the timing and temperature of culturing the plant-based emulsion and separation of curds and whey to reach an optimal target pH at the beginning of aging. In some embodiments, coagulation may occur over a period of between about 10 minutes and about 210 minutes. In some variations, coagulation may occur over a period of between about 10 and about 20 minutes, between about 10 and about 30 minutes, between about 10 and about 40 minutes, between about 20 and about 60 minutes, between about 20 and about 80 minutes, between about 20 and about 90 minutes, between about 30 and about 60 minutes, between about 30 and about 80 minutes, between about 30 and about 90 minutes, between about 60 minutes and about 90 minutes, between about 60 minutes and about 120 minutes, or between about 90 and about 120 minutes. In other variations, coagulation may occur over a period of less than 120 minutes, less than 90 minutes, less than 80 minutes, less than 70 minutes, less than 60 minutes, less than 50 minutes, less than 40 minutes, less than 30 minutes, or less than 20 minutes. In a preferred variation, coagulation may occur over a period of greater than about 15 minutes. In some embodiments, coagulation occurs at the same temperature at which the plant-based emulsion was cultured. In some variations, coagulation occurs at a temperature between about 4° C. and about 70° C. In one variation, coagulation occurs at a temperature between 4° C. and about 50° C. In one variation, coagulation occurs at a temperature between about 26° C. and about 33° C. In another variation, coagulation occurs at a temperature between about 35° C. and about 41° C. In another variation, coagulation occurs at a temperature between about 40° C. and about 46° C. In yet another variation, coagulation occurs at a temperature between about 20° C. and the temperature at which the plant-based emulsion was cultured. In yet another variation, coagulation occurs at a temperature between about 4° C. and the temperature at which the plant-based emulsion was cultured.

In some embodiments, microbial cultures comprising one or more microbes are present during coagulation and formation of the curds. Any of the microbial cultures or microbes described herein or known in the art for use in dairy cheesemaking may be present during coagulation and formation of the curds. Cultures and the microbes they comprise may be present in any of living, viable, or non-viable states, or any combination thereof. Microbes may be detected during coagulation and formation of the curds using any means known in the art, as described in “Cultured Plant-Based Cheese Compositions: Microbial Cultures” above. In certain embodiments, some or all of the microbes have been killed during the previous steps of the cheesemaking process (e.g. because of heat treatment) and are present in a non-viable state. Without wishing to be bound by theory, in some variations, the microbes which are present in a non-viable state release enzymes which may remain active and contribute to flavor development during coagulation and formation of the curds, separation of the curds from the whey, shaping of the curds, and/or aging of the curds by producing flavor compounds from the proteins, sugars, fats, and other materials present in the curds.

Separating the Curds from the Whey

In some embodiments, the method of producing the cultured plant-based cheese composition comprises separating the curds from the whey. The separation of the curds from the whey can be achieved by any means known in the art. Separation of the curds from the whey may also be known as dewatering of the curds and may be achieved by any known means of dewatering a composition. In some embodiments, separation of the curds from whey is achieved by allowing the whey to passively drain from the curds. In some variations, the curds may be wrapped in cheesecloth prior to or during the separation of the curds from the whey. In preferred embodiments, separation of the curds from the whey is achieved by using a mechanical process to drive the whey from the curds. In one embodiment, pressing is used to drive the whey from the curds. Pressing of the curds may be achieved by numerous means known in the art. By way of example and without limitation, pressing of the curds may be accomplished by pressing in a filter press, a plate press, a filter plate press, a centrifugal press, a rotary press, a pneumatic press, a hydraulic press, a screw press, a belt press, a vacuum belt press, a gravity belt press, a gravity belt thickener, a bladder press, or similar. The curds may be pressed at any pressure required to form a cohesive mass of curds. In some embodiments, the curds are pressed at a pressure between about 0.5 pounds per square inch (PSI) and 50 PSI. In one variation, the curds are pressed starting at lower pressures and gradually increasing the pressure to drive the whey from the curds, for example, starting at about 0.5 PSI and gradually increasing the pressure up to about 50 PSI. The curds may be pressed in a continuous process, in a batch process, or a combination thereof. In some embodiments, an initial dewatering step may be used to remove some of the water prior to pressing. The initial dewatering step may be achieved by, for example, gravity draining, gravity dewatering, passing over a dewatering table, or other means known in the art.

In some embodiments, the method and timing of the separation of curds from the whey is optimized to achieve the desired moisture content of the curds at the start of aging. In some embodiments, the moisture content of the curds at the start of aging is 80% or less. In preferred embodiments, the moisture content of the curds at the start of aging is 60% or less. In some variations, the moisture content of the curds at the start of aging may be about 80% or less, about 75% or less, about 70% or less, about 65% or less, about 60% or less, about 55% or less, about 50% or less, about 45% or less, about 40% or less, about 35% or less, or about 30% or less. In other variations, the moisture content of the curds at the start of aging may be between about 30% and about 35%, between about 35% and about 40%, between about 40% and about 45%, between about 45% and about 50%, between about 50% and about 55%, between about 55% and about 60%, between about 60% and about 65%, between about 65% and about 70%, between about 70% and about 75%, or between about 75% and about 80%.

In some embodiments, the timing and temperature of the separation of curds from the whey is optimized to achieve the desired pH of the curds at the start of aging. Without wishing to be bound by theory, the microbial cultures may continue to grow and acidify their environment after the completion of culturing the plant-based emulsion and during coagulation and separation; therefore, in some embodiments, the timing of coagulation and separation may be co-optimized with the timing of culturing and target pH at the end of culturing to reach an optimal target pH at the beginning of aging. For example, if the pH at the end of culturing is significantly higher than the target pH at the beginning of aging, then the coagulation and separation may occur over a longer period of time to reach the target pH prior to aging than if the pH at the end of culturing was similar to the target pH at the beginning of aging. In some embodiments, the pH of the curds at the beginning of aging is between about 4.0 and about 6.0. In one variation, the pH of the curds at the beginning of aging is between about 4.4 and about 4.8. In another variation, the pH of the curds at the beginning of aging is between about 4.6 and about 4.8. In yet another variation, the pH of the curds at the beginning of aging is between about 5.0 and about 5.3. In yet another variation, the pH of the curds at the beginning of aging is between about 5.2 and about 5.6. In additional variations, the pH of the curds at the beginning of aging is between about 4.0 and between about 4.5, between about 4.5 and about 5.0, between about 5.0 and about 5.5, or between about 5.5 and about 6.0. In yet additional variations, the pH of the curds at the beginning is between about 4.0 and about 4.2, between about 4.2 and about 4.4, between about 4.4 and about 4.6, between about 4.6 and about 4.8, between about 4.8 and about 5.0, between about 5.0 and about 5.2, between about 5.2 and about 5.4, between about 5.4 and about 5.6, between about 5.6 and about 5.8, or between about 5.8 and about 6.0. Separation of the curds from the whey may occur over any period of time and at any temperature required to for the curds to reach the desired target moisture content and pH. In some embodiments, the separation of curds from the whey occurs over a period of between about 6 hours and about 72 hours. In some variations, the separation occurs over a period of between about 6 hours and about 12 hours, between about 12 hours and about 24 hours, between about 24 hours and about 36 hours, between about 36 hours and about 48 hours, between about 48 hours and about 72 hours, or greater than 72 hours. In some embodiments, it is preferred to limit the time period and temperature of separation of the curds from the whey for one or more reasons, including minimizing the amount of time required for the cheesemaking process as a whole and achieving the desired pH of the curds at the start of aging. Without wishing to be bound by theory, as described herein, growth of microbial cultures and, thus, acidification may continue after the completion of culturing the plant-based emulsion, including during coagulation. Therefore, in some embodiments, the timing and temperature of separation of the curds from the whey is co-optimized with the timing and temperature of culturing and coagulation of the plant-based emulsion to reach an optimal target pH at the beginning of aging. In some embodiments, separation may occur over a period of between about 10 minutes and about 6 hours. In some variations, separation may occur over a period of between about 10 and about 20 minutes, between about 10 and about 30 minutes, between about 10 and about 40 minutes, between about 20 and about 60 minutes, between about 20 and about 80 minutes, between about 20 and about 90 minutes, between about 30 and about 60 minutes, between about 30 and about 80 minutes, between about 30 and about 90 minutes, between about 60 minutes and about 90 minutes, between about 1 hour and about 2 hours, between about 2 hours and about 3 hours, between about 3 hours and about 4 hours, between about 4 hours and about 5 hours, or between about 5 hours and about 6 hours. In other variations, separation may occur over a period of less than 6 hours, less than 5 hours, less than 4 hours, less than 3 hours, less than 2 hours, less than 90 minutes, less than 80 minutes, less than 70 minutes, less than 60 minutes, less than 50 minutes, less than 40 minutes, less than 30 minutes, or less than 20 minutes. In some embodiments, separation occurs at the same temperature at which the plant-based emulsion was cultured. In some variations, separation occurs at a temperature between about 4° C. and about 50° C. In one variation, separation occurs at a temperature of between about 17° C. and about 21° C. In one variation, separation occurs at a temperature between about 26° C. and about 33° C. In another variation, separation occurs at a temperature between about 35° C. and about 41° C. In yet another variation, separation occurs at a temperature between about 20° C. and the temperature at which the plant-based emulsion was cultured. In yet another variation, coagulation occurs at a temperature between about 4° C. and the temperature at which the plant-based emulsion was cultured.

In some embodiments, microbial cultures comprising one or more microbes are present in the curds during separation of the curds from the whey. Any of the microbial cultures or microbes described herein or known in the art for use in dairy cheesemaking may be present in the curds during separation of the curds from the whey. Cultures and the microbes they comprise may be present in any of living, viable, or non-viable states, or any combination thereof. Microbes may be detected in the curds during separation of the curds from the whey using any means known in the art, as described in “Cultured Plant-Based Cheese Compositions: Microbial Cultures” above. In certain embodiments, some or all of the microbes have been killed during the previous steps of the cheesemaking process (e.g. because of heat treatment) and are present in a non-viable state. Without wishing to be bound by theory, in some variations, the microbes which are present in a non-viable state release enzymes which may remain active and contribute to flavor development during separation of the curds from the whey, shaping of the curds, and aging of the curds by producing flavor compounds from the proteins, sugars, fats, and other materials present in the curds.

### Salting the Curds

In some embodiments, the curds may be salted prior to consumption, shaping or aging. Salt added to the curds halts starter culture activity, preserves the resulting cheese, facilitates biochemical development of flavors, and enhances taste. Salt may be added at concentrations of 0.1-5% by weight of the curds. Any type of salt known in the art for use in food applications may be used to salt the curds, including, but not limited to, table salt (sodium chloride), sea salt, kosher salt, fleur de sel, sel gris, pink salt, Himalayan black salt, smoked salt, flake salt, pickling salt, and the like. In a preferred embodiment, the curds are salted with non-iodized salt. The curds may be salted by any means known in the art for salting curds formed from dairy or non-dairy milk. For example, the salt may be added to the curds using means including, but not limited to, sprinkling the salt onto the curds, mixing or stirring the salt into the curds, rubbing the salt onto the surface of the curds before or after shaping, or any combination thereof. In some embodiments, curds are milled (cut) into pieces before the addition of salt. In some embodiments, salt is added in an amount required for the curds to reach a specific salt in moisture (S/M) content. The target S/M content of the curds at the beginning of aging may be determined based on the cultures present in the curds at the start of aging, any cultures to be added during aging, the final salt content of the cheese, or any combination thereof. In some embodiments, the salt in moisture content of the curds at the beginning of aging is between about between about 3S/M and about 6S/M. In some variations, the S/M content of the curds at the beginning of aging is around 3.0 S/M, around 3.5 S/M, around 4.0 S/M, around 4.5 S/M, around 5.0 S/M, around 5.5 S/M, or around 6.0 S/M. In additional variations, the S/M content of the curds at the beginning of aging is between about 3.0 S/M and about 3.5 S/M, between about 3.5 S/M and about 4.0 S/M, between about 4.0 S/M and about 4.5 S/M, between about 4.5 S/M and about 5.0 S/M, between about 5.0 S/M and about 5.5 S/M, between about 5.5 S/M and about 6.0 S/M, or greater than 6.0 S/M. The amount of salt to reach the desired S/M content can be calculated based on the desired S/M value and the moisture content of the curds at the time of salting. For example, the amount of salt to add to the curds in % w/w (percent weight of the curds) can be calculated as follows:

(% moisture of curds)×(S/M÷100)=(% w/w salt)

### Shaping the Curds

In some embodiments, the method of producing the cultured plant-based cheese composition comprises shaping the curds. In some embodiments, the curds may be shaped prior to aging. The curds may be shaped into any shape and size known in the art to be used in cheesemaking. For example, the curds may be shaped into a wheel, a block, a flat sheet, a sphere, a globular structure, cubes, or the like. In some embodiments, the curds may be pressed into a container referred to as a cheese form or a cheese mold to shape them into the shapes described herein. Any cheese form or cheese mold known in the art for making dairy or non-dairy cheeses may be used to shape the cultured plant-based cheese composition herein. In some embodiments, the curds may be cut from larger shapes into smaller shapes, for example, from a large block into smaller blocks or cubes.

In some embodiments, the curds may be treated using a rind method prior to aging in order to form a specific type of rind on the plant-based cheese product. Any rind method known in the art of dairy or non-dairy cheesemaking may be used in the production of the cultured plant-based cheese composition described herein. In one embodiment, a natural rind method may be used, in which formation of a natural rind is achieved by rubbing the surface of the curds with an oil or other fat and aging the curds without otherwise coating or wrapping them. In some variations of this embodiment, the natural rind method results in a rind with features including, but not limited to, naturally-occurring gray molds, green molds, or a combination thereof. In another embodiment, a bandaged riding method may be used, in which the formation of a rind is achieved by soaking cheesecloth in an oil, thoroughly wrapping the curds in the oil-soaked cheesecloth, pressing the cloth-wrapped curds into the cheese form, and then moving the curds into an aging space. In some variations of this embodiment, the bandaged rind method results in a rind with features including, but not limited to, naturally-occurring light-gray molds. Plant-based oils (in contrast to the animal-based oils lard and butter, which are traditional with dairy cheeses) which may be used in the natural and bandaged rind methods include, but are not limited to, coconut oil, olive oil, soybean oil, or any other oil described herein or known in the art to be used in food production. In another embodiment, the shaped curds may be coated in a polymer-based sealant (e.g., cream wax, polyvinylacetate, Plasticoat®, cheese coating), which forms a permeable barrier. In some variations, these sealants contain anitfungal compounds to discourage yeasts and molds and can be used in conjunction with other rind methods, like waxing. In another embodiment, a waxed rind method may be used in which the curds are coated with a food-safe wax prior to aging. In some embodiments, the outside of the curds is salted prior to aging using methods including, but not limited to, rubbing salt on the surface of the curds, soaking the curds in a brine, or the like. In additional embodiments, prior to aging, the curds are washed in one or more liquids including, but not limited to, brine, beer, wine, vinegar, kombucha, or any other liquid comprising salts, acid, or alcohol, or any combination thereof. In some embodiments, the rind method may include steps to infuse additional flavors into the curd using methods including, but not limited to, curing, rubbing, or soaking with one or more flavored oils; rubbing or coating with one or more herbs or spices; or a combination thereof. In another embodiment, the curds or shaped curds may be vacuum-sealed in plastic or a synthetic polymer barrier prior to aging.

In some embodiments, microbial cultures comprising one or more microbes are present in the curds during shaping. Any of the microbial cultures or microbes described herein or known in the art for use in dairy cheesemaking may be present in the curds during shaping. Cultures and the microbes they comprise may be present in any of living, viable, or non-viable states, or any combination thereof. Microbes may be detected in the curds during shaping using any means known in the art, as described in “Cultured Plant-Based Cheese Compositions: Microbial Cultures” above. In certain embodiments, some or all of the microbes have been killed during the previous steps of the cheesemaking process (e.g. because of heat treatment or salt stress) and are present in a non-viable state. Without wishing to be bound by theory, in some variations, the microbes which are present in a non-viable state release enzymes which may remain active and contribute to flavor development during shaping and aging by producing flavor compounds from the proteins, sugars, fats, and other materials present in the curds.

### Aging the Curds

In some embodiments, the method of producing the cultured plant-based cheese composition comprises aging the curds for a period of about 60 days or longer to produce the cultured plant-based cheese composition. As used herein, “aging” refers to the process of holding curds at a controlled temperature and humidity (or otherwise controlling moisture loss) and allowing living microbial cultures, added proteolytic or lipolytic enzymes, and/or the enzymes of lysed microbial cells to metabolize the compounds in the curds over time. Aging is also known in the art as affinage, ripening, or maturing. In some embodiments, the temperature, humidity, and timing of aging may be optimized to develop the desired moisture content, pH, and flavor profile of the plant-based cheese composition. In some embodiments, additional cultures may be added to the curds to facilitate the development of the desired flavor profile during aging. In some variations, flavor development in the cultured plant-based cheese may occur largely through bacterial metabolism (“bacterial-ripened” cheeses) or through fungal metabolism (“mold-ripened” cheeses). In some embodiments, the curds may be aged for a period of about 60 days or longer to produce the plant-based cheese composition. In some embodiments, the aging of the curds produces a hard, firm, or semi-firm cultured plant-based cheese composition having a moisture content of 60% or less.

The curds may be aged in any conditions known in the art to be used for the aging of dairy or non-dairy cheeses. In some embodiments, the curds are maintained at a temperature between about 0° C. and about 16° C. during aging. In one preferred variation, the curds are maintained at a temperature of between about 10° C. and about 13° C. during aging. In another variation, the curds are maintained at a temperature of between about 1° C. and about 4° C. during aging. In additional variations, the curds are maintained at a temperature of between about 0° C. and about 2° C., between about 2° C. and about 4° C., between about 4° C. and about 6° C., between about 6° C. and about 8° C., between about 8° C. and about 10° C., between about 10° C. and about 12° C., between about 12° C. and about 14° C., between about 14° C. and about 16° C. during aging. In some embodiments, the environment in which the curds are aged (the aging environment) is maintained at a humidity of between about 60% and about 95%. In some variations, the aging environment is maintained at a humidity of at least about 60%, at least about 70%, at least about 80%, at least about 85%, at least about 90%, or at least about 95%. In other variations, the aging environment is maintained at a humidity of between about 60% and about 70%, between about 70% and about 80%, between about 80% and about 85%, between about 85% and about 90%, between about 90% and about 95%, or between about 95% and about 100%. In some embodiments, the environment in which the curds are aged is maintained at the same temperature and humidity through the entire aging process. In other embodiments, the temperature and humidity of the environment in which the curds are aged may change once, twice, or three or more times during the aging process.

The curds may be aged for any amount of time necessary to achieve the desired moisture content, pH, and flavor profile of the final plant-based cheese composition. In some embodiments, the curds are aged for about 60 days or longer to produce the cultured plant-based cheese composition. In some variations, the curds are aged for at least about 60 days, at least about 70 days, at least about 80 days, at least about 90 days, at least about 120 days, at least about 150 days, at least about 180 days, at least about 210 days, at least about 240 days, at least about 270 days, at least about 330 days, or at least about 360 days to produce the cultured plant-based cheese. In other variations, the curds are aged for between about 60 and about 90 days, between about 90 and about 120 days, between about 120 and about 150 days, between about 150 and about 180 days, between about 180 and about 210 days, between about 210 and about 240 days, between about 240 and about 270 days, between about 270 and about 300 days, between about 300 and about 330 days, or between about 330 and about 360 days to produce the cultured plant-based cheese composition. In additional variations, the curds are aged for at least about 2 months, at least about 3 months, at least about 4 months, at least about 5 months, at least about 6 months, at least about 7 months, at least about 8 months, at least about 9 months, at least about 10 months, at least about 11 months, at least about 12 months, at least about 14 months, at least about 16 months, at least about 18 months, at least about 20 months, at least about 22 months, at least about 24 months, at least about 30 months, or at least about 36 months to produce the cultured plant-based cheese composition. In other variations, the curds are aged for between about 2 and about 3 months, between about 3 and about 4 months, between about 4 and about 5 months, between about 5 and about 6 months, between about 6 and about 7 months, between about 7 and about 8 months, between about 8 and about 9 months, between about 9 and about 10 months, between about 10 and about 11 months, between about 11 and about 12 months, between about 12 and about 14 months, between about 14 and about 16 months, between about 16 and about 18 months, between about 18 and about 20 months, between about 20 and about 22 months, between about 22 and about 24 months, between about 24 and about 30 months, or between about 30 and about 36 months to produce the cultured plant-based cheese composition.

In some embodiments, the curds are aged until they reach the desired moisture content to form the cultured plant-based cheese composition. In some embodiments, the cultured plant-based cheese composition has a moisture content of no greater than 60%. In some variations, the cultured plant-based cheese composition has a moisture content of about 60% or less, about 55% or less, about 50% or less, about 45% or less, about 40% or less, about 35% or less, about 30% or less, about 25% or less, about 20% or less, or about 15% or less. In some embodiments, the cultured plant-based cheese composition has a moisture content of between about 10% and about 15%, about 15% and about 20%, about 20% and about 25%, about 25% and about 30%, between about 30% and about 35%, between about 35% and about 40%, between about 40% and about 45%, between about 45% and about 50%, between about 50% and about 55%, between about 55% and about 60%, or between about 60% and about 65%.

In some embodiments, the curds are aged until they reach the desired pH to form the cultured plant-based cheese composition. In some embodiments, the pH of the curds may decrease during aging, resulting in the cultured plant-based cheese composition having a pH lower than that of the curds at the beginning of aging. For example, in bacterial-ripened cheeses, the continued bacterial metabolism of the sugars in the curds during aging may result in a decrease in the pH of the curds and the cultured plant-based cheese composition. In other embodiments, the pH of the curds may increase during aging, resulting in the cultured plant-based cheese composition having a pH higher than that of the curds at the beginning of aging. For example, in mold-ripened cheeses, the fungal metabolism of the organic acids and proteins present in the curds during aging may result in an increase in the pH of the curds and the cultured plant-based cheese composition. In some embodiments, the cultured plant-based cheese composition has a pH of between about 4.5 and about 7.5. In one preferred variation, the cultured plant-based cheese composition has a pH of between 4.5 and 5.8. In another preferred variation, the cultured plant-based cheese composition has a pH of between 5.5 and 7.2. In some additional variations, the cultured plant-based cheese composition has a pH of between about 4.5 and about 5.0, between about 5.0 and about 5.5, or between about 5.5 and about 6.0, between about 6.0 and about 6.5, or between about 6.5 and about 7.0, or between about 7.0 and about 7.5. In additional variations, the cultured plant-based cheese composition has a pH of between about 4.5 and about 4.8, between about 4.8 and about 5.0, between about 5.0 and about 5.2, between about 5.2 and about 5.4, between about 5.4 and about 5.6, between about 5.6 and about 5.8, between about 5.8 and about 6.0, between about 6.0 and about 6.2, between about 6.2 and about 6.4, between about 6.4 and about 6.6, between about 6.6 and about 6.8, between about 6.8 and about 7.0, between about 7.0 and about 7.2, or between about 7.2 and about 7.5.

In some embodiments, microbial cultures comprising one or more microbes are present in the curds during aging. Any of the microbial cultures or microbes described herein or known in the art for use in dairy cheesemaking may be present in the curds during aging. Cultures and the microbes they comprise may be present in any of living, viable, or non-viable states, or any combination thereof. Microbes may be detected in the curds during aging using any means known in the art, as described in “Cultured Plant-Based Cheese Compositions: Microbial Cultures” above. In certain embodiments, some or all of the microbes have been killed during the previous steps of the cheesemaking process (e.g. because of heat treatment or salt stress) and are present in a non-viable state. Without wishing to be bound by theory, in some variations, the microbes which are present in a non-viable state release enzymes which may remain active and contribute to flavor development during aging by producing flavor compounds from the proteins, sugars, fats, and other materials present in the curds.

### Methods of Producing Meltable Plant-Based Cheese Compositions

In another aspect, provided herein is a method of producing a meltable plant-based cheese composition. The cultured plant-based cheese compositions described herein can be used as a base to provide flavor to a meltable plant-based cheese which approximates the flavor profile of a dairy cheese more closely than the meltable plant-based cheeses currently commercially available. In some embodiments, the method comprises mixing the cultured plant-based cheese with additional ingredients one or more gelling agents, one or more plant fats, and salt to create a mixture; blending and cooking the mixture; dispensing the cooked mixture into a form or mold; and setting the cooked mixture to produce the meltable plant-based cheese composition. In certain embodiments, the method further comprises adding coloring agents, preservatives, or a combination thereof to the mixture. In some embodiments, the cultured plant-based cheese composition is present in the meltable plant-based cheese composition in an amount of between about 5% and about 50% by weight of the meltable plant-based cheese composition. In some variations, the cultured plant-based cheese composition is present in an amount of between about 5% and about 10%, between about 10% and about 15%, between about 10% and about 20%, between about 15% and about 20%, between about 15% and about 25%, between about 20% and about 25%, between about 20% and about 30%, between about 25% and about 30%, between about 25% and about 35%, between about 30% and about 35%, between about 30% and about 40%, between about 35% and about 40%, between about 35% and about 45%, between about 40% and about 45%, between about 40% and about 50%, or between about 45% and about 50% by weight of the meltable plant-based cheese composition.

In some embodiments, the method of producing a meltable plant-based cheese composition comprises mixing the cultured plant-based cheese composition with one or more gelling agents, one or more plant fats, and salt to create a mixture. The one or more gelling agents may be any gelling agent known in the art for use as a thickener in food products. The one or more gelling agents may include, but are not limited to, gels (e.g., agar agar, carrageenan, gelatin, pectin, alginate, gellan), gums (e.g., xanthan gum, guar gum, locust bean gum, gellan gum, acacia gum, gum arabic, carob bean gum, gum tragacanth, cassia gum, konjac flour, and konjac gum), native starches (e.g., corn, tapioca, cassava, potato, wheat, rice, arrowroot, oat, sweet potato, sago, mung bean), modified starches (native starches that are physically, chemically, and/or enzymatically modified, including those from corn, tapioca, cassava, potato, wheat, rice, arrowroot, oat, sweet potato, sago, mung bean), cellulose derivatives (e.g., carboxymethyl cellulose, methyl cellulose, hydroxypropyl methylcellulose), and the like. In some embodiments, the meltable plant-based cheese composition comprises one or more gelling agents in an amount of between about 0.5% and about 60% by weight of the meltable plant-based cheese composition. In some variations, the meltable plant-based cheese composition comprises one or more gelling agents in an amount of between about 0.5% and about 1%, between about 0.5% and about 5%, between about 0.5% and 10%, between about 1% and about 5%, between about 1% and about 10%, between about 1% and about 15%, between about 5% and about 10%, between about 5% and about 15%, between about 5% and about 20%, between about 10% and about 15%, between about 10% and about 20%, between about 10% and about 25%, between about 15% and about 20%, between about 15% and about 25%, between about 15% and about 30%, between about 20% and about 25%, between about 20% and about 30%, between about 20% and about 40%, between about 25% and about 30%, between about 25% and about 35%, between about 25% and about 45%, between about 30% and about 35%, between about 30% and about 40%, between about 35% and about 45%, between about 35% and about 40%, between about 35% and about 45%, between about 35% and about 50%, between about 40% and about 45%, between about 40% and about 50%, between about 40% and about 55%, between about 45% and about 50%, between about 45% and about 60%, between about 50% and about 55%, or between about 55% and about 60% by weight of the meltable plant-based cheese composition.

In some embodiments, the method of producing a meltable plant-based cheese composition comprises mixing the cultured plant-based cheese composition with one or more plant fats to create a mixture. In some embodiments, the one or more plant fats is in an amount of between 0% and 30% by weight of the mixture. In some embodiments, the mixture comprises one or more plant fats in an amount of between about 0% and about 30% by weight of the meltable plant-based cheese composition. In some variations, the mixture comprises one or more plant fats in an amount of between about 0% and about 5%, 5% and about 10%, between about 10% and about 15%, between about 10% and about 20%, between about 15% and about 20%, between about 15% and about 25%, between about 20% and about 25%, between about 20% and about 30%, or between about 25% and about 30% by weight of the mixture.

In some embodiments, the method of producing a meltable plant-based cheese composition comprises mixing the cultured plant-based cheese composition with salt to create a mixture. In some embodiments, salt is added to the cultured plant-based cheese composition in an amount of between 0% and 5% by weight of the mixture. The mixture may comprise any salt described herein or known in the art to be used in food applications. In a preferred embodiment, the mixture comprises salt in an amount of between 1% and 3% by weight of the mixture. In some variations, the mixture may comprise between about 0.01% and about 0.05%, about 0.05% and about 0.1%, about 0.1% and about 0.5%, between about 0.5% and about 1.0%, between about 1.0% and about 1.5%, between about 1.5% and about 2.0%, between about 2.0% and about 2.5%, between about 2.5% and about 3.0%, between about 3.0% and about 3.5%, between about 3.5% and about 4.0%, between about 4.0% and about 4.5%, or between about 4.5% and about 5.0% by weight of the mixture.

In some embodiments, the method of producing a meltable plant-based cheese composition comprises blending the mixture. In some embodiments, the mixture of the cultured plant-based cheese composition, one or more gelling agents, one or more plant fats, and salt is blended to homogeneity. The mixture may be blended by any means known in the art including, but not limited to, stirring, blending in a blender or food processor, and the like.

In some embodiments, the method of producing a meltable plant-based cheese composition comprises heating the mixture to between 50 and 90° C. for between 0 and 20 minutes to produce a cooked mixture. In some embodiments, the mixture of the cultured plant-based cheese composition, one or more gelling agents, one or more plant fats, and salt is heated to a temperature above the gelatinization temperature of the one or more gelling agents present in the mixture. In one embodiment, the mixture is heated to a temperature of between about 50° C. and about 90° C. In some variations, the mixture is heated to a temperature between above 50° C., above 55° C., above 60° C., above 65° C., above 70° C., above 75° C., above 80° C., above 85° C., or above 90° C. In some embodiments, the mixture is heated for the amount of time required to bring the entire mixture up to the desired temperature. In one embodiment, the mixture is heated for between about 0 and about 20 minutes. In some variations, the mixture is heated for a period of time between about 1 and about 5 minutes, about 5 and about 10 minutes, about 10 and about 15 minutes, about 15 and about 20 minutes, or more than 20 minutes.

In some embodiments, the method of producing a meltable plant-based cheese composition comprises dispensing the cooked mixture into a form and setting the cooked mixture in the form at between 1 and 8° C. for between 1 and 14 days to produce a meltable plant-based cheese composition. In some embodiments, the mixture of the cultured plant-based cheese composition, one or more gelling agents, one or more plant fats, and salt is dispensed into a form and allowed to set (solidify) to produce the meltable plant-based cheese composition. The mixture may be dispensed and allowed to set in any type of form described herein or known in the art for the setting of gelled food products. The mixture may be allowed to set at any refrigerated temperature typically used in the culinary arts, for example, between about 1° C. and about 8° C., and for any amount of time required for the mixture to completely solidify, for example, between 1 and 14 days.

Methods of Producing Cultured Plant-Based Cheese Compositions from Protein Substrate

In yet another aspect, provided herein is a method of producing a cultured plant-based cheese composition by mechanically forming a protein substrate, adding one or more microbial cultures comprising one or more microbes to the protein substrate, and aging the protein substrate to produce the cultured plant-based cheese composition. In contrast to other methods described herein which comprise providing a plant-based emulsion, culturing the plant-based emulsion, coagulating the proteins in the plant-based emulsion to form solidified curds and liquid whey, and separating the curds and whey, and aging the curds, the method of this aspect comprises mechanically forming a curd-like protein substrate from powdered and liquid ingredients, adding one or more microbial cultures comprising one or more microbes to the protein substrate, and aging the protein substrate to produce the cultured plant-based cheese composition. Thus, the steps of providing a plant-based emulsion, culturing the plant-based emulsion, coagulating the proteins in the plant-based emulsion to form solidified curds and liquid whey, and separating the curds and whey are not required to produce the cultured plant-based cheese of this aspect. In some embodiments, the protein substrate comprises powdered legume material, powdered seed material, or a combination thereof; water; one or more plant fats; salt; and acid.

In some embodiments, the protein substrate comprises powdered legume material, powdered seed material, or a combination thereof in an amount of at least 40% by dry weight of the protein substrate. In some variations, the protein substrate comprises powdered legume material, powdered seed material, or a combination thereof in an amount of at least 45%, at least 50%, at least 55%, at least 60%, at least 65%, at least 70%, at least 75%, at least 80%, at least 85%, at least 90%, or at least 95% by dry weight of the protein substrate. In other variations, the protein substrate comprises powdered legume material, powdered seed material, or a combination thereof in an amount of between 40% and 50%, between 50% and 60%, between 60% and 70%, between 70% and 80%, between 80% and 90%, or between 90% and 100% by dry weight of the protein substrate. The protein substrate may comprise a powdered form of any legume material or seed material described herein or know in the art. In some embodiments, the protein substrate comprises legume flour, seed flour, or a combination thereof. In some variations, the protein substrate comprises soybean flour, sunflower flour, or a combination thereof. In other embodiments, the protein substrate comprises isolated protein powders from legumes or seeds. In some embodiments, the protein substrate comprises isolated pea protein, isolated soybean protein, or a combination thereof.

In some embodiments, the method of producing the plant-based cheese composition comprises hydrating powdered legume material, powdered seed material, or a combination thereof with water to achieve a desired moisture content of the protein substrate. The moisture content of the protein substrate may be designed to mimic the moisture content of the curds or cultured plant-based cheese compositions described herein. In some embodiments, the moisture content of the protein substrate is 80% or less. In preferred embodiments, the moisture content of the protein substrate is 60% or less. In some variations, the moisture content of the protein substrate may be about 80% or less, about 75% or less, about 70% or less, about 65% or less, about 60% or less, about 55% or less, about 50% or less, about 45% or less, about 40% or less, about 35% or less, or about 30% or less. In other variations, the moisture content of the protein substrate may be between about 30% and about 35%, between about 35% and about 40%, between about 40% and about 45%, between about 45% and about 50%, between about 50% and about 55%, between about 55% and about 60%, between about 60% and about 65%, between about 65% and about 70%, between about 70% and about 75%, or between about 75% and about 80%.

In some embodiments, the method of producing the cultured plant-based cheese composition comprises mixing the hydrated powdered legume material, powdered seed material, or combination thereof with one or more plant fats to create a protein substrate. In some embodiments, the protein substrate comprises one or more plant fats. The protein substrate may comprise fats in addition to those fats naturally present in the powdered legume material, powdered seed material, or combination thereof. The protein substrate may comprise any added animal- or plant-based fat described herein or known in the art. In some variations, one or more fats are added to the protein substrate in an amount of between 0% and about 50% by weight of the protein substrate. In some variations, one or more fats are added to the protein substrate in an amount of between about 1% and about 5%, between about 1% and about 10%, between about 5% and about 10%, between about 10% and about 15%, between about 10% and about 20%, between about 15% and about 20%, between about 15% and about 25%, between about 20% and about 25%, between about 20% and about 30%, between about 25% and about 30%, between about 25% and about 35%, between about 30% and about 35%, between about 30% and about 40%, between about 35% and about 40%, between about 35% and about 45%, between about 40% and about 45%, between about 40% and about 50%, or between about 45% and about 50% by weight of the protein substrate.

In some embodiments, the method of producing the cultured plant-based cheese composition comprises mixing the hydrated powdered legume material, powdered seed material, or combination thereof with acid to create a protein substrate. In some embodiments, the hydrated powdered legume material, powdered seed material, or combination thereof is mixed with one or more acids in an amount that achieves a desired pH of the protein substrate. Any food-safe acid known in the art may be added to the protein substrate to achieve the desired pH, including, but not limited to, lactic acid, citric acid, acetic acid, tartaric acid, and the like. The pH of the protein substrate may be designed to mimic the pH of the curds or cultured plant-based cheese compositions described herein. In some embodiments, the pH of the protein substrate is between about 4.0 and about 6.0. In one variation, the pH of the protein substrate is between about 4.4 and about 4.8. In another variation, the pH of the protein substrate is between about 4.6 and about 4.8. In yet another variation, the pH of the protein substrate is between about 5.0 and about 5.3. In yet another variation, the pH of the protein substrate is between about 5.2 and about 5.6. In additional variations, the pH of the protein substrate is between about 4.0 and between about 4.5, between about 4.5 and about 5.0, between about 5.0 and about 5.5, or between about 5.5 and about 6.0. In yet additional variations, the pH of the curds at the beginning is between about 4.0 and about 4.2, between about 4.2 and about 4.4, between about 4.4 and about 4.6, between about 4.6 and about 4.8, between about 4.8 and about 5.0, between about 5.0 and about 5.2, between about 5.2 and about 5.4, between about 5.4 and about 5.6, between about 5.6 and about 5.8, or between about 5.8 and about 6.0.

In some embodiments, the method of producing the cultured plant-based cheese composition comprises mixing the hydrated powdered legume material, powdered seed material, or combination thereof with salt to create a protein substrate. In some embodiments, the protein substrate comprises salt in an amount of between 0% and 5% by weight of the protein substrate. The protein substrate may comprise any salt described herein or known in the art to be used in food applications. In a preferred embodiment, the protein substrate comprises salt in an amount of between 1% and 3% by weight of the protein substrate. In some variations, the protein substrate may comprise between about 0.01% and about 0.05%, about 0.05% and about 0.1%, about 0.1% and about 0.5%, between about 0.5% and about 1.0%, between about 1.0% and about 1.5%, between about 1.5% and about 2.0%, between about 2.0% and about 2.5%, between about 2.5% and about 3.0%, between about 3.0% and about 3.5%, between about 3.5% and about 4.0%, between about 4.0% and about 4.5%, or between about 4.5% and about 5.0% by weight of the protein substrate. In some embodiments, salt is added in an amount required for the curds to reach a specific salt in moisture (S/M) content. The target S/M content of the curds at the beginning of aging may be determined based on the cultures present in the curds at the start of aging, any cultures to be added during aging, the final salt content of the cheese, or any combination thereof. In some embodiments, the salt in moisture content of the curds at the beginning of aging is between about between about 3 S/M and about 6S/M. In some variations, the S/M content of the curds at the beginning of aging is around 3.0 S/M, around 3.5 S/M, around 4.0 S/M, around 4.5 S/M, around 5.0 S/M, around 5.5 S/M, or around 6.0 S/M. In additional variations, the S/M content of the curds at the beginning of aging is between about 3.0 S/M and about 3.5 S/M, between about 3.5 S/M and about 4.0 S/M, between about 4.0 S/M and about 4.5 S/M, between about 4.5 S/M and about 5.0 S/M, between about 5.0 S/M and about 5.5 S/M, between about 5.5 S/M and about 6.0 S/M, or greater than 6.0 S/M.

In additional embodiments, the protein substrate may further comprise additives in order to produce the desired flavor, texture profile, and overall sensory experience associated with the cultured plant-based cheese compositions produced by the processes described herein. In one embodiment, the protein substrate comprises a calcium source such as one of the calcium salts described herein. In certain embodiments, the protein substrate further comprises coloring agents, preservatives, or a combination thereof.

In some embodiments, the method of producing the cultured plant-based cheese composition comprises adding one or more microbial cultures comprising one or more microbes to the protein substrate. Any microbial culture or microbe described herein or known in the art to be used in culturing dairy or non-dairy foods may be added to the protein substrate. In some embodiments, one or more microbial cultures comprising one or more microbes are added to the protein substrate in an amount of between around 10⁷ CFU and around 10¹¹ CFU per gram of the protein substrate. In some variations, one or more microbial cultures comprising one or more microbes are added to the protein substrate in an amount of between around 10⁷ CFU and around 10⁸ CFU, between around 10⁸ CFU and around 10⁹ CFU, between around 10⁹ CFU and around 10¹⁰ CFU, between around 10¹⁰ CFU and around 10¹¹ CFU per gram of the protein substrate. In other embodiments, the amount of microbial cultures or microbes may be measured in DCU per kg of the protein substrate. In some variations, one or more microbial cultures comprising one or more microbes are added to the protein substrate in an amount of between around 1 DCU and around 5 DCU, between around 5 DCU and around 10 DCU, between around 10 DCU and around 15 DCU, between around 15 DCU and around 20 DCU, between around 20 DCU and around 25 DCU, between around 25 DCU and around 30 DCU, between around 30 DCU and around 40 DCU, between around 40 DCU and around 50 DCU, between around 50 DCU and around 60 DCU, between around 60 and around 80 DCU, between around 80 DCU and around 100 DCU, between around 100 DCU and around 150 DCU, or between around 150 DCU and around 200 DCU per kg of the protein substrate.

In some embodiments, one or more enzymes are added to the protein substrate prior to aging. Any enzyme described herein or known in the art to be used in flavor development in dairy or non-dairy cheeses may be added to the protein substrate. In some embodiments, the enzymes may be added to the protein substrate in an amount of between 0.00001% and 5% by weight of the protein substrate. In some variations, proteolytic enzymes may be added to the protein substrate in an amount of between about 0.00001% and about 0.0001%, between about 0.0001% and about 0.001%, between about 0.001% and about 0.01%, between about 0.01% and about 0.1%, between about 0.1% and about 0.5%, between about 0.5% and about 1.0%, between about 1.0% and about 1.5%, between about 1.5% and about 2.0%, between about 2.0% and about 2.5%, between about 2.5% and about 3.0%, between about 3.0% and about 3.5%, between about 3.5% and about 4.0%, between about 4.0% and about 4.5%, between about 4.5% and about 5.0%, or greater than about 5.0% by weight of the protein substrate. In one embodiment, an amount of rennet is added to the protein substrate. In some embodiments, rennet is added to the protein substrate in an amount of between about 10 IMCU and about 200 IMCU per kg of protein substrate. In some variations, rennet is added to the protein substrate in an amount of between about 10 IMCU and about 20 IMCU, between about 20 IMCU and about 30 IMCU, between about 30 IMCU and about 40 IMCU, between about 40 IMCU and about 50 IMCU, between about 50 IMCU and about 75 IMCU, between about 75 IMCU and about 100 IMCU, between about 100 IMCU and about 125 IMCU, between about 125 IMCU and about 150 IMCU, between about 150 IMCU and about 200 IMCU, between about 200 IMCU and about 300 IMCU, between about 300 IMCU and about 400 IMCU, between about 400 IMCU and about 500 IMCU, between about 500 IMCU and about 600 IMCU, between about 600 IMCU and about 700 IMCU, between about 700 IMCU and about 800 IMCU, between about 800 IMCU and about 900 IMCU, or between about 900 IMCU and about 1000 IMCU per kg of protein substrate.

In some embodiments, the method of producing the cultured plant-based cheese composition comprises shaping the protein substrate. The protein substrate may be shaped by any methods described herein or known in the art for shaping curds.

In some embodiments, the method of producing the cultured plant-based cheese composition comprises aging the protein substrate. In some embodiments, the protein substrate is aged for a period of time to produce the cultured plant-based cheese composition. The protein substrate may be shaped and aged using any of the methods and conditions described herein for shaping and aging curds. In some embodiments, the protein substrate is aged for about 60 days or longer to produce the cultured plant-based cheese composition. In some variations, the protein substrate is aged for at least about 60 days, at least about 70 days, at least about 80 days, at least about 90 days, at least about 120 days, at least about 150 days, at least about 180 days, at least about 210 days, at least about 240 days, at least about 270 days, at least about 330 days, or at least about 360 days to produce the cultured plant-based cheese. In other variations, the protein substrate is aged for between about 60 and about 90 days, between about 90 and about 120 days, between about 120 and about 150 days, between about 150 and about 180 days, between about 180 and about 210 days, between about 210 and about 240 days, between about 240 and about 270 days, between about 270 and about 300 days, between about 300 and about 330 days, or between about 330 and about 360 days to produce the cultured plant-based cheese composition. In additional variations, the protein substrate is aged for at least about 2 months, at least about 3 months, at least about 4 months, at least about 5 months, at least about 6 months, at least about 7 months, at least about 8 months, at least about 9 months, at least about 10 months, at least about 11 months, at least about 12 months, at least about 14 months, at least about 16 months, at least about 18 months, at least about 20 months, at least about 22 months, at least about 24 months, at least about 30 months, or at least about 36 months to produce the cultured plant-based cheese composition. In other variations, the protein substrate is aged for between about 2 and about 3 months, between about 3 and about 4 months, between about 4 and about 5 months, between about 5 and about 6 months, between about 6 and about 7 months, between about 7 and about 8 months, between about 8 and about 9 months, between about 9 and about 10 months, between about 10 and about 11 months, between about 11 and about 12 months, between about 12 and about 14 months, between about 14 and about 16 months, between about 16 and about 18 months, between about 18 and about 20 months, between about 20 and about 22 months, between about 22 and about 24 months, between about 24 and about 30 months, or between about 30 and about 36 months to produce the cultured plant-based cheese composition.

The present invention will be further understood by reference to the following nonlimiting examples.

### ENUMERATED EMBODIMENTS

The following enumerated embodiments are representative of some aspects of the invention.
1. A cultured plant-based cheese composition comprising:
   (a) legume material, seed material, or a combination thereof in an amount of at least 40% by dry weight of the cultured plant-based cheese composition;
   (b) one or more microbial cultures comprising one or more microbes;
   (c) one or more coagulating agents;
   (d) one or more proteolytic enzymes; and
   (e) less than 1% nuts by dry weight of the cultured plant-based cheese composition,
   wherein the cultured plant-based cheese composition has a moisture content of no greater than 60%; and
   wherein the cultured plant-based cheese composition has been aged for a period of about 60 days or longer.
2. The composition of embodiment 1, comprising legume material, seed material, or a combination thereof in an amount of at least 50% by dry weight of the cultured plant-based cheese composition.
3. The composition of embodiment 1, comprising legume material, seed material, or a combination thereof in an amount of at least 60% by dry weight of the cultured plant-based cheese composition.
4. The composition any one of embodiments 1 to 3, wherein the legume material is selected from the group consisting of soybean material, pea material, fava bean material, lentil material, chickpea material, peanut material, cannellini bean material, navy bean material, pinto bean material, and sweet lupine material.
5. The composition of embodiment 4, wherein the legume material is soybean material.
6. The composition of any one of embodiments 1 to 5, wherein the seed material is selected from the group consisting of sunflower seed material, pumpkin seed material, squash seed material, chia seed material, flax seed material, and hemp seed material.

The composition of any one of embodiments 1 to 6, comprising less than 0.5% nuts by dry weight of the cultured plant-based cheese composition.
8. The composition of any one of embodiments 1 to 6, comprising less than 0.1% nuts by dry weight of the cultured plant-based cheese composition.
9. The composition of any one of embodiments 1 to 6, wherein the cultured plant-based cheese composition does not comprise nuts.
10. The composition of any one of embodiments 1 to 9, wherein the cultured plant-based cheese composition does not comprise almonds.
11. The composition of any one of embodiments 1 to 10, wherein the cultured plant-based cheese composition does not comprise cashews.
12. The composition of any one of embodiments 1 to 11, wherein the cultured plant-based cheese composition has a moisture content of no greater than 50%.
13. The composition of any one of embodiments 1 to 11, wherein the cultured plant-based cheese composition has a moisture content of no greater than 40%.
14. The composition of any one of embodiments 1 to 13, wherein the cultured plant-based cheese composition has been aged for a period of about 90 days or longer.
15. The composition of any one of embodiments 1 to 13, wherein the cultured plant-based cheese composition has been aged for a period of about 6 months or longer.
16. The composition of any one of embodiments 1 to 15, comprising free amino acids in an amount of at least 50 mg per 100 g of the cultured plant-based cheese composition.
17. The composition of embodiment 16, wherein at least 60% by weight of the free amino acids present in the plant-based cheese composition are derived from the legume material, seed material, or combination thereof of the plant-based cheese composition.
18. The composition of embodiment 16 or 17, wherein the free amino acids comprise free amino acid additives, free amino acids derived from additives, or a combination thereof in an amount of no more than 40% by weight.
19. The composition of any one of embodiments 1 to 18, comprising free glutamate in an amount of at least 50 mg per 100 g of the cultured plant-based cheese composition.
20. The composition of embodiment 19, wherein at least 60% by weight of the free glutamate present in the plant-based cheese composition are derived from the legume material, seed material, or combination thereof of the plant-based cheese composition.
21. The composition of embodiment 19 or 20 wherein the free glutamate comprises free glutamate additives, free glutamate derived from additives, or a combination thereof in an amount of no more than 40% by weight.
22. The composition of any one of embodiments 1 to 21, wherein the one or more microbes are selected from the group consisting of Lactococcus sp., Lactobacillus sp., Streptococcus sp., Propionibacterium sp., Brevibacter sp., Leuconostoc sp., Corynebacterium sp., Pediococcus sp., Enterococcus sp., Bifidobacterium sp., Weissella sp., Penicillium sp., Aspergillus sp., Saccharomyces sp., Candida sp., and Geotrichum sp.
23. The composition of any one of embodiments 1 to 22, wherein the one or more coagulating agents comprise a mineral cation.
24. The composition of any one of embodiments 1 to 23, wherein the one or more coagulating agents comprise an acid.
25. The composition of any one of embodiments 1 to 24, wherein the one or more coagulating agents comprise a coagulating enzyme.
26. The composition of any one of embodiments 1 to 25, wherein the one or more coagulating agents do not comprise a crosslinking enzyme.
27. The composition of any one of embodiments 1 to 25, wherein the one or more coagulating agents do not comprise a transglutaminase.
28. The composition of any one of embodiments 1 to 27 wherein the one or more proteolytic enzymes are selected from the group consisting of animal rennet, pepsin, chymosin, vegetable rennet, microbial rennet, papain, bromelain, serrapeptase, protease, pancreatin, and trypsin.
29. The composition of any of embodiments 1 to 28, further comprising one or more plant fats selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil.
30. The composition of any one of embodiments 1 to 29, further comprising one or more sugars selected from the group consisting of lactose, sucrose, dextrose, galactose, fructose, maltose, and glucose.
31. The composition of any one of embodiments 1 to 30, further comprising one or more syrups selected from the group consisting of honey, corn syrup, rice syrup, and high-fructose corn syrup.
32. The composition of any one of embodiments 1 to 31, further comprising one or more of salt, flavoring agents, texturizing agents, and citrate.
33. The composition of any one of embodiments 1 to 32, wherein the cultured plant-based cheese composition has a pH of between 4.5 and 5.8.
34. The composition of any one of embodiments 1 to 33, wherein the cultured plant-based cheese composition has a pH of between 5.5 and 7.2.
35. A meltable plant-based cheese composition, comprising:
   (i) the cultured plant-based cheese composition of any one of embodiments 1 to 34 in an amount of between about 5% and about 50% by weight of the meltable plant-based cheese composition;
   (ii) one or more gelling agents in an amount of between about 5% and about 60% by weight of the meltable plant-based cheese composition;
   (iii) one or more plant fats in an amount of between 0% and about 30% by weight of the meltable plant-based cheese composition;
   (vi) salt in an amount of between about 0.5% and about 3% by weight of the meltable plant-based cheese composition; and
   (v) water in an amount of between about 20% and about 70% by weight of the meltable plant-based cheese composition;
   wherein the meltable plant-based cheese composition melts at a temperature of between about of between about 50° C. and about 90° C.
36. The meltable plant-based cheese composition of embodiment 35, wherein the one or more gelling agents comprise native tapioca starch, modified tapioca starch, native potato starch, modified potato starch, native corn starch, modified corn starch, carrageenan, agar agar, konjac flour, konjac gum, locust bean gum, xanthan gum, or a combination thereof.
37. The meltable plant-based cheese composition of embodiment 36, wherein the one or more plant fats are selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil.
38. A method of producing a cultured plant-based cheese composition, the method comprising:
   (a) providing a plant-based emulsion comprising legume material, seed material, or a combination thereof;
   (b) adding one or more starter cultures comprising one or more microbes;
   (c) culturing the one or more microbial cultures in the plant-based emulsion;
   (d) coagulating the proteins in the plant-based emulsion to form curds and whey;
   (e) separating the curds from the whey;
   (r) salting the curds;
   (g) shaping the curds; and
   (h) aging the curds for a period of about 60 days or longer to produce the cultured plant-based cheese composition,
   wherein the cultured plant-based cheese composition has a moisture content of no greater than 60% and comprises less than 1% nuts by dry weight of the cultured plant-based cheese composition.
39. The method of embodiment 38, wherein the plant-based emulsion of step (a) is a plant-based milk comprising legume material, seed material, or a combination thereof.
40. The method of embodiment 38 or 39, wherein the plant-based emulsion comprises legume material, seed material, or a combination thereof in an amount of at least about 40% by dry weight of the plant-based emulsion.
41. The method of embodiment 38 or 39, wherein the plant-based emulsion comprises legume material, seed material, or a combination thereof in an amount of at least about 50% by dry weight of the plant-based emulsion.
42. The method of embodiment 38 or 39, wherein the plant-based emulsion comprises legume material, seed material, or a combination thereof in an amount of at least at least about 60% by dry weight of the plant-based emulsion.
43. The method of any one of embodiments 38 to 42, wherein step (a) comprises substeps:
   (a1) providing a base composition comprising legume material, seed material, or a combination thereof;
   (a2) mixing the base composition with water; and
   (a3) comminuting the base composition and water to produce the plant-based emulsion.
44. The method of embodiment 43, further comprising substep:
   (a4) separating and discarding the insoluble solids from the plant-based emulsion.
45. The method of embodiment 43 or 44, wherein the base composition comprises legume material, seed material, or a combination thereof in an amount of at least 90% by dry weight of the base composition.
46. The method of embodiment 43 or 44, wherein the base composition comprises legume material, seed material, or a combination thereof in an amount of at least 95% by dry weight of the base composition.
47. The method of embodiment 43 or 44, wherein the base composition comprises legume material, seed material, or a combination thereof in an amount of at least 99% by dry weight of the base composition.
48. The method of any one of embodiments 38 to 47, wherein the plant-based emulsion of step (a) has a Brix value of 5° Bx or higher.
49. The method of any one of embodiments 38 to 48, wherein the plant-based emulsion of step (a) has a Brix value of 9° Bx or higher.
50. The method of any one of embodiments 43 to 47, wherein the base composition comprises legume material selected from the group consisting of soybean material, pea material, fava bean material, lentil material, chickpea material, peanut material, cannellini bean material, navy bean material, pinto bean material, and sweet lupine material.
51. The method of embodiment 50, wherein the legume material is soybean material.
52. The method of any one of embodiments 43 to 51, wherein the base composition comprises seed material selected from the group consisting of sunflower seed material, pumpkin seed material, squash seed material, chia seed material, flax seed material, and hemp seed material.
53. The method of any one of embodiments 38 to 52, wherein the aging of step (h) occurs over a period of about 90 days or longer.
54. The method of any one of embodiments 38 to 52, wherein the aging of step (h) occurs over a period of about 6 months or longer.
55. The method of any one of embodiments 38 to 54, wherein the separating of step (e) occurs over a period of no more than three hours.
56. The method of any one of embodiments 38 to 55, wherein the separating of step (e) comprises a mechanical process to drive the whey from the curds.
57. The method of embodiment 56, wherein the mechanical process is pressing.
58. The method of any one of embodiments 38 to 57, wherein the cultured plant-based cheese composition has a pH of between 4.5 and 5.8.
59. The method of any one of embodiments 38 to 57, wherein the cultured plant-based cheese composition has a pH of between 5.5 and 7.2.
60. The method of any one of embodiments 38 to 59, wherein the plant-based emulsion of step (a) comprises one or more plant fats selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil.
61. The method of any one of embodiments 38 to 60, wherein the plant-based emulsion of step (a) comprises one or more sugars selected form the group consisting of lactose, sucrose, dextrose, galactose, fructose, maltose, and glucose.
62. The method of any one of embodiments 38 to 61, wherein the plant-based emulsion of step (a) comprises one or more syrups selected from the group consisting of honey, corn syrup, rice syrup, and high-fructose corn syrup.
63. The method of any one of embodiments 38 to 62, wherein the one or more microbes of step (b) are selected from the group consisting of Lactococcus sp., Lactobacillus sp., Streptococcus sp., Propionibacterium sp., Brevibacter sp., Leuconostoc sp., Corynebacterium sp., Pediococcus sp., Enterococcus sp., Bifidobacterium sp., Weissella sp., Penicillium sp., Aspergillus sp., Saccharomyces sp., Candida sp., and Geotrichum sp.
64. The method of any one of embodiments 38 to 63, further comprising adding one or more proteolytic enzymes prior to step (d).
65. The method of embodiment 64, herein the one or more proteolytic enzymes are selected from the group consisting of animal rennet, pepsin, chymosin, vegetable rennet, microbial rennet, papain, bromelain, serrapeptase, protease, pancreatin, and trypsin.
66. The method of any one of embodiments 38 to 65, wherein the culturing of step (c) results in acidification of the plant-based emulsion sufficient to cause the coagulating of step (d).
67. The method of any one of embodiments 38 to 66, wherein the coagulating of step (d) comprises adding one or more coagulating agents selected from the group consisting of mineral cations, acids, or coagulating enzymes.
68. The method of embodiment 67, wherein the one or more coagulating agents do not comprise a crosslinking enzyme.
69. The method of embodiment 67, wherein the one or more coagulating agents do not comprise a transglutaminase.
70. Curds produced according to steps (a) through (e) in any one of embodiments 38 to 69.
71. The method of any one of embodiments 38 to 57, further comprising:
   (i) mixing the cultured plant-based cheese composition with one or more gelling agents, one or more plant fats, and salt to create a mixture;
   (j) blending the mixture;
   (k) heating the mixture to between 50 and 90° C. for between 0 and 20 minutes to produce a cooked mixture;
   (l) dispensing the cooked mixture into a form; and
   (m) setting the cooked mixture in the form at between 1 and 8° C. for between 1 and 14 days to produce a meltable plant-based cheese composition.
72. The method of embodiment 71, wherein the mixture of step (i) comprises:
   (i) cultured plant-based cheese composition in an amount of between about 5% and about 50% by weight;
   (ii) one or more gelling agents in an amount of between about 5% and about 60% by weight;
   (iii) one or more plant fats in an amount of between 0% and about 30% by weight;
   (vi) salt in an amount of between about 0.5% and about 3% by weight; and
   (v) water in an amount of between about 20% and about 70% by weight.
73. The method of embodiment 71 or 72, wherein the one or more gelling agents comprise native tapioca starch, modified tapioca starch, native potato starch, modified potato starch, native corn starch, modified corn starch, carrageenan, agar agar, konjac flour, konjac gum, locust bean gum, xanthan gum, or a combination thereof.
74. The method of any one of embodiments 71 to 73, wherein the one or more plant fats are selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil.
75. A method of producing a cultured plant-based cheese composition, the method comprising:
   (a) hydrating powdered legume material, powdered seed material, or a combination thereof to a moisture content of no greater than 60%;
   (b) mixing the hydrated powdered legume material, powdered seed material, or combination thereof with one or more plant fats, salt, and acid to create a protein substrate;
   (c) adding one or more microbial cultures comprising one or more microbes to the protein substrate;
   (d) shaping the protein substrate; and
   (e) aging the protein substrate for a period of about 60 days or longer to produce the cultured plant-based cheese composition,
   wherein the cultured plant-based cheese composition comprises less than 1% nuts by dry weight of the cultured plant-based cheese composition.
76. The method of embodiment 75, wherein the cultured plant-based cheese composition comprises powdered legume material, powdered seed material, or a combination thereof in an amount of at least about 40% by dry weight of the plant-based emulsion.
77. The method of embodiment 75, wherein the cultured plant-based cheese composition comprises powdered legume material, powdered seed material, or a combination thereof in an amount of at least about 50% by dry weight of the plant-based emulsion.
78. The method of embodiment 75, wherein the cultured plant-based cheese composition comprises powdered legume material, powdered seed material, or a combination thereof in an amount of at least at least about 60% by dry weight of the plant-based emulsion.
79. The method of any one of embodiments 75 to 78, wherein the powdered legume material, powdered seed material, or combination thereof is selected from the group consisting of isolated protein, legume flour, and seed flour.
80. The method of any one of embodiments 75 to 79, wherein the powdered legume material is selected from the group consisting of soybean material, pea material, fava bean material, lentil material, chickpea material, peanut material, cannellini bean material, navy bean material, pinto bean material, and sweet lupine material.
81. The method of embodiment 80, wherein the powdered legume material is soybean material.
82. The method of any one of embodiments 75 to 81, wherein the powdered seed material is selected from the group consisting of sunflower seed material, pumpkin seed material, squash seed material, chia seed material, flax seed material, and hemp seed material.
83. The method of any one of embodiments 75 to 82, wherein the aging of step (e) occurs over a period of about 90 days or longer.
84. The method of any one of embodiments 75 to 82, wherein the aging of step (e) occurs over a period of about 6 months or longer.
85. The method of any one of embodiments 75 to 84, wherein the acid is lactic acid.
86. The method of any one of embodiments 75 to 85, wherein the cultured plant-based cheese composition has a pH of between 4.5 and 5.8.
87. The method of any one of embodiments 75 to 85, wherein the cultured plant-based cheese composition has a pH of between 5.5 and 7.2.
88. The method of any one of embodiments 75 to 87, wherein the one or more plant fats of step (b) are selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil.
89. The method of any one of embodiments 75 to 88, wherein the one or more microbes of step (c) are selected from the group consisting of Lactococcus sp., Lactobacillus sp., Streptococcus sp., Propionibacterium sp., Brevibacter sp., Leuconostoc sp., Corynebacterium sp., Pediococcus sp., Enterococcus sp., Bifidobacterium sp., Weissella sp., Penicillium sp., Aspergillus sp., Saccharomyces sp., Candida sp., and Geotrichum sp.
90. The method of any one of embodiments 75 to 89, wherein step (c) further comprises adding one or more proteolytic enzymes to the protein substrate.
91. The method of embodiment 90, wherein the one or more proteolytic enzymes are selected from the group consisting of animal rennet, pepsin, chymosin, vegetable rennet, microbial rennet, papain, bromelain, serrapeptase, protease, pancreatin, and trypsin.
92. The method of any one of embodiments 75 to 91, wherein the protein substrate further comprises one or more sugars selected form the group consisting of lactose, sucrose, dextrose, galactose, fructose, maltose, and glucose.
93. The method of any one of embodiments 75 to 92, wherein the protein substrate further comprises one or more syrups selected from the group consisting of honey, corn syrup, rice syrup, and high-fructose corn syrup.
94. The cultured plant-based cheese composition produced according to any one of embodiments 75 to 93.
95. The method of any one of embodiments 75 to 95, further comprising:
   (i) mixing the cultured plant-based cheese composition with one or more gelling agents, one or more plant fats, and salt to create a mixture;
   (j) blending the mixture;
   (k) heating the mixture to between 50 and 90° C. for between 0 and 20 minutes to produce a cooked mixture;
   (l) dispensing the cooked mixture into a form; and
   (m) setting the cooked mixture in the form at between 1 and 8° C. for between 1 and 14 days to produce a meltable plant-based cheese composition.
96. The method of embodiment 95, wherein the mixture of step (i) comprises:
   (i) cultured plant-based cheese composition in an amount of between about 5% and about 50% by weight;
   (ii) one or more gelling agents in an amount of between about 5% and about 60% by weight;
   (iii) one or more plant fats in an amount of between 0% and about 30% by weight;
   (vi) salt in an amount of between about 0.5% and about 3% by weight; and
   (v) water in an amount of between about 20% and about 70% by weight.
97. The method of embodiment 95 or 96, wherein the one or more gelling agents comprise native tapioca starch, modified tapioca starch, native potato starch, modified potato starch, native corn starch, modified corn starch, carrageenan, agar agar, konjac flour, konjac gum, locust bean gum, xanthan gum, or a combination thereof.
98. The method of any one of embodiments 95 to 97, wherein the one or more plant fats are selected from the group consisting of corn oil, soybean oil, sunflower oil, coconut oil, canola oil, palm oil, palm kernel oil, rice bran oil, safflower oil, peanut oil, olive oil, cocoa oil, walnut oil, and cottonseed oil.

### EXAMPLES

The presently disclosed subject matter will be better understood by reference to the following Examples, which are provided as exemplary of the invention, and not by way of limitation.

### Example 1: Methods for Creating a Hard, Aged Cheese from Native Soybeans

The following is an exemplary method for producing an aged plant-based cheese from soybeans. The soybeans are comminuted with water and cooked to produce soy milk. The soy milk is then acidified through culturing with mesophilic and/or thermophilic cultures. The cultured milk is coagulated at low temperatures to preserve the viability of the cultures. The curds and whey are separated, and the curds are shaped and aged for a period of several months to years. The live cultures present at the beginning of aging continue to metabolize the compounds in the curds, developing flavor compounds over time and resulting in a cheese with a complex flavor profile similar to that of an aged dairy cheese.

1. Making Soy Milk

To make soy milk, soybeans are ground with filtered water and the fibrous content (“okara”) is separated from the milk by filtering, centrifugation, or other mechanical means. Specifically designed machines or general kitchen appliances like blenders and cheesecloth or nylon mesh for filtering may be used. Particles larger than 200 microns or similar are filtered out.

Soy milk is heated to above 95° C. (simmer or boil) for 10-30 minutes, or any amount of time sufficient to denature the proteins in the milk. Cooking kills endogenous microbes. It also denatures bean proteins, which limits the “beany” taste of soy milk and makes the proteins more digestible. Coconut oil is added (1-10% weight per volume), which incorporates relatively easily into soy milk because of soy's natural emulsifiers (e.g., soy lecithin). Sugar is added if desired (0.1-10% weight per volume) to provide an additional growth substrate for starter cultures beyond the sugar naturally present in the soybeans. The milk is mixed. Soy milk made this way usually has a pH of 6.4-6.8.

2. Acidify the Soy Milk

To acidify the milk, the milk is first stabilized at a proper temperature for the chosen bacteria (e.g., 26-33° C. for mesophilic cultures, 35-41° C. for thermophilic cultures). The cultures are added to the milk, and the mixtures is agitated at a stable temperature for 40-200 minutes. Proteolytic enzymes are added (e.g., microbial chymosin) at the end of culturing to support flavor development during aging. Enzymes are added at a concentration of 10-200 international milk clotting units (IMCU) per liter of milk.

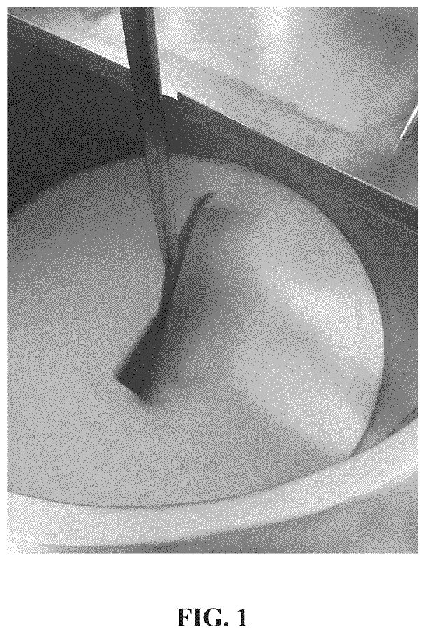

See FIG. 1.

3. Coagulating the Soy Milk

To coagulate the soy milk's proteins and fats into a solid mass, a cation coagulant (e.g., calcium chloride) is added at concentrations of 0.1-0.6% weight per milk volume. The curds are allowed to solidify into a gel for 10-120 minutes, maintaining the same or a slightly higher temperature. Because culturing continues during solidification, the solidification time should be optimized to balance the degree of solidification with the overall time of culturing and the resulting acidification of the curds. For example, longer solidification times may result in a reduced need for pressing to remove liquid, but a lower pH of the curds.

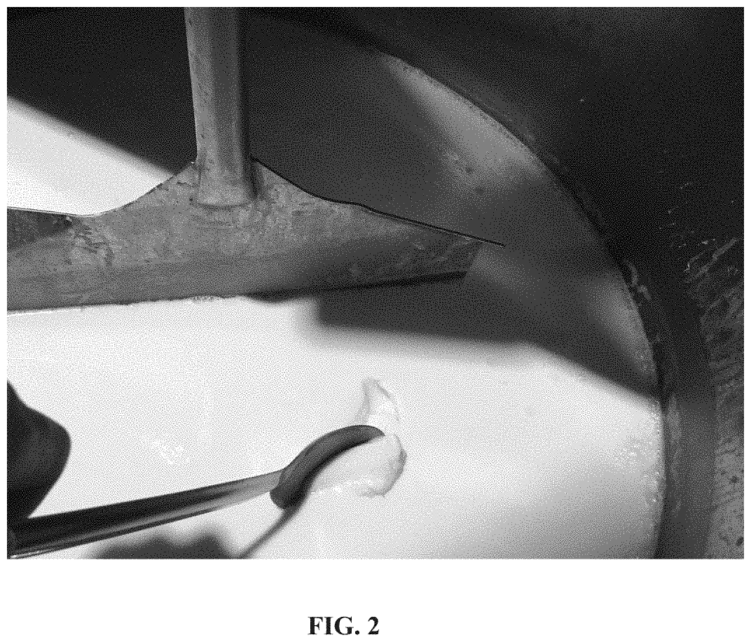

See FIG. 2.

4. Separating Curds and Whey

To drive out liquid whey from coagulated curds, the whey is expelled by mechanically applying gradually increasing pressures to remove moisture from the curds, aiming for a moisture content of 35-60% and a goal final pH of 4.9-5.6. This process might be completed using presses, centrifugation, or other means to exert force on the curds. Curds may be contained using cheesecloths, other filtering wrappers, molds, forms, or plates.

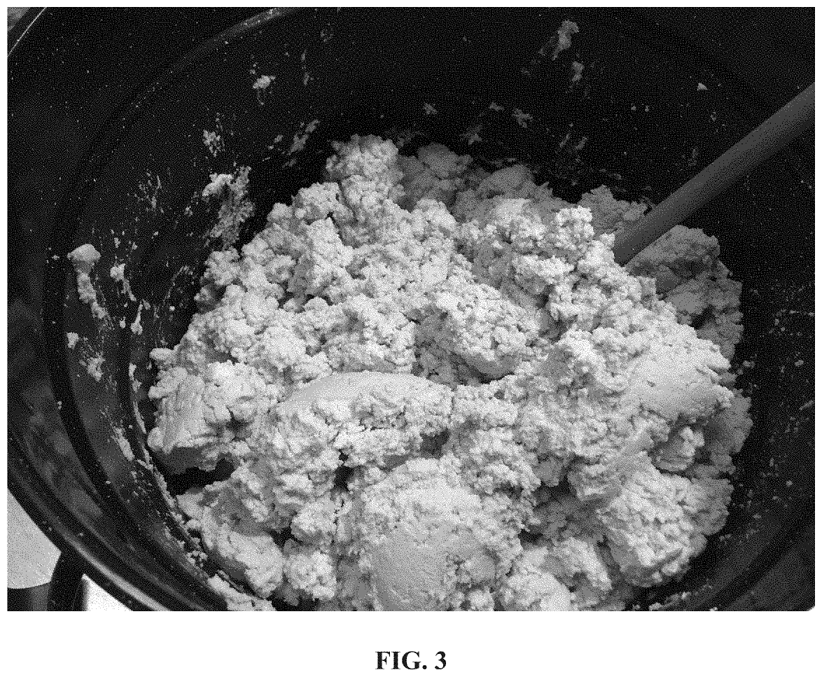

See FIG. 3.

5. Salting

To limit starter culture acid generation and preserve the cheese during aging, salt is added to the curds. The moisture content of the cheese is measured, which can be achieved using weight on drying, electric charge, Karl Fischer titration, or near infrared methods. Salt is added to the curds at 1-4% weight per volume, with a goal “salt in moisture” value of 3-6, with the goal salt in moisture determined by the starter cultures used and final cheese salt content desired. The curds are mixed with the salt.

6. Shaping

To create the final cheese form, the salted curds are pressed a final time into a cheese form (a.k.a. mold), such as a wheel. For cheeses with a higher moisture content, less pressure and time may be needed to obtain a cohesive mass, while for drier curds more pressing may be required. An example protocol might be to place the curds into the chosen form lined with a cheesecloth, and press at increasing pressures (ranging from 0.5-5 pounds per square inch (PSI)) for periods of 30 minutes, flipping the cheese between each press. This gradual increase in pressure can ensure a uniform knitting of the curds without trapping pockets of whey in the curds. Then the curds may be pressed again at 5-10 PSI for 6-24 hours or until the curds have combined into a continuous mass. At the end of this process, the cheese should feel firm, yet give slightly to pressure. Alternatively, one can consume the cheese curds directly after manufacture without shaping as a fresh, cultured cheese product.

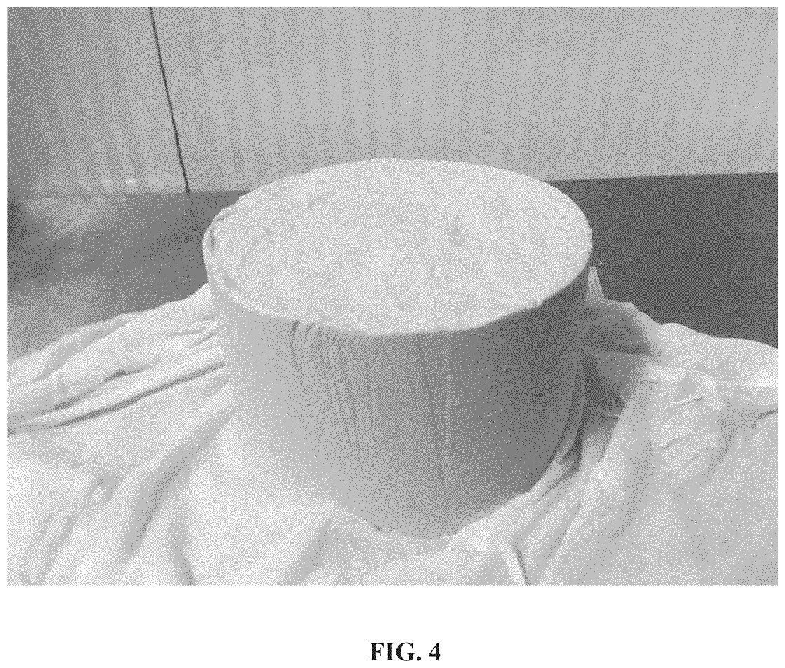

See FIG. 4.

7. Aging

Most rind methods work well with cheese made with a soy and coconut base. Natural rinds may not be desired for cheese aged for more than 1 month, because of increased rates of moisture loss compared to dairy cheeses. Other methods (e.g. bandaging, wax, coating, plastic, foil, etc.) may be better at retaining appropriate moisture levels in the cheese and discouraging the growth of unwanted molds. For example, bandaged rinds are sometimes effective with soy and coconut based cheeses, as they allow for moisture exchange during early stages of aging, discourage the growth of unwanted molds directly on the cheese body, and produce an attractive moldy rind on the outside of the cloth. To bandage a cheese wheel, cheesecloth is cut to the correct size and shape, soaked in coconut oil, and used to cover the cheese wheel. Multiple layers can be used if desired to further control moisture loss. The wheel is then replaced into the mold, and pressed again overnight at the maximum pressure used during shaping. Optionally, one can allow the exterior of the cheese to dry before bandaging by placing it in the aging space for a period of 1-30 days.

For aging, the cheese is moved to a designated space maintained at 7-16° C. with 60-95% relative humidity (unless using a plastic rind, in which case humidity doesn't matter) and aged for a minimum of two months and up to many years. During the first 1-3 months of aging, the cheese wheel may be flipped over every day to ensure that whey does not pool in the bottom half of the wheel. After this period, the cheese may be flipped once or twice a week until the desired age is reached.

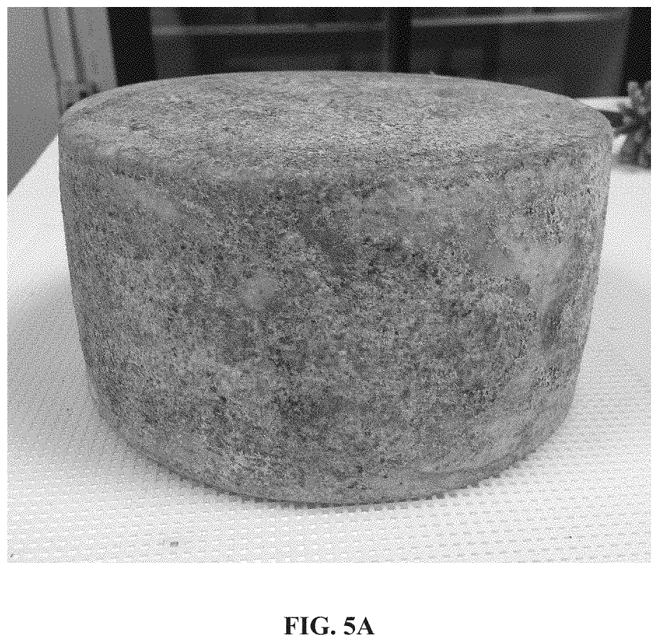

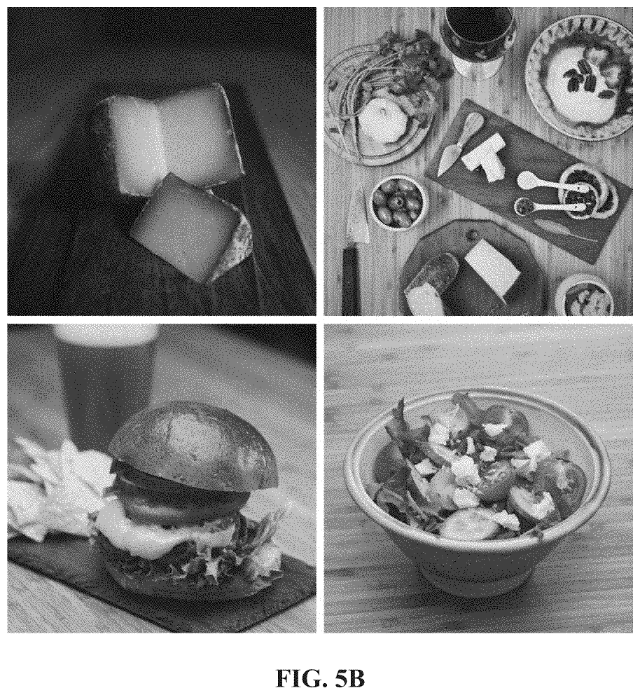

See FIG. 5A and FIG. 5B.

8. Properties of a Mesophilic Culture, Internally Ripened Hard Cheese

Below are some of the key physicochemical properties exhibited by these cheeses that may be fulfilled for a plant-based cheese to provide the right conditions for microbes to create the desired flavors:

Moisture at shaping: 40-60%

Moisture after aging: 35-50%

Salt: Salt levels (in combination with sugar availability) slow start culture activity at the start of aging. Salt in moisture levels start at 4-6 and tend to increase during aging if moisture loss is allowed.

pH at the start of aging: 5.0-5.4

Texture: cohesive to slightly granular

Fat content: 25-45% overall, 45-65% of dry matter

### Example 2: Methods for Creating a Melting Cheese from a Hard, Aged Unmelting Plant-Based Cheese Using Native and Modified Starches

The following is an exemplary method for producing a meltable plant-based cheese from an aged plant-based cheese, such as a cheese produced using the methods of Example 1. The aged plant-based cheese is blended with additional starch and fat ingredients, salt and water and is subsequently cooked and then cooled to allow the formation of a gel. The resulting meltable plant-based cheese will retain the complex flavors of the aged plant-based cheese starting material while having the added benefit of melting upon reheating.

1. Blending

Starting with a hard, aged plant-based cheese (like a cheese producing using the methods of Example 1), any rind resulting from aging is removed, since it will likely be tough and distasteful. The cheese is placed in a blender, mixer, or other processing machine with the capacity to physically disrupt the cheese into a smooth mix. Tapioca starch, modified potato starch (e.g. Precisa 604 from Ingredion), coconut oil, salt, and water are added to the cheese and blended until smooth. Ranges for each of these ingredients are included in the Table 1. Without wishing to be bound by theory, larger amounts of cheese will likely result in a more intense flavor. Larger amounts of modified potato starch will likely result in a more rigid final cheese form. Larger amounts of tapioca starch will likely result in a more rigid final cheese form and greater stretch of the melted form. Larger amounts of coconut oil (or other oils) will likely result in a richer mouthfeel. Salt serves to retain the desired salt intensity, since the high moisture of this cheese will largely obviate salt's preservative effects.

TABLE 1
Ranges of weight percentages for ingredients
to produce a melting plant-based cheese.

| Ingredient | Percentage by weight |
|---|---|
| hard, aged cheese | 5-50% |
| modified potato starch | 5-40% |
| tapioca starch | 0-20% |
| coconut oil | 0-30% |
| salt | 0.5-3% |
| water | 20-70% |

2. Cooking

To activate the gelling properties of starches, the mixture may be cooked to allow the starch molecules to swell, take on moisture, and dissociate into a three-dimensional matrix that can solidify into a solid form. In this example, once the ingredients have been blended to a smooth consistency, they may be cooked at a temperature above the gelatinized temperature of the chosen starches, which is usually between 50-90° C. The duration of cooking is generally only to ensure that the full mixture is brought up to temperature, so ranging from 0-20 minutes.

3. Setting

Once the mixture is fully cooked, it can be dispensed into forms or molds that will determine the final shape. Once in the molds, the molten liquid is allowed to set at cold-storage temperature (1-8° C.) for 1-14 days. Solid processed cheese made in such a way will melt upon reheating and can be sliced, shredded, and grated during cooking or packaging.

### Example 3: Production of Hard, Aged Cheeses from Soybeans

A collection of cultured and aged cheeses was produced from soybeans using a variety of ingredients and methods to optimize the production of flavorful plant-based cheeses. Initial cheeses were aged up to 12 months and evaluated for moisture content, texture and flavor. The “salt in moisture” method was incorporated to provide a more optimal salt concentration for the cultures present in the curds, resulting in enhanced flavor development during aging. Various cultures and rennets were implemented to optimize the flavor profiles of the final cheeses. Implementing a cold-soaking method to prepare the soybeans resulted in more efficient coagulation of the cultured milk. Finally, natural, vacuum-sealed, bandaged, polymer coating, and wax rind formation techniques were evaluated. The cheeses were then weighed after aging and their approximate moisture contents were calculated.

A. Cheeses Aged for 11-12 Months

Cultured, aged cheeses were produced from soybeans using a fixed salt concentration. All such cheeses were produced using the following method and the ingredients outlined in Table 2.

Dry soybeans were combined with boiling-temperature filtered water and soaked for 12-16 hours, except for batch 9, for which the beans were soaked for 2.5 days. The soybeans were then ground with filtered water at a ratio of 300-400 g of soaked soybeans to 1.5 L of water (i.e. a ratio of 3.75-5 mL water per g soybeans) using a TGM-200 continuous soybean grinder with okara separator. The okara separator removed the insoluble fibrous content of the soybeans by centrifugation and filtration through a nylon filter mesh to remove particles greater than about 200 microns. Some of the soy milk preparations were then analyzed for dissolved solids by Brix measurement. Next, the mixture was heated to above 95° C. (simmer or boil) for 20 minutes. Coconut oil was added in the amounts shown in Table 2, except for batch 10, to which fat was added only after pressing as described below. To provide an initial growth substrate for starter cultures, sucrose was added in an amount of 4% weight by soy milk volume (w/v), except for batch 12, to which no sucrose was added, and batch 13, to which sucrose was added in an amount of 2% w/v. 40.2 g of sodium citrate was added to batch 8. The coconut oil, sucrose, and sodium citrate were all added to the heated soy milk before cooling. The resulting milk was mixed thoroughly and then stabilized at a proper temperature for the culture(s) to be added (90° F./32° C. for mesophilic MA series culture MA11, 100° F./38° C. for thermophilic cultures TA61 and TC201). Cultures were then added to the milk in an amount of 0.25 Danisco culturing units (DCU) per liter of soy milk, except for batch 11, to which 0.5 DCU/L was added. The inoculated milk was cultured with agitation using a paddle mixer at a stable temperature until a pH of 6.1-6.2 was reached. After culturing, to support flavor development during aging, rennet was added to the milk at a concentration of about 50 IMCU per liter of inoculated soy milk, except for batch 23, too which about 100 IMCU per liter was added. Batches received one of two types of rennets, as shown in Table 2: Mucor rennet, a native fungal rennet from Mucor miehei (Organic Liquid Vegetable Rennet, New England Cheesemaking Supply Co.); or Star rennet (Dairy Connection Inc.), a chymosin enzyme produced in a genetically engineered fungal host.

To coagulate the inoculated, renneted soy milk's proteins and fats into a solid mass (curds), calcium sulfate was added in an amount of 0.3% weight per milk volume. The curds were allowed to solidify for 10-20 minutes, maintaining the same or a slightly higher temperature than that used for culturing. To drive out liquid whey from coagulated curds, the curds were pressed using a pneumatic press to a moisture content of 50% or less (Table 2).

After pressing, the curds were then salted by adding non-iodized sea salt at a concentration of 2% w/w of the curds. The mass, moisture content, and the pH of the curds were then measured (Table 2). For batch 8, the pressed curds were mixed with coconut oil at the salting stage; this method is referred to hereafter as the “fat after press” method. This allowed for easier separation of the curds and whey prior to pressing. However, much of the added fat was lost during the second pressing step using this method. The curds were then shaped as described below.

For shaping, the salted curds were placed into a cheesecloth-lined, closed-bottom cylindrical form able to hold 3.5-4.2 kg of curds (food-grade polypropylene, 20 cm diameter×15 cm high; New England Cheesemaking Supply Co.) to shape them into a wheel. The curds were then pressed within the form for about 1 hour at mild pressures (1-5 psi). After 1 hour, the shaped curds within the form were inverted and pressed again at 5-10 psi for 6-24 hours or until the curds had combined into a continuous mass. The shaped cheeses were then removed from their forms, rubbed with coconut oil, replaced in their forms, and then pressed again overnight at the maximum pressure used during shaping.

The cheeses were then removed from their forms and moved to a space maintained at about 50-55° F. (10-13° C.) with 80-85% relative humidity for aging. The cheeses were inverted every day during the first 2 months of aging to ensure that whey did not pool on one side. After this period, the cheeses were inverted twice a week and were tasted at regular intervals. The cheeses were aged for 11 to 12 months.

All cheeses began tasting mild, with no clear tasting notes beyond the salt and generic creaminess of the cheese curds. As the cheeses began to age, more complex flavors developed, including umami, nutty, and savory tastes absent in other plant-based cheeses that do not properly age. But in these cheeses the predominant note was a sourness generated from the production of lactic acid. This sourness developed within weeks of the start of aging and remained the predominant flavor thereafter. After significant aging (over 9 months), cheeses that had initially tasted sour began to mellow, allowing complex nutty and earth flavors to be tasted. This decrease in perceived acidity was likely the result of the digestion of lactic acid by nonstarter cultures.

In general, the texture of the cheeses was cohesive but slightly crumbly with a coarse grain. This texture became smooth in the mouth when exposed to the moisture of saliva. Salt content was appropriate for taste. Moisture content began between 40%-50%% for most cheeses, and decreased most significantly during the early stages of aging. After 3-4 months of aging, most of these cheeses exhibited moisture contents between 20-40%. This coincided with a noticeable decrease in volume—as much as a 60% decrease in volume, but most often in the range of a 30-40% decrease (see Section F below). After this initial drying period, the rate of drying slowed significantly. The cheeses developed a natural rind of grey/green molds, which contributed an earth, mushroomy smell to the rind. Some of the cheeses developed cracks in the rind, which could be “healed” by addition of coconut oil.

The overly sour flavor of the cheeses appeared to be largely a product of the sugar content of the cheeses. Cheeses made with less or no sugar added had a mellower, less sour/sharp flavor, which allowed for better appreciation of the nutty taste. Addition of sodium citrate resulted in softer curds during processing, which was likely the result of chelation of the calcium ions that trigger coagulation. Cheeses made with this adjunct were noticeably “buttery” smelling and tasting during the first 4 months of aging, although this effect became more mellow over longer periods.

Altering the cultures used resulted in cheeses with slightly different flavor profiles. MA11 resulted in cheeses with a sharper, more acidic flavor. Thermophilic cultures tended to be mellower. However, these differences were swamped by the more significant differences determined by the acid content of the cheese.

Adding fat after pressing resulted in significant loss of fat during processing. It produced a cheese with greater heterogeneity in texture, but an overall pleasing mouthfeel that melted in the mouth from moisture and warm temperatures.

When used as a base for meltable cheeses (Example 2), the sharp tang of these cheeses was diluted into the other ingredients, mellowing the harness of the acid content. This resulted in pleasant meltable cheeses that retained the depth of flavor present in the hard, aged cheeses, but with a more appropriate level of acidity.

TABLE 2
Ingredients and curd properties of hard cheeses produced from soybeans that have been aged for 11 to 12 months.

| | Soy | Milk | Milk | | Culture | | | Curd | | Curd | |
|---|---|---|---|---|---|---|---|---|---|---|---|
| Batch | Beans | Weight | Brix | | Time | Fat | | Mass | Curd | Moisture | |
| ID | (kg) | (kg) | (°Bx) | Culture | (min) | (% w/v) | Rennet | (kg) | pH | (%) | Notes |
| 1 | 4.6 | 27.7 | N/A | ma11 | N/A | 4% | Mucor | 7.2 | N/A | 46% | |
| 2 | 4 | 25.4 | N/A | ma11 | N/A | 4% | Mucor | 5.65 | N/A | 48% | |
| 3 | 3.8 | 22.65 | N/A | ma11, ta61 | N/A | 4% | Mucor | 5.7 | 5.27 | 44% | |
| 4 | 3.8 | 22 | N/A | ma11 | 185 | 6% | Mucor | 3.9 | N/A | 50% | |
| 5 | 3.5 | 20.9 | N/A | ta61 | 110 | 4% | Mucor | 4.8 | 5.36 | 47% | |
| 6 | 3.5 | 22.45 | N/A | tc201 | 255 | 4% | Star | 4.7 | 5.07 | 49% | |
| 7 | 3.5 | 21.05 | N/A | tc201 | 260 | 4% | Star | 4.15 | 5.05 | 48% | |
| 8 | 3.5 | 23.65 | N/A | ma11 | 210 | 4% | Star | 4.2 | N/A | 49% | 40.2 g sodium citrate added |
| 9 | 3.5 | 23.9 | 5 | ma11 | 150 | 4% | Star | 4.7 | 5.05 | 49% | 2.5 day soak |
| 10 | 3.5 | 23.75 | N/A | ma11 | 160 | 6% | Star | 4.3 | 5.12 | 50% | fat after press method; initial |
| | | | | | | | | | | | curd mass was 3.3 kg |
| 11 | 3.5 | 21.75 | 6 | ma11 | N/A | 4% | Star | 4.15 | 4.88 | 48% | 2x culture |
| 12 | 3.5 | 22.4 | N/A | ma11 | N/A | 4% | Star | 4 | 4.86 | 48% | 0% sucrose |
| 13 | 3.5 | 23.3 | 5 | ma11 | 160 | 4% | Star | 4.25 | 4.93 | 50% | 2% sucrose |

N/A: information not available for this batch

B. Cheeses Produced Using the “Salt in Moisture” Technique

Salt content of the curds is critical for modulating microbial growth and metabolism during aging of cheese by modulating water activity and osmotic pressure, which are functions of both the salt and moisture contents of the curds. In order to achieve consistent water activity and osmotic pressure and optimize microbial growth in soy-based cheeses, several cultured, aged cheeses were produced from soybeans using the “salt in moisture” method as described below.

The cheeses were produced using the same method as described in section A above, with some modifications as follows. Each soy milk preparation was analyzed for dissolved solids by Brix measurement prior to cooking. After cooking but before cooling the soy milk, sucrose was added to the cheeses in an amount of 4% w/v, except for batches 20, 36, and 37, to which 2% w/v sucrose was added. Sodium citrate was added to batch 26 in an amount of 1.7 g/L at the same time that coconut oil and sucrose were added. All of the cheeses were made using the MA series cultures, while batch 28 was additionally cultured with TA61. The inoculated soy milk was cultured as described above for 50 to 120 minutes as specified in Table 3A until a pH of 6.1-6.2 was reached. All batches were treated with Star rennet in an amount of about 50 IMCU per liter of inoculated soy milk. All batches were coagulated using calcium sulfate in an amount of 0.3% w/v except for: batch 17, which was coagulated using calcium sulfate in an amount of 0.5% w/v; and batch 27, which was coagulated using calcium chloride in an amount of 0.3% w/v. The curds were pressed using the methods described in Table 3B. The variable ingredients and properties of the curds measured prior to salting and aging are shown in Table 3A.

After pressing and measuring the moisture content of the curds, the curds were salted using the “salt in moisture” (S/M) technique. S/M can be calculated as follows:

S/M=(% w/w salt)÷(% moisture of curds)×100

To target a specific S/M value, the amount of salt to add to curds can be calculated as follows:

(% moisture of curds)×(S/M÷100)=(% w/w salt)

After the percent moisture of the curds was determined, to target a S/M value of 5, the amount of salt to add to each batch, in terms of percent weight of the curds, was calculated as follows:

(% moisture of curds)×(5÷100)=(% w/w salt)

For some of the cheeses, an estimate of the dry weight percentage of soybean material in each cheese was calculated (Table 3A). Each estimate was calculated by first calculating the dry weight of the curds, and then subtracting the weight of fat that was added.

After salting, the cheeses were shaped and aged as described in section A for 10 to 11 months.

These cheeses exhibited very similar characteristics to the previous cheeses, including acid-forward flavor, flavor development during aging, smell, rind formation, and texture. Although the acidity of the cheeses was slightly decreased, acid content remained relatively high and formed the predominant taste. Additional rennet did not appear to alter flavor or texture, but this was difficult to evaluate given the acidity of the cheeses.

TABLE 3A
Ingredients and curd properties of hard cheeses produced from soybeans using the salt in moisture method.

| | | | | | | | | | | | Soy Bean | |
|---|---|---|---|---|---|---|---|---|---|---|---|---|
| | Soy | Milk | Milk | Culture | | | Curd | | Curd | | Material | |
| Batch | Beans | Weight | Brix | Time | | | Mass | Curd | Moisture | Pressing | Content | |
| ID | (kg) | (kg) | (°Bx) | (min) | Fat | | (kg) | pH | (%) | Method | (% dry weight) | Notes |
| 14 | 3.5 | 23.8 | 5.5 | 120 | 4% | w/v | 5.05 | 4.97 | 58% | | N/A | |
| 15 | 3.5 | 23.55 | 5.5 | 100 | 4% | w/v | 5.1 | <5.20 | 53% | 1.04 | N/A | |
| 16 | 3.5 | 22.15 | 6 | 70 | 4% | w/v | 4.45 | 5.35 | 52% | 1.041 | N/A | |
| 17 | 3.5 | 23.05 | 5.5 | 70 | 4% | w/v | 5.05 | 5.29 | 53% | 1.041 | N/A | coagulant: 0.5% CaSO4 |
| 18 | 3.5 | 21.75 | 6 | 70 | 6% | w/v | 5.3 | 5.3 | 53% | 1.041 | N/A | |
| 19 | 3.5 | 23.1 | 5.5 | 50 | 4% | w/v | 4.5 | 5.34 | 52% | 1.0411 | N/A | |
| 20 | 3.5 | 21.15 | | 70 | 4% | w/v | 4.3 | 5.29 | 55% | 1.041 | N/A | 2% sugar |
| 21 | 3.5 | 23.9 | 5 | 80 | 1 | kg | 5.05 | 5.32 | 54% | 1.04 | 57% | |
| 22 | 3.5 | 21.25 | 5 | 70 | 1 | kg | 4.3 | 5.27 | 51% | 1.041 | 53% | 2% salt |
| 23 | 3.5 | 23.9 | 5 | 70 | 1 | kg | 4.65 | 5.25 | 48% | 1.043 | 59% | 100 IMCU rennet per liter |
| 24 | 3.5 | 22.1 | 5 | 50 | 1 | kg | 4.65 | 5.45 | 51% | 1.043 | 56% | |
| 25 | 3.5 | 22.05 | 5 | 70 | 1 | kg | 4.75 | 5.22 | 52% | 1.043 | 56% | |
| 26 | 3.5 | 20.35 | 6 | 70 | 940 | g | 4.65 | 5.33 | 55% | 1.043 | 55% | 1.7 g/L sodium citrate |
| 27 | 3.3 | 20.4 | 5 | 70 | 940 | g | 4.65 | 5.22 | 56% | 1.043 | 54% | coagulant: 0.3% CaCl2 |
| 28 | 3.3 | 22.5 | 5 | 60 | 940 | g | 4.35 | 5.36 | 53% | 1.044 | 54% | culture: MA series and TA6 |
| 29 | 3.3 | 23 | 5 | 60 | 940 | g | 4.15 | 5.26 | 49% | 1.045 | 56% | |
| 30 | 3.3 | 23.3 | 6 | 60 | 940 | g | 4.85 | 5.5 | 53% | 1.046 | 59% | |
| 31 | 3.3 | 21.75 | 5 | 70 | 940 | g | 4.1 | 5.37 | 53% | 1.047 | 51% | |
| 32 | 3.3 | 23 | 5 | 80 | 940 | g | 4.55 | 5.29 | 54% | 1.048 | 55% | |
| 36 | 3.3 | 21.05 | 6 | 75 | 940 | g | 4.85 | 5.47 | 53% | 1.045 | 59% | 2% sucrose |
| 37 | 3.2 | 20.9 | 5.5 | 85 | 940 | g | 4.85 | 5.81 | 54% | 1.045 | 58% | 2% sucrose |

N/A: information not available for this batch

TABLE 3B
Pressing protocols used to press the curds of the cheeses in Table 3A.

| Pressing | |
|---|---|
| Protocol No. | Pressing Protocol |
| 1.04 | (1) The curds were placed into tofu molds on a pneumatic cheese press until |
| | about 1 inch from the top of the mold. Multiple molds were stacked and |
| | allowed to drain for 5 min. |
| | (2) The order of the stack was reversed and allowed to drain for another 5 min. |
| | (3) The stack was pressed at 0.5 PSI for 5 min. |
| | (4) The curds were broken up and then pressed at 1 PSI for 5 min. |
| | (5) The curds were broken up and then pressed at 2 PSI for 5 min. |
| | (6) The curds were broken up and then pressed at 3 PSI for 5 min. |
| | (7) The curds were broken up and then pressed at 4 PSI for 5 min. |
| | (8) The curds were broken up and then pressed at 5 PSI for 5 min. |
| 1.041 | Same as 1.04, but with 3 final rounds of pressing at 5 PSI. |
| 1.0411 | Same as 1.04, but with 3 rounds at 4 PSI and 3 rounds at 5 PSI. |
| 1.043 | Same as 1.04, but with 4 rounds at 4 PSI and none at 5 PSI. |
| 1.044 | Same as 1.04, but with 5 rounds at 4 PSI for only 3 minutes each and no |
| | pressing rounds at 5 PSI. |
| 1.045 | Same as 1.044, but with 2 rounds at 1 PSI. The curds were first broken up after |
| | the first round at 1 PSI. The 3 PSI round was for 3 minutes, and the 5 rounds at |
| | 4 PSI were for 3 minutes each. |
| 1.046 | Same as 1.045, but all pressing rounds of 2 PSI and greater were for only 2 |
| | minutes each. |
| 1.047 | Same as 1.046, but the 2 PSI round was for 5 minutes, and six rounds were |
| | done at 4 PSI. |
| 1.048 | Same as 1.047, but only five rounds at 4 PSI. |

C. Cheeses Cultured with MA 4000 Series Starter Cultures

The cheeses in sections A and B above were primarily cultured with MA series cultures, which are widely used in dairy cheese production and contain only Lactococcus lactis subsp. lactis and Lactococcus lactis subsp. cremoris. Production of soy cheeses with MA series cultures resulted in a lactic-acid forward flavor of the final cheeses. By contrast, the MA 4000 series includes the L. lactis subsp. lactis and L. lactis subsp. cremoris of MA series cultures, as well as L. lactis subsp. cremoris, which is capable of producing buttery notes by converting citrate to diacetyl, and Streptococcus thermophiles, which produces additional flavor compounds and allows for bacterial activity at higher temperatures during the cheesemaking process.

To optimize for the development of more complex flavor and allow bacterial growth at a broader range of temperatures, a new set of cheeses was produced using the MA 4000 series cultures. These cheeses were produced from soybeans as described in section B above, with some modifications, as described below and shown in Table 4A. Soy milk was made according to the method described in section B, except for batches 39, 40, and 41, in which case a different protocol for production of soymilk (soymilk 2.0) was used. In this protocol, instead of direct grinding in the TSM-200 soybean grinder, soybeans were ground in small batches in a Vitamix A2500 at high speed (“smoothie” setting), grinding 550 g of soaked beans with 1.5 L of filtered water in each batch. This resulted in finer and more consistent particles in the final milk. After grinding, the resulting milk was passed through the TSM-200 twice to filter the slurry and remove the insoluble fibrous content as described in section A. The milk was then cooked and coconut oil and sucrose were added as in section A. Sodium citrate was added to batch 35 in an amount of 1.7 g per liter of soy milk at the same time that coconut oil and sucrose were added. All of these cheeses were inoculated with MA 4000 series cultures at a level of 5 DCU and cultured for the times shown in Table 4A. The culturing temperature for these cheeses was split, because MA4001 is a mix of mesophilic and thermophilic cultures. The cheeses were ripened for 80-100 min at 90° F./32° C., then at 100° F./38° C. for an additional period of 0-70 min, and then were also maintained at 100° F./38° C. during coagulation. Fat was added to batch 38 using the fat after press method described in section A. After culture and coagulation, the cheeses were pressed according to the methods in Table 4B. The variable ingredients and properties of the curds measured prior to salting and aging are shown in Table 4A, along with an estimate of the percent dry weight of soybean material in each cheese calculated as described in section B above. After pressing, the cheeses were salted, shaped, and aged as described in section B for 9-10 months.

Generally, the cheeses cultured with MA 4000 series cultures exhibited a more complex flavor than those cultured with MA series cultures. The MA 4000 series cultures also resulted in less acidic cheeses, although during the initial months of aging this acidic flavor remained the dominant flavor note. MA 4000 series cultures generally required more time during culturing compared to MA series cultures to develop the appropriate acid content.

TABLE 4A
Ingredients and curd properties of hard cheeses produced from soybeans that were cultured using MA 4000 series starter cultures.

| | | | | | | | | | | | Soy Bean | |
|---|---|---|---|---|---|---|---|---|---|---|---|---|
| | Soy | Milk | Milk | Culture | | | Curd | | Curd | | Material | |
| Batch | Beans | Weight | Brix | Time | Fat | Sugar | Mass | Curd | Moisture | Pressing | Content | |
| ID | (kg) | (kg) | (°Bx) | (min) | (g) | (% w/v) | (kg) | pH | (%) | Method | (% dry weight) | Notes |
| 33 | 3.3 | 23.85 | 5 | 80 | 940 | 4% | 4.6 | 5.45 | 55% | 1.045 | 55% | |
| 34 | 3.3 | 21.25 | 5.5 | 105 | 940 | 4% | 4.45 | 5.3 | 54% | 1.045 | 54% | |
| 35 | 3.3 | 22.65 | 5.5 | 170 | 940 | 4% | 4.95 | 5.03 | 57% | 1.045 | 56% | 1.7 g/L sodium citrate |
| 38 | 3.1 | 19.5 | 5 | 120 | 915 | 4% | 3.95 | 5.28 | 56% | 1.051 | 47% | fat after press method |
| 39 | 3 | 25.35 | 4.5 | 111 | 900 | 2% | 4.2 | 5.23 | 55% | 1.045 | 52% | soymilk 2.0 |
| 40 | 3 | 19.7 | 5.5 | 100 | 900 | 2% | 4.35 | 5.4 | 55% | 1.045 | 54% | soymilk 2.0 |
| 41 | 3 | 22.05 | 5 | 127 | 900 | 0 | 4.4 | 5.27 | 56% | 1.045 | 54% | soymilk 2.0 |

TABLE 4B
Pressing protocols used to press the curds of the cheeses in Table 4A.

| Pressing | |
|---|---|
| Protocol No. | Pressing Protocol |
| 1.045 | (1) The curds were placed into tofu molds on a pneumatic cheese press until |
| | about 1 inch from the top of the mold. Multiple molds were stacked and |
| | allowed to drain for 5 min. |
| | (2) The order of the stack was reversed and allowed to drain for another 5 min. |
| | (3) The stack was pressed at 0.5 PSI for 5 min. |
| | (4) The curds were broken up and then pressed at 1 PSI for 5 min. This step |
| | was repeated once for a total of two rounds. The curds were first broken up |
| | after the first round at 1 PSI. |
| | (5) The curds were broken up and then pressed at 2 PSI for 5 min. |
| | (6) The curds were broken up and then pressed at 3 PSI for 3 min. |
| | (7) The curds were broken up and then pressed at 4 PSI for 3 min. This step |
| | was repeated for a total of 5 rounds. |
| 1.051 | Same as 1.045 but only one round of pressing at 4 PSI. |

D. Cheeses Produced Using Microbial Rennet from Rhizomucor miehei

A variety of non-animal rennets are known to exhibit various properties, such as activity and relative retention in curds and whey. To test the effect of different rennets on the soy-based cheesemaking process, cultured, aged cheeses were produced from soybeans as described in section C above, with some modifications, described as follows and shown in Table 5A. Soy milk was produced according to the soymilk 2.0 protocol described in section C above. Ground soybeans for batches 49 and 55 were only passed through the TGM-200 okara separator only once, rather than twice, for filtration. Palm oil, rather than coconut oil, was added to batch 51. Batch 48 was treated with 20 g sodium citrate at the same time that fats and sugar were added. All of these cheeses were inoculated with MA 4000 series cultures at a level of 5 DCU, except for batch 55, which was inoculated with MA series cultures at 5 DCU. After culturing, all of these cheeses were treated with Supreme rennet (Dairy Connection Inc.), a heat-labile protease from the fungus Rhizomucor miehei, except for batch 47, which was treated with a mucorpepsin rennet derived from thistle (Liquid Vegetable Rennet, New England Cheesemaking Supply Co.). Rennet was added in an amount of about 50 IMCU per liter of soy milk. After culturing and coagulation, the curds were pressed using the methods described in Table 5B. The variable ingredients and properties of the curds measured after pressing are shown in Table 5A, along with an estimate of the percent dry weight of soybean material in each cheese calculated as described in section B above. The curds were then salted using the S/M technique described in section B above to a level of 5 S/M, except for batch 42, which was salted to a level of 6 S/M, and batch 43, which was not salted until after shaping. The salted curds were shaped, and batch 43 was salted after shaping by rubbing a layer of sea salt on the surface of the cheese. The cheeses were aged as described in section A above for 8-9 months.

TABLE 5A
Ingredients and curd properties of hard cheeses produced from soybeans that were treated with heat-labile native or recombinant microbial rennet.

| | | | | | | | | | | | | Soy Bean | |
|---|---|---|---|---|---|---|---|---|---|---|---|---|---|
| | Soy | Milk | Milk | Culture | | | | Curd | | Curd | | Material | |
| Batch | Beans | Weight | Brix | Time | Fat | Sugar | | Mass | Curd | Moisture | Pressing | Content | |
| ID | (kg) | (kg) | (°Bx) | (min) | (g) | (% w/v) | CaSO4 | (kg) | pH | (%) | Method | (% dry weight) | Notes |
| 42 | 3 | 24.85 | 5 | 95 | 900 | 4% | 0.3% | 4.6 | 5.53 | 59% | 1.045 | 52% | S/M = 6 |
| 43 | 3 | 23 | 5.5 | 110 | 900 | 4% | 0.3% | 5 | 5.28 | 59% | 1.045 | 56% | S/M = 5; dry salt |
| 44 | 3 | 21.6 | 5.5 | 105 | 0 | 4% | 66 g | 3.1 | 5.34 | 56% | 1.052 | 100% | |
| 45 | 3 | 21.85 | 5.5 | 116 | 900 | 2% | 66 g | 3.2 | 5.22 | 60% | 1.045 | 30% | |
| 46 | 3 | 22.45 | 5.5 | 110 | 800 | 2% | 66 g | 4.8 | 5.32 | 56% | 1.045 | 62% | |
| 47 | 3 | 21.1 | 5.5 | 115 | 800 | 2% | 66 g | 4.45 | 5.27 | 58% | 1.045 | 57% | rennet: murcopepsin |
| 48 | 3 | 20.65 | 5.5 | 115 | 400 | 2% | 66 g | 4.05 | 5.26 | 61% | 1.045 | 75% | 20 g sodium citrate |
| 49 | 2.75 | 20.05 | 5.5 | 110 | 800 | 2% | 66 g | 4.3 | 5.2 | 56% | 1.07 | 58% | single-filter |
| 50 | 3 | 20.95 | 5.5 | 105 | 400 | 2% | 66 g | 3.9 | 5.2 | 56% | 1.07 | 77% | |
| 51 | 3 | 20.6 | 5.5 | 105 | 400 | 2% | 66 g | 3.75 | 5.17 | 56% | 1.07 | 76% | fat: palm oil |
| 52 | 3 | 20.45 | 5.5 | 107 | 600 | 2% | 66 g | 4.35 | 5.28 | 59% | 1.07 | 66% | |
| 53 | 3 | 20.8 | 5.5 | 105 | 800 | 0 | 66 g | 4.4 | 5.18 | 62% | 1.07 | 52% | |
| 54 | 3 | 20.6 | 5.5 | 115 | 500 | 0 | 66 g | 3.9 | 5.39 | 60% | 1.07 | 68% | |
| 55 | 2.75 | 19.75 | 5 | 105 | 500 | 2% | 66 g | 3.644 | 5.29 | 54% | 1.07 | 70% | culture: MA series; |
| | | | | | | | | | | | | | single-filter |

TABLE 5B
Pressing protocols used to press the curds of the cheeses in Table 5A.

| Pressing | |
|---|---|
| Protocol | |
| No. | Pressing Protocol |
| 1.045 | (1) The curds were placed into tofu molds on a pneumatic cheese press until |
| | about 1 inch from the top of the mold. Multiple molds were stacked and allowed |
| | to drain for 5 min. |
| | (2) The order of the stack was reversed and allowed to drain for another 5 min. |
| | (3) The stack was pressed at 0.5 PSI for 5 min. |
| | (4) The curds were broken up and then pressed at 1 PSI for 5 min. This step was |
| | repeated once for a total of two rounds. The curds were first broken up after the |
| | first round at 1 PSI. |
| | (5) The curds were broken up and then pressed at 2 PSI for 5 min. |
| | (6) The curds were broken up and then pressed at 3 PSI for 3 min. |
| | (7) The curds were broken up and then pressed at 4 PSI for 3 min. This step was |
| | repeated for a total of 5 rounds. |
| 1.052 | Same as 1.045 but 2 rounds at 3 PSI and 4 rounds at 4 PSI. |
| 1.07 | (1) The curds were placed into tofu molds on a pneumatic cheese press until |
| | about 1 inch from the top of the mold. Stack them and let them drain for 5 min. |
| | (2) The order of the stack was reversed and allowed to drain for another 5 min. |
| | (3) The order of the stack was reversed and the stack was pressed at 0.5 PSI for |
| | 5 min. |
| | (4) The order of the stack was reversed and the stack was pressed at 1 PSI for 5 |
| | min. |
| | (5) The order of the stack was reversed, the curds were broken up, and the stack |
| | was pressed at 1 PSI for 5 min. |
| | (6) The order of the stack was reversed, the curds were broken up, and the stack |
| | was pressed at 2 PSI for 5 min. |
| | (7) The order of the stack was reversed, the curds were broken up, and the stack |
| | was pressed at 2.8 PSI for 3 min. |
| | (8) The order of the stack was reversed, the curds were broken up, and the stack |
| | was pressed at 3.5 PSI for 3 min. |
| | (9) The order of the stack was reversed, the curds were broken up, and the stack |
| | was pressed at 4 PSI for 3 min. This step was repeated once for a total of two |
| | rounds. |
| | (10) The order of the stack was reversed, the curds were broken up, and the |
| | stack was pressed at 4.5 PSI for 3 min. This step was repeated once for a total of |
| | two rounds. |

E. Cheeses Produced Using a Variety of Method from Cold-Soaked Soybeans

In soy milk production, the soybeans are often soaked in hot or boiling water prior to comminution in order to decrease the prominence of a “beany” taste in the resulting soy milk. However, coagulation may be negatively impacted by this method, and the “beany” taste of soybeans may be overpowered by stronger and more complex flavors in a cultured cheese.

In order to optimize the coagulation method of the production of soy-based cheese, soy cheeses were produced from soy milk made from cold-soaked, rather than hot-soaked, soybeans. Soybeans were soaked in cold water for a period of 12-16 hours and ground to produce soy milk as described in section C above, except that the ground beans were passed through the TGM-200 okara separator only once, rather than twice, for filtration. The resulting soy milk was then used to produce cheeses as described in section D above with some modifications as shown in Table 6A-6C and described below. Coconut oil was added to all batches in the amounts indicated in Table 6A-6C, except for batches 82 and 83, in which soybean oil was added in the amounts indicated. About 20 g (1% w/v) sodium citrate was added to batches 59 and 78 at the same time that fats and sugar were added. After the addition of fats and sugar, the soy milk was cultured with either MA series, MA 4000 series, Therm C201, TA61, Su Casu, or Kazu cultures, as indicated in Table 6A, with each batch receiving a total of 5 DCU, except for batch 62, which received 2 g of culture. To determine the effect of additional starter culture enzymes on flavor profile without additional living culture, batches 63 and 75 received an additional 20 g of heat-killed starter culture. The cultured milk was treated with a mixture of Supreme and Star rennets, except for batches 56-60, which were treated with Supreme rennet only. Rennet was added in an amount of about 50 IMCU per liter, except for batch 85, which received 100 IMCU per liter. Rennet was added after culturing but before pressing, except for some batches, for which the rennet was added at different times, as described in the “Notes” column of Table 6A and Table 6B. The curds were then pressed according to the methods described in Table 6D. The variable ingredients and properties of the curds measured after pressing are shown in Table 6A-6C, along with an estimate of the percent dry weight of soybean material in each cheese calculated as described in section B above. After pressing, the curds were then salted using the S/M technique described in section B to a level of 5 S/M and were shaped into wheels as described in section A. For batch 65, rennet was added only after pressing and salting the curds in a total amount of 150 IMCU each of Star and Supreme rennet. Because the rennets were dissolved in 37 mL of filtered water, corresponding to about 1% of the curd weight, this was estimated to have increased the moisture content of the curds by about 1% just prior to shaping.

After shaping, various methods of rind formation were applied to the cheeses prior to aging. The cheeses in Table 6A were aged for 7 to 9 months using a natural rind formation method as described in section A, except for batches 70 and 80, which were vacuum-sealed in plastic prior to aging. The cheeses in Table 6B were aged using a bandaged rind formation method and were aged for 4 to 7 months. The cheeses in Table 6C were and aged after the addition of a polymer coating, a foil wrap, and/or a wax coating. The rind formation methods are described in Table 6E.

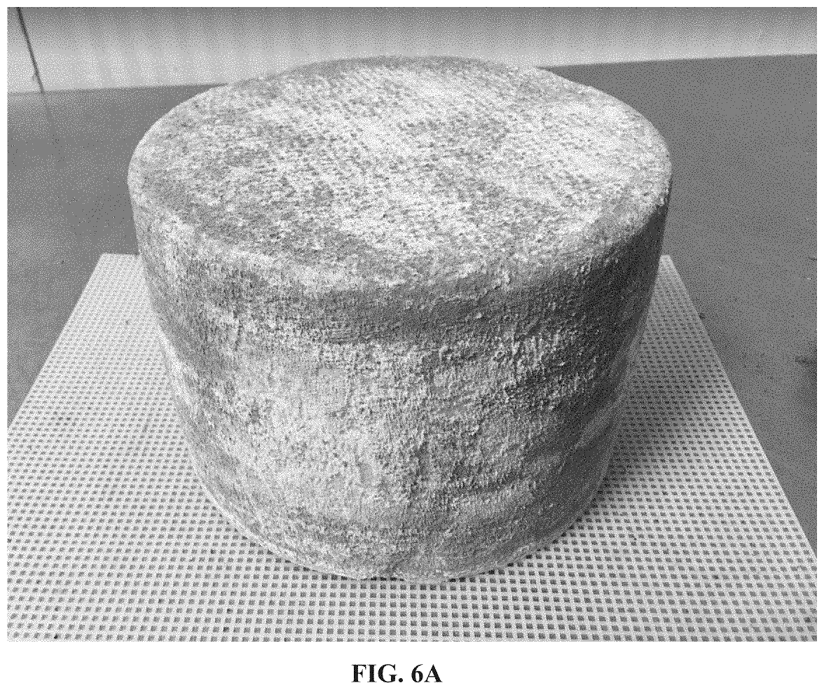

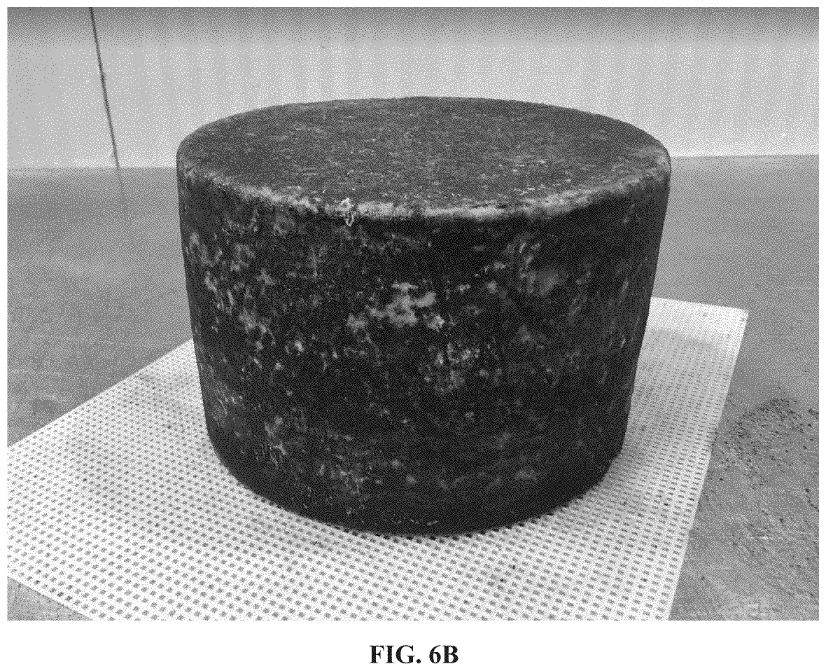

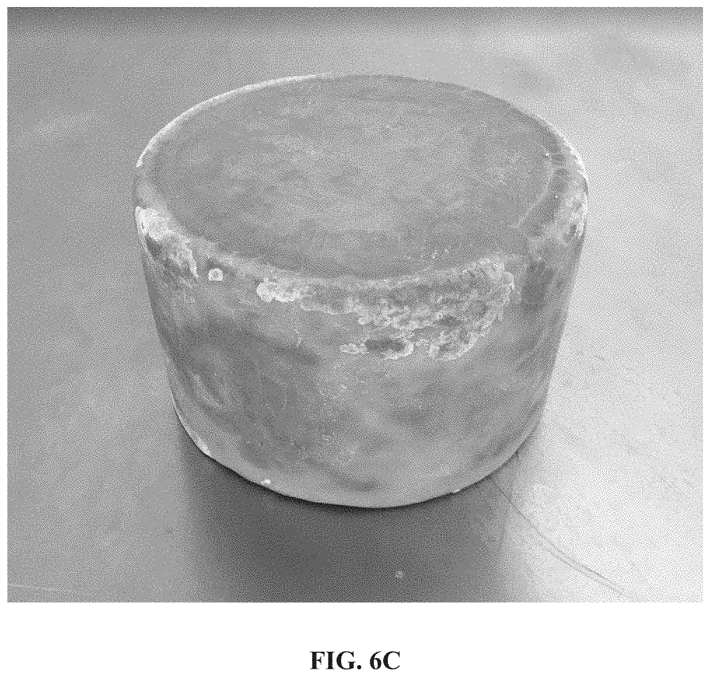

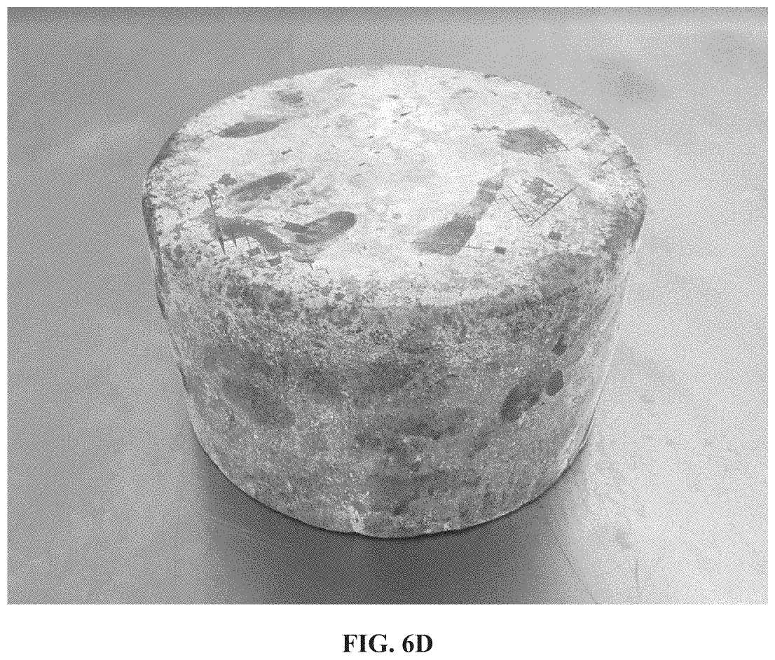

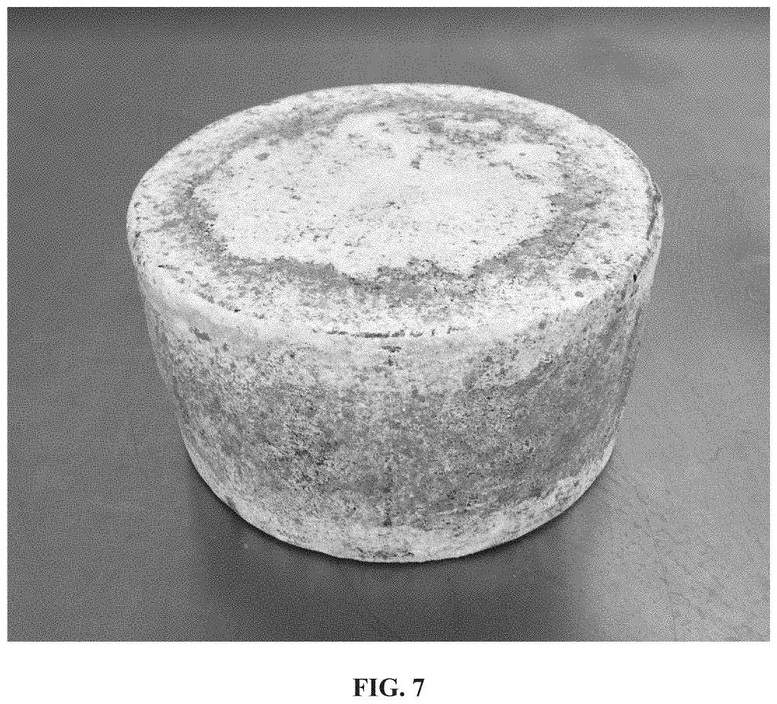

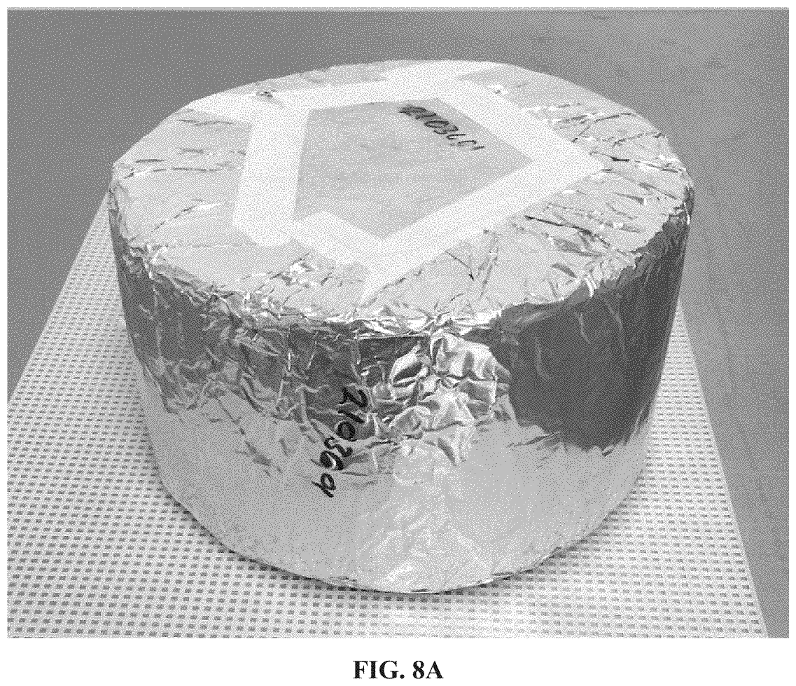

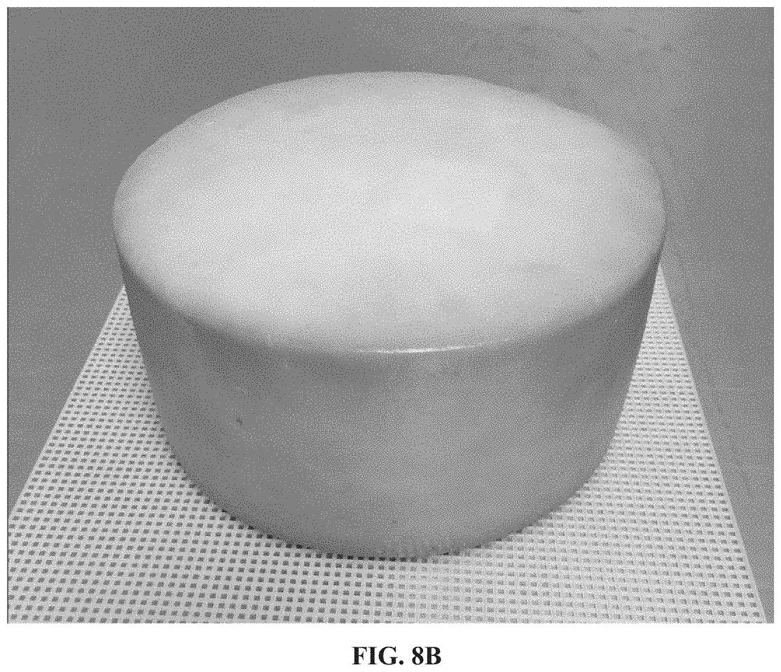

Cold-soaking the soybeans used to produce the soy milk led to more efficient coagulation of the curds after culturing without adding a noticeable beany taste. This may have been because the flavor development of the culturing of the cheese overpowered any beany taste present. Bandaged rinds exhibited fewer cracks forming in the rind of the cheeses, which can result from rapid drying of natural rind cheeses. The bandaged rinds also had a different type of visual rind development, favoring light-grey molds rather than the darker molds more common on the natural rind cheeses. Vacuum-sealed cheeses had no such rind formation. Examples of natural rind cheeses are shown in FIG. 6A-6D. An example of a bandaged-rind cheese is shown in FIG. 7. Examples of cheeses with a polymer coating are shown in FIG. 8A-8B. FIG. 8A shows a cheese that has been given a polymer coating and a foil wrap. FIG. 8B shows a cheese that has been given a polymer coating.

TABLE 6A
Ingredients and curd properties of hard cheeses produced from soybeans by a variety
of methods and aged using the natural rind and vacuum sealing methods.

| | | | | | | | | | | | | | Soy Bean | |
|---|---|---|---|---|---|---|---|---|---|---|---|---|---|---|
| | | | | | | | | | | | | | Material | |
| | Soy | Milk | Milk | | Culture | | Sugar | | Curd | | Curd | | Content | |
| Batch | Beans | Weight | Brix | | Time | Fat | (% | CaSO4 | Mass | Curd | Moisture | Pressing | (% dry | |
| ID | (kg) | (kg) | (°Bx) | Culture | (min) | (g) | w/v) | (g) | (kg) | pH | (%) | Method | weight) | Notes |
| 56 | 2.75 | 20.6 | 9.5 | ma4001 | 95 | 500 | 2% | 66 | 3.6 | 5.45 | 54% | 1.07 | 70% | rennet: supreme |
| | | | | | | | | | | | | | | only |
| 57 | 3 | 22 | 9.5 | ma4002 | 115 | 600 | 2% | 72 | 4 | 5.36 | 53% | 1.07 | 68% | rennet: supreme |
| | | | | | | | | | | | | | | only |
| 58 | 2.75 | 20.01 | 10 | ma4001 | 150 | 500 | 2% | 66 | 3.55 | 5.22 | 52% | 1.07 | 71% | rennet: supreme |
| | | | | | | | | | | | | | | only |
| 59 | 2.75 | 20.01 | 10 | ma4001 | 150 | 500 | 2% | 100 | 3.616 | 5.27 | 53% | 1.07 | 71% | rennet: supreme |
| | | | | | | | | | | | | | | only; 20 g sodium |
| | | | | | | | | | | | | | | citrate added |
| 60 | 2.75 | 20.11 | 8.5 | ma4001 | 170 | 500 | 2% | 66 | 3.582 | 5.21 | 53% | 1.09 | 70% | rennet: supreme |
| | | | | | | | | | | | | | | only |
| 61 | 2.75 | 20.299 | 9.5 | ma4001 | 170 | 500 | 2% | 66 | 3.602 | 5.18 | 51% | 1.09 | 72% | |
| 62 | 2.75 | 21.49 | 9.5 | Therm C201 | N/A | 600 | 2% | 66 | 3.634 | 5 | 50% | 1.09 | 67% | culture amount: 2 g |
| 63 | 2.75 | 20.302 | 10 | ma4001/ | 165 | 600 | 2% | 66 | 3.816 | 5.22 | 52% | 1.09 | 67% | 20 g heat-killed |
| | | | | ma11 | | | | | | | | | | MA11 |
| 64 | 2.75 | 19.2 | 10.5 | ma4001 | 165 | 600 | 2% | 66 | 3.746 | 5.25 | 50% | 1.09 | 68% | |
| 65 | 2.75 | 20.252 | 9.5 | ma4001 | 165 | 600 | 2% | 66 | 3.76 | 5.27 | 50% | 1.09 | 68% | rennet added after |
| | | | | | | | | | | | | | | salting, adding ~1% |
| | | | | | | | | | | | | | | mositure for ~51% |
| | | | | | | | | | | | | | | moisture total |
| 66 | 2.75 | 20.058 | 10 | ma4001 | 165 | 600 | 2% | 66 | 4.084 | 5.26 | 56% | 1.09 | 67% | |
| 67 | 2.75 | 19.572 | 10 | ma4001 | 165 | 600 | 2% | 66 | 3.702 | 5.25 | 53% | 1.09 | 66% | |
| 68 | 2.8 | 19.895 | 10 | ma4001 | 155 | 600 | 2% | 66 | 3.814 | 5.28 | 53% | 1.09 | 67% | |
| 69 | 2.8 | 20.531 | 9.5 | ma4001 | 160 | 600 | 2% | 66 | 3.9 | 5.22 | 53% | 1.09 | 67% | rennet added at |
| | | | | | | | | | | | | | | beginning of |
| | | | | | | | | | | | | | | culturing |
| 70 | 2.8 | 19.939 | 10 | ma4001 | 160 | 600 | 0% | 66 | 4.124 | 5.27 | 56% | 1.09 | 67% | aged vacuum sealed |
| 71 | 2.8 | 19.142 | 9.5 | ma4001 | 160 | 600 | 2% | 66 | 3.57 | 5.18 | 51% | 1.09 | 66% | |
| 72 | 2.8 | 20.15 | 10 | ma4001 | 160 | 600 | 2% | 66 | 3.82 | 5.2 | 52% | 1.09 | 67% | |
| 73 | 2.8 | 20.5 | 9.5 | ma4001 | 165 | 600 | 0% | 66 | 3.698 | 5.24 | 51% | 1.09 | 67% | |
| 74 | 2.7 | 19.396 | 10 | ma4001 | 165 | 600 | 0% | 66 | 3.744 | 5.25 | 51% | 1.09 | 67% | |
| 75 | 2.75 | 20.233 | 10 | ma4001 | 160 | 600 | 2% | 66 | 3.772 | 5.17 | 51% | 1.09 | 68% | 20 g heat-killed |
| | | | | | | | | | | | | | | MA14 |
| 76 | 2.8 | 19.65 | 10.5 | ma4001 | 165 | 500 | 2% | 66 | 3.63 | 5.22 | 50% | 1.09 | 72% | |
| 77 | 2.8 | 19.45 | 9 | ma4001 | 160 | 500 | 0% | 66 | 3.368 | 5.19 | 50% | 1.09 | 70% | |
| 78 | 2.8 | 19.32 | 10.5 | ma4001 | 170 | 500 | 2% | 80 | 3.556 | 5.17 | 50% | 1.09 | 72% | rennet added after |
| | | | | | | | | | | | | | | 80 min culturing; |
| | | | | | | | | | | | | | | 20 g sodium citrate |
| | | | | | | | | | | | | | | added |
| 80 | 2.8 | 20.75 | 9.5 | ma4001 | 170 | 500 | 0% | 66 | 3.584 | 5.2 | 53% | 1.09 | 70% | rennet added at |
| | | | | | | | | | | | | | | start of culturing; |
| | | | | | | | | | | | | | | aged vacuum sealed |
| 81 | 2.8 | 20.65 | 9 | ma11 | 105 | 500 | 0% | 66 | 3.584 | 5.27 | 52% | 1.09 | 71% | rennet added at |
| | | | | | | | | | | | | | | start of culturing |
| 82 | 2.8 | 19.65 | 10 | ma11 | 115 | 500 | 2% | 66 | 3.534 | 5.26 | 50% | 1.09 | 72% | fat: soybean oil; |
| | | | | | | | | | | | | | | rennet added at |
| | | | | | | | | | | | | | | start of culturing |
| 83 | 2.75 | 20.6 | 9.5 | ma11 | 120 | 500 | 0% | 66 | 3.572 | 5.23 | 52% | 1.09 | 71% | fat: soybean oil; |
| | | | | | | | | | | | | | | rennet added at |
| | | | | | | | | | | | | | | start of culturing |
| 84 | 2.8 | 20.35 | | ma11 | 135 | 500 | 0% | 66 | 3.53 | 5.31 | 51% | 1.09 | 71% | |

TABLE 6B
Ingredients and curd properties of hard cheeses produced from soybeans by a variety of methods and aged using the bandaged rind method.

| | | | | | | | | | | | | | Soy Bean | |
|---|---|---|---|---|---|---|---|---|---|---|---|---|---|---|
| | | | | | | | | | | | | | Material | |
| | Soy | Milk | Milk | | Culture | | Sugar | | Curd | | Curd | | Content | |
| Batch | Beans | Weight | Brix | | Time | Fat | (% | CaSO4 | Mass | Curd | Moisture | Pressing | (% dry | |
| ID | (kg) | (kg) | (°Bx) | Culture | (min) | (g) | w/v) | (g) | (kg) | pH | (%) | Method | weight) | Notes |
| 79 | 2.8 | 20.65 | 8 | ma4001 | 160 | 500 | 1% | 66 | 3.558 | 5.18 | 52% | 1.09 | 71% | rennet added at |
| | | | | | | | | | | | | | | start of culturing |
| 85 | 2.8 | 20.3 | 10 | ma11 | 155 | 500 | 0% | 66 | 3.552 | 5.05 | 52% | 1.09 | 71% | 100 IMCU/L |
| | | | | | | | | | | | | | | rennet, added at |
| | | | | | | | | | | | | | | start of culturing |
| 86 | 2.8 | 20.6 | 9.5 | ma11 | 140 | 500 | 0% | 66 | 3.55 | 5.11 | 52% | 1.09 | 71% | |
| 87 | 2.8 | 20.7 | 9.5 | ma11 | 130 | 500 | 0% | 66 | 3.492 | 5.24 | 51% | 1.091 | 71% | |
| 88 | 2.8 | | 9.5 | ma11, ta61 | 130 | 500 | 0% | 66 | 3.47 | 5.3 | 50% | 1.091 | 71% | |
| 89 | 2.8 | 21.15 | 9.5 | ma11, ta61 | 135 | 500 | 2% | 66 | 3.55 | 5.23 | 50% | 1.092 | 72% | |
| 90 | 2.8 | 20.5 | 10 | ma11 | 130 | 500 | 2% | 67 | 3.638 | 5.22 | 52% | 1.092 | 71% | |
| 91 | 2.8 | 20.75 | 9 | ma4002 | 170 | 500 | 0% | 68 | 3.596 | 5.33 | 52% | 1.092 | 71% | |
| 92 | 2.8 | 20.45 | 10 | ma4002 | 180 | 500 | 1% | 68 | 3.652 | 5.25 | 52% | 1.092 | 71% | |
| 93 | 2.8 | 20.65 | 10 | ma11, ta61 | 145 | 500 | 0% | 68 | 3.634 | 5.29 | 52% | 1.092 | 71% | |
| 94 | 2.8 | 20.3 | 10 | ma11, ta61 | 145 | 500 | 0% | 67 | 3.576 | 5.27 | 52% | 1.092 | 71% | |
| 95 | 2.8 | 19.95 | 9.5 | ma11, ta61 | 160 | 500 | 0% | 66 | 3.332 | 5.27 | 48% | 1.093 | 71% | |
| 96 | 2.8 | 20.3 | 10 | ma11, ta61 | 175 | 500 | 0% | 67 | 3.766 | 5.28 | 53% | 1.011 | 72% | |
| 97 | 2.8 | 20.2 | 10 | ma4001 | 185 | 500 | 0% | 67 | 3.648 | 5.3 | 53% | 1.093 | 71% | |
| 98 | 2.8 | 20.5 | 10 | ma4001 | 190 | 500 | 0% | 68 | 3.436 | 5.26 | 53% | 1.093 | 69% | |
| 99 | 2.8 | 20.4 | 10 | SU CASU | 177 | 500 | 0% | 67 | 3.424 | 5.09 | 51% | 1.093 | 70% | |
| 104 | 2.8 | 20.55 | 9.5 | KAZU, TA61 | 210 | 500 | 0% | 68 | 3.73 | 5.19 | 54% | 1.012 | 71% | |
| 105 | 2.8 | 20.2 | 10 | ma4001, raw | 190 | 500 | 0% | 67 | 3.65 | 5.32 | 54% | 1.012 | 70% | |
| | | | | soy | | | | | | | | | | |

N/A: information not available for this batch

TABLE 6C
Ingredients and curd properties of hard cheeses produced from soybeans
by a variety of methods and aged using the polymer coating rind method.

| | Soy | Milk | | | Culture | | | | Curd | | Curd | |
|---|---|---|---|---|---|---|---|---|---|---|---|---|
| Batch | Beans | Weight | Milk | | Time | Fat | Sugar | CaSO4 | Mass | Curd | Moisture | |
| ID | (kg) | (kg) | Brix | Culture | (min) | (a) | (g) | (g) | (kg) | pH | (%) | Rind |
| 106 | 2.4 | 16.624 | 10.5 | ma4001 | 210 | 660 | 0 | 72 | 3.426 | 5.19 | 50% | polymer coating |
| 107 | 2.5 | 17.232 | 10.5 | ma4001 | 180 | 688 | 0 | 75 | 3.498 | 5.3 | 50% | polymer coating, foil |
| 108 | 2.5 | 17.164 | 10.5 | ma4001 | 195 | 868 | 0 | 75 | 3.708 | 5.3 | 50% | polymer coating, wax |

TABLE 6D
Pressing protocols used to press the curds of the cheeses in Table 6A and 6B.

| Pressing | |
|---|---|
| Protocol No. | Pressing Protocol |
| 1.07 | (1) The curds were placed into tofu molds on a pneumatic cheese press until |
| | about 1 inch from the top of the mold. The molds were then stacked and |
| | allowed to drain for 5 min. |
| | (2) The order of the stack was reversed and allowed to drain for another 5 min. |
| | (3) The order of the stack was reversed and the stack was pressed at 0.5 PSI |
| | for 5 min. |
| | (4) The order of the stack was reversed and the stack was pressed at 1 PSI for |
| | 5 min. |
| | (5) The order of the stack was reversed, the curds were broken up, and the |
| | stack was pressed at 1 PSI for 5 min. |
| | (6) The order of the stack was reversed, the curds were broken up, and the |
| | stack was pressed at 2 PSI for 5 min. |
| | (7) The order of the stack was reversed, the curds were broken up, and the |
| | stack was pressed at 2.8 PSI for 3 min. |
| | (8) The order of the stack was reversed, the curds were broken up, and the |
| | stack was pressed at 3.5 PSI for 3 min. |
| | (9) The order of the stack was reversed, the curds were broken up, and the |
| | stack was pressed at 4 PSI for 3 min. This step was repeated once for a total of |
| | two rounds. |
| | (10) The order of the stack was reversed, the curds were broken up, and the |
| | stack was pressed at 4.5 PSI for 3 min. This step was repeated once for a total |
| | of two rounds. |
| 1.09 | (1) The curds were placed into tofu molds on a pneumatic cheese press until |
| | about 1 inch from the top of the mold. The molds were then stacked, and the |
| | stack was pressed at 0.5 PSI for 5 min. |
| | (2) The order of the stack was reversed and the stack was pressed at 1 PSI for |
| | 5 min. |
| | (3) The order of the stack was reversed, the curds were broken up, and the |
| | stack was pressed at 1 PSI for 5 min. |
| | (4) The order of the stack was reversed, the curds were broken up, and the |
| | stack was pressed at 2 PSI for 5 min. |
| | (5) The order of the stack was reversed, the curds were broken up, and the |
| | stack was pressed at 3 PSI for 3 min. |
| | (6) The order of the stack was reversed, the curds were broken up, and the |
| | stack was pressed at 4 PSI for 3 min. This step was repeated once for a total of |
| | two rounds. |
| | (7) The order of the stack was reversed, the curds were broken up, and the |
| | stack was pressed at 4.5 PSI for 3 min. This step was repeated once for a total |
| | of two rounds. |
| 1.091 | Same as 1.09 but with 3 pressing rounds at 4.5 PSI. |
| 1.092 | Same as 1.091 but with 2 pressing rounds at 2 PSI. |
| 1.093 | (1) The curds were placed into tofu molds on a pneumatic cheese press until |
| | about 1 inch from the top of the mold. The molds were then stacked, and the |
| | stack was pressed at 0.5 PSI for 3 min. |
| | (2) The order of the stack was reversed and the stack was pressed at 1 PSI for |
| | 3 min. |
| | (3) The order of the stack was reversed, the curds were broken up, and the |
| | stack was pressed at 1 PSI for 3 min. |
| | (4) The order of the stack was reversed, the curds were broken up, and the |
| | stack was pressed at 2 PSI for 3 min. |
| | (5) The order of the stack was reversed, the curds were broken up, and the |
| | stack was pressed at 3 PSI for 3 min. |
| | (6) The order of the stack was reversed, the curds were broken up, and the |
| | stack was pressed at 4 PSI for 3 min. This step was repeated once for a total of |
| | two rounds. |
| | (7) The order of the stack was reversed, the curds were broken up, and the |
| | stack was pressed at 4.5 PSI for 3 min. This step was repeated twice for a total |
| | of three rounds. |
| 1.011 | Same as 1.093 but only 2 minutes for all pressing rounds and only 2 rounds of |
| | pressing at 4.5 PSI. |
| 1.012 | Same as 1.093 except that the curds were not broken up in step (3) and the |
| | pressing was only performed once (not repeated) in step (6). |

TABLE 6E
Rind formation methods used after shaping for the cheeses in Tables 6 A and 6B.

| Method Name | Method Description |
|---|---|
| Natural | Each shaped cheese was allowed to dry for a period of up to 14 days or until a |
| | slight rind had formed. This initial rind felt drier than the original curds to the |
| | touch. After the initial rind formation, the cheese was rubbed with a vegetable |
| | oil, which may have included coconut oil, olive oil, or soybean oil. The cheese |
| | was rubbed until the surface was covered but no excess oil remained on the |
| | surface of the cheese. This process was repeated every two days during the |
| | early stages of aging (the first 2 months). During this period, the cheese was |
| | flipped daily and brushed gently with a brush to moderate mold growth. In |
| | these first months, each cheese lost moisture and shrank in size, and a rind |
| | formed. The rind was formed by fuzzy molds, a softer growth of yeasts and |
| | other bacteria, and/or a hardened version of the curds. After the first two |
| | months, frequency of applying oil was decreased to once a week and the |
| | frequency of flipping and brushing decreased to twice a week. |
| Vac-Seal | The shaped cheeses were removed from their shaping molds and vacuum |
| | sealed in plastic or a similar polymer membrane prior to aging. Each cheese |
| | was still flipped as with the natural rind cheeses, but no further effort was |
| | made to maintain the cheese or its rind. If desired, cheeses can be allowed to |
| | form an initial rind like for natural-rind cheese before vacuum sealing to |
| | control moisture. |
| Bandaged | The shaped cheeses were removed from their shaping molds. If desired, the |
| | cheeses can be allowed to form an initial rind like for natural-rind cheeses |
| | before bandaging. Cheesecloth was cut to size for each wheel. If an oil was |
| | used that is solid at room temperature (like coconut oil), the oil was heated to |
| | remove microbial load and to liquefy the oil. Each piece of cheesecloth was |
| | soaked in the oil before being applied to the wheel. The surfaces of the cloth |
| | were smoothed out to remove any air bubbles and ensure that each cloth was |
| | fully saturated with fat. Multiple layers of cheesecloth can be used, with |
| | greater numbers of layers corresponding to slower rates of moisture loss |
| | during aging. Once the cheese was wrapped fully, the cheese was replaced in |
| | the shaping mold and pressed at the final pressure that was used to shape the |
| | cheese. The bandaged cheese was thus pressed overnight, allowing the cloth to |
| | bind to the cheese. The cheese was then removed from the mold and placed in |
| | an aging space. In a few weeks, each cheese began to develop a mold covering |
| | on the cloth. As with natural rind cheeses, each cheese was brushed and |
| | flipped every day during the first two months of aging. After this period, |
| | brushing and flipping occurred only twice a week. |
| Polymer coating | After shaping, the curds were optionally allowed to dry in an aging space for a |
| | period of 1-7 days. After this period or immediately after shaping, the curds |
| | were coated with a polymer polyvinylacetate coating using a sponge. Multiple |
| | layers were generally applied during this first coating. Once coated, the shaped |
| | curds were then moved into an appropriate aging space. After the first coat, |
| | cheeses can be coated additional times to regulate moisture loss, or cheeses |
| | can be later protected from moisture loss by coating with wax, foil, bandages, |
| | or plastic bags/barriers. |
| Foil | Usually after an initial drying or aging period of 1-30 days, cheeses can be |
| | wrapped and sealed in foil to limit moisture loss and gas exchange. |
| Wax | After an optional drying phase where cheeses are allowed to dry for 1-30 |
| | days, cheeses can be coated in wax to seal in moisture. Cheeses that have |
| | previously been polymer coated can also be waxed. Low-temperature and high |
| | temperature waxes are available. |

F. Weight, Moisture Content, and Volume Reduction of Cheeses after Aging

Cheeses produced in sections A through E above were weighed after aging, and moisture content was estimated based on the measured mass of the aged cheeses. The moisture content measurements were approximate because small core samples of the cheese had been consumed for taste testing, corresponding to less than 5% of the weight of the cheese. Additionally, a portion of the weight loss may have been due to loss of carbon as carbon dioxide gas resulting from the metabolic activity of microbial cultures during aging. Nonetheless, these measurements provide approximate moisture contents after aging and suggest trends in the aging of these cheeses over time.

Estimated water content of each cheese was estimated by subtracting the weight lost from the starting moisture content of the cheese as follows:

[(curd % moisture)×(curd mass (kg))]−(weight lost (kg))=(water content (kg))

Next, the curd dry weight was calculated as follows:

(curd mass (kg))×[1−(curd % moisture)]=(dry weight (kg))

Assuming that curd dry weight is stable over time, the final moisture content of the aged cheese was calculated as follows:

(water content (kg))/[(dry weight (kg))+(water content (kg))]=final % moisture

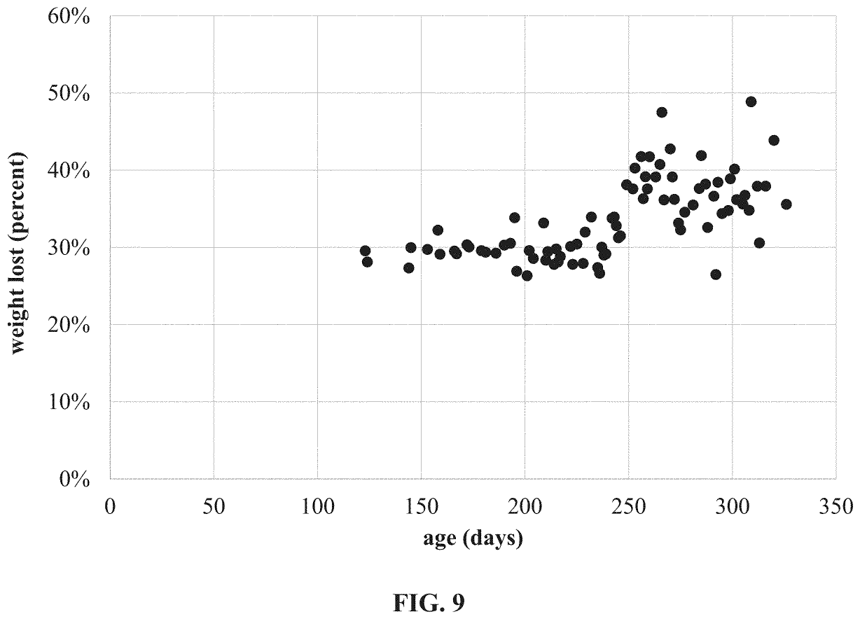

The weight measurements and moisture calculations of the aged cheeses are shown in Table 7A. The overall moisture content of the aged cheeses range from approximately 10% to approximately 36%. The cheeses made from soy beans soaked in cold water (produced in section E) lost about 30% of their weight in the first four months of aging, resulting in moisture contents in the range of approximately 30-40%. Most of the older cheeses produced in sections C and D also exhibited moisture contents in this range, suggesting that the cheeses may have stabilized at a moisture content of between 25-40%. Most of the oldest cheeses produced in sections A and B show moisture contents of approximately 10-30%, suggesting that they continued to lose moisture beyond the first four months. A plot of cheese age and moisture content is shown in FIG. 9.

The reduction in volume of the aged cheeses over time was also estimated as shown in Table 7B. The diameter and height of each cheese wheel was measured after aging, and the final diameter of each cheese was expressed as a percentage of the original diameter (7.875 inches; “Percent Original Diameter”). The percent original diameter was then cubed in order to estimate the volume loss of each cheese over time (“Percent Original Volume”), as cheese wheel height data was unavailable. As discussed in section A, the cheeses exhibited a noticeable decrease in volume over time, typically around 30-40% (Table 7B).

TABLE 7A
Weight and estimated moisture content of aged soy-based cheeses.

| | Example 3 | Starting | Starting | Measured | | | Weight | Weight | Estimated | Estimated |
|---|---|---|---|---|---|---|---|---|---|---|
| | Methods | Curd Mass | Curd Moisture | Mass | Age at Measurement | | Lost | Lost | Water Content | Moisture |
| Batch | Section | (Kg) | Content | (g) | days | months | (g) | (%) | (kg) | Content |
| 12 | A | 4 | 48% | 2577 | 326 | 11 | 1423 | 36% | 0.50 | 19% |
| 15 | B | 5.1 | 53% | 2863 | 320 | 11 | 2237 | 44% | 0.47 | 16% |
| 17 | B | 5.05 | 53% | 3134 | 316 | 11 | 1916 | 38% | 0.76 | 24% |
| 19 | B | 4.5 | 52% | 3124 | 313 | 10 | 1376 | 31% | 0.96 | 31% |
| 20 | B | 4.3 | 55% | 2669 | 312 | 10 | 1631 | 38% | 0.73 | 28% |
| 21 | B | 5.05 | 54% | 2582 | 309 | 10 | 2468 | 49% | 0.26 | 10% |
| 22 | B | 4.3 | 51% | 2803 | 308 | 10 | 1497 | 35% | 0.70 | 25% |
| 23 | B | 4.65 | 48% | 2941 | 306 | 10 | 1709 | 37% | 0.52 | 18% |
| 24 | B | 4.65 | 51% | 2994 | 305 | 10 | 1656 | 36% | 0.72 | 24% |
| 25 | B | 4.75 | 52% | 3031 | 302 | 10 | 1719 | 36% | 0.75 | 25% |
| 26 | B | 4.65 | 55% | 2783 | 301 | 10 | 1867 | 40% | 0.69 | 25% |
| 27 | B | 4.65 | 56% | 2841 | 299 | 10 | 1809 | 39% | 0.80 | 28% |
| 28 | B | 4.35 | 53% | 2837 | 298 | 10 | 1513 | 35% | 0.79 | 28% |
| 29 | B | 4.15 | 49% | 2723 | 295 | 10 | 1427 | 34% | 0.61 | 22% |
| 30 | B | 4.85 | 53% | 2986 | 293 | 10 | 1864 | 38% | 0.71 | 24% |
| 31 | B | 4.1 | 53% | 3014 | 292 | 10 | 1086 | 26% | 1.09 | 36% |
| 32 | B | 4.55 | 54% | 2883 | 291 | 10 | 1667 | 37% | 0.79 | 27% |
| 33 | C | 4.6 | 55% | 3101 | 288 | 10 | 1499 | 33% | 1.03 | 33% |
| 34 | C | 4.45 | 54% | 2750 | 287 | 10 | 1700 | 38% | 0.70 | 26% |
| 35 | C | 4.95 | 57% | 2876 | 285 | 10 | 2074 | 42% | 0.75 | 26% |
| 36 | B | 4.85 | 53% | 3025 | 284 | 9 | 1825 | 38% | 0.75 | 25% |
| 37 | B | 4.85 | 54% | 3128 | 281 | 9 | 1722 | 36% | 0.90 | 29% |
| 38 | C | 3.95 | 56% | 2585 | 277 | 9 | 1365 | 35% | 0.85 | 33% |
| 39 | C | 4.2 | 55% | 2844 | 275 | 9 | 1356 | 32% | 0.95 | 34% |
| 40 | C | 4.35 | 55% | 2908 | 274 | 9 | 1442 | 33% | 0.95 | 33% |
| 41 | C | 4.4 | 56% | 2806 | 272 | 9 | 1594 | 36% | 0.87 | 31% |
| 42 | D | 4.6 | 59% | 2800 | 271 | 9 | 1800 | 39% | 0.91 | 33% |
| 43 | D | 5 | 59% | 2862 | 270 | 9 | 2138 | 43% | 0.81 | 28% |
| 44 | D | 3.1 | 56% | 1979 | 267 | 9 | 1121 | 36% | 0.62 | 31% |
| 45 | D | 3.2 | 60% | 1680 | 266 | 9 | 1520 | 48% | 0.40 | 24% |
| 46 | D | 4.8 | 56% | 2844 | 265 | 9 | 1956 | 41% | 0.73 | 26% |
| 47 | D | 4.45 | 58% | 2709 | 263 | 9 | 1741 | 39% | 0.84 | 31% |
| 48 | D | 4.05 | 61% | 2359 | 260 | 9 | 1691 | 42% | 0.78 | 33% |
| 49 | D | 4.3 | 56% | 2684 | 259 | 9 | 1616 | 38% | 0.79 | 30% |
| 50 | D | 3.9 | 56% | 2373 | 258 | 9 | 1527 | 39% | 0.66 | 28% |
| 51 | D | 3.75 | 56% | 2388 | 257 | 9 | 1362 | 36% | 0.74 | 31% |
| 52 | D | 4.35 | 59% | 2533 | 256 | 9 | 1817 | 42% | 0.75 | 30% |
| 53 | D | 4.4 | 62% | 2628 | 253 | 8 | 1772 | 40% | 0.96 | 36% |
| 54 | D | 3.9 | 60% | 2434 | 252 | 8 | 1466 | 38% | 0.87 | 36% |
| 55 | D | 3.644 | 54% | 2255 | 249 | 8 | 1389 | 38% | 0.58 | 26% |
| 56 | E | 3.6 | 54% | 2466 | 246 | 8 | 1134 | 32% | 0.81 | 33% |
| 57 | E | 4 | 53% | 2750 | 245 | 8 | 1250 | 31% | 0.87 | 32% |
| 58 | E | 3.55 | 52% | 2385 | 244 | 8 | 1165 | 33% | 0.68 | 29% |
| 59 | E | 3.616 | 53% | 2389 | 243 | 8 | 1227 | 34% | 0.69 | 29% |
| 60 | E | 3.582 | 53% | 2372 | 242 | 8 | 1210 | 34% | 0.69 | 29% |
| 61 | E | 3.602 | 51% | 2552 | 239 | 8 | 1050 | 29% | 0.79 | 31% |
| 62 | E | 3.634 | 50% | 2580 | 238 | 8 | 1054 | 29% | 0.76 | 30% |
| 63 | E | 3.816 | 52% | 2670 | 237 | 8 | 1146 | 30% | 0.84 | 31% |
| 64 | E | 3.746 | 50% | 2748 | 236 | 8 | 998 | 27% | 0.88 | 32% |
| 65 | E | 3.76 | 50% | 2730 | 235 | 8 | 1030 | 27% | 0.85 | 31% |
| 66 | E | 4.084 | 56% | 2698 | 232 | 8 | 1386 | 34% | 0.90 | 33% |
| 67 | E | 3.702 | 53% | 2518 | 229 | 8 | 1184 | 32% | 0.78 | 31% |
| 68 | E | 3.814 | 53% | 2749 | 228 | 8 | 1065 | 28% | 0.96 | 35% |
| 69 | E | 3.9 | 53% | 2713 | 225 | 8 | 1187 | 30% | 0.88 | 32% |
| 71 | E | 3.57 | 51% | 2577 | 223 | 7 | 993 | 28% | 0.83 | 32% |
| 72 | E | 3.82 | 52% | 2669 | 222 | 7 | 1151 | 30% | 0.84 | 31% |
| 73 | E | 3.698 | 51% | 2632 | 217 | 7 | 1066 | 29% | 0.82 | 31% |
| 74 | E | 3.744 | 51% | 2691 | 216 | 7 | 1053 | 28% | 0.86 | 32% |
| 75 | E | 3.772 | 51% | 2648 | 215 | 7 | 1124 | 30% | 0.80 | 30% |
| 76 | E | 3.63 | 50% | 2621 | 214 | 7 | 1009 | 28% | 0.81 | 31% |
| 77 | E | 3.368 | 50% | 2376 | 211 | 7 | 992 | 29% | 0.69 | 29% |
| 78 | E | 3.556 | 50% | 2548 | 210 | 7 | 1008 | 28% | 0.77 | 30% |
| 79 | E | 3.558 | 52% | 2378 | 209 | 7 | 1180 | 33% | 0.67 | 28% |
| 81 | E | 3.584 | 52% | 2560 | 204 | 7 | 1024 | 29% | 0.84 | 33% |
| 82 | E | 3.534 | 50% | 2488 | 202 | 7 | 1046 | 30% | 0.72 | 29% |
| 83 | E | 3.572 | 52% | 2631 | 201 | 7 | 941 | 26% | 0.92 | 35% |
| 84 | E | 3.53 | 51% | 2580 | 196 | 7 | 950 | 27% | 0.85 | 33% |
| 85 | E | 3.552 | 52% | 2350 | 195 | 7 | 1202 | 34% | 0.65 | 27% |
| 86 | E | 3.55 | 52% | 2466 | 193 | 6 | 1084 | 31% | 0.76 | 31% |
| 87 | E | 3.492 | 51% | 2434 | 190 | 6 | 1058 | 30% | 0.72 | 30% |
| 88 | E | 3.47 | 50% | 2455 | 186 | 6 | 1015 | 29% | 0.72 | 29% |
| 89 | E | 3.55 | 50% | 2507 | 181 | 6 | 1043 | 29% | 0.73 | 29% |
| 90 | E | 3.638 | 52% | 2562 | 179 | 6 | 1076 | 30% | 0.82 | 32% |
| 91 | E | 3.596 | 52% | 2515 | 173 | 6 | 1081 | 30% | 0.79 | 31% |
| 92 | E | 3.652 | 52% | 2544 | 172 | 6 | 1108 | 30% | 0.79 | 31% |
| 93 | E | 3.634 | 52% | 2574 | 167 | 6 | 1060 | 29% | 0.83 | 32% |
| 94 | E | 3.576 | 52% | 2520 | 166 | 6 | 1056 | 30% | 0.80 | 32% |
| 95 | E | 3.332 | 48% | 2362 | 159 | 5 | 970 | 29% | 0.63 | 27% |
| 96 | E | 3.766 | 53% | 2552 | 158 | 5 | 1214 | 32% | 0.78 | 31% |
| 97 | E | 3.648 | 53% | 2563 | 153 | 5 | 1085 | 30% | 0.85 | 33% |
| 98 | E | 3.436 | 53% | 2406 | 145 | 5 | 1030 | 30% | 0.79 | 33% |
| 99 | E | 3.424 | 51% | 2488 | 144 | 5 | 936 | 27% | 0.81 | 33% |
| 104 | E | 3.73 | 54% | 2681 | 124 | 4 | 1049 | 28% | 0.97 | 36% |
| 105 | E | 3.65 | 54% | 2571 | 123 | 4 | 1079 | 30% | 0.89 | 35% |

TABLE 7B
Reduction in volume of aged soy-based cheeses.

| | | | Approx. | | | | |
|---|---|---|---|---|---|---|---|
| | | Age at | Age at | | | Percent | Percent |
| | Methods | Measurement | Measurement | Diameter | Height | Original | Original |
| Batch | Section | (days) | (months) | (in) | (in) | Diameter | Volume |
| 1 | A | 376 | 13 | 6.19 | 3.25 | 79% | 49% |
| 3 | A | 374 | 12 | 6.31 | 4.13 | 80% | 52% |
| 12 | A | 370 | 12 | 6.88 | 3.88 | 87% | 67% |
| 15 | B | 368 | 12 | 6.63 | 4.50 | 84% | 60% |
| 17 | B | 363 | 12 | 6.88 | 5.00 | 87% | 67% |
| 18 | B | 361 | 12 | 6.88 | 5.00 | 87% | 67% |
| 19 | B | 360 | 12 | 7.00 | 4.75 | 89% | 70% |
| 20 | B | 356 | 12 | 6.63 | 4.13 | 84% | 60% |
| 21 | B | 354 | 12 | 6.50 | 4.50 | 83% | 56% |
| 22 | B | 353 | 12 | 6.75 | 4.25 | 86% | 63% |
| 23 | B | 352 | 12 | 6.75 | 4.50 | 86% | 63% |
| 24 | B | 349 | 12 | 6.63 | 4.63 | 84% | 60% |
| 25 | B | 348 | 12 | 6.75 | 4.75 | 86% | 63% |
| 26 | B | 346 | 12 | 6.63 | 4.25 | 84% | 60% |
| 27 | B | 345 | 12 | 6.63 | 4.25 | 84% | 60% |
| 28 | B | 342 | 11 | 6.75 | 4.38 | 86% | 63% |
| 29 | B | 341 | 11 | 6.75 | 4.13 | 86% | 63% |
| 30 | B | 339 | 11 | 6.75 | 4.63 | 86% | 63% |
| 31 | B | 338 | 11 | 6.88 | 4.38 | 87% | 67% |
| 32 | B | 335 | 11 | 6.75 | 4.38 | 86% | 63% |
| 33 | C | 334 | 11 | 6.88 | 4.63 | 87% | 67% |
| 34 | C | 332 | 11 | 6.75 | 4.25 | 86% | 63% |
| 35 | C | 331 | 11 | 6.69 | 4.25 | 85% | 61% |
| 36 | B | 328 | 11 | 6.75 | 4.56 | 86% | 63% |
| 37 | B | 327 | 11 | 6.88 | 4.63 | 87% | 67% |
| 38 | C | 325 | 11 | 7.00 | 3.63 | 89% | 70% |
| 39 | C | 324 | 11 | 6.81 | 4.19 | 87% | 65% |
| 40 | C | 321 | 11 | 6.75 | 4.38 | 86% | 63% |
| 41 | C | 319 | 11 | 6.75 | 4.25 | 86% | 63% |
| 42 | D | 318 | 11 | 6.75 | 4.31 | 86% | 63% |
| 43 | D | 317 | 11 | 6.81 | 4.38 | 87% | 65% |
| 44 | D | 314 | 10 | 6.75 | 3.00 | 86% | 63% |
| 45 | D | 313 | 10 | 6.50 | 2.75 | 83% | 56% |
| 47 | D | 310 | 10 | 6.63 | 4.25 | 84% | 60% |
| 49 | D | 303 | 10 | 6.63 | 4.19 | 84% | 60% |
| 51 | D | 300 | 10 | 6.63 | 3.75 | 84% | 60% |
| 52 | D | 298 | 10 | 6.50 | 4.00 | 83% | 56% |
| 53 | D | 297 | 10 | 6.50 | 4.25 | 83% | 56% |
| 54 | D | 296 | 10 | 6.63 | 3.75 | 84% | 60% |
| 55 | D | 293 | 10 | 6.50 | 3.38 | 83% | 56% |
| 56 | E | 292 | 10 | 6.75 | 3.63 | 86% | 63% |
| 57 | E | 291 | 10 | 6.75 | 3.88 | 86% | 63% |
| 58 | E | 289 | 10 | 6.75 | 3.38 | 86% | 63% |
| 59 | E | 286 | 10 | 6.63 | 3.50 | 84% | 60% |
| 60 | E | 285 | 10 | 6.63 | 3.50 | 84% | 60% |
| 61 | E | 284 | 9 | 6.88 | 3.75 | 87% | 67% |
| 62 | E | 283 | 9 | 6.75 | 3.63 | 86% | 63% |
| 63 | E | 282 | 9 | 6.88 | 4.00 | 87% | 67% |
| 64 | E | 279 | 9 | 6.88 | 3.88 | 87% | 67% |
| 65 | E | 278 | 9 | 6.88 | 3.75 | 87% | 67% |
| 66 | E | 275 | 9 | 6.75 | 4.00 | 86% | 63% |
| 67 | E | 272 | 9 | 6.88 | 3.63 | 87% | 67% |
| 68 | E | 271 | 9 | 7.13 | 3.75 | 90% | 74% |
| 69 | E | 270 | 9 | 6.88 | 3.75 | 87% | 67% |
| 70 | E | 269 | 9 | 7.75 | 4.25 | 98% | 95% |
| 71 | E | 268 | 9 | 6.88 | 3.63 | 87% | 67% |
| 72 | E | 265 | 9 | 6.75 | 3.75 | 86% | 63% |
| 73 | E | 264 | 9 | 7.00 | 3.63 | 89% | 70% |
| 74 | E | 263 | 9 | 6.88 | 3.75 | 87% | 67% |
| 75 | E | 262 | 9 | 6.88 | 3.75 | 87% | 67% |
| 76 | E | 261 | 9 | 7.00 | 3.63 | 89% | 70% |
| 77 | E | 258 | 9 | 6.75 | 3.38 | 86% | 63% |
| 78 | E | 255 | 9 | 6.88 | 3.88 | 87% | 67% |
| 79 | E | 254 | 8 | 6.88 | 3.63 | 87% | 67% |
| 80 | E | 251 | 8 | 7.88 | 3.88 | 100% | 100% |
| 81 | E | 250 | 8 | 6.88 | 3.63 | 87% | 67% |
| 82 | E | 249 | 8 | 6.88 | 3.50 | 87% | 67% |
| 83 | E | 248 | 8 | 6.88 | 3.63 | 87% | 67% |
| 84 | E | 243 | 8 | 6.88 | 3.50 | 87% | 67% |
| 85 | E | 242 | 8 | 6.88 | 3.50 | 87% | 67% |
| 86 | E | 241 | 8 | 7.00 | 3.38 | 89% | 70% |
| 87 | E | 240 | 8 | 7.00 | 3.50 | 89% | 70% |
| 88 | E | 237 | 8 | 7.00 | 3.38 | 89% | 70% |
| 89 | E | 236 | 8 | 6.88 | 3.50 | 87% | 67% |
| 90 | E | 235 | 8 | 7.00 | 3.63 | 89% | 70% |
| 91 | E | 233 | 8 | 7.00 | 3.50 | 89% | 70% |
| 92 | E | 230 | 8 | 7.00 | 3.50 | 89% | 70% |
| 93 | E | 228 | 8 | 7.00 | 3.63 | 89% | 70% |
| 94 | E | 227 | 8 | 7.00 | 3.50 | 89% | 70% |
| 95 | E | 222 | 7 | 7.00 | 3.38 | 89% | 70% |
| 96 | E | 221 | 7 | 6.88 | 3.63 | 87% | 67% |
| 97 | E | 219 | 7 | 7.00 | 3.50 | 89% | 70% |
| 98 | E | 216 | 7 | 7.00 | 3.50 | 89% | 70% |
| 99 | E | 212 | 7 | 6.88 | 3.50 | 87% | 67% |
| 104 | E | 193 | 6 | 7.00 | 3.75 | 89% | 70% |
| 105 | E | 192 | 6 | 7.00 | 3.50 | 89% | 70% |

### Example 4: Production of Melting Cheeses from Hard, Aged Cheese from Soybeans

Melting versions of cheese by combining hard, aged cheeses with other ingredients to create a solid form that sliced and shredded easily when cold, but melted, browned, and crisped when heated. The ingredients used to make these cheeses are shown in Table 8A. First, the aged cheese base was prepared by removing the rind formed during aging. The aged cheese base and all other ingredients were then added to a blender and blended until smooth. The mixtures were then heated to bring them to a temperature above the gelatinization temperature of the starch or starches in the mixture. The approximate gelatinization temperatures for the starch types used are shown in Table 8B. Once the mixture was heated through to the desired temperature, the mixtures were placed into forms and allowed to solidify at refrigerated temperatures (1-5° C.) for at least 24 hours. This resulted in cheeses which sliced and shredded easily while cold, and melted when heated.

The amount of aged cheese base had a significant effect on the intensity of meltable cheese flavor. Meltable cheeses with less than 15% input aged cheese base were quite mild in flavor, while cheeses with more than 25% of aged cheese base had a much stronger cheese flavor. Greater proportions of aged cheese base also decreased the amount of starches or other gelling agents necessary to create a solid cheese mass. But the greater proportion of aged cheese base also decreased the water content. In the positive, this decreased water content helped create cheeses that browned nicely under heat (e.g., cooking in an oven). At very high concentrations of aged cheese base (over 35%) however, the meltable cheeses had a noticeably more brittle texture, depending on the other ingredients used.

TABLE 8A
Ingredients used to produce meltable plant-based cheeses using an aged soybean cheese base.

| | | Organic | | | | | Aged | | | | |
|---|---|---|---|---|---|---|---|---|---|---|---|
| | | Tapioca | Kappa | Precisa | Precisa | Penpure | Cheese | | Coconut | | Other |
| | Gel | Starch | Carrageenan | 604 | 680 | 80 | Base | Water | Oil | Salt | Ingredients |
| Batch | Type | (g) | (g) | (g) | (g) | (g) | (g) | (g) | (g) | (g) | (g) |
| ml-1 | NA | 0 | 0 | 0 | 0 | 0 | 380 | 115 | 0 | N/A | 14 g sodium citrate |
| ml-2 | NA | 0 | 0 | 0 | 0 | 0 | 300 | 120 | 0 | 4 | 9 g sodium citrate; 0.75 |
| | | | | | | | | | | | g sodium hexametaphosphate |
| ml-3 | starch | 7.5 | 0 | 0 | 0 | 0 | 226 | 113 | 27 | 2.1 | 31.25 g powdered soymilk |
| ml-4 | starch | 35 | 0 | 0 | 0 | 0 | 200 | 400 | 40 | 4 | 62.5 g powdered soymilk |
| ml-5 | carrageenan | 35 | 10 | 0 | 0 | 0 | 200 | 300 | 40 | 4 | 6 g sodium citrate; 62.5 |
| | | | | | | | | | | | g powdered soymilk |
| ml-6 | carrageenan | 35 | 7 | 0 | 0 | 0 | 200 | 300 | 40 | 4 | 6 g sodium citrate; 62.5 |
| | | | | | | | | | | | g powdered soymilk |
| ml-7 | starch | 55 | 0 | 0 | 0 | 0 | 200 | 300 | 40 | 4 | 62.5 g powdered soymilk |
| ml-8 | carrageenan | 35 | 5 | 0 | 0 | 0 | 200 | 300 | 40 | 4 | 6 g sodium citrate; 62.5 |
| | | | | | | | | | | | g powdered soymilk |
| ml-9 | starch | 25 | 0 | 30 | 0 | 0 | 200 | 300 | 40 | 4 | 6 g sodium citrate; 62.5 |
| | | | | | | | | | | | g powdered soymilk |
| ml-10 | starch | 33 | 0 | 100 | 0 | 0 | 100 | 300 | 0 | 6 | |
| ml-11 | starch | 26.6 | 0 | 26.6 | 26.6 | 0 | 200 | 200 | 0 | 0 | |
| ml-12 | starch | 26.6 | 0 | 26.6 | 26.6 | 0 | 100 | 300 | 0 | 0 | |
| ml-13 | starch | | 0 | 40 | 40 | 0 | 200 | 200 | 0 | 0 | |
| ml-14 | starch | | 0 | 40 | 40 | 0 | 100 | 300 | 0 | 0 | |
| ml-15 | starch | 40 | 0 | 40 | 0 | 0 | 200 | 200 | 0 | 0 | |
| ml-16 | starch | 40 | 0 | 40 | 0 | 0 | 100 | 300 | 0 | 0 | |
| ml-17 | starch | 40 | 0 | 0 | 40 | 0 | 200 | 200 | 0 | 0 | |
| ml-18 | starch | 40 | 0 | 0 | 40 | 0 | 100 | 300 | 0 | 0 | |
| ml-19 | starch | 25 | 0 | 50 | 25 | 0 | 100 | 300 | 0 | 6 | |
| ml-20 | starch | 33.25 | 0 | 66.5 | 33.25 | 0 | 100 | 300 | 0 | 6 | |
| ml-21 | starch | 44 | 0 | 0 | 0 | 88 | 100 | 300 | 0 | 6 | |
| ml-22 | starch | 23 | 0 | 0 | 0 | 46 | 100 | 300 | 0 | 6 | |
| ml-23 | starch | 33 | 0 | 0 | 0 | 66 | 100 | 300 | 0 | 6 | |
| ml-24 | starch | 30 | 0 | 100 | 0 | 0 | 125 | 162.5 | 75 | 7.5 | |
| ml-25 | starch | 20 | 0 | 80 | 0 | 0 | 110 | 224 | 60 | 6.25 | |
| ml-26 | starch | 25 | 0 | 75 | 0 | 0 | 110 | 224 | 60 | 6.25 | |
| ml-27 | starch | 25 | 0 | 75 | 0 | 0 | 100 | 234 | 60 | 6.25 | |
| ml-28 | starch | 25 | 0 | 75 | 0 | 0 | 110 | 234 | 50 | 6.25 | |
| ml-29 | starch | 20 | 0 | 70 | 0 | 0 | 100 | 244 | 60 | 6.25 | |
| ml-30 | starch | 20 | 0 | 55 | 0 | 0 | 125 | 243.75 | 50 | 6.25 | |
| ml-31 | starch | 17.5 | 0 | 52.5 | 0 | 0 | 100 | 263.75 | 60 | 6.25 | |
| ml-32 | starch | 27.5 | 0 | 65 | 0 | 0 | 125 | 216.25 | 60 | 6.25 | |
| ml-33 | starch | 25 | 0 | 60 | 0 | 0 | 125 | 223.75 | 60 | 6.25 | |
| ml-34 | starch | 25 | 0 | 60 | 0 | 0 | 125 | 222.5 | 60 | 7.5 | |
| ml-35 | starch | 25 | 0 | 60 | 0 | 0 | 150 | 198 | 60 | 7 | |
| ml-36 | starch | 25 | 0 | 55 | 0 | 0 | 150 | 203 | 60 | 7 | |
| ml-37 | starch | 20 | 0 | 45 | 0 | 0 | 200 | 184 | 45 | 6 | |
| ml-38 | starch | 20 | 0 | 35 | 0 | 0 | 250 | 155 | 35 | 5 | |

N/A: information not available for this batch

TABLE 8B
Approximate gelatinization temperatures of starches
and gels used to produce meltable plant-base cheeses.

| | Gelatinization |
|---|---|
| Ingredient | Temperature |
| Tapioca Starch | 58-68° C. |
| Kappa Carrageenan | 60-80° C. |
| Ingredion Precisa 604 | 60-65° C. |
| (modified potato starch) | |
| Ingredion Precisa 680 | 62-72° C. |
| (modified waxy maize | |
| starch) | |
| Ingredion Penpure 80 | 60-65° C. |
| (waxy potato starch) | |

### Example 5: Production of Hard, Aged Cheeses from Isolated Legume Protein

Cheeses were also produced from isolated soy and pea proteins, but with the same goals as cheese made from milk, providing the proper conditions for microbes to develop flavors during aging. As before, the key parameters are pH, salt, water content, microbes, and access to nutrients. But in this case, there is no need to first create a plant-based milk which is then cultured and coagulated. Instead, the isolated proteins can be used to directly create a protein substrate, with moisture content and pH similar to the curds created after coagulation of plant-based milk proteins, to which cultures and rennet may be added for flavor development during aging. By skipping the milk preparation, coagulation and culturing stages, aged plant-based cheeses can be produced with simpler logistics and less waste. This Example provides an exemplary method for producing aged plant-based cheeses from isolate proteins, as well as working examples of plant-based cheeses produced from isolated soy and pea protein.

A. Exemplary Method for Producing Aged Plant-Based Cheeses from Isolated Proteins

To produce such cheeses, isolated proteins from legumes are first hydrated in boiling water, limited to the moisture content desired in the final cheese. The use of boiling water in this step further serves to pasteurize the protein, killing any unwanted microbes. The hydrated proteins are then mixed with coconut oil, salt, and lactic acid to produce a curd-like protein substrate for aging with rennet and cultures. Coconut oil or another plant fat is added within a range of 20-50% of the final weight, depending on the consistency and texture desired. The amount of lactic acid depends on the pH desired for the cheese variety, but as before the final pH values are generally desired to be between 4.4-4.8 for certain varieties and 5.0-5.8 for others. The amount of salt is similarly dependent on the conditions desired for the final cheese. Sugars can also be added to reflect the sugar content of dairy cheese curds, although most simple sugars are removed with the whey during dairy cheesemaking process or the soy cheesemaking process described in Example 3. Cultures and rennet are then added to the protein substrate. The amount of added rennet approximates the amount of rennet retained by dairy cheeses at the end of cheesemaking. For example, cheddar cheese retains approximately 20% of rennet enzymatic activity (Holmes et al., Distribution of Milk Clotting Enzymes Between Curd and Whey and Their Survival During Cheddar Cheese Making 1,4. J Dairy Sci. 1977 Jun. 1; 60(6):862-9), although this varies significantly with different enzymes and cheese varieties. The proper concentration of cultures is similarly pinned to the usual microbial concentrations in dairy cheeses, which, for example, are around 10⁹ CFU of starter culture per gram at the beginning of aging of cheddar cheese (Wilkinson M G, LaPointe G. Invited review: Starter lactic acid bacteria survival in cheese: New perspectives on cheese microbiology. J Dairy Sci. 2020 Dec. 1; 103(12):10963-85). The protein substrate is then aged as described in the examples above to produce an aged plant-base cheese. Vacuum-sealing these types of cheeses is often preferred due to their softer nature. To create harder cheeses, gum or other gels can be added. After aging, these cheeses may also be used as a base for the meltable cheeses described in Example 2.

An example cheese thus might have the following composition (all values expressed as percent weight): 20-35% protein isolate (e.g., soy, pea), 20-35% coconut oil (or other plant fat), 35-50% water, 0.1-1.0% lactic acid, 0.5% concentrated or lyophilized cultures, 1-3% salt, 0.001-0.01% rennet concentrate, 0-2% minerals (e.g., a calcium source, if desired for nutrition).

B. Production of Cheeses from Isolated Soy and Pea Proteins

Aged cheeses were produced from pea and soy isolated protein as described in section A above. The proteins were hydrated, mixed with lactic acid to achieve the desired pH (about 5), and mixed with coconut oil to produce a protein substrate for culturing. The variable amounts of starting ingredients, the final pH, and the final moisture content of the protein substrate are shown in Table 9. MA series cultures were added to the protein substrate in an amount of 25 DCU, and a mixture of Supreme and Star rennet was then added in an amount of about 500-1000 IMCU per kg of protein substrate. Calcium sulfate was added, primarily as a source of calcium. The protein substrate was then shaped into a wheel and prepared for aging using the bandaged rind method as described in Table 6D and aged for about 5 months.

Because these cheeses did not involve a coagulation step, they did not have the protein gel network present in the cheeses made from plant-based milks described in Example 1. This lack of protein-protein bonds resulted in a number of distinct characteristics. The texture of these cheeses tended to be more granular and less cohesive. The fats in the cheeses were not trapped by a protein matrix, and so theses cheeses tended to lose fat if pressed with significant force. The exterior of the cheese did not form a significant rind, so moisture loss was relatively quick and the flavors of molds that grew on the exterior of the cheese were able to penetrate deeper into the body of the cheese. But despite not involving a culturing step, these cheeses did produce cheese-like aromas and flavors as they aged. This suggests that these protocols, or variations thereof, can result in an easily produced cheese product with cheese flavor (if not texture) that may be incorporated into other food products or cheese formulations.

TABLE 9
Ingredients and curd properties of aged cheeses produced from soy and pea isolated protein.

| | | Protein | | Calcium | | Protein | Protein | Protein | Legume |
|---|---|---|---|---|---|---|---|---|---|
| | | Mass | Fat | sulfate | Salt | Substrate Mass | Substrate | Substrate | Material Content |
| Batch | Base | (kg) | (g) | (g) | (g) | (kg) | pH | Moisture | (% dry weight) |
| 109 | soy protein | 0.14 | 125 | 9 | 11 | 0.6 | 5.04 | 41% | 65% |
| 110 | pea protein | 0.29 | 250 | 18 | 22 | 1 | 4.85 | 41% | 58% |

### Example 6: Production of Hard, Aged Cheeses from Soy and Sunflower Flours

In another variation of the invention, plant-based cultured cheeses may be produced from flours of legumes or seeds. As in Example 4, these cheeses likewise seek to establish the conditions beneficial for microbial production of flavors during aging, but using bulk ingredients from milled ingredients, such as beans or seeds. The major differences between these cheeses and those in Example 4 are changes in the concentrations of different ingredients to account for the more diverse nutrients contained in whole plant materials as opposed to protein concentrates or isolates. In particular, milled bulk ingredients will generally have higher contents of fat, carbohydrates, and fiber.

An example cheese thus might have the following composition (all values expressed as percent weight): 35-55% legume or seed flour (e.g., sunflower, soybean, chickpea), 0-25% coconut oil (or other plant fat), 35-50% water, 0.1-1.0% lactic acid, 0.5% concentrated or lyophilized cultures, 1-3% salt, 0.001-0.01% rennet concentrate, 0-2% minerals (e.g., a calcium source, if desired for nutrition).

Aged cheeses were produced from soybean and sunflower seed flours as described in section A above. The flours were hydrated, mixed with lactic acid to achieve the desired pH (about 5), and mixed with 65 g coconut oil to produce a protein substrate for culturing. The amounts of flour and the mass, final pH, and moisture content of each protein substrate are shown in Table 10. MA series cultures were added to each protein substrate in an amount of 2.5 g, and a mixture of Supreme and Star rennet was then added in an amount of 500-1000 IMCU per kg of protein substrate. Calcium sulfate was added in an amount of 9 g to each substrate, primarily as a source of calcium. Finally, 11 g of salt was added to each protein substrate. Each protein substrate was then shaped into a wheel and prepared for aging using the bandaged rind method as described in Table 6D and aged for about 6 months.

Like the cheeses made from isolated proteins, these cheeses shared the characteristics of a cheese form made without forming a protein-protein matrix, including both the distinct characteristics in texture and flavor from the rind molds as well as the promising development of cheese aroma and flavors over time. Although the protein isolate cheeses had a finely granular texture, these cheeses had more obvious small particles of material, resulting from the more coarse nature of the initial product.

TABLE 10
Ingredients and curd properties of aged cheeses
produced from soy bean flour and sunflower flour.

| | | | Protein | | |
|---|---|---|---|---|---|
| | | Protein | Substrate | Protein | Protein |
| | | Mass | Mass | Substrate | Substrate |
| Batch | Base | (kg) | (kg) | pH | Moisture |
| 111 | soybean flour | 0.205 | 0.5 | 5.14 | 41% |
| 112 | sunflower flour | 0.27 | 0.5 | N/A | 41% |

N/A: information not available for this batch

### Example 7: Methods for Creating White-Mold, Surface-Ripened (“Bloomy”) Plant-Based Cheeses

In another variation of the invention, plant-based cultured cheeses may be produced in the style of traditional white-mold, surface ripened cheeses, also known as bloomy cheeses.

The flavors of these cheeses are primarily generated by the action of surface-growing white molds: Penicillium candidum and/or Geotrichum candidum (which is technically a yeast, but certain types grow in a white-mold-like manner). These molds prefer a number of conditions to properly grow and create flavors: an abundance of lactic acid as a food source, oxygen, proper salt conditions, proper moisture conditions, and a proper external environment. For the cheese maker, these conditions may require greater acid production by the bacterial starter cultures, higher curd moisture content, and different aging conditions and handling. During aging, these cheeses mature from the outside in. In other words, without wishing to be bound by theory, the enzymes responsible for the distinct flavors associated with these cheeses start in the mold rind and gradually work their way into the cheese. Although the enzymes of the bacterial starter cultures play a role in flavor development, the primary action is from the mold enzymes. Yeasts are generally the first to colonize the cheese rind after cheesemaking, then P. candidum and G. candidum shortly after. As these fungi grow, their powerful enzymes break down proteins and fats into an array of flavor compounds. Protein breakdown also produces ammonia, which neutralizes the acids produced by the starter bacteria (which are also being metabolized by the fungi), resulting in a significant increase in pH during aging.

Here are some of the key physicochemical properties exhibited by these cheeses that may be fulfilled for a plant-based cheese to provide the right conditions for microbes to create the desired flavors:

Moisture at shaping: 55-65%

Moisture after aging: 50-60%

Salt: At early stages, high levels of salt on the cheese exterior, which selects for halotolerant yeasts and P. candidum and G. candidum and against other unwanted molds.

pH at the start of aging: 4.4-5.2

Texture: cohesive

Fat content: 20-35% overall, 50-65% of dry matter

As with other nondairy cheeses, a key decision point for the cheese maker will be how to best control the moisture content of the cheese. The molecular structure of many plant-based proteins leads to a curd structure with more limited syneresis than dairy curds. Below are exemplary procedures for making these styles of cheeses with a soybean base.

A. Preparation of the Milk

First, soy milk is made as described in Example 3. Fat and sugar are added as desired for the final cheese. Because of the comparatively high levels of acid that are optimal in these cheeses, some seeds and legumes may require additional sugar to allow the starter cultures to produce the desired acid levels.

The milk is stabilized at a temperature appropriate for the intended starter cultures. Usually these are mesophilic cultures or blends, but in some cases thermophilic cultures are also used as either adjuncts for flavor complexity or even as the primary acid producers. The last case is usually reserved for so-called “stabilized curd” bloomy-rind cheeses, which have a curd that is more solid than the most common bloomy-rind cheeses. Without wishing to be bound by theory, this more durable structure is largely attributable to a higher pH at the start of aging, although higher fat contents can also play a role. In addition to the bacterial starter cultures, Penicillium candidum and Geotrichum candidum are added either in combination or separately. Other halophilic yeasts can also be added. Yeasts play a role in the ecological succession of the cheese rind during aging, priming the cheese surface for the succession of P. candidum and G. candidum by moderating the surface pH. Although appropriate yeasts are naturally in most environments and will adventitiously colonize cheeses if given the right conditions, one can add specific isolated strains to obtain more consistent behavior during aging.

B. Culturing and Ripening

During cheesemaking, there are three general strategies for bloomy-rind cheeses. First, lactic-set bloomy cheeses develop acid only after coagulation, meaning that almost no acid development occurs during a liquid phase. These curds are often not cut, but instead ladled directly into molds to drain slowly as they develop acid over a period of up to three days. Second, coagulated curd bloomy cheeses culture for a period as a liquid milk, often less than 1 hour. The milk is then coagulated, and the curd is cut into large pieces (0.2-3 cm cubes), which facilitates whey release. In dairy cheeses, this coagulation is achieved with rennet, while for plant-based cheeses the other methods discussed must be used. These curds are then transferred into molds to drain as they finish developing acid for up to two days. The third style is the “stabilized paste” mentioned earlier. These cheeses often have significant acid development as a liquid, until a pH of 6.0-6.2 is reached. The milk is coagulated, and curds are cut into smaller pieces (1 cm cubes) and allowed to release whey in the vat, potentially with a curd washing step (where the curds are washed in water), which serves to reduce the sugar content of the curds to further limit acid development. These cheeses also drain in their forms for up to a day or two.

For plant-based cheeses, any of these strategies can be pursued, although the nature and duration of each step may be tuned to the base ingredients used. In particular, a press may be necessary to reach the desired moisture content, either because the draining curds may not release enough whey to reach the desired moisture content or to facilitate faster cheesemaking. The strategy taken will have its greatest effect on the final texture of the finished cheese, although it will also affect the development of flavor by cultures. Below are exemplary protocols for each strategy.

1. Lactic set cheese. Once the milk has reached the desired temperature, the cultures are added and allowed to hydrate for 5 min if using lyophilized, direct-vat cultures. If bulk cultures or another culture type are used, then hydration is unnecessary. The cultures are then stirred into the milk. If desired, rennet (˜10-100 IMCU/liter) is mixed in, although this addition is less critical for mold-ripened cheeses because of the comparatively powerful action of fungal enzymes versus bacterial ones. After the milk has been mixed, a mineral or enzymatic coagulant is added and the milk is allowed to coagulate. The temperatures is maintained between 20° C. and the culturing temperature and the milk is allowed to acidify as a solid mass for 7-24 hours until the curd reaches a pH of 4.4-4.6. The curds are transferred in thin layers to forms that can freely drain. These forms are generally small, under 500 g per cheese. The cheeses are allowed to drain for the next 12-36 hours, keeping the temperature above 20° C. The solidified cheeses are unmolded, 1.5-2% w/w of salt is applied to the surface of each cheese, and they are allowed to absorb salt and dry on the draining surface for another 24 hours, while the humidity is kept high (ideally 80-85%) and the temperature over 17° C. By dry salting these cheeses, the cheese maker creates an extremely salty environment on the surface of the cheese at the start of aging, selecting for halotolerant yeasts and molds and discouraging other molds (e.g., blue molds). As the cheese ages, this gradient moderates as salt migrates into the interior of the cheese. Once dry, the cheeses are moved to an aging space with temperatures between 10-13° C. and humidity above 95%. The cheeses are turned daily. Once the cheeses have developed complete mold coats, one can wrap them and transfer them to a cooler aging space (2-5° C.) to finish aging.

2. Coagulated curd cheese. Once the milk has reached the desired temperature, cultures are added and allowed to hydrate for 5 min (if using direct-vat cultures), and are then stirred into the milk. If desired, rennet (˜10-100 IMCU/liter) is mixed in. The milk is allowed to acidify for 30-60 min, looking for a small drop in pH (0.05-0.1). A mineral or enzymatic coagulant is added and the milk allowed to coagulate, maintaining the culturing temperature. The curds are cut into 2-3 cm cubes. One can optionally allow the curds to drain at this stage, or keep them in the whey. Once the curds have reached a pH of 6.35-6.45, they are transferred into forms. Forms for these types of cheeses can be larger than the lactic-set curds. The key factors in choosing an appropriate form are the desire for a relatively high surface-area to volume ratio (since these cheeses ripen or age from the outside in) and the durability of the high-moisture curds, which may not stay intact for larger shapes. At temperatures maintained above 20° C., the cheeses are allowed to drain in their forms for 8-16 hours. Once the cheeses have reached a pH of 4.6-4.8, the exterior of the cheese is salted with 1.5-2% w/w of salt. Once the salt is absorbed, the cheeses are set on the draining area for another 18-36 hours, maintaining temperatures between 17-21° C. and humidity between 75-85%. Once the cheeses are set, they are moved to an aging space and treated as described for the lactic-set cheeses.

3. Stabilized curd cheese. Once the milk has reached the desired temperature, cultures are added and allowed to hydrate for 5 min (if using direct-vat cultures), and are then stirred into the milk. The milk is allowed to acidify for 120-240 min, looking for a drop in pH to 6.1-6.3. Below this level (in the case of soymilk), the proteins will begin to coagulate. If desired, rennet (˜10-100 IMCU/liter) is mixed in. A mineral or enzymatic coagulant is added and the milk allowed coagulate for 20-90 min, maintaining the culturing temperature. The curds are cut into 1 cm pieces and allowed to release whey in the vat. If desired, the curds are washed by draining all or a significant portion (greater than 25%) of the released whey and replacing it with filtered water of equal temperature, being careful not to overly disturb the curds. Another option is to simply drain the whey as it is released. The curds are transferred into forms that can drain freely, and maintained at temperatures between 20° C. and the culturing temperature for 8-24 hours. The goal at the end of this draining is a cheese that is solid enough to handle and with a pH of 4.9-5.2. The exterior of the cheese is salted with 1.5-2% w/w of salt. Once the salt is absorbed, the cheeses are set on the draining area for another 18-36 hours, maintaining temperatures between 17-21° C. and humidity between 75-85%. Once the cheeses are set, they are moved to an aging space and treated as described for the lactic-set cheeses.

C. Pressing

If the plant-based curds do not release enough whey to generate solid cheeses with the protocols above (or if a faster production time is desired), one can incorporate mechanical pressing or other dewatering methods to achieve the desired moisture content. These methods can be used in concert with any of the above strategies, with acid developing to different extents while the milk is in a liquid form. But instead of allowing the curds to drain entirely under their own weight, the curds are pressed to accelerate the removal of whey. Such pressing might occur in the cheese forms or the curds may be pressed together in other molds or systems. How the curds are handled during pressing will have significant effects on the final texture of the cheese. But this process's effects on cheese flavor (and microbiology) will be largely shaped by its effect on moisture content and pH. For example, the milk may be allowed to acidify for 120-240 min, with a target pH of 6.1-6.2. Then, a mineral or enzymatic coagulant may be added to allow the milk to coagulate for 20-60 min, maintaining the culturing temperature. The remaining acid development could then occur in the vat, with or without cutting the curd to facilitate syneresis. Once the desired final pH level has been reached, the curds may be transferred to a dewatering process, whether that's manual pressing in cloths and molds or other methods. Once the final moisture content has been reached, the cheeses can be shaped into final forms, salted, and aged as described above.

D. Salting

White-mold, bloomy-rind cheeses are most commonly salted by applying salt directly to the final forms. This allows for the establishment of a high salt exterior of the cheese to select for desired fungi, but without resulting in oversalting the cheese. Brining and even milling and salting the curds directly can be used to produce satisfactory cheeses, but one may balance a desire for a high-salt exterior without producing a cheese with excess salt after aging.

E. Aging

Flipping or turning these types of cheeses during aging is particularly important to moderate the mold growth, as not turning the cheeses frequently can result in the mold growing into whatever surface it rests on. Then, once the cheese is flipped, the rind may split from the cheese paste and remain attached to the lower surface. During the final cold stage of aging (2-5° C.), the cheesemaker may choose to wrap their cheeses in a barrier to protect them. There are specifically designed papers for this purpose, and other materials like parchment paper can also be effective.

### Example 8: Production of Bloomy Cheeses from Native Soybeans

Cultured and aged bloomy cheeses were produced from soybeans to optimize the production and flavors of this cheese variety. First, coagulated curd cheeses were produced with pressing to facilitate whey release. Soy milk was created using methods described herein (Brix value: 11.5° Bx) with a high-level of fat addition, aiming to have added fat account for 40-50% of the final dry mass of the cheese. A mesophilic culture (1-2DCU of Danisco MA11 or MM100 per gallon of input soymilk), P. candidum (Danisco PC Neige 0.05-0.2 doses per gallon of input soymilk) and G. candidum (Lallemand GCA FLAV-ANTAGE 0.01-0.03 doses per gallon on input soymilk) we added at the beginning of culturing. The soy milk was allowed to culture for 120-240 min before adding a mixture of Supreme and Star rennets in an amount of about 50-70 IMCU per liter followed by a mineral coagulant (calcium sulfate) at a concentration of 0-0.6% w/w. The coagulated curd was cut and left to continue culturing overnight or until a pH of 4.6-4.8 or 5.0-5.2 was reached. The curds were then pressed in a pneumatic press until the desired moisture content (55-65%) was reached. The curds were then transferred into a cheese mold and pressed again to form the final shape of the cheese. Once the shape was formed, the exterior of each cheese was rubbed with 2% of the wheel's weight in salt. The wheel was allowed to absorb the salt and dry for 24 hours at temperatures of 50-55° F. and humidity of 75-85%. Cheeses 116 and 117 were additionally rubbed with a layer of food-grade ash, which serves to moderate the pH of the cheese surface and add an attractive black coating to the rind. The wheels were then allowed to age at 50-55° F. and 90-98% humidity for a period of 7-14 days. During this period, the cheeses were flipped daily and allowed to grow a full mold coat. Once a full mold coat was present, the cheeses was wrapped in ripening paper designed for bloomy cheeses, which has two layers allowing for appropriate gas exchange and moisture retention during aging. Cheeses were then moved into a cooler aging environment (35-42° F.) and allowed to age for up to 2 months. The variable ingredients and properties of the curds measured prior to salting and aging are shown in Table 11.

TABLE 11
Ingredients and curd properties of bloomy cheeses produced from soy beans.

| | | | | | | | | |
|---|---|---|---|---|---|---|---|---|
| Batch | Milk | | Culture | Fat | CaSO4 | Curd Mass | Curd | Curd Moisture |
| ID | (kg) | Cultures | and | (g) | (g) | (kg) | pH | (%) |

| | | | | | | | |
|---|---|---|---|---|---|---|---|
| 113 | 5.68 | ma11, pc_neige, gc_flavantage | 375 | 34 | 2.24 | 4.36 | 64% |
| 114 | 3.78 | ma11, pc_neige, gc_flavantage | 250 | 0 | 1.306 | 4.38 | N/A |
| 115 | 2.835 | mm100, pc_neige, gc_flavantage | 178 | 8.5 | 0.818 | 4.18 | 61% |
| 116 | 2.835 | mm100, pc_neige, gc_flavantage | 178 | 8.5 | 942 | 4.76 | 58% |
| 117 | 2.835 | mm100, pc_neige, gc_flavantage | 178 | 8.5 | 920 | 5.23 | 57% |

N/A: information not available for this batch. Note that for batches 116 and 117, the pH measurement is from before shaping, meaning that the final pH of the shaped cheese is lower than this value given the time elapsed.

These cheeses developed a dense, attractive white rind. Their texture ranged from creamy and spreadable to dense and toothsome, but none were as runny and molten as some dairy bloomy cheeses because of the cheeses' biochemical structure. Flavor development was very much similar to a dairy cheese, with earthy, mushroomy flavors in the rind and a creamy tang to the cheese paste. Some cheeses developed signs of excessive proteolysis, including dark coloration in the rind, ammonia build up, and bitter taste. It is likely that these characteristics were produced by rapid mold growth, which can break down proteins into bitter peptides faster than those peptides can be converted into amino acids. These defects were moderated by altering the extent of culturing, the temperature and duration of aging, the microbial strains used, and other factors.

### Example 9: Methods for Creating Blue-Mold Ripened Plant-Based Cheeses

In another variation of the invention, plant-based cultured cheeses may be produced in the style of traditional blue-mold internally ripened cheeses.

This category of cheese gains its flavors from the actions of blue molds that grow internally in the cheese, specifically the mold Penicillium roqueforti. Unlike bloomy cheeses, whose halotolerant molds grow on the outside of the cheese, these cheeses are produced in a way that allows for oxygen penetration into the interior of the cheese, allowing internal mold growth. This is primarily achieved by creating a more crumbly, open cheese texture—which allows for small air pockets inside the cheese wheel—and by physically piercing the cheese with rods to allow air flow. In contrast to white-molds, P. roqueforti is more salt sensitive, and cheesemakers will also use this sensitivity to control its growth. Salt content of these cheeses tend to be high. If left completely unchecked, the molds will grow into tough mats within the cheese, altering the cheese's texture. If slightly stressed by the introduction of salt, the molds will grow more delicately, and the stress will trigger the production of blue-green spores that give blue cheeses their distinctive color. Like other mold-ripened cheeses, without wishing to be bound by theory, blue cheeses will gain some flavor because of the action of the bacterial starter cultures and rennet, but these flavors will be secondary to those created by the stronger proteases and lipases of the fungal cultures. Also, like other mold-ripened cheeses, these cheeses generally have comparatively high moisture contents and low pH levels at the start of aging. The lactic acid serves as a nutrient for the growing molds.

Here are some of the key physicochemical properties exhibited by these cheeses that may be fulfilled for a plant-based cheese to provide the right conditions for microbes to create the desired flavors:

Moisture at shaping: 50-65%

Moisture after aging: 40-58%

Salt: In the cheese interior, high salt levels (over 6 salt in moisture) will hinder P. roqueforti growth. Salt is thus used to first promote growth (by absence) and then slow growth (by presence) during aging. Eventual salt in moisture levels of 4-8.

pH at the start of aging: 4.4-4.8 (some milder types can start at 5.0-5.3)

Texture: crumbly with air gaps

Fat content: 20-35% overall, 50-65% of dry matter

For the cheese maker, the primary concerns are achieving the right acid content, moisture content, open texture conducive to mold growth, and the extent of mold growth allowed. Below are exemplary procedures for making these styles of cheeses with a soybean base.

A. Preparation of the Milk

First, soy milk is made as described earlier. Fat and sugar are added as desired for the final cheese. Because of the comparatively high levels of acid that are optimal in these cheeses, some seeds and legumes may require additional sugar to support the starter cultures to produce the desired acid content.

The milk is stabilized at the temperature appropriate for the intended starter cultures. Usually these are mesophilic cultures or blends, but thermophilic cultures are also used as either adjuncts for flavor complexity or could even be used as the primary acid producers. In addition to the bacterial starter cultures, P. roqueforti (Danisco's Choozit PS and PV strains) is widely available in multiple strains with slightly different characteristics. If the cultures being used are direct vat cultures, they are sprinkled on the surface of the milk and allowed to rehydrate for 5 minutes before being stirred into the milk. If using a bulk culture, it may be stirred directly into the milk.

B. Culturing and Ripening

Like bloomy cheeses, these cheeses can be allowed to develop acid more or less as a liquid milk or solid curds, as long as the right acid content, moisture content, and texture is achieved. Below, two example protocols are provided, one where moisture content is lowered through draining and another where mechanical pressing or another dewatering process is used to remove whey.

1. Drained curd blue. The milk is cultured for 0-120 minutes. If desired, rennet (˜10-100 IMCU/liter) or lipase (0.02-0.2 grams per liter of milk) are mixed in to facilitate flavor generation. A mineral or enzymatic coagulant is added, and the milk is allowed to coagulate, maintaining the culturing temperature, for 10-120 min. The curd is cut into 1-4 cm cubes to allow whey to begin to drain and the curds are allowed to drain for 0-120 min. The curds are transferred into a form and allow the curds to drain in the forms and develop acid for 1-3 days. Temperatures are maintained near 20-23° C. and the cheeses are turned daily. The goal pH at the end is 4.4-4.8. Once the cheeses have reached the goal pH and drained enough to stand on their own, they are removed from their forms, dry-rubbed with salt, and allowed to dry for the next 2 days. The goal amount of salt applied is 2-4% of the weight of the cheese.

2. Pressed curd blue. Because of the nature of some plant-based cheese curds, pressing can be a faster and more effective method to achieve the desired moisture content and open texture for blue cheeses. The milk is cultured for 0-180 minutes. If desired, rennet (˜10-100 IMCU/liter) or lipase (0.02-0.2 grams per liter of milk) are mixed in to facilitate flavor generation. A mineral or enzymatic coagulant is added and the milk is allowed to coagulate, maintaining the culturing temperature, for 10-120 min. The curd is cut into 1-4 cm cubes to allow whey to begin to drain and the curds are allowed to drain for up to 20 hours. In this case, the goal pH of the curds at the start of pressing is near the final pH, 4.4-4.9. The curds are pressed to remove moisture, aiming for the desired final moisture content. These cheeses can either be dry salted as describe above milled and salted. In the latter case, once the curds are pressed, they are milled by being roughly cut or broken them into 2-3 cm pieces. The curds are salted with 2-4% w/w of salt and mixed. The salt amount is important because if the curds are oversalted, the growth of the chosen mold culture may be hindered. Alternatively, the salt can be applied to the outside of the cheese and allowed to soak in. The curds are transferred to forms and either allowed to settle into the form by gravity or gently pressed (less than 3 PSI).

C. Aging

After salting, the cheeses are moved to an aging room and maintained in temperatures between 10-13° C. and humidity above 90%. The cheeses are turned daily for the first 1-2 months. After 5-12 days, the cheeses are pierced to allow oxygen to penetrate the cheese interior, 2-4 holes per square inch. If desired, this process is repeated after an additional period of aging (5-21 days). Once sufficient blue mold growth is achieved, the cheese can be transferred to a colder aging environment (1-4° C.) for 1-6 months. This temperature along with the increasing salt in the cheese interior slows the growth rate of the mold, but allows for continued proteolysis and lipolysis from the mold's enzymes.

To prepare cheeses for aging, there are a number of strategies to prepare the surface of the cheese. Natural rind cheeses are allowed to grow a rind of adventitious microbes from the environment, generally yeasts, molds, and gram-positive bacteria (e.g., Bacillus). Often, to prepare the surface of these cheeses for a natural rind, a flat knife or blade is used to scrape and rub the exterior of the cheese to cover any gaps and holes in the cheese surface. This step provides a smooth exterior surface on which the natural rind can form and protects the inside of the cheese from unwanted microbial growth. Other options are to wrap the cheese in foil, plastic films, or wax. One can also wrap the cheese with natural materials like leaves or cloth bandages. For all rind methods besides a natural rind, the cheese is allowed to form a natural rind for at least the initial stages of mold growth (2-5 weeks), since the blue molds require oxygen to grow.

D. Fat Addition

An additional strategy that can be used to accentuate the crumbly texture and provide additional fat as a substrate for lipolysis, is adding additional oil or fat to the curds before final shaping. This addition often leads to a less cohesive cheese mass, which in the case of these cheese types is desirable, although it can be detrimental to other cheese styles. To do this, liquid fat is added to the curds and mixed in gently. The curds are replaced in the form and allowed to settle into the final shape or pressed gently to achieve the same result.

### Example 10: Production of Blue Cheeses from Native Soybeans

Cultured and aged blue cheeses were produced from soybeans to optimize the production and flavors of this cheese variety. First, pressed curd blue cheeses were produced, again based on the behavior of coagulated soybean proteins. Soy milk was created using the methods described herein with a high-level of fat addition, aiming to have added fat account for 40-50% of the final dry mass of the cheese. A mesophilic culture (1-2 DCU of Danisco MM100 or Chr. Hansen Flora Danica per gallon of input soymilk) and P. roqueforti (Danisco P. roqueforti PS 0.1-0.3 doses per gallon of input soymilk) were added at the beginning of culturing. The milk was allowed to culture for 120-240 min before adding a mixture of Supreme and Star rennets in an amount of about 50-70 IMCU per liter followed by a mineral coagulant (calcium sulfate) at a concentration of 0-0.6% w/w. The coagulated curd was cut and left to continue culturing overnight or until a pH of 4.3-4.9 was reached. The curds were then pressed in a pneumatic press until the desired moisture content (50-65%) was reached. The curds were then milled and salted, aiming for a salt in moisture of 5.4. These curds were transferred into a cheese mold and pressed again to form the final shape of the cheese, using gentle pressures to facilitate an open texture of the final cheese.

Cheeses were then aged at 10-13° C. and relative humidity of 80-95%. Cheeses were flipped daily for the first 1-2 months of aging, and then weekly after that. During the first weeks of aging, the molds proliferated. Both cheeses were punctured to facilitate oxygen penetration into the cheese to stimulate mold growth, first at 1-2 weeks of age and then again after another 1-3 weeks. At one month of age, these cheeses were wrapped in foil and moved to a cooler aging temperature (1-4° C.) and aged for 3-9 months. The variable ingredients and properties of the curds measured prior to salting and aging are shown in Table 12.

TABLE 12
Ingredients and curd properties of blue cheeses produced from soy beans.

| | Soy | Soy | | | | | | | |
|---|---|---|---|---|---|---|---|---|---|
| Batch | Beans | Milk | Milk | | Fat | CaSO4 | Curd Mass | Curd | Curd Moisture |
| ID | (kg) | (kg) | Brix | Culture | (g) | (g) | (kg) | pH | (%) |
| 118 | N/A | 11.4 | 11.5 | floradanica, p_roqueforti_ps | 750 | 68 | 3.862 | 4.84 | 61% |
| 119 | 2.2 | 14.1 | 11 | mm100, p_roqueforti_ps | 689 | 66 | 4.584 | 4.35 | 65% |
| 120 | 2.2 | 15.5 | 11 | mm100, p_roqueforti_ps | 835 | 66 | 3.89 | 4.53 | 56.5% |

N/A: information not available for this batch

### Example 11: Methods for Creating Thermophilic Plant-Based Grana Cheeses

In another variation of the invention, plant-based cultured cheeses may be produced in the style of traditional thermophilic, internally-ripened grana cheeses.

This category of cheese is characterized by long aging times, a grainy and dry texture, and lower fat contents than other cheeses. Thermophilic cultures are generally used because dairy curds are usually cooked at relatively high temperatures (up to 55° C.) to facilitate the loss of whey. For plant-based curds, one has the option of incorporating these high heat cooking steps or not (as plant-based cheese curds often do not exhibit the same magnitude of whey removal at high temperatures), meaning that cheeses could be made with mesophilic cultures as adjuncts, resulting in altered flavor profiles. In either case, mechanical processes may be required to remove sufficient moisture, and the cheese maker will likely also facilitate additional moisture loss during aging to create a hard texture.

Here are some of the key physicochemical properties exhibited by these cheeses that may be fulfilled for a plant-based cheese to provide the right conditions for microbes to create the desired flavors:

Moisture at shaping: 35-55%

Moisture after aging: 25-40%

Salt: high salt in moisture limits the development of acid by starter cultures. The low moisture also contributes to higher salt in moisture levels of 6-13

pH at the start of aging: 5.2-5.6

Texture: granular

Fat content: 25-35% overall, 40-50% dry matter

For the cheese maker, the primary concerns are achieving limited acid development and low moisture content. Provided below are exemplary procedures for making these styles of cheeses with a soybean base.

First, soy milk is made as described earlier. Fat and sugar are added as desired for the final cheese. Less fat will likely result in a more crumbly final texture and facilitate easier whey removal in later steps. Because of the comparatively low levels of acid that are optimal in these cheeses, only limited sugars should be necessary.

The milk is stabilized at the temperature appropriate for the intended starter cultures. If the cultures being used are direct vat cultures, they are sprinkled on the surface of the milk and allowed to rehydrate for 5 minutes before being stirred into the milk. If a bulk culture is being used, it is stirred directly into the milk. Like previous cheeses, acid development can occur either as liquid milk or as solid curds. The milk is cultured for 0-180 minutes. If desired, rennet (˜10-100 IMCU/liter) or lipase (0.02-0.2 grams per liter of milk) are mixed in to facilitate flavor generation. a mineral or enzymatic coagulant is added and the milk is allowed to coagulate, maintaining the culturing temperature, for 10-120 min. The curds are cut into 1-4 cm cubes to allow whey to begin to drain, and the curds are allowed to drain for 0-120 min. Optionally, one can either (1) heat the milk before coagulation or (2) heat the coagulated curds to temperatures up to 55° C. to facilitate whey removal. Any released whey is drained and the curds are transferred to cloth-lined molds or another means of dewatering. The curds are pressed or dewatered until they reach a moisture level under 55%, ideally 45-50% moisture. The goal pH of the pressed curds is 5.2-5.6. To salt the cheeses, one can mill and salt the curds before pressing into final forms, or brine the final cheeses. The cheeses are pressed into their final shapes for 6-24 hours. If not previously salted, the cheeses are immersed into a heavy brine (a full saturated salt solution) for 6 hours for every kg of weight of the cheese wheel. The wheel is turned multiple times during brining. The cheese wheels are transferred to an aging space at 10-13° C. and 80-85% humidity. Traditionally, these types of cheeses are allowed to develop a natural, oiled rind, but wax, bandages, coatings, and even plastic films can be used successfully. The cheeses are aged for 6-24 months or longer, and are flipped every day for the first month and then every week after that.

### Example 12: Production of Thermophilic Plant-Based Grana Cheeses from Native Soybeans

Cultured and aged blue cheeses were produced from soybeans to optimize the production and flavors of this cheese variety. First, soy milk was created using the methods described herein with lower fat content, aiming for fat to account for 30% of the final dry mass of the cheese. A thermophilic culture blend (Danisco Su Casu) was used with or without the addition of a mesophilic culture (Danisco MM100). The milk was allowed to culture for 110-260 min at temperatures between 30-43° C. before adding rennet in an amount of about 50-70 IMCU per liter followed by a mineral coagulant (calcium sulfate) at a concentration of 0-0.6% w/w. The coagulated curd was cut and left to culture until reaching a pH of 5.7-6.0. The curds were then pressed in a pneumatic press until the desired moisture content (45-55%) was reached. The curds were then milled and salted, aiming for a salt in moisture of 5-6. These curds were transferred into a cheese mold and pressed again to form the final shape of the cheese

Cheeses were then aged at 10-13° C. and relative humidity of 80-85%. Cheeses were flipped daily for the first 1-2 months of aging, and then weekly after that. To prepare the rinds of these cheeses, bandages, polymer coatings, and wax was used in various combinations.

TABLE 13
Ingredients and curd properties of thermophilic grana cheeses produced from soy beans.

| | Soy | Milk | | | | | | | | | Curd | | Curd | |
|---|---|---|---|---|---|---|---|---|---|---|---|---|---|---|
| Batch | Beans | Weight | Milk | | Fat | | Sugar | | CaSO4 | | Mass | Curd | Moisture | |
| ID | (kg) | (kg) | Brix | Culture | Amount | | (% w/v) | Rennet | Amount | | (kg) | pH | (%) | Rind |
| 121 | 3.5 | 20.9 | N/A | ta61 | 4% | w/v | 4% | mucor | 0.3% | w/v | 4.8 | 5.36 | 47% | natural |
| 122 | 3.5 | 22.45 | N/A | tc201 | 4% | w/v | 4% | mucor | 0.3% | w/v | 4.7 | 5.07 | 49% | natural |
| 123 | 3.5 | 21.05 | N/A | tc201 | 4% | w/v | 4% | mucor | 0.3% | w/v | 4.15 | 5.05 | 48% | natural |
| 124 | 2.75 | 21.49 | 9.5 | Therm C201 | 600 | g | 2% | supreme/star | 66 | g | 3.634 | 5 | 50% | natural |
| 125 | 2.8 | 20.4 | 10 | su casu | 500 | g | 0% | supreme/star | 67 | g | 3.424 | 5.09 | 51% | bandaged |
| 126 | 2.5 | 17.264 | 10.5 | su casu | 507 | g | 0 | star/supreme | 75 | g | 3.282 | 5.25 | 50% | polymer coating |
| 127 | 2.5 | 17.336 | 10 | su casu, mm100 | 507 | g | 0 | star/supreme | 75 | g | 2.882 | 5.23 | 49% | polymer coating |

| | | | | | | | | | | | | |
|---|---|---|---|---|---|---|---|---|---|---|---|---|
| 128 | 2.695 | 18.936 | 10 | su casu, mm100 | 733 | 0 | star/supreme | 67 | 3.71 | 5.51 | 51% | polymer coating |

N/A: information not available for this batch

### Example 13: Methods for Creating Hard, Aged Cheeses with Desired Glutamate Content, Moisture, and Lactic Acid Content from Soybeans

A representative sample of the hard, aged cheeses produced from soybeans in the foregoing Examples were analyzed for key parameters in the desirability of cheeses, specifically glutamate content, acidity, and moisture content.

1. Measuring Glutamate Content

To measure the glutamate content of the cheese, cheese samples of 0.5 grams were first pulverized in 20 milliliters of sterile deionized water. These samples were kept in a 55° C. water bath for 60 minutes. 1.5 milliliter aliquots of this homogenized sample were then transferred to microcentrifuge tubes, which were spun at 5000×g for 5 minutes. 1.2 milliliters of the supernatant were drawn off, avoiding any oils or solids at the solution-air interface. This material was spun one more time at 5000×g for 5 minutes, and 1 milliliter of supernatant was removed and stored frozen at −20° C. until analysis.

Glutamate was measured based on the activity of glutamate dehydrogenase as previously published (Bernt, E. & Bergmeyer, H. U. Methods of Enzymatic Analysis (Second Edition). Academic Press 1704-1715, 1974; Chapman, J. & Zhou, M. Microplate-based fluorometric methods for the enzymatic determination of 1-glutamate: application in measuring 1-glutamate in food samples. Anal. Chim. Acta 402:47-52, 1999). In brief, the following reactions were assembled in 96-well plates: 50 microliters of sample diluted to an estimated glutamate content of between 1-10 nanomoles, 10 millimolar Tris-HCl (Tris(hydroxymethyl)aminomethane hydrochloride), 0.625 units of glutamate dehydrogenase, 0.05 milligrams of WST-1 (2-(4-Iodophenyl)-3-(4-nitrophenyl)-5-(2,4-disulfophenyl)-2H-tetrazolium), 0.075 units of diaphorase, and 0.075 milligrams of NAD (Nicotinamide adenine dinucleotide). If the measured concentration of the sample fell outside the range of 1-10 nanomoles, the measurement was repeated with a different sample dilution rate until a readable measurement was obtained. L-glutamate was used to make standards of known concentration, and for each reaction, a blank reaction missing glutamate dehydrogenase was prepared to measure background signal. These plates were incubated for 30 minutes at 37° C., and then absorbance was read at 450 nanometers on a plate reader. The concentration of glutamate was calculated based on the sample readings minus the blank readings, using the linear standard curve.

2. Measuring Moisture Content

To measure the moisture content of the cheese, 20 gram samples were dry baked for 3 hours at 105° C. or until the mass of the sample no longer changed with additional baking. Moisture was calculated as the change in mass between the wet and dry sample.

3. Measuring Lactic Acid (pH)

To measure the pH of the cheese, a Hanna Instruments HI981032 Cheese pH Tester was used according to the manufacturer's instructions. The pH meter was calibrated with buffers of pH 7 and pH 4 before use.

4. Characterization of Cheeses

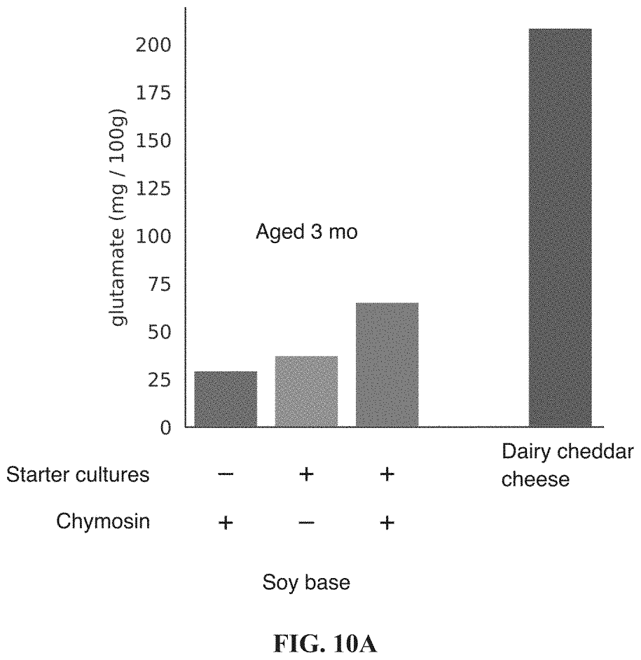

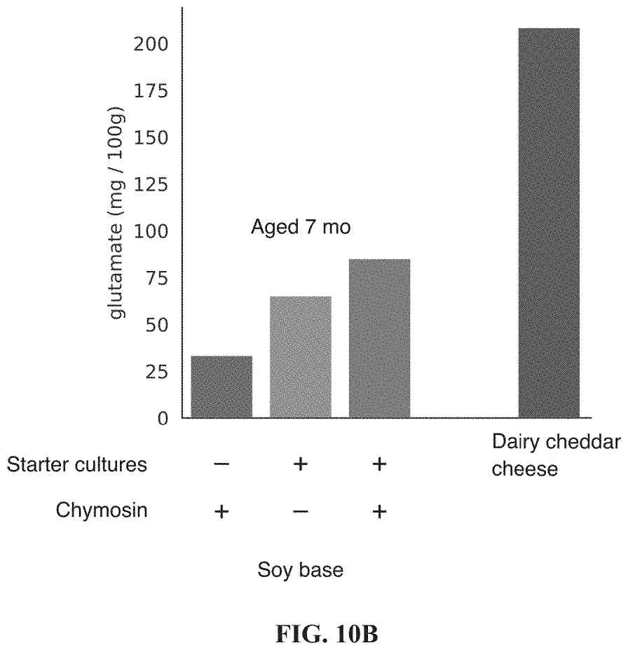

Three cheeses, batches 129-131, were produced according to Example 3C except that the soybeans were soaked in cold water, no sugar was added to the milk, and the salt added was for a salt in moisture of 4. Batch 130 was produced without starter culture, batch 131 was produced without star rennet (chymosin), and all batches were aged using the vac-seal method described in Table 6E. As shown in FIGS. 10A-10B, the absence of either rennet or starter cultures resulted in a decrease in the accumulation of glutamate in 3-month old cheeses as compared to a cheese made with both rennet and starter cultures. Similar patterns were observed after aging for 7 months. Glutamate accumulation in cheeses with and without either rennet or starter cultures is shown in Table 14. An age of “0 months” refers to shaped and salted curds that have not yet begun to age, while an age of “1 month”, “3 months”, and “7 months” refer to the curds after they have been vac-sealed and aged for 1, 3, and 7 months, respectively. As shown in Table 14, the batch 129, which was made with both rennet and cultures, accumulated the highest amount of glutamate of the three plant-based cheeses. For comparison, the dairy cheese Tillamook® Medium Cheddar, which had been aged for two months, was found to have a glutamate concentration of 208.67, a pH of 5.07, and a moisture content of 37.88%.

TABLE 14
Characterization of hard cheeses produced from soybeans as
described herein with and without rennet or starter cultures
and without additional flavoring agents. A dairy-based cheddar
cheese is included for comparison. “NM” indicates
that the parameter was not measured at the given age.

| | | | Batch ID | | |
|---|---|---|---|---|---|
| | Name | Age | 129 | 130 | 131 |
| Rennet (chymosin) | | | Yes | Yes | No |
| Starter culture (ma4001) | | | Yes | No | Yes |
| | Glutamate | 0 months | 25.66 | 53.51 | 41.57 |
| | (mg/100 g) | 1 month | 49.53 | 37.59 | 33.62 |
| | | 3 months | 65.44 | 29.64 | 37.59 |
| | | 7 months | 85.34 | 33.62 | 65.44 |
| | Lactic Acid | 0 months | 5.34 | 6.08 | 5.35 |
| | (pH) | 1 month | 5.16 | 4.9 | 5.05 |
| | | 3 months | 4.96 | 4.74 | 4.91 |
| | | 7 months | 5.2 | 4.96 | 5.13 |
| | Moisture % | 7 months | 49.32% | 58.86% | 48.99% |

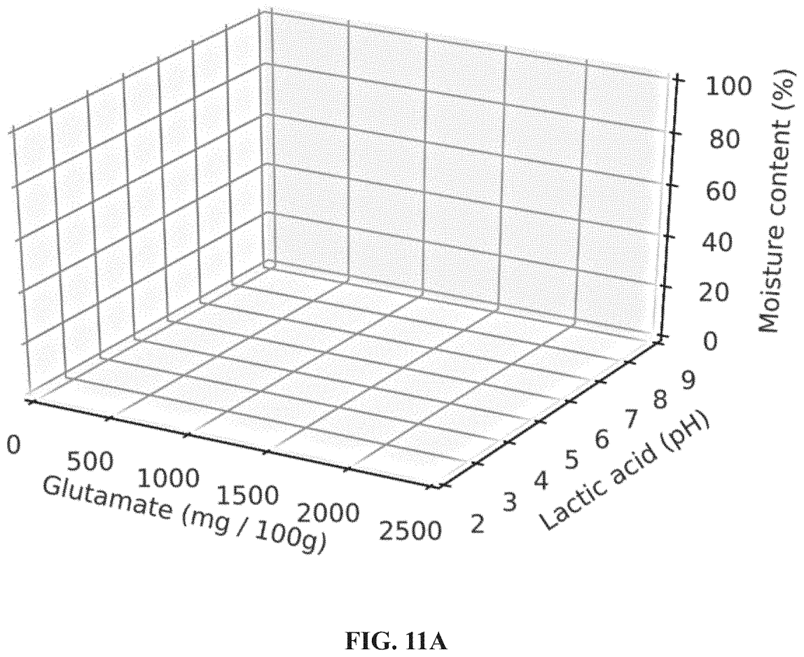

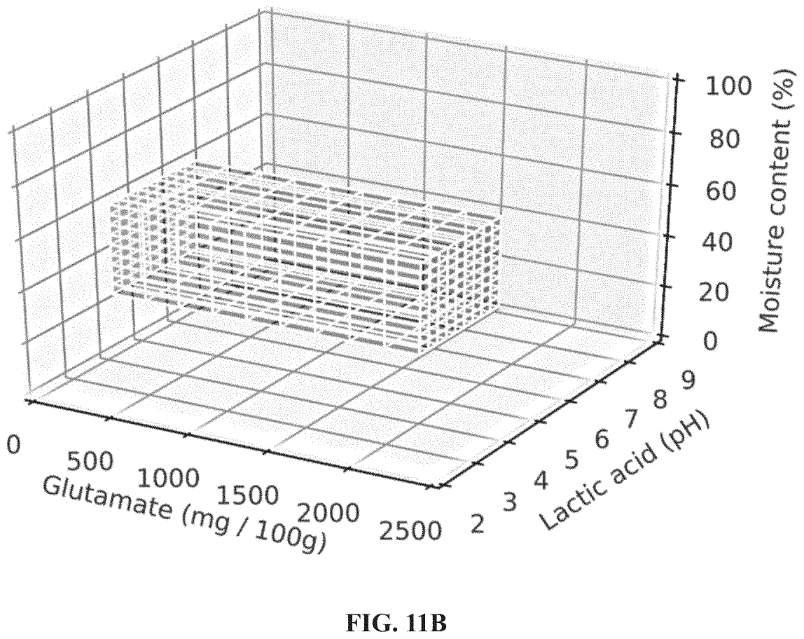

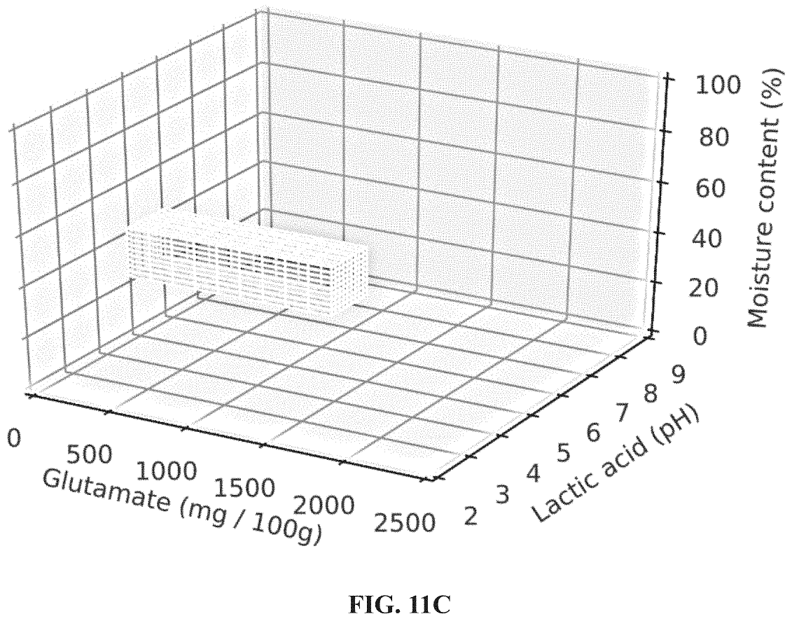

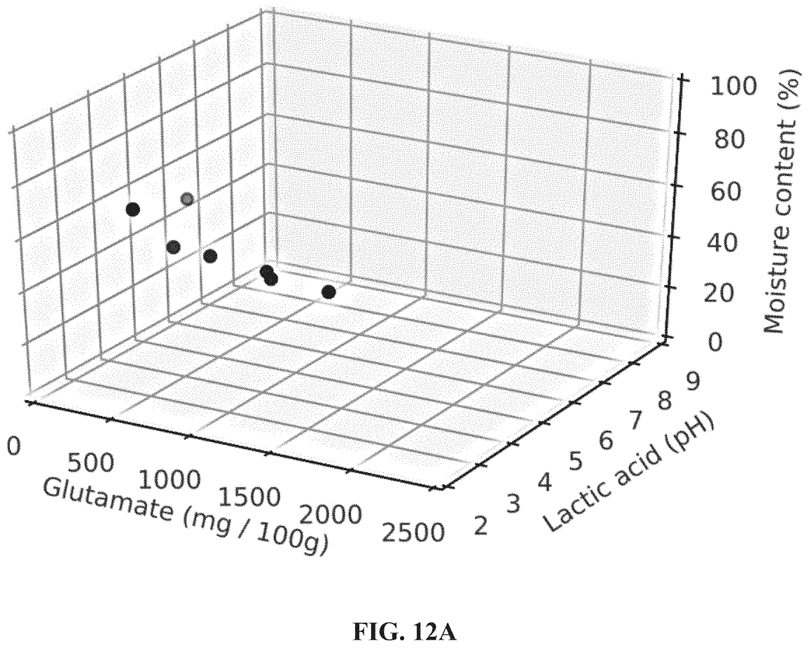

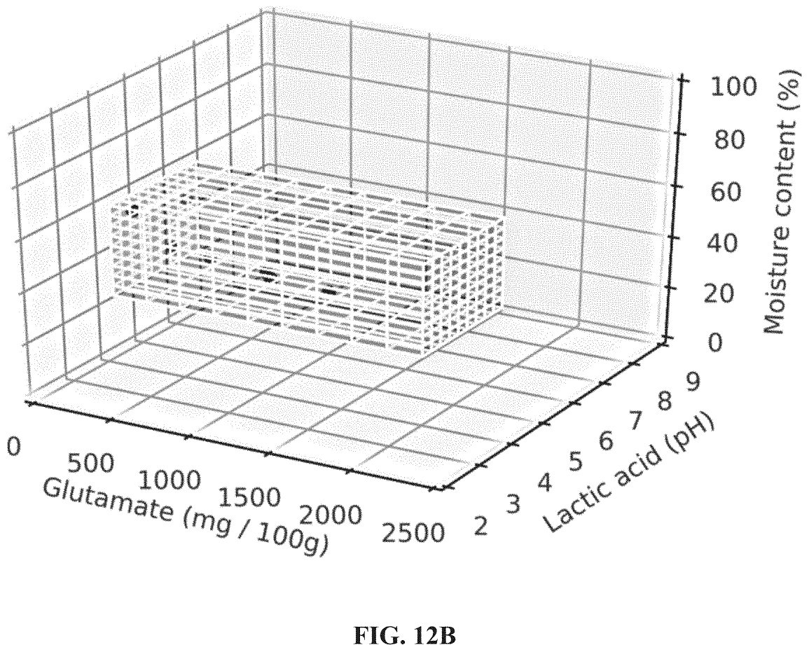

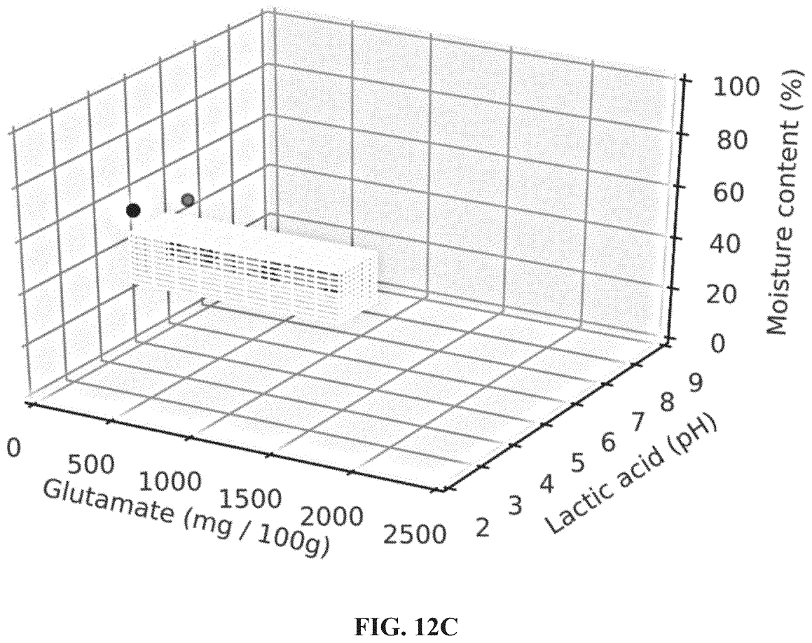

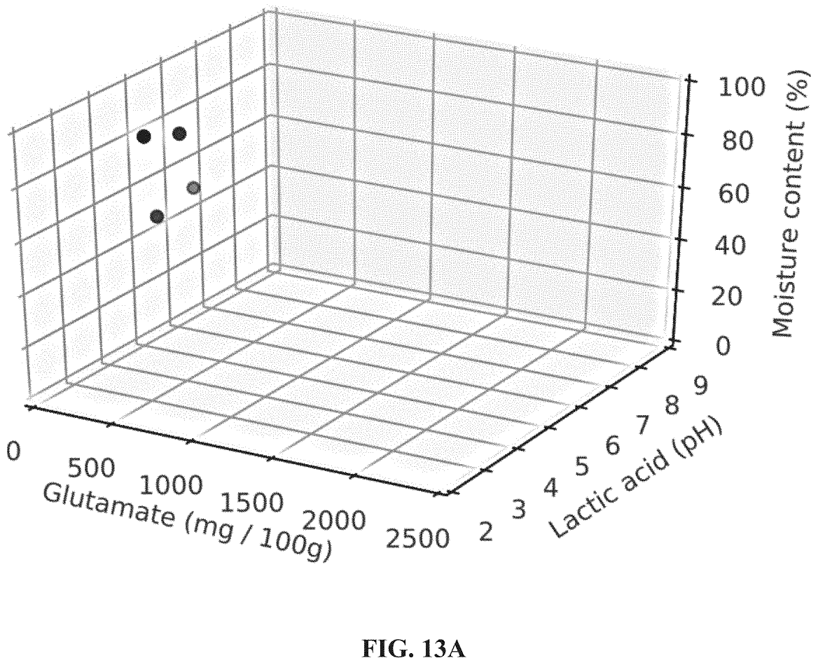

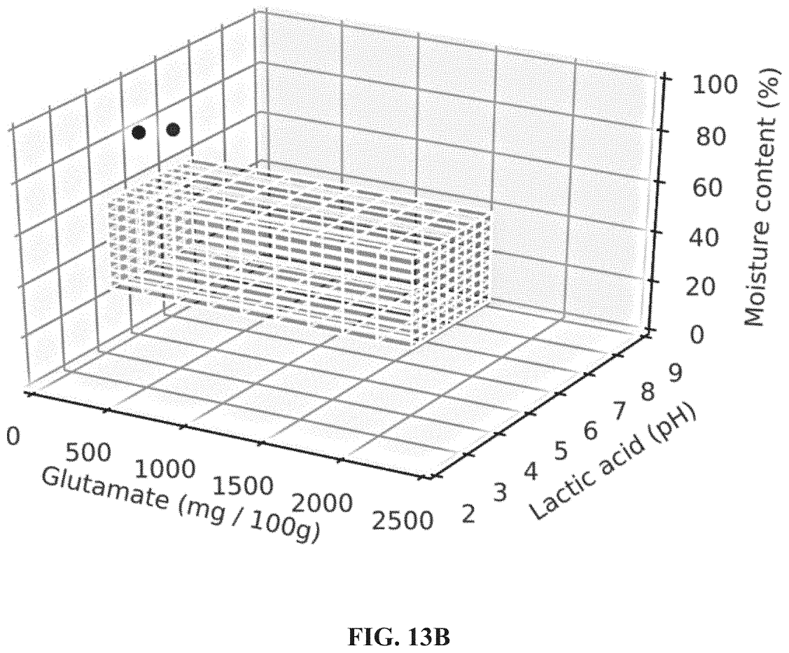

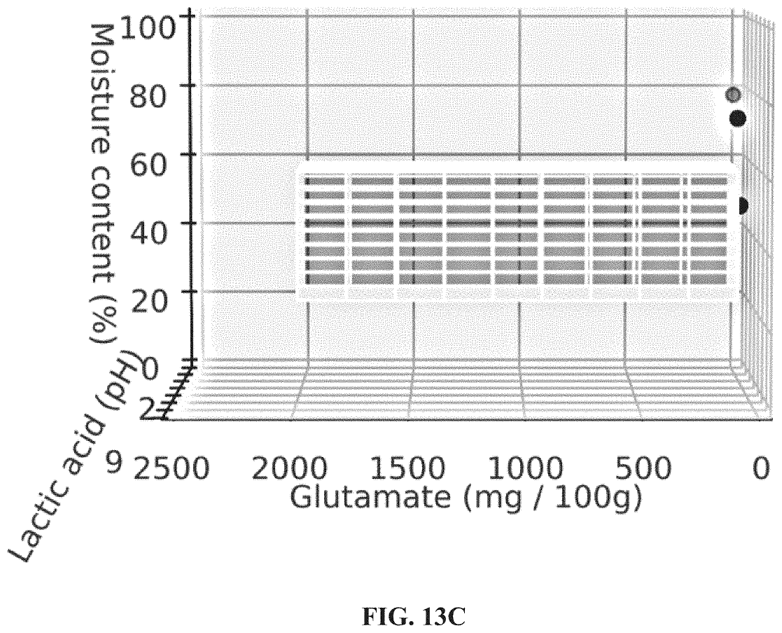

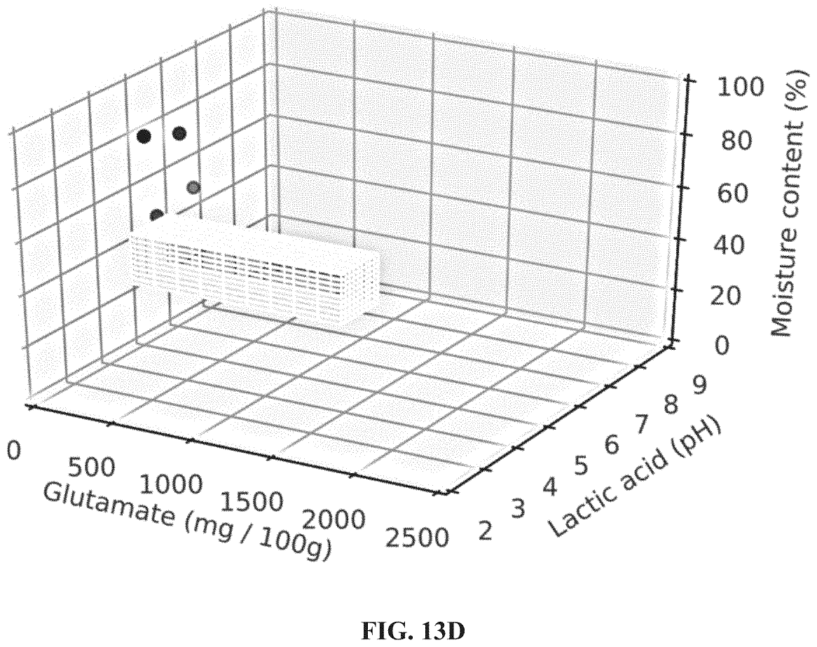

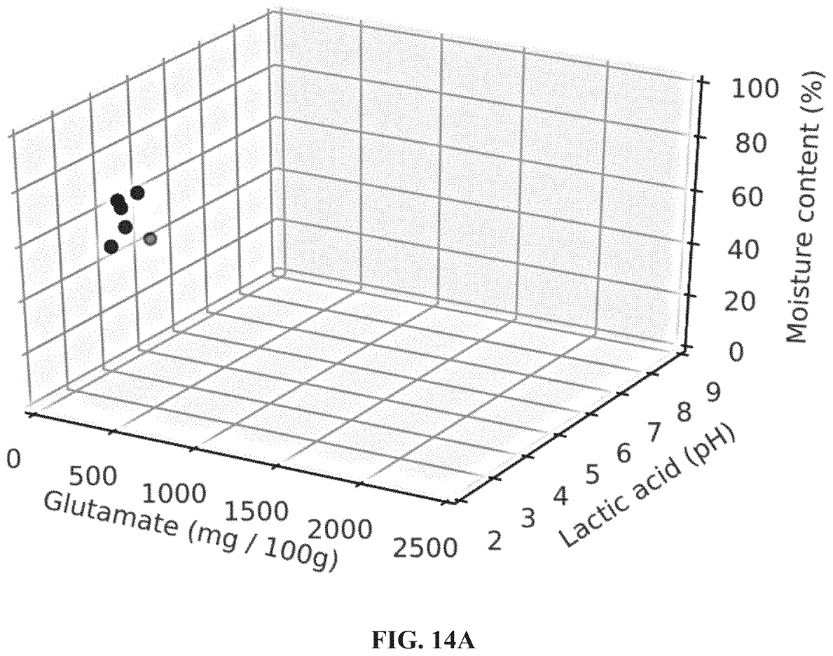

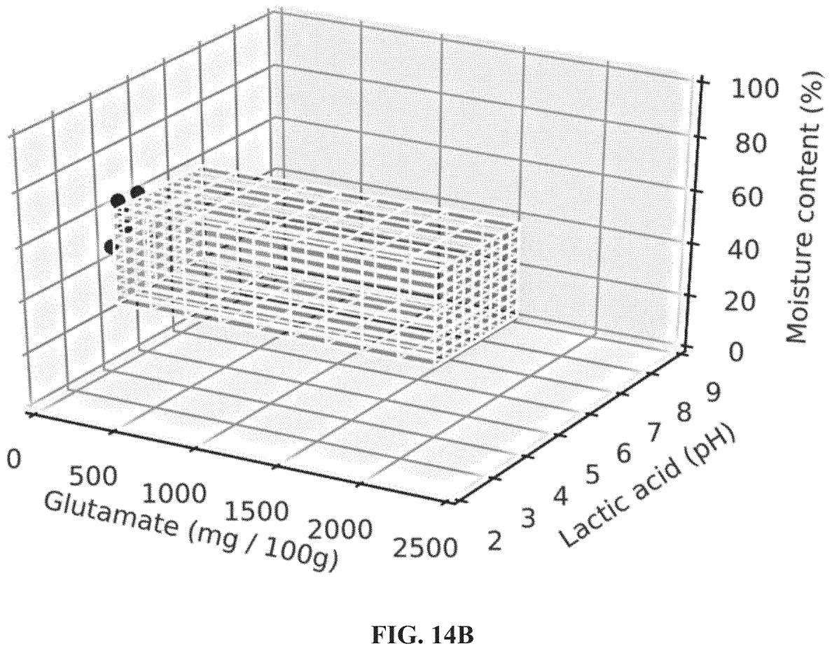

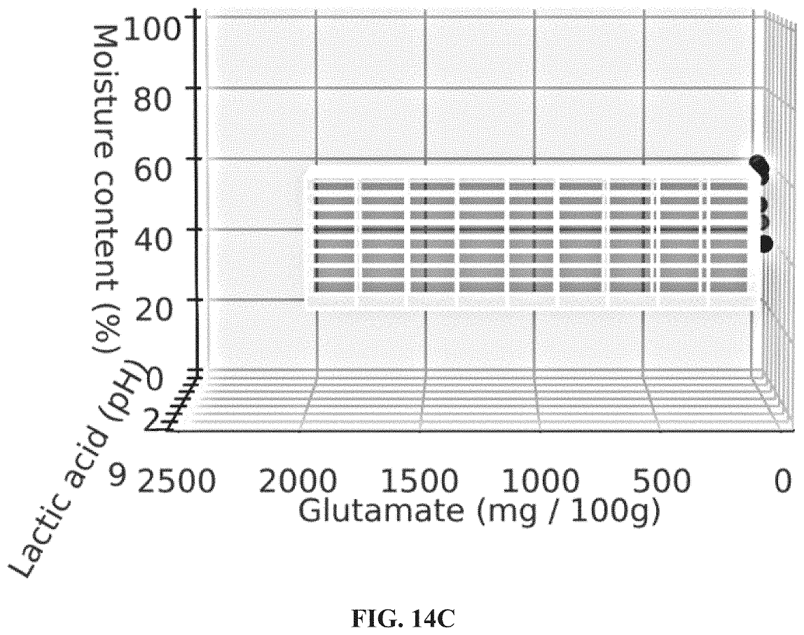

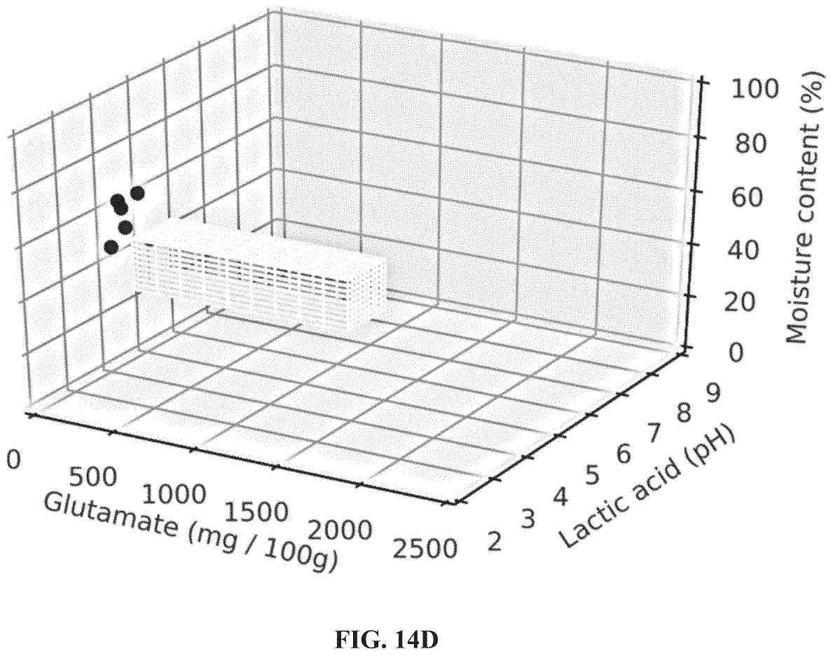

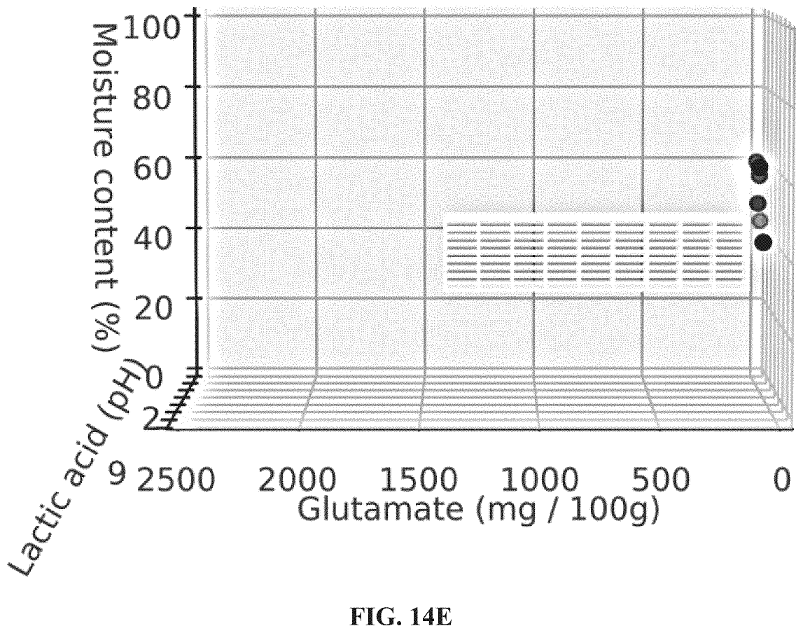

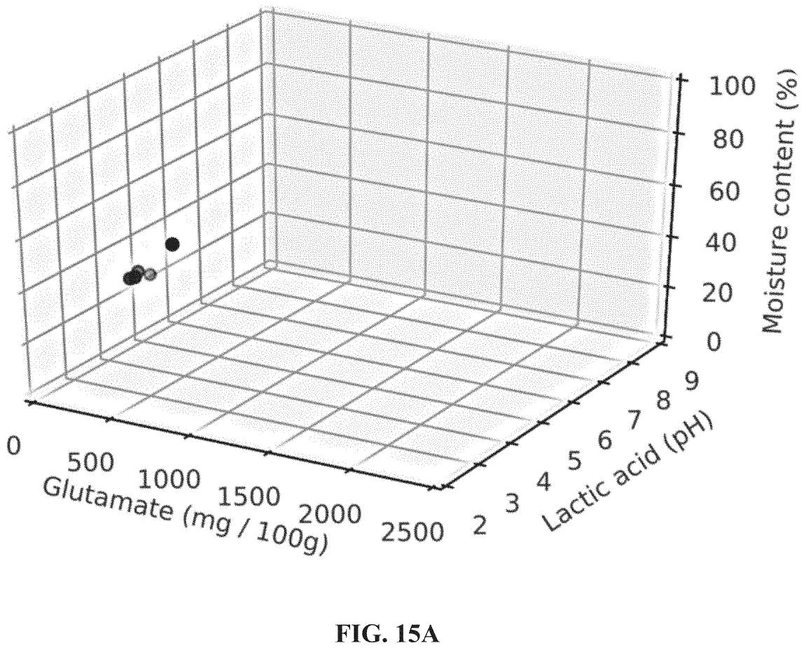

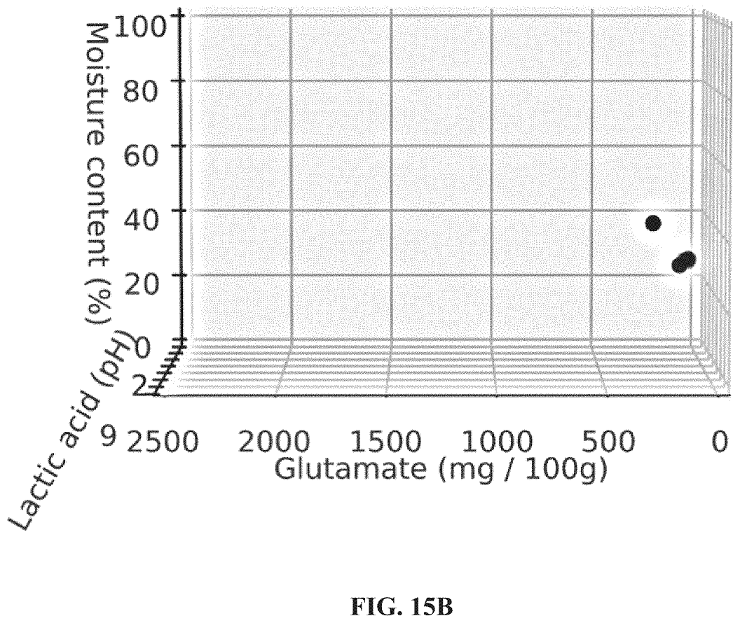

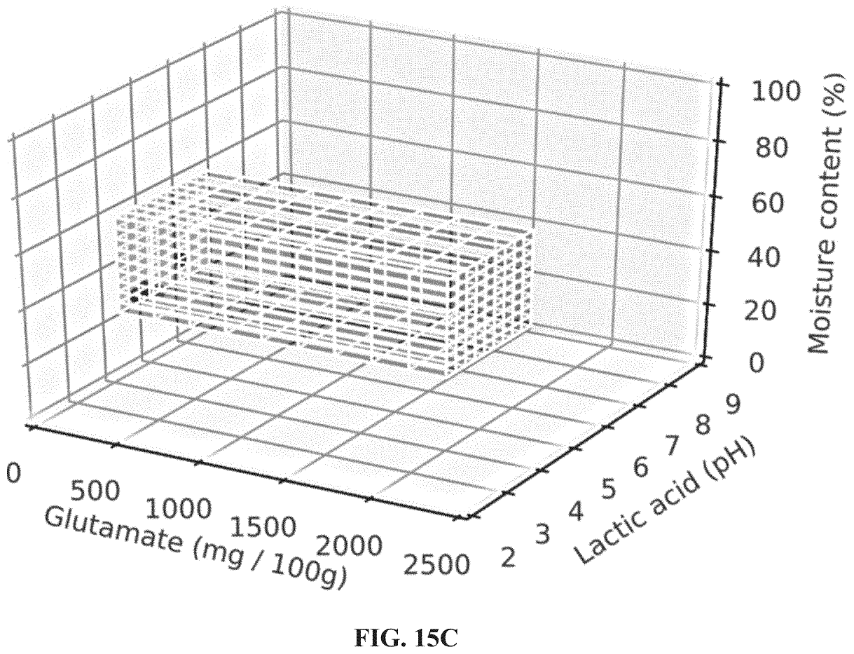

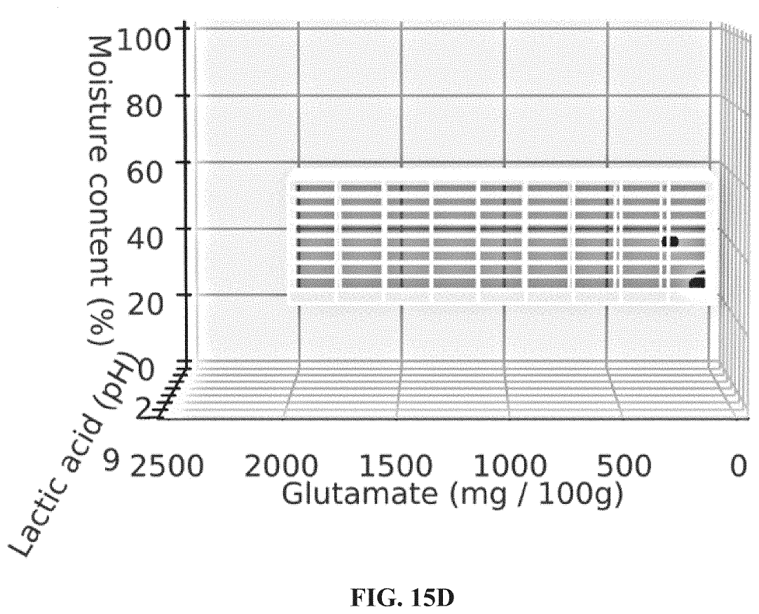

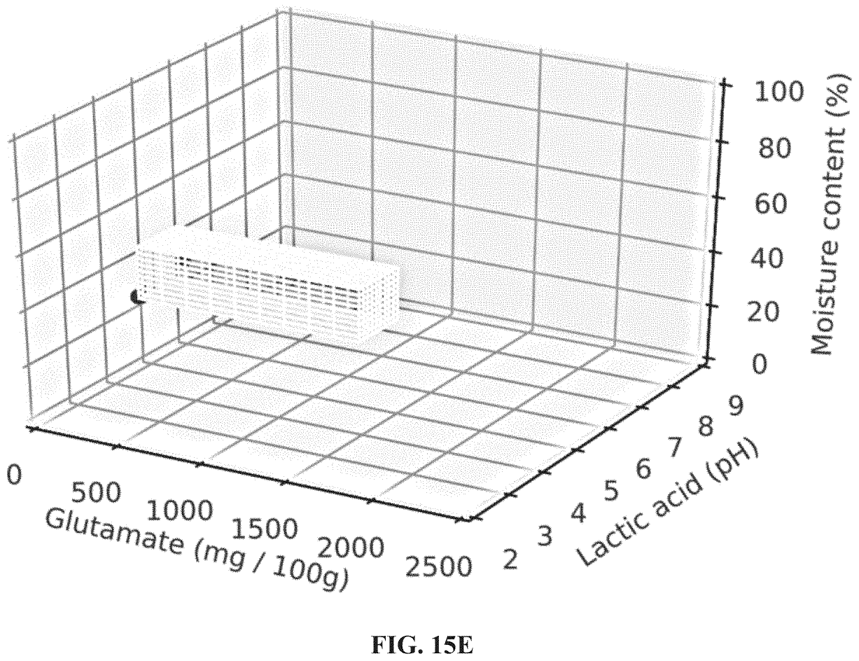

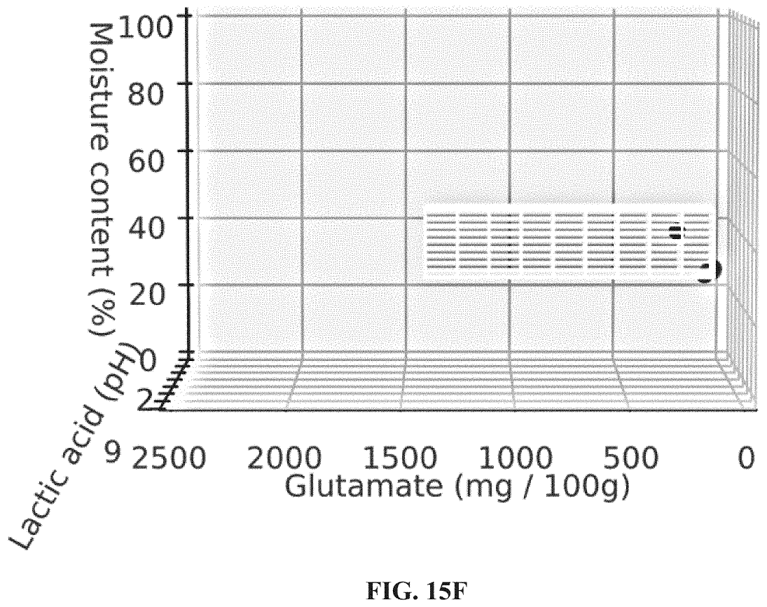

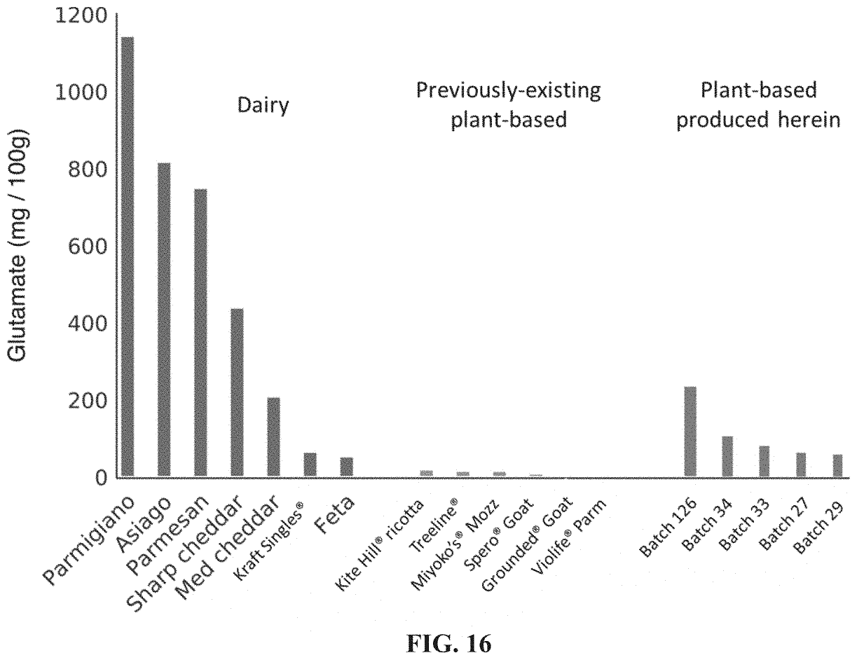

As shown in FIG. 11A, cheeses can be characterized by their glutamate content in milligrams per 100 grams of cheese, lactic acid content, and moisture content. The acceptable parameter space as shown in FIG. 11B is between 50 milligrams and 2000 milligrams of glutamate per 100 grams of cheese, between pH 4.0 and pH 6.5, and between 25% and 60% moisture content. Within this acceptable range, the preferred parameter space as shown in FIG. 11C is between 75 milligrams and 1400 milligrams of glutamate per 100 grams of cheese, between pH 4.4 and pH 5.5, and between 28% and 47% moisture content. Commercially available example dairy cheeses, both aged and unaged, are shown within this parameter space in FIG. 11D. Commercially available example aged dairy cheeses are shown within the acceptable (FIG. 12B) and preferred (FIG. 12C) parameter spaces in FIGS. 12A-C. The two example dairy cheeses that fall outside of the preferred space in FIG. 12C are Kraft Singles® American processed cheese and Belfiore Cheese™ Mediterranean Style Feta in Brine, representing processed cheeses and softer, higher-moisture cheeses which are expected to fall outside the preferred space. Commercially available example unaged dairy cheeses are shown within the acceptable (FIGS. 13B-13C) and preferred (FIG. 13D) parameter spaces in FIGS. 13A-D. As shown in FIGS. 13C and 13D, all of the unaged dairy cheeses fall below the acceptable and preferred ranges for glutamate content. Previously-existing exemplary non-dairy cheeses that contain no additives or exogenous sources of flavors are shown to fall outside of the both the acceptable (FIGS. 14B-14C) and preferred (FIGS. 14D-14E) parameter spaces in FIGS. 14A-E. Notably, as shown in FIG. 14C and FIG. 14E, all of the non-dairy cheeses fall below the acceptable and preferred ranges for glutamate content, and several fall above the acceptable and preferred ranges for moisture content. By contrast, the cultured plant-based cheeses produced as described herein and aged for 12 months are all shown in FIGS. 15A-F to fall within the acceptable (FIGS. 15C-15D) parameter space for moisture content, lactic acid development, and glutamate accumulation without any additions of flavor compounds of ingredients. Some of the cheese produced as described herein also fall within the preferred parameter space, as shown in FIGS. 15E-F, while others are within preferred parameter space for moisture content and lactic acid, and only slightly below the preferred glutamate content.

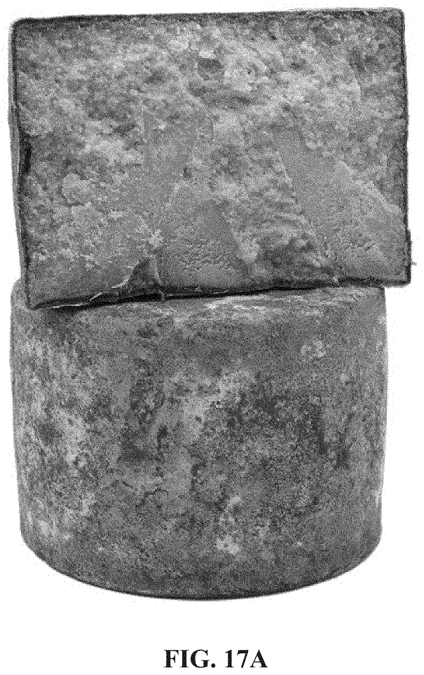

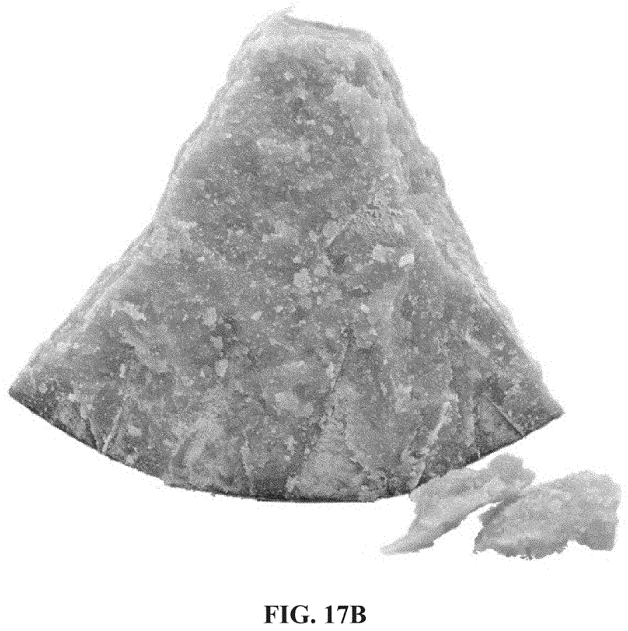

Table 15 shows the glutamate content, pH, and moisture content for commercially available dairy and non-dairy cheese as well as for Batches 27 and 29 as produced by the method in Example 3B and specified in Table 3A, Batches 33 and 34 as produced by the method in Example 3C and specified in Table 4A, and Batch 126 as produced by the method in Example 12 and specified in Table 13. Images of Batch 33 are shown in FIGS. 17A-17B. Almost all of the commercially available plant-based cheeses fall outside the acceptable parameter space (Table 15). Those that fall within the acceptable parameter space, specifically Miyoko's® Aged Sharp English Farmhouse Cashew Milk Cheese and Daiya® Cheddar Shreds, contain flavoring additives expected to add exogenous glutamate, such as nutritional or inactive yeast, and other flavoring agents listed as “natural flavors” on the product nutrition labels (Table 15). Of the previously-existing plant-based cheeses that fall outside of the acceptable parameter space, Violife® Just Like Cheddar has the highest concentration of glutamate (Table 15); however, it contains an ingredient(s) listed as “Cheddar flavor (vegan sources)”, which is likely to contain exogenous glutamate, as none of the other listed ingredients would be expected to add a detectable amount of protein or glutamate. Notably, while some of the previously-existing plant-based cheeses are cultured (specifically, the Kite Hill® Almond Milk Ricotta, Miyoko's® Aged Sharp English Farmhouse Cashew Milk Cheese, Miyoko's® Organic Cashew Milk Mozzarella Smoked, Treeline® Herb Garlic Cheese, and Spero® The Goat Cheese), none are known to use rennet or other proteolytic enzymes, and none are aged for significant periods.

By contrast, Batches, 27, 29, 33, 34, and 126 produced as described herein with rennet and cultures and aged for 12 months fall within the acceptable range for glutamate, despite the fact that they contain no flavoring additives expected to add glutamate (Table 15). Therefore, most or all of the glutamate present in Batches, 27, 29, 33, 34, and 126 is derived from enzymatic and microbial digestion of the proteins present in the starting soybean material during aging. These results demonstrate the surprisingly superior efficacy of the methods and compositions described herein for producing plant-based cheeses with flavor and moisture profiles that are more desirable than previously available plant-based cheeses and more similar to aged dairy cheeses. Furthermore, the compositions and methods describe here also result in much harder, denser cheeses than many of the other plant-based cheeses, which tend to be much softer or less cohesive. Not only does this decrease in moisture provide an eating experience more like hard and semi-hard cheese, but it also allows proper aging and flavor development.

TABLE 15
Characterization of hard cheeses produced from soy as described herein, compared to commercially-
available dairy-based and plant-based cheeses and other fermented food products.

| | | | | | | | |
|---|---|---|---|---|---|---|---|
| | | | Age | Flavoring | Glutamate | | Moisture |
| Batch ID/Name | Variety | Base | (months) | Additives | (mg/100 g) | pH | % |

Cultured Plant-Based Cheeses Produced Herein

| | | | | | | | |
|---|---|---|---|---|---|---|---|
| 27 | Hard | Soy | 12 | None | 63.56 | 4.67 | 29.38% |
| 29 | Hard | Soy | 12 | None | 58.80 | 4.45 | 28.18% |
| 33 | Hard | Soy | 12 | None | 81.39 | 4.5 | 28.70% |
| 34 | Grana | Soy | 12 | None | 106.73 | 4.82 | 27.64% |
| 126 | Hard | Soy | 12 | None | 235.94 | 4.93 | 40.28% |

Previously-Existing Non-Dairy Cheeses¹

| | | | | | | | |
|---|---|---|---|---|---|---|---|
| Spero ® the Goat Cheese | Soft | Sunflower seeds | 0 | None | 8.87 | 4.42 | 57.74% |
| Grounded ® Hemp Seed Goat | Soft | Hemp, coconut oil | 0 | None | 4.12 | 5.2 | 40.49% |
| Cheese with Garlic, Lemon + | | | | | | | |
| Thyme | | | | | | | |
| Violife ® Just Like Parmesan | Starch-fat | Coconut oil | 0 | None | 0 | 4.14 | 45.01% |
| Daiya ® Cheddar Shreds | Starch-fat | Coconut oil | 0 | Inactive Yeast, Yeast | 113.18 | 4.36 | 46.59% |
| | | | | Extract, Lactic Acid, | | | |
| | | | | Vegan Natural Flavors | | | |
| Violife ® Just Like Cheddar | Starch-fat | Coconut oil | 0 | Cheddar flavor, olive | 33.62 | 3.74 | 52.18% |
| | | | | extract, paprika extract | | | |
| Kite Hill ® Almond Milk Ricotta | Ricotta | Almond | 0 | None | 19.57 | 4.29 | 61.41% |
| Miyoko's ® Aged Sharp English | Soft | Cashew | 0 | Organic chickpea miso, | 97.27 | 4.24 | 23.58% |
| Farmhouse Cashew Milk Cheese | | | | Nutritional Yeast, | | | |
| | | | | Natural flavors | | | |
| Treeline ® Herb Garlic Cheese | Soft | Cashew | 0 | None | 16.00 | 4.48 | 50.19% |
| Miyoko's ® Organic Cashew | Mozzarella | Cashew | 0 | None | 16.00 | 4.85 | 60.48% |
| Milk Mozzarella Smoked | | | | | | | |

Dairy Cheeses

| | | | | | | | |
|---|---|---|---|---|---|---|---|
| Tillamook ® Sharp Cheddar | Cheddar | Cow milk | 9 | None | 439.41 | 5.1 | 36.81% |
| Tillamook ® Medium Cheddar | Cheddar | Cow milk | 2 | None | 208.67 | 5.07 | 37.88% |
| Kraft Singles ® | Processed cheese | Cow milk | 2 | None | 65.44 | 6.14 | 47.65% |
| Parmigiano Reggiano | Parmesan | Cow milk | 36 | None | 1,144.03 | 5.34 | 29.33% |
| Stravecchio 36 months | | | | | | | |
| Belgioioso ® Parmesan 10 | Parmesan | Cow milk | 10 | None | 749.73 | 5.34 | 32.61% |
| months | | | | | | | |
| Belfiore Cheese ™ Mediterranean | Feta | Cow milk | 2 | None | 53.51 | 4.63 | 53.96% |
| Style Feta in Brine | | | | | | | |
| Stella ® 12 Month Aged Asiago | Asiago | Cow milk | 12 | None | 817.36 | 5.15 | 31.97% |
| BelGioioso ® Ricotta con latte | Ricotta | Cow milk | 0 | None | 45.55 | 6.02 | 74.21% |
| Old Amsterdam ® Classic Gouda 8 | Gouda | Cow milk | 8 | None | N/D | 5.43 | 34.89% |
| Months | | | | | | | |
| Tillamook ® Low-moisture | Mozzarella | Cow milk | 1 | None | 41.57 | 5.32 | 47.18% |
| Mozzarella | | | | | | | |
| El Mexicano ® Cremoso Queso | Queso fresco | Cow milk | 0 | None | 39.56 | 6.4 | 50.77% |
| Fresco | | | | | | | |
| Knudsen ® Cottage Cheese 4% | Cottage cheese | Cow milk | 0 | None | 48.25 | 5.01 | 79.80% |
| milkfat small curd | | | | | | | |

N/D indicates data not available.
Italic values fall outside the acceptable cheese parameter space as defined in FIG. 11B and Example 13, section 4.
¹Full ingredients of previously-existing non-diary cheeses are listed below in alphabetical order.

Daiya® Cheddar Shreds Ingredients: Filtered Water, Tapioca Starch, Expeller Pressed: Canola and/or Safflower Oil, Coconut Oil, Inactive Yeast, Pea Protein, Vegan Natural Flavors, Salt, Xanthan Gum, Lactic Acid (Vegan), Yeast Extract, Titanium Dioxide Color, Annatto Color.

Grounded® Hemp Seed Goat Cheese with Garlic, Lemon+Thyme Ingredients: Filtered Water, Hemp Seed, Coconut Oil, Sea Salt, Tapioca Starch, Citrus Fiber, Sea Salt, Lactic Acid, Glucono Delta Lactone, Spices. (Marinade: Sunflower Oil, Extra Virgin Olive Oil, Meyer Lemon, Garlic, Thyme, Black Pepper).

Kite Hill® Almond Milk Ricotta Ingredients: Almond Milk (Water, Almonds), Salt, Enzymes, Tartaric Acid, Cultures.

Miyoko's® Aged Sharp English Farmhouse Cashew Milk Cheese Ingredients: Organic Cashew Milk (Organic Cashews, Filtered Water), Organic Chickpea Miso (Organic Rice Koji (Organic Rice, Koji Spores), Organic Whole Chickpeas, Sea Salt, Water), Nutritional Yeast, Sea Salt, Natural Flavors (derived from Oregano, Plum, Flaxseed), Cultures.

Miyoko's® Organic Cashew Milk Mozzarella Smoked Ingredients: Organic Cashew Milk (Filtered Water, Organic Cashews), Organic Coconut Oil, Organic Tapioca Starch, Sea Salt, Organic Agar, Mushroom Extract, Organic Konjac, Cultures.

Spero® the Goat Cheese Ingredients: Organic Sunflower Seeds, Water, Coconut Oil, Natural Flavors, Salt, Probiotic cultures.

Treeline® Herb Garlic Cheese Ingredients: Cashew Nuts, Filtered Water, Sea Salt, Cultured Brown Rice, Lemon Juice, Dried Scallions, Garlic Powder, Onion Powder, White Pepper, Dried Basil, Dried Oregano, L. acidophilus.

Violife® Just Like Cheddar Ingredients: Filtered Water, Coconut Oil, Food Starch-Modified (Potato & Corn), Potato Starch, Salt (Sea Salt), Cheddar Flavor (vegan sources), Olive Extract, Paprika extract & Beta Carotene (Color), Vitamin B12.

Violife® Just Like Parmesan Ingredients: Filtered Water, Potato & Rice Starch, Food Starch-Modified (potato), Coconut Oil, Salt (Sea Salt), Rice Protein, Parmezan Flavor (vegan sources), Olive Extract, Beta Carotene (Color), Vitamin B12.

Those skilled in the art will recognize, or be able to ascertain using no more than routine experimentation, many equivalents to the specific embodiments of the invention described herein. Such equivalents are intended to be encompassed by the following claims.

Unless defined otherwise, all technical and scientific terms used herein have the same meanings as commonly understood by one skilled in the art to which the disclosed invention belongs. Publications cited herein and the materials for which they are cited are specifically incorporated by reference.

What is claimed is:

1. A cultured plant-based cheese composition comprising:
(a) legume material, seed material, or a combination thereof in an amount of at least 40% by dry weight of the cultured plant-based cheese composition;
(b) one or more microbial cultures comprising one or more microbes;
(c) one or more coagulating agents;
(d) one or more proteolytic enzymes; and
(e) less than 1% nuts by dry weight of the cultured plant-based cheese composition,
wherein the cultured plant-based cheese composition has a moisture content of no greater than 60%; and
wherein the cultured plant-based cheese composition has been aged for a period of about 60 days or longer.

2. The composition of claim 1, wherein the legume material is soybean material.

3. The composition of claim 1, wherein the cultured plant-based cheese composition does not comprise nuts.

4. The composition of claim 1, wherein the cultured plant-based cheese-composition has a moisture content of no greater than 40%.

5. The composition of claim 1, wherein the cultured plant-based cheese composition has been aged for a period of about 90 days or longer.

6. The composition of claim 1, comprising free glutamate in an amount of at least 50 mg per 100 g of the cultured plant-based cheese composition.

7. The composition of claim 6, wherein at least 60% by weight of the free glutamate present in the plant-based cheese composition are derived from the legume material, seed material, or combination thereof of the plant-based cheese composition.

8. The composition of claim 1, wherein the plant-based cheese composition:
(i) does not comprise nutritional yeast;
(ii) does not comprise inactivated yeast;
(iii) does not comprise yeast extract;
(iv) does not comprise miso;
(v) does not comprise mushroom extract;
(vi) does not comprise onion powder;
(vii) does not comprise garlic powder;
(viii) does not comprise exogenous free amino acids;
(ix) does not comprise exogenous monosodium glutamate;
(x) does not comprise exogenous inosine-5′-monophosphate;
(xi) does not comprise exogenous guanosine-5′-monophosphate;
(xii) does not comprise exogenous succinic acid;
(xiii) does not comprise exogenous propionic acid;
(xiv) does not comprise exogenous lactic acid;
(xv) does not comprise exogenous diacetyl;
(xvi) does not comprise exogenous acetic acid;
(xvii) does not comprise exogenous keto acids;
(xviii) does not comprise exogenous alpha-keto acids;
(xix) does not comprise exogenous alpha-ketoglutarate;
(xx) does not comprise exogenous methyl ketones;
(xxi) does not comprise exogenous lactones;
(xxii) does not comprise exogenous homofuraneol;
(xxiii) does not comprise exogenous butyric acid;
(xxiv) does not comprise exogenous furaneol;
(xxv) does not comprise exogenous 3-(methylthio) propanal;
(xxvi) does not comprise exogenous 2,3-butanedione;
(xxvii) does not comprise exogenous (e)-2-nonenal; and/or
(xxviii) does not comprise exogenous (Z)-2-nonenal.

9. The composition of claim 1, wherein the one or more microbes are selected from the group consisting of Lactococcus sp., Lactobacillus sp., Streptococcus sp., Propionibacterium sp., Brevibacter sp., Leuconostoc sp., Corynebacterium sp., Pediococcus sp., Enterococcus sp., Bifidobacterium sp., Weissella sp., Penicillium sp., Aspergillus sp., Saccharomyces sp., Candida sp., and Geotrichum sp.

10. The composition of claim 1, wherein the one or more coagulating agents do not comprise a crosslinking enzyme.

11. The composition of claim 1, wherein the one or more proteolytic enzymes are selected from the group consisting of animal rennet, pepsin, chymosin, vegetable rennet, microbial rennet, papain, bromelain, serrapeptase, protease, pancreatin, and trypsin.

12. The composition of claim 1, wherein the cultured plant-based cheese composition has a pH of between 4.0 and 6.5.

13. A meltable plant-based cheese composition, comprising:
(i) the cultured plant-based cheese composition of claim 1 in an amount of between about 5% and about 70% by weight of the meltable plant-based cheese composition;
(ii) one or more gelling agents in an amount of between about 5% and about 60% by weight of the meltable plant-based cheese composition;
(iii) one or more plant fats in an amount of between 0% and about 30% by weight of the meltable plant-based cheese composition;
(vi) salt in an amount of between about 0.5% and about 3% by weight of the meltable plant-based cheese composition; and
(v) water in an amount of between about 20% and about 70% by weight of the meltable plant-based cheese composition;
wherein the meltable plant-based cheese composition melts at a temperature of between about 50° C. and about 90° C.

14. A method of producing a cultured plant-based cheese composition, the method comprising:
(a) providing a plant-based emulsion comprising legume material, seed material, or a combination thereof;
(b) adding one or more starter cultures comprising one or more microbes;
(c) culturing the one or more microbial cultures in the plant-based emulsion;
(d) coagulating the proteins in the plant-based emulsion to form curds and whey;
(e) separating the curds from the whey;
(r) salting the curds;
(g) shaping the curds; and
(h) aging the curds for a period of about 60 days or longer to produce the cultured plant-based cheese composition,
wherein the cultured plant-based cheese composition has a moisture content of no greater than 60% and comprises less than 1% nuts by dry weight of the cultured plant-based cheese composition.

15. The method of claim 14, wherein the plant-based emulsion comprises legume material, seed material, or a combination thereof in an amount of at least about 40% by dry weight of the plant-based emulsion.

16. The method of claim 14, wherein step (a) comprises substeps:
(a1) providing a base composition comprising legume material, seed material, or a combination thereof;
(a2) mixing the base composition with water; and
(a3) comminuting the base composition and water to produce the plant-based emulsion.

17. The method of claim 16, further comprising substep:
(a4) separating and discarding the insoluble solids from the plant-based emulsion.

18. The method of claim 16, wherein the base composition comprises legume material, seed material, or a combination thereof in an amount of at least 90% by dry weight of the base composition.

19. The method of claim 14, wherein the plant-based emulsion of step (a) has a Brix value of 5° Bx or higher.

20. The method of claim 14, wherein the legume material is soybean material.

21. The method of claim 14, wherein the aging of step (h) occurs over a period of about 90 days or longer.

22. The method of claim 14, wherein the cultured plant-based cheese composition has a pH of between 4.0 and 6.5.

23. The method of claim 14, wherein the one or more microbes of step (b) are selected from the group consisting of Lactococcus sp., Lactobacillus sp., Streptococcus sp., Propionibacterium sp., Brevibacter sp., Leuconostoc sp., Corynebacterium sp., Pediococcus sp., Enterococcus sp., Bifidobacterium sp., Weissella sp., Penicillium sp., Aspergillus sp., Saccharomyces sp., Candida sp., and Geotrichum sp.

24. The method of claim 14, further comprising adding one or more proteolytic enzymes prior to step (d).

25. The method of claim 24, wherein the one or more proteolytic enzymes are selected from the group consisting of animal rennet, pepsin, chymosin, vegetable rennet, microbial rennet, papain, bromelain, serrapeptase, protease, pancreatin, and trypsin.

26. The method of claim 14, wherein the coagulating of step (d) comprises adding one or more coagulating agents selected from the group consisting of mineral cations, acids, or coagulating enzymes.

27. Curds produced according to steps (a) through (e) in claim 14.

28. The method of claim 14, further comprising:
(i) mixing the cultured plant-based cheese composition with one or more gelling agents, one or more plant fats, and salt to create a mixture;
(j) blending the mixture;
(k) heating the mixture to between 50 and 90° C. for between 0 and 20 minutes to produce a cooked mixture;
(l) dispensing the cooked mixture into a form; and
(m) setting the cooked mixture in the form at between 1 and 8° C. for at least one day to produce a meltable plant-based cheese composition.

29. The method of claim 28, wherein the mixture of step (i) comprises:
(i) cultured plant-based cheese composition in an amount of between about 5% and about 70% by weight;
(ii) one or more gelling agents in an amount of between about 5% and about 60% by weight;
(iii) one or more plant fats in an amount of between 0% and about 30% by weight;
(vi) salt in an amount of between about 0.5% and about 3% by weight; and
(v) water in an amount of between about 20% and about 70% by weight.

30. A method of producing a cultured plant-based cheese composition, the method comprising:
(a) hydrating powdered legume material, powdered seed material, or a combination thereof to a moisture content of no greater than 60%;
(b) mixing the hydrated powdered legume material, powdered seed material, or combination thereof with one or more plant fats, salt, and acid to create a protein substrate;
(c) adding one or more microbial cultures comprising one or more microbes to the protein substrate;
(d) shaping the protein substrate; and
(e) aging the protein substrate for a period of about 60 days or longer to produce the cultured plant-based cheese composition,
wherein the cultured plant-based cheese composition comprises less than 1% nuts by dry weight of the cultured plant-based cheese composition.
